SEQUENCE LISTING (221 sequences)

SEQ ID NO: 1 - DNA, 4534 bp, synthetic construct
  misc_feature 1..4534: note = Synthetic Construct
  source 1..4534: mol_type = other DNA
ggcgaatcggacccacaagagcactgctaaatacattcaaatatctatccgctcatgagacaataaccctgataaatgcttcaataatattgaaaaaggaagaatatgagtattcaacatttccgtgtcgcccttattcccttttttgcggcattttgccttcctgtttttgctcacccagaaacgctggtgaaagtaaaagatgccgaagatcagttgggtgcacgtgtgggttacatcgaactggacctcaacagcggtaagattcttgagagttttcgccccgaagaacgtttcccaatgatgagcacttttaaagttctgctctgtggcgcggtattatcccgtattgacgccgggcaagagcaactcggtcgccgcatacactattctcagaatgacttggttgagtactcaccagtcacagaaaagcatcttacggacggcatgacagtacgcgaattatgcagcgctgccataaccatgagtgataacacggcggccaacttacttctgacaacgatcggaggaccgaaggagcttaccgcttttttgcacaacatgggtgatcatgtaactcgccttgatcgttgggaaccggagctgaatgaagccataccaaacgacgagcgtgacaccacgatgcctgtagctatggcaacaacgttgcgcaaactcttaactggcgaacttcttactctcgcttcccggcaacaattaatagactggatggaggcggataaagttgcaggaccacttctgcgctcggcccttccggctggctggtttattgctgataaatctggagccggtgagcgtgggtcccgcggtattattgcagccctggggccagatggtaagccctcccgtatcgtagttatctacacgacggggagccaggcaactatggacgaacgtaatcgccagatcgctgagataggtgcctccctgattaagcattggtaataataacgtaaaaacccgcttcggcgggtttttttatgcaagacgctggctctgacatcgagtagttcagtagcggaaatgtgagcaaaaggccagcaaaaggccaggaaccgtaaaaaggccgcgttgctggcgtttttccataggctccgcccccctgacgagcatcacaaaaatcgacgctcaagtcagaggtggcgaaacccgacaggactataaagataccaggcgtttccccctggaagctccctcgtgcgctctcctgttccgaccctgccgcttaccggatacctgtccgcctttctcccttcgggaagcgtggcgctttctcatagctcacgctgtaggtatctcagttcggtgtaggtcgttcgctccaagctgggctgtgtgcacgaaccccccgttcagcccgaccgctgcgccttatccggtaactatcgtcttgagtccaacccggtaagacacgacttatcgccactggcagcagccactggtaacaggattagcagagcgaggtatgtaggcggtgctacagagttcttgaagtggtggcctaactacggctacactagaaggacagtatttggtatctgcgctctgctaaagccagttaccttcggaaaaagagttggtagctcttgatccggcaaacaaaccaccgctggtagcggtggtttttttgtttgcaagtagcagattacgcgcagaaaaaaaggatctcaagaagatcttttgatcttttctacgggtggtaatctatgtatcctggcaactccgagcccttccaccgagacgaaataataaaaaagccggattaataatctggctttttatattctctgattttaagacccactttcacatttaagttgtttttctaatccgcatatgatcaattcaaggccgaataagaaggctggctctgcaccttggtgatcaaataattcgatagcttgtcgtaataatggcggcatactatcagtagtaggtgtttccctttcttctttagcgacttgatgctcttgatcttccaatacgcaacctaaagtaaaatgccccacagcgctgagtgcatataatgcattctctagtgaaaaaccttgttggcataaaaaggctaattgattttcgagagtttcatactgtttttctgtaggccgtgtacctaaatgtacttttgctccatcgcgatgacttagtaaagcacatctaaaacttttagcgttattacgtaaaaaatcttgccagctttccccttctaaagggcaaaagtgagtatggtgcctatctaacatctcaatggctaaggcgtcgagcaaagcccgcttattttttacatgccaatacaatgtaggctgctctacacctagcttctgggcgagtttacgggttgttaaaccttcgattccgacctcattaagcagctctaatgcgctgttaatcactttacttttatctaatctagacatcattaattcctaatttttgttgacactctatcattgatagagttattttaccactccctatcagtgatagagaaaagtgaaagcgctcaacgggtgtgcttcccgttctgatgagtccgtgaggacgaaagcgcctctacaaataattttgtttaaggtttacacaattaaggaggcttttttatggactacaaagaccatgacggtgattataaagatcatgacatcgattacaaggatgacgatgacaagggatcaatgcacaccgagaacgtactggatatcagaaccattgttgccaacgagtacgctgttaaaacctcagcggttgagtgggacgtgactgacatcgttaaaaatgccatcattggcggtatctcctttataccctccgtaggccctgccataagctttctggttgggcttttttggcctcaatctaaggaaaacatctgggagggcatcgtaaagcagattgaacggatgattgaagagagcgcccttaaaacgattaaggggatcttagcaggtgatatcgcgtatatacaggaaagaatggctacggtggccgatctgctggataaacatccgggcagtgaggaagctcgatctgcgttcaacaatttggcggagaatatagatggttaccataaaaagtttaataatttttctgatgatgttaactaccaaattcttccaatgttttccaccaccgtcatgatgcaaatcacatattgggttgctggcttggagcgacgaaacgaaatcggcctgagcgatatagatattgaaaaggtccgagggctgatcaaaaagactgtcgaacaggcaaattcttatatcaataatatttacgaccgggaactgaatgatgcgctgaataattcaaccgcagatacggttgcaaacaacgtgatgagcgtgcatggtcattgccgcctgcacggggtagagtatatcagcatctgggataaactctctgaagcagaaagcgtgaataaccgtatctacgtggacgttctctcatatagcacctttttcgatcgtcagacggcaaaggcgcgtatccaagctctgactccggaaaaagatatggctccaccgcttaaaccggcattaaacgggggtaagcgccgtaaaattgattctctgactggacatatcgttcgcattggtggcgcgccgcgcgttggcggtctgaccgtagtgttcgacgatggcaattcacaccgcttgggcaccatctctggtgaaaccgcttccatctcgctgaacgggtcccgcataacctctctggaagtgtggggcaacggtgcagttgatcaggcagtgttcacgttgtccgatggccgctctctgagctttggcgcgcctggtacttcgcgatatcgcaaattttacgttggcgaatcacactatatcgcgggcatatacctttctagcgattattctcctttggcaggtcaagcggcaaacatagcagtttcataccaacttataaatgatgacgagaaatgactagcaggcataaggaggtaatagaatgtcgcgaattacgattgtggttgatagcgatgaacagaaagccgagttttactctaactcgccggtaccggtacacaaagatcttaacgcggttggcccgcttagcgatgttacaataagcccacatgcttcagttgaggttttccgtatcgacaccccaatcattcctgaatccaggcggtcactgcgtgttgtgaataccggtttgtcaaactccgttactgctaaattttactggtcacactcatttactagtgaatggtttgaatcgggatcgattgacgttggccttggcgaagagaaggttttaaacgttccgaacaactccttctattatagtaaattcgttatttataacaatactgataaagtggcctatgttaccgccaatctagtatgaatgcctcggtaccaaattccagaaaagaggcctcccgaaaggggggccttttttcgttttggtccatgcctcggtaccaaattccagaaaagaggcctcccgaaaggggggccttttttcgttttggtcccgtctctgttccttatcatct

SEQ ID NO: 2 - DNA, 402 bp, synthetic construct
  misc_feature 1..402: note = Synthetic Construct
  source 1..402: mol_type = other DNA
atgtcgcgaattacgattgtggttgatagcgatgaacagaaagccgagttttactctaactcgccggtaccggtacacaaagatcttaacgcggttggcccgcttagcgatgttacaataagcccacatgcttcagttgaggttttccgtatcgacaccccaatcattcctgaatccaggcggtcactgcgtgttgtgaataccggtttgtcaaactccgttactgctaaattttactggtcacactcatttactagtgaatggtttgaatcgggatcgattgacgttggccttggcgaagagaaggttttaaacgttccgaacaactccttctattatagtaaattcgttatttataacaatactgataaagtggcctatgttaccgccaatctagtatga

SEQ ID NO: 3 - DNA, 1335 bp, synthetic construct
  misc_feature 1..1335: note = Synthetic Construct
  source 1..1335: mol_type = other DNA
atggactacaaagaccatgacggtgattataaagatcatgacatcgattacaaggatgacgatgacaagggatcaatgcacaccgagaacgtactggatatcagaaccattgttgccaacgagtacgctgttaaaacctcagcggttgagtgggacgtgactgacatcgttaaaaatgccatcattggcggtatctcctttataccctccgtaggccctgccataagctttctggttgggcttttttggcctcaatctaaggaaaacatctgggagggcatcgtaaagcagattgaacggatgattgaagagagcgcccttaaaacgattaaggggatcttagcaggtgatatcgcgtatatacaggaaagaatggctacggtggccgatctgctggataaacatccgggcagtgaggaagctcgatctgcgttcaacaatttggcggagaatatagatggttaccataaaaagtttaataatttttctgatgatgttaactaccaaattcttccaatgttttccaccaccgtcatgatgcaaatcacatattgggttgctggcttggagcgacgaaacgaaatcggcctgagcgatatagatattgaaaaggtccgagggctgatcaaaaagactgtcgaacaggcaaattcttatatcaataatatttacgaccgggaactgaatgatgcgctgaataattcaaccgcagatacggttgcaaacaacgtgatgagcgtgcatggtcattgccgcctgcacggggtagagtatatcagcatctgggataaactctctgaagcagaaagcgtgaataaccgtatctacgtggacgttctctcatatagcacctttttcgatcgtcagacggcaaaggcgcgtatccaagctctgactccggaaaaagatatggctccaccgcttaaaccggcattaaacgggggtaagcgccgtaaaattgattctctgactggacatatcgttcgcattggtggcgcgccgcgcgttggcggtctgaccgtagtgttcgacgatggcaattcacaccgcttgggcaccatctctggtgaaaccgcttccatctcgctgaacgggtcccgcataacctctctggaagtgtggggcaacggtgcagttgatcaggcagtgttcacgttgtccgatggccgctctctgagctttggcgcgcctggtacttcgcgatatcgcaaattttacgttggcgaatcacactatatcgcgggcatatacctttctagcgattattctcctttggcaggtcaagcggcaaacatagcagtttcataccaacttataaatgatgacgagaaatga

SEQ ID NO: 4 - protein, 133 aa, synthetic construct
  REGION 1..133: note = Synthetic Construct
MSRITIVVDSDEQKAEFYSNSPVPVHKDLNAVGPLSDVTISPHASVEVFRIDTPIIPESRRSLRVVNTGLSNSVTAKFYWSHSFTSEWFESGSIDVGLGEEKVLNVPNNSFYYSKFVIYNNTDKVAYVTANLV

SEQ ID NO: 5 - protein, 444 aa, synthetic construct
  REGION 1..444: note = Synthetic Construct
MDYKDHDGDYKDHDIDYKDDDDKGSMHTENVLDIRTIVANEYAVKTSAVEWDVTDIVKNAIIGGISFIPSVGPAISFLVGLFWPQSKENIWEGIVKQIERMIEESALKTIKGILAGDIAYIQERMATVADLLDKHPGSEEARSAFNNLAENIDGYHKKFNNFSDDVNYQILPMFSTTVMMQITYWVAGLERRNEIGLSDIDIEKVRGLIKKTVEQANSYINNIYDRELNDALNNSTADTVANNVMSVHGHCRLHGVEYISIWDKLSEAESVNNRIYVDVLSYSTFFDRQTAKARIQALTPEKDMAPPLKPALNGGKRRKIDSLTGHIVRIGGAPRVGGLTVVFDDGNSHRLGTISGETASISLNGSRITSLEVWGNGAVDQAVFTLSDGRSLSFGAPGTSRYRKFYVGESHYIAGIYLSSDYSPLAGQAANIAVSYQLINDDEK

SEQ ID NO: 6 - protein, 135 aa, Xenorhabdus nematophila
MITIHISGGSVTINNNIVTETDVQNTPASAPLSITNFRDMTIEPHSSVEAIRTDTPIIPESRPNYYVANSGPASSVRAVFYWSHSFTSEWFESSSIIVKAGEDGVLHSPGNSLYYSKVVIYNDTDKRAFVTGYNL

SEQ ID NO: 7 - protein, 419 aa, Photorhabdus luminescens
MQTENVLDIRTIVANEYAVKTSALEWDVTDIVKNAIIGGISFIPSVGPAISFLVGLFWPQSKENIWEGIVKQIERMIEESALKTIKGILAGDIAYIQERMATVADLLDKHPGSEEARSAFNNLAENIDGYHKKFNNFSDDVNYQILPMFSTTVMMQITYWVAGLERKDEIGLSNIDIEKVRGLIKKTVEQANSYINNIYDRELNDALNNSTADTVANNVMSVHGHCRLHGIEYISIWDRLSEAESVNNRIYVDVLSYSTFFDRQTAKARIQALTPEKDMAPPLKPALNGGKRRKIDSLTGHIVRIGGAARVGGLTVVFDDGSRHQLGTISSETSSISLNGSRITSLEVWGNGAVDQAVFTLRDGRSLSLGSPGTSRYRKFHVGESHYIAGIYLSSDYSPLAGQAANIAVSYQLINDDEK

SEQ ID NO: 8 - protein, 137 aa, Xenorhabdus doucetiae
MITINISGGSVTINNTYNITSESGIQNTPASEPLTVIPYRDMTIEPHSSIEATRTDTPIIPETRPNYYIANSGPASEVRAVFYWSHSFTSQWFESSSIIVKAGEDGILQSPSNSLYYSKVVIYNDTDKRAFVTGYNK

SEQ ID NO: 9 - protein, 429 aa, Xenorhabdus nematophila
MNNEPMNTNESQASEIVPSMNESILAAPYSISTPNYEWDMSSIIKDAIIGGIGFIPGPGSAISFLLGLFWPQQTDNTWEQILQKVEQMIEQANLKTIQGILNGDIQEIKGKMEHVQFMLESSPGTQESHDAYMFLARYLVSIDEKFKSFDNKTNYQILPMYTNTIMLQAPYWKMGIERKDEIKLTDIEVNELKELIGKLSTSADKYIHDVYTREYDNAMNTSTAANITNNLLSVRGYCLLHGLECLEVINHIQNNSLEQSFYPKTISYSTVFDRQTNKTRVQALTEDDQMQEPFKPALINGKYNKIKSLIGYVQRIGNAPRVGGIKVTFANDASYTLGTVTSEVNSIELNDSVITSLEVWGNGAIDEAFFTLSDGRQFRLGQRYASNYRKYAVDNHYISGLYLASDEPSLAGQAAGIAVSYHMIADKKS

SEQ ID NO: 10 - protein, 135 aa, Xenorhabdus poinarii
  REGION 1..135: note = G6
MITINISGGSVTINNNISSVTDIQKPLDAEPLSVTNYRDLTIEPHSSIQADRTDTPIIPETRPNYYVANSGPASSIKAVFYWSHSFTSEWFEYSSITVKAGEDGILKSPSNSVYYSKVVIYNDTDKRAFVTGYNM

SEQ ID NO: 11 - protein, 429 aa, Xenorhabdus nematophila; identical to SEQ ID NO: 9
  REGION 1..429: note = F1

SEQ ID NO: 12 - protein, 135 aa, Xenorhabdus nematophila
  REGION 1..135: note = F1
MITINITGDNVRVNNNIATETDLQNTPASAPLSIINFRDMTIEPHSSVEAIRTDTPIIPESRPNYYVANSGPASSVRAVFYWSHSFTSEWFESSSIIVKAGEDGVLHSPGNSLYYSKVVIYNDTDKRAFVTGYNL

SEQ ID NO: 13 - protein, 429 aa, Xenorhabdus nematophila
  REGION 1..429: note = str. Websteri
MNNEPMNTNESQVSEIVPSMNESILAAPYSISTPNYEWDMSSIIKDAIIGGIGFIPGPGSAISFLLGLFWPQQTDNTWEQIFQKVEQMIEQANLKTIQGILNGDIQEIKGKMEHVQFMLESSPGTQESHDAYMFLARYLVSIDEKFKSFDNKTNYQILPMYTNTIMLQAPYWKMGIERKDEIKLTDIEVNELKELIGKLSTSADKYIHDVYTREYDNAMNTSTAANITNNLLSVRGYCLLHGLECLEVINHIQNNSLEQSFYPKTISYSTVFDRQTNKTRVQALTEDDQMQEPFKPALINGKYNKIKSLIGYVQRIGNAPRVGGIKVTFANDASYTLGTVTSEVNSIELNDSVITSLEVWGNGAVDEAFFTLSDGRQFRLGQRYASNYRKYAVDNHYISGLYLASDEPSLAGQAAGIAVSYHMIADKKS

SEQ ID NO: 14 - protein, 135 aa, Xenorhabdus nematophila; identical to SEQ ID NO: 12
  REGION 1..135: note = str. Websteri

SEQ ID NO: 15 - protein, 414 aa, Xenorhabdus poinarii
  REGION 1..414: note = G6
MNNSPMNDQLSTAPYSISTPNYEWDMSSIIKDAIIGGIGFIPGPGSAISFLLGLFWPQQTDNTWDQILQKIEQMIEEANLKTIKGILNGDIQEIKGKMEHVQHMLESSPGSQESHDAYMFLARFLVSIDEKFKSFDDRTNYQILPMYTNTIMLQAPYWKMGIEKKEDIGLTDIEVGELKELIDKLYTKSHEYIHNTYNREYDNAINTSTAESITNNLLSVRGYCLLHGCECLEVIAHIQNNSLDKGFYPTTISYSNVFDRPTNKMRIQALTEDDQMQEPFKPSFVNGQYNKIKSLEGYVTRIGNAPRVGGIKITFENNASYTLGTVTSETTFIELNESVITSIEVWGNGAVDEAFFTLSDGRQMRLGQRYASRYRKYAADGHYISGLYLASDEPSLAGQAAGIAVSYHMIVDKQ

SEQ ID NO: 16 - protein, 111 aa, Vibrio parahaemolyticus
MSNNIKHETDYSHDWTVEPNGGVTEVDSKHTPIIPEVGRSVDIENTGRGELTIQYQWGAPFMAGGWKVAKSHVVQRDETYHLQRPDNAFYHQRIVVINNGASRGFCTIYYH

SEQ ID NO: 17 - protein, 141 aa, Xenorhabdus cabanillasii
  REGION 1..141: note = JM26
MITININVNGNDITGTNNNEPTPVSTTYGPNTPASEPPVVSNYSDITIEPHSSVQATRIDTPVIPEARPDYYVANSGPAPSVRAVFYWSHSFTSEWFESSSITVKAGEDGILKAPGNSLYYSKVVIYNDTDKRAFVTGYNK

SEQ ID NO: 18 - protein, 141 aa, Xenorhabdus ehlersii
MNTININISGSTVTVISNNDSNPEPLTYNTNTPASDPLTASPYRDMTIEPHSSIEATRTDTPIIPETRPNYYVANSGPASSVRAVFYWSHSFTSEWFEYSSIIVKAGKDGILQSPNNALYYSKVVIYNDTDKRAFVTGYNK

SEQ ID NO: 19 - protein, 111 aa, Vibrio parahaemolyticus; identical to SEQ ID NO: 16
  REGION 1..111: note = v110

SEQ ID NO: 20 - protein, 140 aa, Xenorhabdus khoisanae
MITININGSSSITIINNSQTAPATKIDNQNTPESELHIISNYSDMTIEPHSSVQATRTDTPIIPETRPNYYVANSGPAPEVRAVFYWSHSFTSQWFEHSSITVKAGEDGILQSPSNSVYYSKVVIYNDTDKRAFVTGYNK

SEQ ID NO: 21 - protein, 140 aa, Xenorhabdus sp.
  REGION 1..140: note = GDc328
MININISGSSDITIINNTPSNPEPLIYNTDTPASEPLTVNPYRDMTIEPHSSIEAIRIDTPIIPETRPNYYVANSGPASSVRAVFYWSHSFTSEWFEYSAITVKAGEDGILQSPSNSVYYSKVVIYNETDKRAFVTGYNK

SEQ ID NO: 22 - protein, 141 aa, Xenorhabdus thuongxuanensis
MNTININISSSTVTVISNNDTNPEPLTYNTNTPASEPLTVSPYRDMTIEPHSSIEATRTDTPIIPERHRNYYVANSGPASSVRAVFYWSHSFTSQWFEHSSITVKAGEDGILQAPSNSLYYSKVVIYNDTDQRAFVTGYNK

SEQ ID NO: 23 - protein, 132 aa, Alcaligenes faecalis
MKDQFSNNEIEKLSRGVGLETSPADESVQLLSGGTFTVPKHGSVQAAKYSTPVIPEIHKSYWIFNAGKANKIKAVFYWSHSFTSSWFEYSSVEVGIGEEKKLQAPSNSLYYSKVVLFNGTDQNATVSVTVAK

SEQ ID NO: 24 - protein, 141 aa, Xenorhabdus eapokensis
MNTININISGSTVTVISNNDTNPEPLTYNTNTPASEPLTVSPYRDMTIEPHSSIEATRTDTPIIPERRRNYYVANSGPASSVRAVFYWSHSFTSQWFEHSSITVKAGEDGILQAPSNSLYYSKVVIYNDTDQRAFVTGYNK

SEQ ID NO: 25 - protein, 135 aa, Xenorhabdus nematophila; identical to SEQ ID NO: 12

SEQ ID NO: 26 - protein, 140 aa, Xenorhabdus miraniensis
MITINISGSSSITIINNTQTAPISKIDNQNTPESETHIISNYSDMTIEPHSSVQATRIDTPIIPETRPNYYVANSGPAPEVRAVFYWSHSFTSQWFEHSSITVKAGEDGILKSPGNSLYYSKVVIYNDTDKRAFVTGYNK

SEQ ID NO: 27 - protein, 144 aa, Photorhabdus luminescens
  REGION 1..144: note = subsp. laumondii
MPVNQIGLHNEKVKNMRKITVDNDVVGHDTEINSVVSSTAEKIRQQFGVKVDPNSSQEKFYIATPIIPESRKNIVVTNEGLADVITAKYYWSHSFTSEYFEDNSVDVKVGESKVLVAPSNPLYYSKVVIFNNTKSVAFVTVREK

SEQ ID NO: 28 - protein, 141 aa, Xenorhabdus ishibashii
MNTININISSSTVTVISNNGSNPEPLTYNANTPASEPLTVSPYKDMTIEPRSSIEATRTDTPIIPETRPNYYVANSGPASSVRAVFYWSHSFTSQWFEYSSIIVKAGEDGILKSPSNSLYYSKVVIYNDTDQRAFVTGYNK

SEQ ID NO: 29 - protein, 141 aa, Xenorhabdus beddingii
MITININISGGEFQSVIDNKNISTLKNDNIITPASESPTISNYKEMTVEPHSSIEATRIDTPIIPETRPNYFIANSGPASSVRAVFYWSHSFTSEWFESSSVIVNAGEEKILHSPSNSLYYSKVVIYNDTDQRAFITGYNL

SEQ ID NO: 30 - protein, 141 aa, Xenorhabdus kozodoii
MSTINININSSTVTVITNNGETPVPLTYNTNTPESEPLTVNPYRDMTIEPRSSIEATRIDTPIIPETRPNYYVANSGPASSVRAVFYWSHSFTSQWFEYSSIIVKAGEDGILESPSNSLYYSKVVIYNDTDKRAFVTGYNK

SEQ ID NO: 31 - protein, 141 aa, Xenorhabdus vietnamensis
MNTININISGSNVTVINNNDSNSEPLTYNTNTPASEPLTVSPYKDMTIEPHSSIEAIRIDTPIIPETRPNYYVANSGPAPSVRAVFYWSHSFTSQWFEHSSITVKAGEDGILQSPSNSVYYSKVVIYNDTDKRAFVTGYNK

SEQ ID NO: 32 - protein, 132 aa, Xenorhabdus budapestensis
MVLQLQIVIMNLLQYRQLTVQIHQHQNPLQSGNYSDITIEPHSSVQATRIDTPIIPEARPDYYVANSGPAPTVRAVFYWSHSFTSEWFESSSIIVKAGEDGILKAPGNSLYYSKVVIYNDTDKRAFVTGYNK

SEQ ID NO: 33 - protein, 425 aa, Xenorhabdus khoisanae
MNTTPIIISENKTLPLSNEILMIDTYTVATPDYEWDMSSIIKDAIIGGIGFIPGAGPAMSFLLGLFWPQQKDNTWEQILQKVEQMIEDAALKTIKGILNGDIQEIKGKMEHVEYMLENSPGSQESRDAYMFLARYLVSVEEKFKSFDNKTNYQILPMYSNTLMLQAPYWKMGIEKKGDIGLTDIEVDELNQLINKLVVNANNYIRTMYTNQYDDAINTSTAESVTNNLFSVRGYCLLHGLECLEFIEHIQNDSLESGFYPKTISYSTVFDRPTNKTRIQALTEDDQTQEPLKPSLVNGKYNKIKSLTGYVQRIGNAPRVGGITIIFDNDSSHTLGTVTSETRSIELSGSVITSLEVWGNGAVDEALFRLSDGRQFSFGQRYAKKYRKFAVDGHYIAGLYLASDEPSLAGQTAGIVVSYHMLTDKK

SEQ ID NO: 34 - protein, 425 aa, Xenorhabdus sp.
  REGION 1..425: note = GDc328
MNTTPINVSENDTLPVLTDVMLIVPYTTSTPDYEWDMSSIIKDAIIGGVGFIPGVGSAMSFLLGLFWPQQKDNTWEQILQKVEQMIENAALQTIKGILNGDIQEIKGKMEHVQYMLETSPGSQESHDAYMFLARYLVSIDERFKSFDNKTNYQILPMYTNTVMLQIPYWKMGIEKKNDIGLTDIEVNELKQLIDTLVDRARNYIHTMYTNEYNNAINTSTAESVTNNLLSVRGYCLLHGLECIELIEHLQNNSLESGFNPKTISYSTVFDRPTNKTRIQALTEDDQMQEPFKPSLIDGKYNKIKSLLGYVRRIGNAPRVGGIQITFANDSSYTLGTVTSETSSIELNDSVIERLEVWGNGAVDEALFTLSDGRQLRVGERYATKYRKYAVDGHYIAGLYLASDEPSLAGQAAGIAVSYHMLADKK

SEQ ID NO: 35 - protein, 430 aa, Xenorhabdus doucetiae
MNNTSININENETLPLEVIPSMPEPMLIVPYATSTPDYEWDASGIIKDAIIGGIGFIPGPGPAISFLLGLFWPQQADNTWEQILQKVEQMIEDAVLKTIQGILNGDIQEIKGKMEHVQYMLETSPGSQESREAYMFLARYLVSIDEKFKSFDNKTNYQILPMYTNTLMLQVPYWKMGIEKQKDIGLSDIEVNELKQLIDKLYTKANSYIHETYTRQYNDAINTSTAANITNNLFSVRGYCLLHGLECLEMIEHLQKNSLESGFYPKTISYSTVFDRQTPKMRIQALTEDDQMQEPLKPSLINGKYNQIKSLTGYVRRIGNAPRVGGMTITFANGASYTLGTVTSETTSIELNGSVIESLEVWGDGAVDEALFTLSDKRLFRIGERYARKYKKYAVDSHYIAGLYLASDEPSLAGQAAGIAVSYHMLDDKK

SEQ ID NO: 36 - protein, 425 aa, Xenorhabdus cabanillasii
  REGION 1..425: note = JM26
MNTTPITVSTNETSSLMTDVMPMDLYAISTPDYEWDMSSIIKDAVIGGIGFIPGPGPAISFLLGLFWPQQKDNTWEQILQKVEQMIENAVLQTIKGILNGEVQEIKGKMEHVESMLKNSPGSQESHDAYMFLARYLVSIDEKFKSFDNRTNYQILPMYTNTIMLQIPYWKMGIEKKKDIGLTDIEVNELKELIDKLVDKAKNYIHTMYTNEHNNAVNTSTAESVTNNLLSVRGYCLLHGLECIEVIEHIQNNSLESGFYPKIISYSTAFDRPTNKMRIQALTEDDAMQEPFKPSLINGKYNKIQSLTGYIQRIGNAPRVGGIRITFTNGSSYTLGTVTSETHSIKLNDSVIESLEVWGNGAVDEALFKLSDGRLLRIGERYAKKYRKYAVDNHYIAGIYLASDEPSLAGQAAGIAVSYHMMADKK

SEQ ID NO: 37 - protein, 438 aa, Vibrio parahaemolyticus
MTNEYVVTMSSLTEFNPNNARKSYLFDNYEVDPNYAFKAMVSFGLSNIPYAGGFLSTLWNIFWPNTPNEPDIENIWEQLRDRIQDLVDESIIDAINGILDSKIKETRDKIQDINETIENFGYAAAKDDYIGLVTHYLIGLEENFKRELDGDEWLGYAILPLLATTVSLQITYMACGLDYKDEFGFTDSDVHKLTRNIDKLYDDVSSYITELAAWADNDSYNNANQDNVYDEVMGARSWCTVHGFEHMLIWQKIKELKKVDVFVHSNLISYSPAVGFPSGNFNYIATGTEDEIPQPLKPNMFGERRNRIVKIESWNSIEIHYYNRVGRLKLTYENGEVVELGKAHKYDEHYQSIELNGAYIKYVDVIANGPEAIDRIVFHFSDDRTFVVGENSGKPSVRLQLEGHFICGMLADQEGSDKVAAFSVAYELFHPDEFGTEK

SEQ ID NO: 38 - protein, 419 aa, Photorhabdus luminescens
  REGION 1..419: note = subsp. laumondii
MHTENVLDIRTIVANEYAVKTSAVEWDVTDIVKNAIIGGISFIPSVGPAISFLVGLFWPQSKENIWEGIVKQIERMIEESALKTIKGILAGDIAYIQERMATVADLLDKHPGSEEARSAFNNLAENIDGYHKKFNNFSDDVNYQILPMFSTTVMMQITYWVAGLERRNEIGLSDIDIEKVRGLIKKTVEQANSYINNIYDRELNDALNNSTADTVANNVMSVHGHCRLHGVEYISIWDKLSEAESVNNRIYVDVLSYSTFFDRQTAKARIQALTPEKDMAPPLKPALNGGKRRKIDSLTGHIVRIGGAPRVGGLTVVFDDGNSHRLGTISGETASISLNGSRITSLEVWGNGAVDQAVFTLSDGRSLSFGAPGTSRYRKFYVGESHYIAGIYLSSDYSPLAGQAANIAVSYQLINDDEK

SEQ ID NO: 39 - protein, 431 aa, Pectobacterium peruviense
MNNYTANVGFKKEFNPILLTPQDTFLLRMSIEQLDVSGILKSVLQKGVSFIPTVGPALSFMIGFFWPQKKSDLWQQVLDLVDQKIRESELKVIRGILSGDLAYKKMRMEAVATMMEKSPGTPETRATFNNLADEFYGFQEKFNSFKEDDSTNYLILPMYSITVMLELVYWINGLEKKDQLGLSYIEVAKLEGYVNETFDTARKYIEDMYKEKLEDAYENSPGDDIVNNVMSVHGYCQLNGVEYISIWRKIKEAQSISKQFYVDVLTYSIFFGRQTPKLKYLALTDAEDMPPPFRPNIVNGKRTKIRHITGCITRIGGTARVGGLKLDFEDGSTYDLGTITGETRSISLNGSTITSVEVWGRGAIDELRFNLSDGRVFSFGEMGTTNYMRFSISEEHHIAGMFLSSDATGLARQAANFGVSYQLNEDFELKE

SEQ ID NO: 40 - protein, 431 aa, Pectobacterium odoriferum
MNNYTANVGFKKEFNPILLTPQDTFLLRMSIEQVDVSGILKSVLQKGVSFIPTVGPALSFMIGFFWPQKKSDLWQQVLDLVDQKIRESELKVIRGILSGDLAYKKMRMEAVATMMEKSPGTPETRATFNNLADEFYGFQEKFSSFKEDDSTNYLILPMYSITVMLELVYWINGLEKKDQLGLSYIEVAKLEGYVNETFDIARKYIEDMYKEKLEDAYENSPGDDIVNNVMSVHGYCQLNGVEYISIWRKIKEAQSISKQFYVDVLTYSIFFGRQTPKLKYLALTDAEDMPPPFRPNIVNGKRTKIRHITGCITRIGGTARVGGLKLDFEDGSTYDLGTITGETRSISLNGSTITSVEVWGRGAIDELRFNLSDGRVFSFGEMGTTNYMRFSISEEHHIAGMFLSSDATGLARQAANFGVSYQLNEDFELKE

SEQ ID NO: 41 - protein, 419 aa, Photorhabdus sp.
  REGION 1..419: note = HUG-39
MHTENVLDIRTIVANEYAVKTSALEWDVTDIVKNAIIGGISFIPSVGPAISFLVGLFWPQSKENIWEGIVKQIERMIEESALKTIKGILAGDIAYIQERMATVADLLDKHPGSEEARSAFNNLAENIDGYHKKFSNFSDDVNYQILPMFSTTVMMQITYWVAGLERKDEIGLSNIDVEKVRGLIKKTVEQANSYINNIYDRELNDALNNSTADTVANNVMSVHGHCRLHGIEYISIWDKLSEAESVNNKIYVDVLSYSTFFDRQTAKARIQALTPEKDMTPPLKPALNGGKRRKIDSLTGHIVRIGGAARVGGLTVVFDDGNRHQLGTISGETSSISLNGSRITSLEVWGNGAVDQAVFTLNDGRSLSLGSPGTSRYRKFYVGESHYIAGIYLSSDYNPLAGQAANIAVSYQLINDDEK

SEQ ID NO: 42 - protein, 419 aa, Photorhabdus laumondii
  REGION 1..419: note = subsp. clarkei
MHTENVLDIRTIVANEYAVKTSAVEWDVTDIVKNAIIGGISFIPSVGPAISFLVGLFWPQSKENIWEGIVKQIERMIEESALKTIKGILAGDIAYIQERMATVADLLDKHPGSEEARSAFNNLAENIDGYHKKFNNFSDDVNYQILPMFSTTVMMQITYWVAGLERRNEIGLSDIDIEKVRGLIKKTVEQANSYINNIYDRELNDALNNSTADTVANNVMSVHGHCRLHGIEYISIWDKLSEAESVNNRIYVDVLSYSTFFDRQTAKARIQALTPEKDMAPPLKPALNGGKRRKIDSLMGHIVRIGGAPRVGGLTVVFDDGNSHRLGTISGETASISLNGSRITSLEVWGNGAVDQAVFTLSDGRSLSFGAPGTSRYRKFYVGESHYIAGIYLSSDYSPLAGQAANIAVSYQLINDDEK

SEQ ID NO: 43 - protein, 438 aa, Vibrio parahaemolyticus; identical to SEQ ID NO: 37
  REGION 1..438: note = v110

SEQ ID NO: 44 - protein, 420 aa, Photorhabdus luminescens
MMQTENVLDIRTIVANEYAVKTSALEWDVTDIVKNAIIGGISFIPSVGPAISFLVGLFWPQSKENIWEGIVKQIERMIEESALKTIKGILAGDIAYIQERMATVADLLDKHPGSEEARSAFNNLAENIDGYHKKFNNFSDDVNYQILPMFSTTVMMQITYWVAGLERKDEIGLSNIDVEKVRGLIKKTVEQANSYINNIYDRELNDALNNSTADTVANNVMSVHGHCRLHGIEYISIWDRLSEAESVNNRIYVDVLSYSTFFDRQTAKARIQALTPEKDMAPPLKPALNGGKRRKIDSLTGHIVRIGGTARVGGLTVVFDDGSRHQLGTISGETSSISLNGSRITSLEVWGNGAVDQAVFTLRDGRSLSLGSPGTSRYRKFYVGESHYIAGIYLSSDYSPLAGQAANIAVSYQLINDDEK

SEQ ID NO: 45 - protein, 419 aa, Photorhabdus sp.
  REGION 1..419: note = S10-54
MHTENVLDLRTIVANEYAVKTSALEWDVTDIVKNAIIGGISFIPSVGPAISFLVGLFWPQSKENIWEGIVKQIERMIEESALKTIKGILAGDIAYIQERMATVADLLDKHPGSDEARSAFNNLAENIDGYHKKFNNFSDDVNYQILPMFSTTVMMQITYWVAGLERRAEIGLSDIDIEKVRGLIKKTVEQANSYINDIYDRELNDALNNSTADTVANNVMSVHGHCRLHGIEYISIWDKLSETESVNNRIYVDVLSYSTFFDRQTAKARIQALTPEKDMAPPLKPALNGGKRRKIDSLMGHIVRIGGAPRVGGLTVVFDDGSSHRLGTISGETASISLNGSRITSLEVWGNGAVDRAVFTLSDGRSLLFGDPGTSRYRKFYVGESHYISGIYLSSDYSPLAGQAANIAVSYQLINDDEK

SEQ ID NO: 46 - protein, 419 aa, Photorhabdus sp.; identical to SEQ ID NO: 45
  REGION 1..419: note = S8-52

SEQ ID NO: 47 - protein, 419 aa, Photorhabdus luminescens
MQTENVLDIRTIVANEYAVKTSALEWDVTDIVKNAIIGGISFIPSVGPAISFLVGLFWPQSKENIWEGIVKQIERMIEESALKTIKGILAGDIAYIQERMATVANLLDKHPGSEEARSAFNNLAENIDGYHKKFSNFSDDVNYQILPMFSTTVMMQITYWVAGLERKDEIGLSNIDVEKVRGLIKKTVEQANSYINNIYDRELNDALNHSTADTVANNVMSVHGHCRLHGIEYISIWDRLSEAESVNNRIYVDVLSYSTFFDRQTAKARIQALTPEKDMTPPLKPALNGGKRRRIDSLTGHIVRIGGAARVGGLTVVFDDGSRHQLGTISSETSSISLNGSRITSLEVWGNGAVDQAVFTLRDGRSLSLGSPGTSRYRKFHVGESHYIAGIYLSSDYSPLAGQAANIAVSYQLINDDER

SEQ ID NO: 48 - protein, 419 aa, Photorhabdus luminescens
MQTENVLDIRTIVANEYAVKTSALEWDVTDIVKNAIIGGISFIPSVGPAISFLVGLFWPQSKENIWEGIVKQIERMIEESALKTIKGILAGDIAYIQERMATVADLLDKHPGSEEARSAFNNLAENIDGYHKKFNNFSDDVNYQILPMFSTTVMMQITYWVAGLERKDEIGLSNIDIEKVRGLIKKTVEQANSYINNIYDRELNDALNNSTADTVANNVMSVHGHCRLHGIEYISIWDRLSEAESVNNRIYVDVLSYSTFFDRQTAKARIQALTPEKDMAPPLKPALNGGKRRKIDSLTGHIVRIGGAARVGGLTVVFDDGSRHQLGTISGETSSISLNGSRITSLEVWGNGAVDQAVFTLRDGRSLSLGSPGTSRYRKFHVGESHYIAGIYLSSDYSPLAGQAANIAVSYQLINDDEK

SEQ ID NO: 49 - protein, 419 aa, Photorhabdus sp.; identical to SEQ ID NO: 45
  REGION 1..419: note = S9-53

SEQ ID NO: 50 - protein, 419 aa, Photorhabdus luminescens
  REGION 1..419: note = subsp. sonorensis
MHTENVLNLRTIVANEYAVKTSALEWDVTDIVKNAIIGGISFIPSVGPAISFLVGLFWPQSQENIWEGIVKQIERMIEESALKTIKGILAGDIAYIQERMATVADLLDKHPGSDEARSAFNNLAENIDGYHKKFNNFSDDVNYQILPMFSTTVMMQITYWVAGLERRAEIGLSDIDVEKVRGLIKKTVEQANSYINHIYDRELNDALNNSTADTVANNVMSVHGHCRLHGVEYISIWDRLSESESVNNRIYVDVLSYSTFFDRQTAKARIQALTPEQDMAPPLKPALNGGKRRKIDSLMGHIVRIGGAPRVGGLTVVFDDGSSHRLGTISGETASISLNGSRITSLEVWGNGAVDRAVFTLSDGRFLLFGDPGTSRYRKFYVGESHYISGIYLSSDYNPLAGQAANIAVSYQLINDDEK

SEQ ID NO: 51 - protein, 419 aa, Photorhabdus heterorhabditis
MQTENVLDIRTIVANEYTVKTSALEWDVTDIVKNAIIGGISFIPSVGPAISFLVGLFWPQSKENIWEGIVKQIERMIEESALKTIKGILAGDIAYIQERMATVAELLEKHPGSEEARSAFNNLAENIDGYHKKFNNFSDDINYQILPMFSTTVMMQITYWVAGLEKKDEIGLSDIDIEKVRGLIKKTVEQANSYINNIYDRELNDALNNSTANTVANNVMSVHGHCRLHGIEYISIWDKLSEAESVNNRIYVDVLSYSTFFDRQTAKARIQALTPEKDMTPPLKPALNGENRRKINSLMGHIVRIGGAPRVGGLTVVFDDGSRHQLGTISGETTSISLDGSRITSLEVWGNGAVDKAIFTLNDGRSLSFGEPGTSKYRKFYVGESHYISGIYLSSDYSPLAGQAANIAVSYQLINEDKK

SEQ ID NO: 52 - protein, 419 aa, Photorhabdus luminescens
  REGION 1..419: note = subsp. mexicana
MHTENVLNLRTIVANEYAVKTSALEWDVTDIVKNAIIGGISFIPSVGPAISFLVGLFWPQSQENIWEGIVKQIERMIEESALKTIKGILAGDIAYIQERMATVADLLDKHPGSDEARSAFNNLAENIDGYHKKFNNFSDDVNYQILPMFSTTVMMQITYWVAGLERRAEIGLSDIDIEKVRGLIKKTVEQANSYINSIYDRELNDALNNSTADTVANNVMSVHGHCRLHGIEYISIWDRLSESESVNNRIYVDVLSYSTFFDRQTAKARIQALTPEQDMAPPLKPALNGGKRRKIDSLMGHIVRIGGAPRVGGLTVVFDDGSSHRLGTISGETASISLNGSRITSLEVWGNGAVDRAVFTLSDGRFLLFGDPGTSRYRKFYVGDSHYISGIYLSSDYNPLAGQAANIAVSYQLINDDEK

SEQ ID NO: 53 - protein, 404 aa, Xenorhabdus miraniensis
MLDTYTVSTPDYEWDMSSIIKDAIIGGIGFIPGAGPAMSFLLGLFWPQQKDNTWEQILQKVEQMIEDAALKTIQGILNGDIQEIKGKMEHVEYMLETSPGSQESHDAYMFLARYLVSVEEKFKSFDNKINYQILPMYSNTLMLQAPYWKMGIEKKGEIGLTDIEVNELNQLINKLVINANNYIHTMYTNQYDDAINNSTAGTVTNNLFSVRGYCLLHGLECLELIEHIQNDSLESGFYPKTISYSTVFDRPTNKTRIQALTEDDKTQEPLKPSLVNGKYNKIKSLIGYVQRIGNAPRVGGIKVIFDNNSSHTLGTVTSETRSIDLNGSVISSLEVWGNGAVDEALFRLSDGRQFSFGQRYASKYRKFAVDGHYIAGLYLASDEPSLAGQTAGIVVSYHMLTDKK

SEQ ID NO: 54 - protein, 429 aa, Xenorhabdus nematophila
MNNEPMNTNESQVSEIVPSMNESILAAPYSISTPNYEWDMSSIIKDAIIGGIGFIPGPGSAISFLLGLFWPQQTDNTWEQILQKVEQMIEQANLKTIQGILNGDIQEIKGKMEHVQFMLESSPGTQESHDAYMFLARYLVSIDEKFKSFDNKTNYQILPMYTNTIMLQAPYWKMGIERKDEIKLTDIEVNELKELIGKLSTSADKYIHDVYTREYDNAMNTSTAANITNNLLSVRGYCLLHGLECLEVINHIQNNSLEQSFYPKTISYSTVFDRQTNKTRVQALTEDDQMQEPFKPALINGKYNKIKSLIGYVQRIGNAPRVGGIKVTFANDASYTLGTVTSEVNSIELNDSVITSLEVWGNGAVDEAFFTLSDGRQFRLGQRYASNYRKYAVDNHYISGLYLASDEPSLAGQAAGIAVSYHMIADKKS

SEQ ID NO: 55 - protein, 420 aa, Alcaligenes faecalis
MKLLELKSVYSEQEQERFYTRSISLGDWDYSAIIKSSVMFGLGQIPVVGKALSTIVGLFWPKNEKDVWQKSLDELREYIDNQILATIQGILNGELREIQKKMEYVARLLEESPGSPEACSEYKNLQFYLVGKDEKFRSFDELTNYKLMPMYASMILLQASYWKMGIDKKDQIGLSSIDLNSLKNHIDDLADSSRDYINRIYETELDRTYENSRPDEVANNMFSVRGYSLLHGVEAVEVVKNIRDLDFDKRFNINVISYSTAVGTITGGMIAQALTPDSEMAQPLCPEVFGQQANKIVQIIGYSGPRINSLFRIGGLEIIYENGDSSLLGERVGNRDVFDLNGSLIKTVEMRYQGLMDEVKFTLFDGRVMQVGQGESYSGYVKYEVEGHYISGVFLSRDRATYPGRTSTASVSFNMVPAIT

SEQ ID NO: 56 - protein, 117 aa, Xenorhabdus eapokensis
MIYYFESLFRVGGIKITFANGSSYTLGTVTSETSSIELNDSVIERLEVWGNGAVDEALFTLSDGRQLRVGERYARNYRDYAVDGHYIAGLYLASDEPSLAGQAAGIAVSYHMLDEKK

SEQ ID NO: 57 - protein, 419 aa, Photorhabdus kayaii; identical to SEQ ID NO: 41

SEQ ID NO: 58 - protein, 419 aa, Photorhabdus cinerea
MQTENVLDIRTIVANEYAVKTSALEWDVTDIVKNAIIGGISFIPSVGPAISFLVGLFWPQSKENIWEGIVKQIERMIEESALKTIKGILAGDIAYIQERMATVADLLDKHPGSEEARSAFNNLAENIDGYHKKFNNFSDDVNYQILPMFSTTVMMQITYWVTGLERKDEIGLSNIDIEKVRGLIKKTVEQANSYINNIYDRELNDALNNSTADTVANNVMSVHGHCRLHGIEYISIWDKLSEAESVNNRIYVDVLSYSTFFDRQTAKARIQALTPEKDMTPPLKPALNGGKRRKIDSLTGHIVRIGGAARVGGLTVVFDDSSRHQLGTISDETSSISLNGSRITSLEVWGNGAVDQAVFTLNDGRSLSLGSPGTSRYRKFYVGESHYIAGIYLSSDYSPLARQAANIAVSYQLINDDEK

SEQ ID NO: 59 - protein, 15 aa, synthetic construct
  REGION 1..15: note = Synthetic Construct
GGGGSGGGGSGGGGS

SEQ ID NO: 60 - protein, 18 aa, synthetic construct
  REGION 1..18: note = Synthetic Construct
KESGSVSSEQLAQFRSLD

SEQ ID NO: 61 - protein, 14 aa, synthetic construct
  REGION 1..14: note = Synthetic Construct
EGKSSGSGSESKST

SEQ ID NO: 62 - protein, 8 aa, synthetic construct
  REGION 1..8: note = Synthetic Construct
GGGGGGGG

SEQ ID NO: 63 - protein, 20 aa, synthetic construct
  REGION 1..20: note = Synthetic Construct
GGGGSGGGGSGGGGSGGGGS

SEQ ID NO: 64 - protein, 15 aa, synthetic construct
  REGION 1..15: note = Synthetic Construct
EAAAKEAAAKEAAAK

SEQ ID NO: 65-100 - skipped (36 entries)

SEQ ID NO: 101 - DNA, 4534 bp, synthetic construct; identical to SEQ ID NO: 1
  misc_feature 1..4534: note = Synthetic Construct
  source 1..4534: mol_type = other DNA

SEQ ID NO: 102 - DNA, 402 bp, synthetic construct; identical to SEQ ID NO: 2
  misc_feature 1..402: note = Synthetic Construct
  source 1..402: mol_type = other DNA

SEQ ID NO: 103 - DNA, 1335 bp, synthetic construct; identical to SEQ ID NO: 3
  misc_feature 1..1335: note = Synthetic Construct
  source 1..1335: mol_type = other DNA

SEQ ID NO: 104 - DNA, 3537 bp, synthetic construct
  misc_feature 1..3537: note = Synthetic Construct
  source 1..3537: mol_type = other DNA
atggataacaatccgaacatcaatgaatgcattccttataattgtttaagtaaccctgaagtagaagtattaggtggagaaagaatagaaactggttacaccccaatcgatatttccttgtcgctaacgcaatttcttttgagtgaatttgttcccggtgctggatttgtgttaggactagttgatataatatggggaatttttggtccctctcaatgggacgcatttcttgtacaaattgaacagttaattaaccaaagaatagaagaattcgctaggaaccaagccatttctagattagaaggactaagcaatctttatcaaatttacgcagaatcttttagagagtgggaagcagatcctactaatccagcattaagagaagagatgcgtattcaattcaatgacatgaacagtgcccttacaaccgctattcctctttttgcagttcaaaattatcaagttcctcttttatcagtatatgttcaagctgcaaatttacatttatcagttttgagagatgtttcagtgtttggacaaaggtggggatttgatgccgcgactatcaatagtcgttataatgatttaactaggcttattggcaactatacagattatgctgtacgctggtacaatacgggattagaacgtgtatggggaccggattctagagattgggtaaggtataatcaatttagaagagaattaacactaactgtattagatatcgttgctctgttcccgaattatgatagtagaagatatccaattcgaacagtttcccaattaacaagagaaatttatacaaacccagtattagaaaattttgatggtagttttcgaggctcggctcagggcatagaaagaagtattaggagtccacatttgatggatatacttaacagtataaccatctatacggatgctcataggggttattattattggtcagggcatcaaataatggcttctcctgtagggttttcggggccagaattcacttttccgctatatggaactatgggaaatgcagctccacaacaacgtattgttgctcaactaggtcagggcgtgtatagaacattatcgtccactttatatagaagaccttttaatatagggataaataatcaacaactatctgttcttgacgggacagaatttgcttatggaacctcctcaaatttgccatccgctgtatacagaaaaagcggaacggtagattcgctggatgaaataccgccacagaataacaacgtgccacctaggcaaggatttagtcatcgattaagccatgtttcaatgtttcgttcaggctttagtaatagtagtgtaagtataataagagctcctatgttctcttggatacatcgtagtgctgaatttaataatataattgcatcggatagtattactcaaatccctgcagtgaagggaaactttctttttaatggttctgtaatttcaggaccaggatttactggtggggacttagttagattaaatagtagtggaaataacattcagaatagagggtatattgaagttccaattcacttcccatcgacatctaccagatatcgagttcgtgtacggtatgcttctgtaaccccgattcacctcaacgttaattggggtaattcatccattttttccaatacagtaccagctacagctacgtcattagataatctacaatcaagtgattttggttattttgaaagtgccaatgcttttacatcttcattaggtaatatagtaggtgttagaaattttagtgggactgcaggagtgataatagacagatttgaatttattccagttactgcaacactcgaggctgaatataatctggaaagagcgcagaaggcggtgaatgcgctgtttacgtctacaaaccaactagggctaaaaacaaatgtaacggattatcatattgatcaagtgtccaatttagttacgtatttatcggatgaattttgtctggatgaaaagcgagaattgtccgagaaagtcaaacatgcgaagcgactcagtgatgaacgcaatttactccaagattcaaatttcaaagacattaataggcaaccagaacgtgggtggggcggaagtacagggattaccatccaaggaggggatgacgtatttaaagaaaattacgtcacactatcaggtacctttgatgagtgctatccaacatatttgtatcaaaaaatcgatgaatcaaaattaaaagcctttacccgttatcaattaagagggtatatcgaagatagtcaagacttagaaatctatttaattcgctacaatgcaaaacatgaaacagtaaatgtgccaggtacgggttccttatggccgctttcagcccaaagtccaatcggaaagtgtggagagccgaatcgatgcgcgccacaccttgaatggaatcctgacttagattgttcgtgtagggatggagaaaagtgtgcccatcattcgcatcatttctccttagacattgatgtaggatgtacagacttaaatgaggacctaggtgtatgggtgatctttaagattaagacgcaagatgggcacgcaagactagggaatctagagtttctcgaagagaaaccattagtaggagaagcgctagctcgtgtgaaaagagcggagaaaaaatggagagacaaacgtgaaaaattggaatgggaaacaaatatcgtttataaagaggcaaaagaatctgtagatgctttatttgtaaactctcaatatgatcaattacaagcggatacgaatattgccatgattcatgcggcagataaacgtgttcatagcattcgagaagcttatctgcctgagctgtctgtgattccgggtgtcaatgcggctatttttgaagaattagaagggcgtattttcactgcattctccctatatgatgcgagaaatgtcattaaaaatggtgattttaataatggcttatcctgctggaacgtgaaagggcatgtagatgtagaagaacaaaacaaccaacgttcggtccttgttgttccggaatgggaagcagaagtgtcacaagaagttcgtgtctgtccgggtcgtggctatatccttcgtgtcacagcgtacaaggagggatatggagaaggttgcgtaaccattcatgagatcgagaacaatacagacgaactgaagtttagcaactgcgtagaagaggaaatctatccaaataacacggtaacgtgtaatgattatactgtaaatcaagaagaatacggaggtgcgtacacttctcgtaatcgaggatataacgaagctccttccgtaccagctgattatgcgtcagtctatgaagaaaaatcgtatacagatggacgaagagagaatccttgtgaatttaacagagggtatagggattacacgccactaccagttggttatgtgacaaaagaattagaatacttcccagaaaccgataaggtatggattgagattggagaaacggaaggaacatttatcgtggacagcgtggaattactccttatggaggaatag

SEQ ID NO: 105 - protein, 1176 aa, Bacillus thuringiensis
  REGION 1..1176: note = subsp. aizawai
MDNNPNINECIPYNCLSNPEVEVLGGERIETGYTPIDISLSLTQFLLSEFVPGAGFVLGLVDIIWGIFGPSQWDAFLVQIEQLINQRIEEFARNQAISRLEGLSNLYQIYAESFREWEADPTNPALREEMRIQFNDMNSALTTAIPLFAVQNYQVPLLSVYVQAANLHLSVLRDVSVFGQRWGFDAATINSRYNDLTRLIGNYTDYAVRWYNTGLERVWGPDSRDWVRYNQFRRELTLTVLDIVALFSNYDSRRYPIRTVSQLTREIYTNPVLENFDGSFRGMAQRIEQNIRQPHLMDILNSITIYTDVHRGFNYWSGHQITASPVGFSGPEFAFPLFGNAGNAAPPVLVSLTGLGIFRTLSSPLYRRIILGSGPNNQELFVLDGTEFSFASLTTNLPSTIYRQRGTVDSLDVIPPQDNSVPPRAGFSHRLSHVTMLSQAAGAVYTLRAPTFSWQHRSAEFNNIIPSSQITQIPLTKSTNLGSGTSVVKGPGFTGGDILRRTSPGQISTLRVNITAPLSQRYRVRIRYASTTNLQFHTSIDGRPINQGNFSATMSSGSNLQSGSFRTVGFTTPFNFSNGSSVFTLSAHVFNSGNEVYIDRIEFVPAEVTFEAEYDLERAQKAVNELFTSSNQIGLKTDVTDYHIDQVSNLVECLSDEFCLDEKQELSEKVKHAKRLSDERNLLQDPNFRGINRQLDRGWRGSTDITIQGGDDVFKENYVTLLGTFDECYPTYLYQKIDESKLKAYTRYQLRGYIEDSQDLEIYLIRYNAKHETVNVPGTGSLWPLSAQSPIGKCGEPNRCAPHLEWNPDLDCSCRDGEKCAHHSHHFSLDIDVGCTDLNEDLGVWVIFKIKTQDGHARLGNLEFLEEKPLVGEALARVKRAEKKWRDKREKLEWETNIVYKEAKESVDALFVNSQYDQLQADTNIAMIHAADKRVHSIREAYLPELSVIPGVNAAIFEELEGRIFTAFSLYDARNVIKNGDFNNGLSCWNVKGHVDVEEQNNQRSVLVVPEWEAEVSQEVRVCPGRGYILRVTAYKEGYGEGCVTIHEIENNTDELKFSNCVEEEIYPNNTVTCNDYTVNQEEYGGAYTSRNRGYNEAPSVPADYASVYEEKSYTDGRRENPCEFNRGYRDYTPLPVGYVTKELEYFPETDKVWIEIGETEGTFIVDSVELLLMEE

SEQ ID NO: 106 - protein, 1176 aa, Bacillus thuringiensis
  REGION 1..1176: note = subsp. entomocidus
MDNNPNINECIPYNCLSNPEVEVLGGERIETGYTPIDISLSLTQFLLSEFVPGAGFVLGLVDIIWGIFGPSQWDAFPVQIEQLINQRIEEFARNQAISRLEGLSNLYQIYAESFREWEADPTNPALREEMRIQFNDMNSALTTAIPLLAVQNYQVPLLSVYVQAANLHLSVLRDVSVFGQRWGFDAATINSRYNDLTRLIGNYTDYAVRWYNTGLERVWGPDSRDWVRYNQFRRELTLTVLDIVALFSNYDSRRYPIRTVSQLTREIYTNPVLENFDGSFRGMAQRIEQNIRQPHLMDILNSITIYTDVHRGFNYWSGHQITASPVGFSGPEFAFPLFGNAGNAAPPVLVSLTGLGIFRTLSSPLYRRIILGSGPNNQELFVLDGTEFSFASLTTNLPSTIYRQRGTVDSLDVIPPQDNSVPPRAGFSHRLSHVTMLSQAAGAVYTLRAPTFSWQHRSAEFNNIIPSSQITQIPLTKSTNLGSGTSVVKGPGFTGGDILRRTSPGQISTLRVNITAPLSQRYRVRIRYASTTNLQFHTSIDGRPINQGNFSATMSSGSNLQSGSFRTVGFTTPFNFSNGSSVFTLSAHVFNSGNEVYIDRIEFVPAEVTFEAEYDLERAQKAVNELFTSSNQIGLKTDVTDYHIDQVSNLVECLSDEFCLDEKQELSEKVKHAKRLSDERNLLQDPNFRGINRQLDRGWRGSTDITIQGGDDVFKENYVTLLGTFDECYPTYLYQKIDESKLKAYTRYQLRGYIEDSQDLEIYLIRYNAKHETVNVPGTGSLWPLSAQSPIGKCGEPNRCAPHLEWNPDLDCSCRDGEKCAHHSHHFSLDIDVGCTDLNEDLGVWVIFKIKTQDGHARLGNLEFLEEKPLVGEALARVKRAEKKWRDKREKLEWETNIVYKEAKESVDALFVNSQYDQLQADTNIAMIHAADKRVHSIREAYLPELSVIPGVNAAIFEELEGRIFTAFSLYDARNVIKNGDFNNGLSCWNVKGHVDVEEQNNQRSVLVVPEWEAEVSQEVRVCPGRGYILRVTAYKEGYGEGCVTIHEIENNTDELKFSNCVEEEIYPNNTVTCNDYTVNQEEYGGAYTSRNRGYNEAPSVPADYASVYEEKSYTDGRRENPCEFNRGYRDYTPLPVGYVTKELEYFPETDKVWIEIGETEGTFIVDSVELLLMEE

SEQ ID NO: 107 - protein, 1176 aa, Bacillus thuringiensis; identical to SEQ ID NO: 106
  REGION 1..1176: note = subsp. kurstaki

SEQ ID NO: 108 - protein, 934 aa, Bacillus thuringiensis
  REGION 1..934: note = subsp. sotto
MDNNPNINECIPYNCLSNPEVEVLGGERIETGYTPIDISLSLTQFLLSEFVPGAGFVLGLVDIIWGIFGPSQWDAFLVQIEQLINQRIEEFARNQAISRLEGLSNLYQIYAESFREWEADPTNPALREEMRIQFNDMNSALTTAIPLFAVQNYQVPLLSVYVQAANLHLSVLRDVSVFGQRWGFDAATINSRYNDLTRLIGNYTDYAVRWYNTGLERVWGPDSRDWVRYNQFRRELTLTVLDIVALFSNYDSRRYPIRTVSQLTREIYTNPVLENFDGSFRGMAQRIEQNIRQPHLMDILNRITIYTDVHRGFNYWSGHQITASPVGFSGPEFAFPLFGNAGNAAPPVLVSLTGLGIFRTLSSPLYRRIILGSGPNNQELFVLDGTEFSFASLTTNLPSTIYRQRGTVDSLDVIPPQDNSVPPRAGFSHRLSHVTMLSQAAGAVYTLRAPTFSWQHRSAEFNNIIPSSQITQIPLTKSTNLGSGTSVVKGPGFTGGDILRRTSPGQISTLRVNITAPLSQRYRVRIRYASTTNLQFHTSIDGRPINQGNFSATMSSGSNLQSGSFRTVGFTTPFNFSNGSSVFTLSAHVFNSGNEVYIDRIEFVPAEVTFEAEYDLERAQKAVNELFTSSNQIGLKTDVTDYHIDQVSNLVECLSDEFCLDEKQELSEKVKHAKRLSDERNLLQDPNFRGINRQLDRGWRGSTDITIQGGDDVFKENYVTLLGTFDECYPTYLYQKIDESKLKAYTRYQLRGYIEDSQDLEIYLIRYNAKHETVNVPGTGSLWPLSAQSPIGKCGEPNRCAPHLEWNPDLDCSCRDGEKCAHHSHHFSLDIDVGCTDLNEDLGVWVIFKIKTQDGHARLGNLEFLEEKPLVGEALARVKRAEKKWRDKREKLEWETNIVYKEAKESVDALFVNSQYDRLQADTNIAMIHAADKR

SEQ ID NO: 109 - protein, 1155 aa, Bacillus thuringiensis
  REGION 1..1155: note = subsp. aizawai
MDNNPNINECIPYNCLSNPEVEVLGGERIETGYTPIDISLSLTQFLLSEFVPGAGFVLGLVDIIWGIFGPSQWDAFLVQIEQLINQRIEEFARNQAISRLEGLSNLYQIYAESFREWEADPTNPALREEMRIQFNDMNSALTTAIPLFAVQNYQVPLLSVYVQAANLHLSVLRDVSVFGQRWGFDAATINSRYNDLTRLIGNYTDHAVRWYNTGLERVWGPDSRDWIRYNQFRRELTLTVLDIVSLFPNYDSRTYPIRTVSQLTREIYTNPVLENFDGSFRGSAQGIEGSIRSPHLMDILNSITIYTDAHRGEYYWSGHQIMASPVGFSGPEFTFPLYGTMGNAAPQQRIVAQLGQGVYRTLSSTLYRRPFNIGINNQQLSVLDGTEFAYGTSSNLPSAVYRKSGTVDSLDEIPPQNNNVPPRQGFSHRLSHVSMFRSGFSNSSVSIIRAPMFSWIHRSAEFNNIIPSSQITQIPLTKSTNLGSGTSVVKGPGFTGGDILRRTSPGQISTLRVNITAPLSQRYRVRIRYASTTNLQFHTSIDGRPINQGNFSATMSSGSNLQSGSFRTVGFTTPFNFSNGSSVFTLSAHVFNSGNEVYIDRIEFVPAEVTFEAEYDLERAQKAVNELFTSSNQIGLKTDVTDYHIDQVSNLVECLSDEFCLDEKKELSEKVKHAKRLSDERNLLQDPNFRGINRQLDRGWRGSTDITIQGGDDVFKENYVTLLGTFDECYPTYLYQKIDESKLKAYTRYQLRGYIEDSQDLEIYLIRYNAKHETVNVPGTGSLWPLSAPSPIGKCAHHSHHFSLDIDVGCTDLNEDLGVWVIFKIKTQDGHARLGNLEFLEEKPLVGEALARVKRAEKKWRDKREKLEWETNIVYKEAKESVDALFVNSQYDRLQADTNIAMIHAADKRVHSIREAYLPELSVIPGVNAAIFEELEGRIFTAFSLYDARNVIKNGDFNNGLSCWNVKGHVDVEEQNNHRSVLVVPEWEAEVSQEVRVCPGRGYILRVTAYKEGYGEGCVTIHEIENNTDELKFSNCVEEEVYPNNTVTCNDYTATQEEYEGTYTSRNRGYDGAYESNSSVPADYASAYEEKAYTDGRRDNPCESNRGYGDYTPLPAGYVTKELEYFPETDKVWIEIGETEGTFIVDSVELLLMEE

SEQ ID NO: 110 - protein, 1155 aa, Bacillus thuringiensis; identical to SEQ ID NO: 109
  REGION 1..1155: note = subsp. berliner

SEQ ID NO: 111 - protein, 1155 aa, Bacillus thuringiensis; identical to SEQ ID NO: 109
  REGION 1..1155: note = subsp. kurstaki

SEQ ID NO: 112 - protein, 1178 aa, Bacillus thuringiensis
  REGION 1..1178: note = subsp. kurstaki
MDNNPNINECIPYNCLSNPEVEVLGGERIETGYTPIDISLSLTQFLLSEFVPGAGFVLGLVDIIWGIFGPSQWDAFLVQIEQLINQRIEEFARNQAISRLEGLSNLYQIYAESFREWEADPTNPALREEMRIQFNDMNSALTTAIPLFAVQNYQVPLLSVYVQAANLHLSVLRDVSVFGQRWGFDAATINSRYNDLTRLIGNYTDYAVRWYNTGLERVWGPDSRDWVRYNQFRRELTLTVLDIVALFPNYDSRRYPIRTVSQLTREIYTNPVLENFDGSFRGSAQGIERSIRSPHLMDILNSITIYTDAHRGYYYWSGHQIMASPVGFSGPEFTFPLYGTMGNAAPQQRIVAQLGQGVYRTLSSTLYRRPFNIGINNQQLSVLDGTEFAYGTSSNLPSAVYRKSGTVDSLDEIPPQNNNVPPRQGFSHRLSHVSMFRSGFSNSSVSIIRAPMFSWIHRSAEFNNIIASDSITQIPAVKGNFLFNGSVISGPGFTGGDLVRLNSSGNNIQNRGYIEVPIHFPSTSTRYRVRVRYASVTPIHLNVNWGNSSIFSNTVPATATSLDNLQSSDFGYFESANAFTSSLGNIVGVRNFSGTAGVIIDRFEFIPVTATLEAEYNLERAQKAVNALFTSTNQLGLKTNVTDYHIDQVSNLVTYLSDEFCLDEKRELSEKVKHAKRLSDERNLLQDSNFKDINRQPERGWGGSTGITIQGGDDVFKENYVTLSGTFDECYPTYLYQKIDESKLKAFTRYQLRGYIEDSQDLEIYLIRYNAKHETVNVPGTGSLWPLSAQSPIGKCGEPNRCAPHLEWNPDLDCSCRDGEKCAHHSHHFSLDIDVGCTDLNEDLGVWVIFKIKTQDGHARLGNLEFLEEKPLVGEALARVKRAEKKWRDKREKLEWETNIVYKEAKESVDALFVNSQYDQLQADTNIAMIHAADKRVHSIREAYLPELSVIPGVNAAIFEELEGRIFTAFSLYDARNVIKNGDFNNGLSCWNVKGHVDVEEQNNQRSVLVVPEWEAEVSQEVRVCPGRGYILRVTAYKEGYGEGCVTIHEIENNTDELKFSNCVEEEIYPNNTVTCNDYTVNQEEYGGAYTSRNRGYNEAPSVPADYASVYEEKSYTDGRRENPCEFNRGYRDYTPLPVGYVTKELEYFPETDKVWIEIGETEGTFIVDSVELLLMEE

SEQ ID NO: 113 - protein, 1179 aa, Bacillus thuringiensis
  REGION 1..1179: note = subsp. aizawai
MEIMNNQNQCVPYNCLNDPTIEILEGERIETGYTPIDISLSLTQFLLSEFVPGAGFVLGLIDLIWGFVGPSQWDAFLVQIEQLINQRIEEFARNQAISRLEGLSNLYQIYAEAFREWEADPTNPALTEEMRIQFNDMNSALTTAIPLFTVQNYQVPLLSVYVQAANLHLSVLRDVSVFGQRWGFDVATINSRYNDLTRLIGTYTDYAVRWYNTGLERVWGPDSRDWVRYNQFRRELTLTVLDIVSLFPNYDSRTYPIRTVSQLTREIYTNPVLENFDGSFRGMAQRIEQNIRQPHLMDLLNSITIYTDVHRGFNYWSGHQITASPVGFAGPEFTFPRYGTMGNAAPPVLISTTGLGIFRTLSSPLYRRIILGSGPNNQNLFVLDGTEFSFASLTADLPSTIYRQRGTVDSLDVIPPQDNSVPARAGFSHRLSHVTMLSQAAGAVYTLRAPTFSWRHRSAEFSNLIPSSQITQIPLTKSINLGSGTSVVKGPGFTGGDILRITSPGQISTLRVTITAPLSQRYRVRIRYASTTNLQFHTSIDGRPINQGNFSATMSSGGNLQSGSFRTAGFTTPFNFSNGSSIFTLSAHVFNSGNEVYIERIEFVPAEVTFEAEYDLERAQEAVNALFTSSNQLGLKTNVTDYHIDQVSNLVECLSGEFCLDEKRELSEKVKHANRLSDERNLLQDPNFRGINRQPDRGWRGSTDITIQGGDDVFKENYVTLPGTFNECYPTYLYQKIDESKLKAYTRYQLRGYIEDSQHLEIYLIRYNTKHETVNVPGTGSLWPLSVENPIGKCGEPNRCAPQLEWNPDLDCSCRDGEKCAHHSHHFSLDIDIGCTDLNENLGVWVIFKIKMQDGHARLGNLEFLEEKPLVGESLARVKRAEKKWRDKREKLQVETNIVYKEAKESVDALFVNSQYDRLQADTDIAMIHAADKRVHRIREAYLPELSVIPGVNAGIFEELEGRIFTAYSLYDARNVIKNGDFNNGLSCWNVKGHVDVEEQNNHRSVLVVPEWEAEVSQEVRVCPGRGYILRVTAYKEGYGEGCVTIHEIEDNTDELKFSNCVEEEVYPNNTVTCNDYTANQEEYGGAYTSRNRGYGESYESNSSIPAEYAPVYEEAYIDGRKENPCESNRGYGDYTPLPAGYVTKELEYFPETDKVWIEIGETEGTFIVDSVELLLMEE

SEQ ID NO: 114 - protein, 1181 aa, Bacillus thuringiensis
  REGION 1..1181: note = subsp. alesti
MDNNPKINECIPYNCLSNPEVEVLGGERIETGYTPIDISLSLTQFLLSEFVPGAGFVLGLIDLIWGFVGPSQWDAFLVQIEQLISQRIEEFARNQAISRLEGLSNLYQIYAEAFREWEADPTNPALREEMRIQFNDMNSALTTAIPLFTVQNYQVPLLSVYVQAVNLHLSVLRDVSVFGQRWGLDVATINSRYNDLTRLIGTYTDYAVRWYNTGLERVWGPDSRDWVRYNQFRRELTLTVLDIVSLFPNYDSRTYPIRTVSQLTREIYTNPVLENFDGSFRGSAQRIEQSIRSPHLMDILNSITIYTDAHGGYYYWSGHQIMASPVGFSGPEFTFPLYGTMGNAAPQQRIVAQLGQGVYRTLSSTFYRNPFIIGINNQRLSVLDGTEFAYGSSSNLPSAVYRKSGTVDSLDEIPPQDNNVPPRQGFSHRLSHVSMFRSGFSNSSVSIIRAPMFSWIHRSAEFNNIIPSSQITQIPLTKSTNLGSGTSVVKGPGFTGGDILRRTSPGQISTLRVNITAPLSQRYRVRIRYASTTNLQFHTSIDGRPINQGNFSATMSSGGNLQSGSFRTVGFTTPFNFSNGSSVFTLSAHVFNSGNEVYIDRIEFVPAEVTFEAEYDLERAQEAVNALFTSPNQIGLKTDVTDYHIDQVSNLVECLSDEFCLDEKRELSEKVKHAKRLSDERNLLQDPNFRGINRQPDRGWRGSTDITIQGGDDVFKENYVTLPGTFDECYPTYLYQKIDESKLKAYTRYELRGYIEDSQDLEIYLIRYNAKHETVNVPGTGSLWPLSFESSIGKCGEPNRCAPHLEWNPDLDCSCRDGEKCAHHSHHFSLDIDVGCIDLNEDLGVWVIFKIKTQDGHARLGNLEFLEEKPLVGEALARVKRAEKKWRDKREKLQLETNIVYKEAKESVDALFVNSQYDQLQADTNIAMIHTADKRVHRIQEAYLPELSVIPGVNAGIFEELEGRIFTAYSLYDARNVIKNGDFNNGLSCWNVKGHVDVEEQNNHRSVLVVPEWEAEVSQEVRVCPGRGYILRVTAYKEGYGEGCVTIHEIENNTDELKFSNCVEEEVYPNNTVTCNEYTANQEEYGGAYTSCNRGYDETYGSNYSVPADYASVYEEKAYTDGRRENPCESNRGYGDYTPLPAGYVTKQLEYFPETDKVWIEIGETEGTFIVDSVELFLMEE

SEQ ID NO: 115 - protein, 911 aa, Bacillus thuringiensis
MDNNPNINECIPYNCLSNPEVEVLGGERIETGYTPIDISLSLTQFLLSEFVPGAGFVLGLVDIIWEIFSVLSSDAFLVQIEQLINQRIEEFARNQAISRLEGLSNLYQIYAESFREWEADPTNPALREEMRIQFNDMNSALTTAIPLFAVQNYQVPLLSVYVTCNYIISSESVMCGQRSGFDAATINSRYNDLTRLIGNYTDHAVRWYNTGLERVWGPDSRDWIRYNQFRRELTLTVLDIVSLFPNYDSRTYPIRTVSQLTREIYTNPVLENFDGSFRGSAQGIEGSIRSPHLMDILNSITIYTDAHRGEYYWSGHQIMASPVGFSGPEFTFPLYGTMGNSAPQQRIVAQLGQGVYRTLSSTLYRRPFNIGINNQQLSVLDGTEFAYGTSSNLPSAVYRKSGTVDSLDEIPPQNNNVPPRQGFSHRLSHVSMFRSGFSNSSVSIIRAPMFSWIHRSAEFNNIIPSSQITQIPLTKSTNLGSGTSVVKGPGFTGGDILRRTSPGQISTLRVNITAPLSQRYRVRILYASTTNLQFHTSIDGRPINQGNFSATMSSGRNLQSGSLRTVGFTTPFNFSNGSSVFTLSAHVFNSGNEVYIDRIEFVPAEVTFEAEYDLERAQKAVNELFTSSNQIGLKTDVTDYHIDQVSNLVECLSDEFCLDEKKELSEKVKHAKRLSDERNLLQDPNFRGINRQLDRGWRRSTDITTQGGDDFFQENYVTLLGTLMGFPSIYIKKWWFEIKSLYPLPIRGYIEDSQDLEIYLIRYNAKHETVNVPGTVPYGRFQPQVPIGKCAHHSHHFSLDIDVGCTDLNEDLGVWVIFKIKTQDGHARLGNLEFLEEKPLVGEALARVKRAEKKWRDKREKLEWETNIVYKEAKESVDALFVNSQYDRLQADTNIAMIHAADKRVHSIREA

SEQ ID NO: 116 - protein, 1176 aa, Bacillus thuringiensis
MDNNPNINECIPYNCLSNPEVEVLGGERIETGYTPIDISLSLTQFLLSEFVPGAGFVLGLVDIIWGIFGPSQWDAFLVQIEQLINQRIEEFARNQAISRLEGLSNLYQIYAESFREWEADPTNPALREEMRIQFNDMNSALTTAIPLLAVQNYQVPLLSVYVQAANLHLSVLRDVSVFGQRWGFDAATINSRYNDLTRLIGNYTDYAVRWYNTGLERVWGPDSRDWVRYNQFRRELTLTVLDIVALFSNYDSRRYPIRTVSQLTREIYTNPVLENFDGSFRGMAQRIEPEYRQPHLMDILNSISIYTDVHRGFNYWSGHQITTSPVGFSGPEFTFPLYGTYGNAAPPQRIAQTGLGIFRTLSSPLYRRIILGSGPNNQELFVLDGTEFSFASLTTNLPSTIYRQRGTVDSLDVIPPQDNSVPPRAGFSHRLSHVPMLSQAAGAVYTLRASLFLLLVLLIHARSIFNNIIPSSQITQSFKKIISWTSVVKGPGFTGGDILRRPSPGLISTLRVNITAPLSQRYRVRIRYAFTTNLQFLTSIDGRPINQGNFYATMSSGSNLQSGSFRTVGFTTPFNFSNGSSVFTLSAHVFNSGNEVYIDRIEFVPAEVTFEAEYDLERAQNGVNQLFTSSNQIGLKTDGTDYHIDQVSNLVECLSDEFCLDEKQELSEKVKHAKRLSDERNLLQDPNFRGINRQLDRGWRGSHDITIQGGDDVFKENYVTLLGTFDECYPTYLYQKIDQSKLKAYTSYQLRGYIEDSQDLEIYLIGYNAKQQTVNVPGTGSLWPVYAPKPIGKCGEPNRCAPHLEWNPDLDCSCRDGEKCAHHSLHFSIDIDVGCTDLNEDLGVWVIFKIKTEDGHARLGNLEFLEEKPLVGEALARVKRAEKKWRDKRVKLEWETNIVYKEAKESVDALFVNSQYDQLQADTNIAMIHAADKRVHSIREAYLPELSVIPGVNAAIFEELEGRIFTAFSLYDARNVIKNGDFNNGLSCWNVKGHVDVEEQNNQRSVLVVPEWEAEVSQEVRVCPGRGYFPRVTAYKEGYGEGCVTIHEIENNTDELKFSNCVEEEIYPNNTVTCNDYTVNQEEYGGAYTSRNRGYNEAPSVPADYASVYEEKSYTDGRRENPCEFNRGYRDYTGLPVGYVTKALEYFPETDKVWIEIGETEGTFIVDSVELLLMEE

SEQ ID NO: 117 - protein, 1228 aa, Bacillus thuringiensis
  REGION 1..1228: note = subsp. entomocidus
MTSNRKNENEIINAVSNHSAQMDLLPDARIEDSLCIAEGNNIDPFVSASTVQTGINIAGRILGVLGVPFAGQLASFYSFLVGELWPRGRDQWEIFLEHVEQLINQQITENARNTALARLQGLGDSFRAYQQSLEDWLENRDDARTRSVLHTQYIALELDFLNAMPLFAIRNQEVPLLMVYAQAANLHLLLLRDASLFGSEFGLTSQEIQRYYERQVERTRDYSDYCVEWYNTGLNSLRGTNAASWVRYNQFRRDLTLGVLDLVALFPSYDTRTYPINTSAQLTREVYTDAIGATGVNMASMNWYNNNAPSFSAIEAAAIRSPHLLDFLEQLTIFSASSRWSNTRHMTYWRGHTIQSRPIGGGLNTSTHGATNTSINPVTLRFASRDVYRTESYAGVLLWGIYLEPIHGVPTVRFNFTNPQNISDRGTANYSQPYESPGLQLKDSETELPPETTERPNYESYSHRLSHIGIILQSRVNVPVYSWTHRSADRTNTIGPNRITQIPMVKASELPQGTTVVRGPGFTGGDILRRTNTGGFGPIRVTVNGPLTQRYRIGFRYASTVDFDFFVSRGGTTVNNFRFLRTMNSGDELKYGNFVRRAFTTPFTFTQIQDIIRTSIQGLSGNGEVYIDKIEIIPVTATFEAEYDLERAQEAVNALFTNTNPRRLKTDVTDYHIDQVSNLVACLSDEFCLDEKRELLEKVKYAKRLSDERNLLQDPNFTSINKQPDFISTNEQSNFTSIHEQSEHGWWGSENITIQEGNDVFKENYVTLPGTFNECYPTYLYQKIGESELKAYTRYQLRGYIEDSQDLEIYLIRYNAKHETLDVPGTESLWPLSVESPIGRCGEPNRCAPHFEWNPDLDCSCRDGEKCAHHSHHFSLDIDVGCTDLHENLGVWVVFKIKTQEGHARLGNLEFIEEKPLLGEALSRVKRAEKKWRDKREKLQLETKRVYTEAKEAVDALFVDSQYDRLQADTNIGMIHAADKLVHRIREAYLSELPVIPGVNAEIFEELEGHIITAISLYDARNVVKNGDFNNGLTCWNVKGHVDVQQSHHRSDLVIPEWEAEVSQAVRVCPGCGYILRVTAYKEGYGEGCVTIHEIENNTDELKFKNREEEEVYPTDTGTCNDYTAHQGTAGCADACNSRNAGYEDAYEVDTTASVNYKPTYEEETYTDVRRDNHCEYDRGYVNYPPVPAGYVTKELEYFPETDTVWIEIGETEGKFIVDSVELLLMEE

SEQ ID NO: 118 - protein, 1228 aa, Bacillus thuringiensis
  REGION 1..1228: note = subsp. kurstaki
MTSNRKNENEIINAVSNHSAQMDLLPDARIEDSLCIAEGNNIDPFVSASTVQTGINIAGRILGVLGVPFAGQLASFYSFLVGELWPRGRDQWEIFLEHVEQLINQQITENARNTALARLQGLGDSFRAYQQSLEDWLENRDDARTRSVLYTQYIALELDFLNAMPLFAIRNQEVPLLMVYAQAANLHLLLLRDASLFGSEFGLTSQEIQRYYERQVERTRDYSDYCVEWYNTGLNSLRGTNAASWVRYNQFRRDLTLGVLDLVALFPSYDTRTYPINTSAQLTREVYTDAIGATGVNMASMNWYNNNAPSFSAIEAAAIRSPHLLDFLEQLTIFSASSRWSNTRHMTYWRGHTIQSRPIGGGLNTSTHGATNTSINPVTLRFASRDVYRTESYAGVLLWGIYLEPIHGVPTVRFNFTNPQNISDRGTANYSQPYESPGLQLKDSETELPPETTERPNYESYSHRLSHIGIILQSRVNVPVYSWTHRSADRTNTIGPNRITQIPMVKASELPQGTTVVRGPGFTGGDILRRTNTGGFGPIRVTVNGPLTQRYRIGFRYASTVDFDFFVSRGGTTVNNFRFLRTMNSGDELKYGNFVRRAFTTPFTFTQIQDIIRTSIQGLSGNGEVYIDKIEIIPVTATFEAEYDLERAQEAVNALFTNTNPRRLKTDVTDYHIDQVSNLVACLSDEFCLDEKRELLEKVKYAKRLSDERNLLQDPNFTSINKQPDFISTNEQSNFTSIHEQSEHGWWGSENITIQEGNDVFKENYVTLPGTFNECYPTYLYQKIGESELKAYTRYQLRGYIEDSQDLEIYLIRYNAKHETLDVPGTESLWPLSVESPIGRCGEPNRCAPHFEWNPDLDCSCRDGEKCAHHSHHFSLDIDVGCTDLHENLGVWVVFKIKTQEGHARLGNLEFIEEKPLLGEALSRVKRAEKKWRDKREKLQLETKRVYTEAKEAVDALFVDSQYDRLQADTNIGMIHAADKLVHRIREAYLSELPVIPGVNAEIFEELEGHIITAISLYDARNVVKNGDFNNGLTCWNVKGHVDVQQSHHRSDLVIPEWEAEVSQAVRVCPGCGYILRVTAYKEGYGEGCVTIHEIENNTDELKFKNREEEEVYPTDTGTCNDYTAHQGTAGCADACNSRNAGYEDAYEVDTTASVNYKPTYEEETYTDVRRDNHCEYDRGYVNYPPVPAGYVTKELEYFPETDTVWIEIGETEGKFIVDSVELLLMEE

SEQ ID NO: 119 - protein, 1229 aa, Bacillus thuringiensis
MTSNRKNENEIINALSIPTVSNPSTQMNLSPDARIEDSLCVAEVNNIDPFVSASTVQTGINIAGRILGVLGVPFAGQLASFYSFLVGELWPSGRDPWEIFLEHVEQLIRQQVTENTRNTAIARLEGLGRGYRSYQQALETWLDNRNDARSRSIILERYVALELDITTAIPLFRIRNEEVPLLMVYAQAANLHLLLLRDASLFGSEWGMASSDVNQYYQEQIRYTEEYSNHCVQWYNTGLNNLRGTNAESWLRYNQFRRDLTLGVLDLVALFPSYDTRTYPINTSAQLTREIYTDPIGRTNAPSGFASTNWFNNNAPSFSAIEAAIFRPPHLLDFPEQLTIYSASSRWSSTQHMNYWVGHRLNFRPIGGTLNTSTQGLTNNTSINPVTLQFTSRDVYRTESNAGTNILFTTPVNGVPWARFNFINPQNIYERGATTYSQPYQGVGIQLFDSETELPPETTERPNYESYSHRLSHIGLIIGNTLRAPVYSWTHRSADRTNTIGPNRITQIPLVKALNLHSGVTVVGGPGFTGGDILRRTNTGTFGDIRLNINVPLSQRYRVRIRYASTTDLQFFTRINGTTVNIGNFSRTMNRGDNLEYRSFRTAGFSTPFNFLNAQSTFTLGAQSFSNQEVYIDRVEFVPAEVTFEAEYDLERAQKAVNALFTSTNPRRLKTDVTDYHIDQVSNMVACLSDEFCLDEKRELFEKVKYAKRLSDERNLLQDPNFTFISGQLSFASIDGQSNFPSINELSEHGWWGSANVTIQEGNDVFKENYVTLPGTFNECYPNYLYQKIGESELKAYTRYQLRGYIEDSQDLEIYLIRYNAKHETLDVPGTDSLWPLSVESPIGRCGEPNRCAPHFEWNPDLDCSCRDGERCAHHSHHFTLDIDVGCTDLHENLGVWVVFKIKTQEGYARLGNLEFIEEKPLIGEALSRVKRAEKKWRDKREKLQLETKRVYTEAKEAVDALFVDSQYDQLQADTNIGMIHAADKLVHRIREAYLSELPVIPGVNAEIFEELEGHIITAMSLYDARNVVKNGDFNNGLTCWNVKGHVDVQQSHHRSDLVIPEWEAEVSQAVRVCPGRGYILRVTAYKEGYGEGCVTIHEIENNTDELKFKNCEEEEVYPTDTGTCNDYTAHQGTAACNSRNAGYEDAYEVDTTASVNYKPTYEEETYTDVRRDNHCEYDRGYVNYPPVPAGYVTKELEYFPETDTVWIEIGETEGKFIVDSVELLLMEE

SEQ ID NO: 120 - protein, 1233 aa, Bacillus thuringiensis
  REGION 1..1233: note = subsp. morrisoni
MTSNRKNENEIINALSIPTVSNPSTQMNLSPDARIEDSLCVAEVNNIDPFVSASTVQTGINIAGRILGVLGVPFAGQLASFYSFLVGELWPSGRDPWEIFLEHVEQLIRQQVTENTRNTAIARLEGLGRGYRSYQQALETWLDNRNDARSRSIILERYVALELDITTAIPLFRIRNEEVPLLMVYAQAANLHLLLLRDASLFGSEWGMASSDVNQYYQEQIRYTEEYSNHCVQWYNTGLNNLRGTNAESWLRYNQFRRDLTLGVLDLVALFPSYDTRTYPINTSAQLTREIYTDPIGRTNAPSGFASTNWFNNNAPSFSAIEAAIFRPPHLLDFPEQLTIYSASSRWSSTQHMNYWVGHRLNFRPIGGTLNTSTQGLTNNTSINPVTLQFTSRDVYRTESNAGTNILFTTPVNGVPWARFNFINPQNIYERGATTYSQPYQGVGIQLFDSETELPPETTERPNYESYSHRLSHIGLIIGNTLRAPVYSWTHRSADRTNTIGPNRITQIPLVKALNLHSGVTVVGGPGFTGGDILRRTNTGTFGDIRLNINVPLSQRYRVRIRYASTTDLQFFTRINGTTVNIGNFSRTMNRGDNLEYRSFRTAGFSTPFNFLNAQSTFTLGAQSFSNQEVYIDRVEFVPAEVTFEAEYDLERAQKAVNALFTSTNPRRLKTDVTDYHIDQVSNMVACLSDEFCLDEKRELFEKVKYAKRLSDERNLLQDPNFTFISGQLSFASIDGQSNFPSINELSEHGWWGSANVTIQEGNDVFKENYVTLPGTFNECYPNYLYQKIGESELKAYTRYQLRGYIENSQDLEIYLIRYNAKHEAINVPGTESIWSISAESTIGKCTEPNRCAPHYEWNPDLDCSCRDGEKCAHHSHHSTLDIDVGCTDLHENLGVWLIFKIKTQDGHARLGNLEYLEEKPLLGEALRRVKRTEKKWRDKREKLHLETKRVYTEAKESVDALFVDSQYDRLQANSNIGMIHAADKLVHSIREAYLSELPVIRGVNADIFEELEGHILTAFSLYDARNAVKNGDFNNGLTCWNVKGHVDVQQSHHRFDLVVPEWKAEVSQAVRVCPGCGYILRVTAYKEGYGEGCVTIHEIEENTDELNFKNRVEEEIYPPDTGTCKYYTENQGTRTCGNECGSRNEGYDNAYEINAKSSLEYRPTYEEETYTDVRRENHCEYARGYINYSPVPAGYVTKELEYFPETDTVWIEIGETEGKFIVDSVELLLMEE

SEQ ID NO: 121 - protein, 1231 aa, Bacillus thuringiensis
  REGION 1..1231: note = subsp. wuhanensis
MTSNRKNENEIINALSIPAVSNHSAQMDLSLDARIEDSLCIAEGNNINPLVSASTVQTGINIAGRILGVLGVPFAGQLASFYSFLVGELWPSGRDPWEIFLEHVEQLIRQQVTENTRNTAIARLEGLGRGYRSYQQALETWLDNRNDARSRSIILERYVALELDITTAIPLFRIRNEEVPLLMVYAQAANLHLLLLRDASLFGSEWGMASSDVNQYYQEQIRYTEEYSNHCVQWYNTGLNNLRGTNAESWLRYNQFRRDLTLGVLDLVALFPSYDTRTYPINTSAQLTREIYTDPIGRTNAPSGFASTNWFNNNAPSFSAIEAAIFRPPHLLDFPEQLTIYSASSRWSSTQHMNYWVGHRLNFRPIGGTLNTSTQGLTNNTSINPVTLQFTSRDVYRTESNAGTNILFTTPVNGVPWARFNFINPQNIYERGATTYSQPYQGVGIQLFDSETELPPETTERPNYESYSHRLSHIGLIIGNTLRAPVYSWTHRSADRTNTIGPNRITQIPAVKGRFLFNGSVISGPGFTGGDVVRLNRNNGNIQNRGYIEVPIQFTSTSTRYRVRVRYASVTSIELNVNLGNSSIFTNTLPATAASLDNLQSGDFGYVEINNAFTSATGNIVGARNFSANAEVIIDRFEFIPVTATFEAEYDLERAQKAVNALFTSTNPRRLKTDVTDYHIDQVSNMVACLSDEFCLDEKRELFEKVKYAKRLSDERNLLQDPNFTFISGQLSFASIDGQSNFTSINELSEHGWWGSENVTIQEGNDVFKENYVTLPGTFNECYPNYLYQKIGESELKAYTRYQLRGYIEDSQDLEIYLIRYNAKHETLDVPGTDSLWPLSVKSPIGRCGEPNRCAPHFEWNPDLDCSCRDGERCAHHSHHFTLDIDVGCTDLHENLGVWVVFKIKTQEGYARLGNLEFIEEKPLIGEALSRVKRAEKKWRDKREKLQLETKRVYTEAKETVDALFVDSHYNRLQADTNIGMIHAADRLVHRIHEAYLPELPFIPGINAVIFEELENRISTAFSLYDARNVIKNGDFNNGLSCWNVKGHVDVQQSHHRSDLVIPEWEAEVSQAVRVCPGRGYILRVTAYKEGYGEGCVTIHEIENNTDELKFKNCEEEEVYPTDTGTCNDYTAHQGTAACNSRNAGYEDAYEVDTTASVNYKPTYEEETYTDVRRDNHCEYDRGYVNYPPVPAGYVTKELEYFPETDTVWIEIGETEGKFIVDSVELLLMEE

SEQ ID NO: 122 - protein, 1227 aa, Bacillus thuringiensis
MTSNRKNENEIINALSIPAVSNHSAQMNLSTDARIEDSLCIAEGNNIDPFVSASTVQTGINIAGRILGVLGVPFAGQIASFYSFLVGELWPRGRDPWEIFLEHVEQLIRQQVTENTRDTALARLQGLGNSFRAYQQSLEDWLENRDDARTRSVLYTQYIALELDFLNAMPLFAIRNQEVPLLMVYAQAANLHLLLLRDASLFGSEFGLTSQEIQRYYERQVEKTREYSDYCARWYNTGLNNLRGTNAESWLRYNQFRRDLTLGVLDLVALFPSYDTRVYPMNTSAQLTREIYTDPIGRTNAPSGFASTNWFNNNAPSFSAIEAAVIRPPHLLDFPEQLTIFSVLSRWSNTQYMNYWVGHRLESRTIRGSLSTSTHGNTNTSINPVTLQFTSRDVYRTESFAGINILLTTPVNGVPWARFNWRNPLNSLRGSLLYTIGYTGVGTQLFDSETELPPETTERPNYESYSHRLSNIRLISGNTLRAPVYSWTHRSADRTNTISSDSITQIPLVKSFNLNSGTSVVSGPGFTGGDIIRTNVNGSVLSMGLNFNNTSLQRYRVRVRYAASQTMVLRVTVGGSTTFDQGFPSTMSANESLTSQSFRFAEFPVGISASGSQTAGISISNNAGRQTFHFDKIEFIPITATFEAEYDLERAQEAVNALFTNTNPRRLKTGVTDYHIDEVSNLVACLSDEFCLDEKRELLEKVKYAKRLSDERNLLQDPNFTSINKQPDFISTNEQSNFTSIHEQSEHGWWGSENITIQEGNDVFKENYVILPGTFNECYPTYLYQKIGEAELKAYTRYQLSGYIEDSQDLEIYLIRYNAKHETLDVPGTESVWPLSVESPIGRCGEPNRCAPHFEWNPDLDCSCRDGEKCAHHSHHFSLDIDVGCIDLHENLGVWVVFKIKTQEGHARLGNLEFIEEKPLLGEALSRVKRAEKKWRDKREKLQLETKRVYTEAKEAVDALFVDSQYDRLQADTNIGMIHAADKLVHRIREAYLSELSVIPGVNAEIFEELEGRIITAISLYDARNVVKNGDFNNGLACWNVKGHVDVQQSHHRSVLVIPEWEAEVSQAVRVCPGRGYILRVTAYKEGYGEGCVTIHEIENNTDELKFKNCEEEEVYPTDTGTCNDYTAHQGTAACNSRNAGYEDAYEVDTTASVNYKPTYEEETYTDVRRDNHCEYDRGYVNYPPVPAGYMTKELEYFPETDKVWIEIGETEGKFIVDSVELLLMEE

SEQ ID NO: 123 - protein, 1189 aa, Bacillus thuringiensis
  REGION 1..1189: note = subsp. aizawai
MEENNQNQCIPYNCLSNPEEVLLDGERISTGNSSIDISLSLVQFLVSNFVPGGGFLVGLIDFVWGIVGPSQWDAFLVQIEQLINERIAEFARNAAIANLEGLGNNFNIYVEAFKEWEEDPNNPATRTRVIDRFRILDGLLERDIPSFRISGFEVPLLSVYAQAANLHLAILRDSVIFGERWGLTTINVNENYNRLIRHIDEYADHCANTYNRGLNNLPKSTYQDWITYNRLRRDLTLTVLDIAAFFPNYDNRRYPIQPVGQLTREVYTDPLINFNPQLQSVAQLPTFNVMESSAIRNPHLFDILNNLTIFTDWFSVGRNFYWGGHRVISSLIGGGNITSPIYGREANQEPPRSFTFNGPVFRTLSNPTLRLLQQPWPAPPFNLRGVEGVEFSTPTNSFTYRGRGTVDSLTELPPEDNSVPPREGYSHRLCHATFVQRSGTPFLTTGVVFSWTHRSATLTNTIDPERINQIPLVKGFRVWGGTSVITGPGFTGGDILRRNTFGDFVSLQVNINSPITQRYRLRFRYASSRDARVIVLTGAASTGVGGQVSVNMPLQKTMEIGENLTSRTFRYTDFSNPFSFRANPDIIGISEQPLFGAGSISSGELYIDKIEIILADATFEAESDLERAQKAVNALFTSSNQIGLKTDVTDYHIDQVSNLVDCLSDEFCLDEKRELSEKVKHAKRLSDERNLLQDPNFRGINRQPDRGWRGSTDITIQGGDDVFKENYVTLPGTVDECYPTYLYQKIDESKLKAYTRYELRGYIEDSQDLEIYLIRYNAKHEIVNVPGTGSLWPLSAQSPIGKCGEPNRCAPHLEWNPDLDCSCRDGEKCAHHSHHFTLDIDVGCTDLNEDLGLWVIFKIKTQDNHARLGNLEFLEEKPLLGEALARVKRAEKKWRDKREKLQLETNIVYKEAKESVDALFVNSQYDRLQVNTNIAMIHAADKRVHRIREAYLPELSVIPGVNAAIFEELEGRIFTAYSLYDARNVIKNGDFNNGLLCWNVKGHVDVEEQNNHRSVLVIPEWEAEVSQEVRVCPGRGYILRVTAYKEGYGEGCVTIHEIEDNTDELKFSNCVEEEVYPNNTVTCNNYTGTQEEYEGTYTSRNQGYDEAYGNNPSVPADYASVYEEKSYTDGRRENPCESNRGYGDYTPLPAGYVTKDLEYFPETDKVWIEIGETEGTFIVDSVELLLMEE

SEQ ID NO: 124 - protein, 1189 aa, Bacillus thuringiensis
  REGION 1..1189: note = subsp. entomocidus
MEENNQNQCIPYNCLSNPEEVLLDGERISTGNSSIDISLSLVQFLVSNFVPGGGFLVGLIDFVWGIVGPSQWDAFLVQIEQLINERIAEFARNAAIANLEGLGNNFNIYVEAFKEWEEDPNNPETRTRVIDRFRILDGLLERDIPSFRISGFEVPLLSVYAQAANLHLAILRDSVIFGERWGLTTINVNENYNRLIRHIDEYADHCANTYNRGLNNLPKSTYQDWITYNRLRRDLTLTVLDIAAFFPNYDNRRYPIQPVGQLTREVYTDPLINFNPQLQSVAQLPTFNVMESSRIRNPHLFDILNNLTIFTDWFSVGRNFYWGGHRVISSLIGGGNITSPIYGREANQEPPRSFTFNGPVFRTLSNPTLRLLQQPWPAPPFNLRGVEGVEFSTPTNSFTYRGRGTVDSLTELPPEDNSVPPREGYSHRLCHATFVQRSGTPFLTTGVVFSWTDRSATLTNTIDPERINQIPLVKGFRVWGGTSVITGPGFTGGDILRRNTFGDFVSLQVNINSPITQRYRLRFRYASSRDARVIVLTGAASTGVGGQVSVNMPLQKTMEIGENLTSRTFRYTDFSNPFSFRANPDIIGISEQPLFGAGSISSGELYIDKIEIILADATFEAESDLERAQKAVNALFTSSNQIGLKTDVTDYHIDQVSNLVDCLSDEFCLDEKRELSEKVKHAKRLSDERNLLQDPNFRGINRQPDRGWRGSTDITIQGGDDVFKENYVTLPGTVDECYPTYLYQKIDESKLKAYTRYELRGYIEDSQDLEIYLIRYNAKHEIVNVPGTGSLWPLSAQSPIGKCGEPNRCAPHLEWNPDLDCSCRDGEKCAHHSHHFTLDIDVGCTDLNEDLGVWVIFKIKTQDGHARLGNLEFLEEKPLLGEALARVKRAEKKWRDKREKLQLETNIVYKEAKESVDALFVNSQYDRLQVDTNIAMIHAADKRVHRIREAYLPELSVIPGVNAAIFEELEGRIFTAYSLYDARNVIKNGDFNNGLLCWNVKGHVDVEEQNNHRSVLVIPEWEAEVSQEVRVCPGRGYILRVTAYKEGYGEGCVTIHEIEDNTDELKFSNCVEEEVYPNNTVTCNNYTGTQEEYEGTYTSRNQGYDEAYGNNPSVPADYASVYEEKSYTDGRRENPCESNRGYGDYTPLPAGYVTKDLEYFPETDKVWIEIGETEGTFIVDSVELLLMEE

SEQ ID NO: 125 - protein, 1176 aa, Bacillus thuringiensis
  REGION 1..1176: note = subsp. galleriae
MENNIQNQCVPYNCLSNPEEILLDGERISTGNSSIDISLSLVQLLVSNFVPGGGFLVGLLDFVWGIVGPSPWDAFLVQIEQLINERIAAYARSAAISNLEGLGNNFNIYVEAFKEWEADPDNPVTRTRVVDRFRILDGLLERDIPSFRIAGFEVPLLSVYAQAANLHLAILRDSSIFGARWGLTTINVNENYNRLIRHIDEYANHCADTYNRGLNNLPKSTYQDWITYNRLRRDLTLTVLDIAAFFPSYDNRRYPIQSVGQLTREIYTDPLITFNPQLQSVAQLPTFNVMESNAIRTPHLFDVLNNLTIFTDWFSVGRNFYWGGHRVISNRIGGGNITSPIYGREANQEPPRSFTFNGPVFRTLSNPTFRPLQQPWPAPPFNLRGVEGVEFSTPLNSFTYRGRGTVDSLTELPPEDNSVPPREGYSHRLCHATFVQRSGTPFLTTGPVFSWTHRSATDRNIIYPDVINQIPLVKAFNLTSGTSVVRGPGFTGGDIIRTNVNGSVLSMSLNFSNTTLQRYRVRVRYAASQTMVMSVTVGGSTTGNQGFPSTMSANGALTSQSFRFAEFPVGISASGSQGASISISNNVGRQMFHLDRIEFLPVTSTFEEEYDLERAQEAVNALFTSTNQLGLKTDVTDYHIDQVSNLVECLSDEFCLDEKRELSEKVKHAKRLSDERNLLQDRNFRSINGQLDRGWRGSTDITIQGGDDVFKENYVTLPGTFDECYPTYLYQKIDESKLKSYTRYELRGYIEDSQDLEIYLIRYNAKHEIVNVPGTGSLWPLSIENSIGPCGEPNRCAPHLEWNPNLDCSCRDGEKCAHHSHHFSLDIDVGCTDLNEDLGVWVIFKIKTQDGHARLGNLEFLEEKPLLGEALARVKRAEKKWRDKREKLEWETNIVYKEAKESVDALFVNSQYDRLQADTNIAMIHAADKRVHRIREAYLPELSVIPGVNAGIFEELEGRIFTAYSLYDARNVIKNGDFNNGLLCWNLKGHVDVEEQNNHRSVLVVPEWEAEVSQEVRVCPGRGYILRVTAYKEGYGEGCVTIHEIEDNTDELKFSNCVEEEVYPNNTVTCNDYTATQEEYGGAYTSRNHGYGKSYESNSSVQADYASVYEEKADTDGRRDNHCESNRGYGDYTPLPAGYVTKELEYFPETDKVWVEIGETEGTFIVDSVELLLMEE

SEQ ID NO: 126 - protein, 1165 aa, Bacillus thuringiensis
  REGION 1..1165: note = subsp. aizawai
MEINNQNQCVPYNCLSNPKEIILGEERLETGNTVADISLGLINFLYSNFVPGGGFIVGLLELIWGFIGPSQWDIFLAQIEQLISQRIEEFARNQAISRLEGLSNLYKVYVRAFSDWEKDPTNPALREEMRIQFNDMNSALITAIPLFRVQNYEVALLSVYVQAANLHLSILRDVSVFGERWGYDTATINNRYSDLTSLIHVYTNHCVDTYNQGLRRLEGRFLSDWIVYNRFRRQLTISVLDIVAFFPNYDIRTYPIQTATQLTREVYLDLPFINENLSPAASYPTFSAAESAIIRSPHLVDFLNSFTIYTDSLARYAYWGGHLVNSFRTGTTTNLIRSPLYGREGNTERPVTITASPSVPIFRTLSYITGLDNSNPVAGIEGVEFQNTISRSIYRKSGPIDSFSELPPQDASVSPAIGYSHRLCHATFLERISGPRIAGTVFSWTHRSASPTNEVSPSRITQIPWVKAHTLASGASVIKGPGFTGGDILTRNSMGELGTLRVTFTGRLPQSYYIRFRYASVANRSGTFRYSQPPSYGISFPKTMDAGEPLTSRSFAHTTLFTPITFSRAQEEFDLYIQSGVYIDRIEFIPVTATFEAEYDLERAQKVVNALFTSTNQLGLKTDVTDYHIDQVSNLVACLSDEFCLDEKRELSEKVKHAKRLSDERNLLQDPNFRGINRQPDRGWRGSTDITIQGGDDVFKENYVTLPGTFDECYPTYLYQKIDESKLKAYTRYQLRGYIEDSQDLEIYLIRYNAKHEIVNVPGTGSLWPLSVENQIGPCGEPNRCAPHLEWNPDLHCSCRDGEKCAHHSHHFSLDIDVGCTDLNEDLGVWVIFKIKTQDGHARLGNLEFLEEKPLLGEALARVKRAEKKWRDKRETLQLETTIVYKEAKESVDALFVNSQYDRLQADTNIAMIHAADKRVHRIREAYLPELSVIPGVNAAIFEELEERIFTAFSLYDARNIIKNGDFNNGLLCWNVKGHVEVEEQNNHRSVLVIPEWEAEVSQEVRVCPGRGYILRVTAYKEGYGEGCVTIHEIENNTDELKFNNCVEEEVYPNNTVTCINYTATQEEYEGTYTSRNRGYDEAYGNNPSVPADYASVYEEKSYTDRRRENPCESNRGYGDYTPLPAGYVTKELEYFPETDKVWIEIGETEGTFIVDSVELLLMEE

SEQ ID NO: 127 - protein, 1160 aa, Bacillus thuringiensis
MDINHQNQCIPYNCLSNPDAILLDAERLETGNTVADISLGLINFLYSNFVPGGGFIVGLLELIWGFVGPSQWEIFLAQIEQLISQRIEEFARNQAISRLEGLSNNYEIYTETFRAWEKDPSNPALREEMRTQFNVMNSALIAAIPLLRVRNYEVALLSVYVQAANLHLSVLRDVSVYGQRWGFDPATVNSRYSDLTRLIHVYTDHCVDTYNDGLKNLEGSRLSDWVVYNRFRRRLTISVLDIIAFFPNYDIEAYPIQTASQLTREVYLDLPFVNETLSPPASYPTFSAAESAIIRSPHLVDFLNSFTIYTDSLASYAYWGGHLVNSFRTGTTTNLIRSPLYGREGNTERPVTISASPSVPIFRTLSYFTGLNNNNPVAGIEGVEFQNTISRSIYRKSGPIDSFSELPPQDVSVSPAIGYSHRLCHATFLERISGPRIAGTVFSWTHRSASPINEVSPSRITQIPWVKAHTLASGASVIKGPGFTGGDILTRNSMGDLGALRVTFTGRLPQSYYIRFRYASVANRSGTFRYSQPPSYGISFPKTMDAGEALTSRSFAHTTLFTPITFSRAQEEFDLYIQSGVYIDRIEFIPVDATFESEINLERAQKAVNALFTSTNQLGLKTDVTDYHIDQVSNLVECLSDEFCLDEKRELSEKVKHAKRLSDERNLLQDPNFRGINRQPDRGWRGSTDITIQGGDDVFKENYVTLTGTFDECYPTYLYQKIDESKLKAYTRYQLRGYIEDSQDLEIYLIRYNAKHEIVNVPGTGSLWPLSVQSPIGKCGEPNRCAPHLEWNPDLDCSCRDEEKCAHHSHHFSLDIDVGCTDLNEDLGVWVIFKIKTQDGHARLGNLEFLEEKPLVGEALARVKRAEKKWRDKREKLELETNIVYKEAKESVDALFVNSQYDQLQADTNIAMIHAADKRVHSIREAYLPELSVIPGVNAGIFEELEGRIFTAYSLYDARNVIKNGDFNNGLSCWNVKGHVDVEEQNNHRSVLVVPEWEAEVSQEVRVCPGRGYILRVTAYKEGYGEGCVTIHEVDNNTDELKFSNCEKEQVYPGNTVACNDYNKNHGANACSSRNRGYDESYESNSSIPADYAPVYEEEAYTDGQRGNPCEFNRGHTPLPAGYVTAELEYFPETDTVWVEIGETEGTFIVDSVELLLMEE

SEQ ID NO: 128 - protein, 1171 aa, Bacillus thuringiensis
  REGION 1..1171: note = subsp. kenyae
MEIVNNQNQCVPYNCLNNPENEILDIERSNSTVATNIALEISRLLASATPIGGILLGLFDAIWGSIGPSQWDLFLEQIELLIDQKIEEFARNQAISRLEGISSLYGIYTEAFREWEADPTNPALKEEMRTQFNDMNSILVTAIPLFSVQNYQVPFLSVYVQAANLHLSVLRDVSVFGQAWGFDIATINSRYNDLTRLIPIYTDYAVRWYNTGLDRLPRTGGLRNWARFNQFRRELTISVLDIISFFRNYDSRLYPIPTSSQLTREVYTDPVINITDYRVGPSFENIENSAIRSPHLMDFLNNLTIDTDLIRGVHYWAGHRVTSHFTGSSQVITTPQYGITANAEPRRTIAPSTFPGLNLFYRTLSNPFFRRSENITPTLGINVVQGVGFIQPNNAEVLYRSRGTVDSLNELPIDGENSLVGYSHRLSHVTLTRSLYNTNITSLPTFVWTHHSATNTNTINPDIITQIPLVKGFRLGGGTSVIKGPGFTGGDILRRNTIGEFVSLQVNINSPITQRYRLRFRYASSRDARITVAIGGQIRVDMTLEKTMEIGESLTSRTFSYTNFSNPFSFRANPDIIRIAEELPIRGGELYIDKIELILADATFEEEYDLERAQKAVNALFTSTNQLGLKTDVTDYHIDQVSNLVECLSDEFCLDEKRELSEKVKHAKRLSDERNLLQDPNFRGINRQPDRGWRGSTDITIQGGDDVFKENYVTLPGTFDECYPTYLYQKIDESKLKAYTRYELRGYIEDSQDLEIYLIRYNAKHETVNVPGTGSLWPLSAQSPIGKCGEPNRCAPHLEWNPNLDCSCRDGEKCAHHSHHFSLDIDVGCTDLNEDLGVWVIFKIKTQDGYARLGNLEFLEENPLLGEALARVKRAEKKWRDKCEKLEWETNIVYKEAKESVDALFVNSQYDRLQADTNIAMIHAADKRVHSIREAYLPELSVIPGVNAAIFEELEGRIFTAFSLYDARNVIKNGDFNNGLSCWNVKGHVDVEEQNNHRSVLVVPEWEAEVSQEVRVCPGRGYILRVTAYKEGYGEGCVTIHEIEDNTDELKFSNCVEEEVYPNNTVTCNNYTATQEEHEGTYTSRNRGYDEAYESNSSVHASVYEEKSYTDRRRENPCESNRGYGDYTPLPAGYVTKELEYFPETDKVWIEIGETEGTFIVDSVELLLMEE

SEQ ID NO: 129 - protein, 1174 aa, Bacillus thuringiensis
  REGION 1..1174: note = subsp. aizawai
MENNIENQCIPYNCLNNPEVEILGIERSNSNVAAEIGLGLSRLLVSRIPLGDFILGLFDVIWGAIGPSQWDIFLEQIELLIGQRIEEFARNQAISRLQGLSNLYRIYTNAFKNWEVDPTNPALREEMRIQFNDMNSALTTAIPLFSVQGYEIPLLSVYVQAANLHLSVLRDVSVFGQRWGFDVATINSRYNDLTRLIGEYTDYAVRWYNTGLNRLPRNEGVRGWARFNRFRRELTISVLDIISFFQNYDSRLYPIPTIYQLTREVYTDPVINITDYRVTPSFESIENSAIRSPHLMDFLNNIIIDTDLIRGVHYWAGHRVTSHFTGSSQVISSPQYGITANAEPSRTIAPSTFPGLNLFYRTLSDPFFRRSDNIMPTLGINVVQGVGFIQPNNGEVLYRRRGTVDSLDELPIDGENSLVGYSHRLSHVTLTRSLYNTNITSLPTFVWTHHSATDRNIIYPDVITQIPLVKSFSLTSGTSVVRGPGFTGGDIIRTNVNGNVLSMSLNFSNTSLQRYRVRVRYAASQTMVMRVNVGGSTTFDQGFPSTMSANGSLTSQSFRFAEFPVGISTSGSQTAGISISNNPGRQTFHLDRIEFIPVDATFEAEYDLERAQKAVNSLFTSSNQIELKTDVTDYHIDQVSNLVDCLSDEFCLDEKRELSEKVKHAKRLSDERNLLQDPNFRGINRQPDRGWRGSTDITIQGGDDVFKENYVTLPGTFDECYPTYLYQKIDESKLKAYNRYQLRGYIEDSQDLEIYLIRYNAKHETVNVPGTGSLWPLSVESPIGRCGEPNRCVPHLEWNPDLDCSCRDGEKCAHHSHHFSLDIDVGCTDLQEDLGVWVVFKIKTQEGYARLGNLEFIEEKPLIGEALSRVKRAEKKWRDKREKLQLETKRVYTEAKEAVDALFVDSQYDRLQADTNIGMIHAADRLVHQIHEAYLPELPFIPGINVVIFEELENRISTALSLYDARNVIKNGDFNNGLSCWNVKGHVDVVEQNNHRSVLVVPEWEAEVSQTIRVCPGRGYILRVTAYKEGYGEGCVTIHEIENNTDELKFKNCEEEEVYPTDTGTCNDYTAHQGTAGSTDSCNSRNIRYEDAYEMNTTASVNYKPTYEEERYTDVQGDNHCEYDRGYVNYRPVPAGYVTKELEYFPETDKVWIEIGETEGKFIVDNVELLLMEE

SEQ ID NO: 130 - protein, 1174 aa, Bacillus thuringiensis
  REGION 1..1174: note = subsp. aizawai
MENNIQNQCVPYNCLNNPEVEILNEERSTGRLPLDISLSLTRFLLSEFVPGVGVAFGLFDLIWGFITPSDWSLFLLQIEQLIEQRIETLERNRAITTLRGLADSYEIYIEALREWEANPNNAQLREDVRIRFANTDDALITAINNFTLTSFEIPLLSVYVQAANLHLSLLRDAVSFGQGWGLDIATVNNHYNRLINLIHRYTKHCLDTYNQGLENLRGTNTRQWARFNQFRRDLTLTVLDIVALFPNYDVRTYPIQTSSQLTREIYTSSVIEDSPVSANIPNGFNRAEFGVRPPHLMDFMNSLFVTAETVRSQTVWGGHLVSSRNTAGNRINFPSYGVFNPGGAIWIADEDPRPFYRTLSDPVFVRGGFGNPHYVLGLRGVAFQQTGTNHTRTFRNSGTIDSLDEIPPQDNSGAPWNDYSHVLNHVTFVRWPGEISGSDSWRAPMFSWTHRSATPTNTIDPERITQIPLVKAHTLQSGTTVVRGPGFTGGDILRRTSGGPFAYTIVNINGQLPQRYRARIRYASTTNLRIYVTVAGERIFAGQFNKTMDTGDPLTFQSFSYATINTAFTFPMSQSSFTVGADTFSSGNEVYIDRFELIPVTATFEAEYDLERAQKAVNALFTSINQIGIKTDVTDYHIDQVSNLVDCLSDEFCLDEKRELSEKVKHAKRLSDERNLLQDPNFKGINRQLDRGWRGSTDITIQRGDDVFKENYVTLPGTFDECYPTYLYQKIDESKLKPYTRYQLRGYIEDSQDLEIYLIRYNAKHETVNVLGTGSLWPLSVQSPIRKCGEPNRCAPHLEWNPDLDCSCRDGEKCAHHSHHFSLDIDVGCTDLNEDLDVWVIFKIKTQDGHARLGNLEFLEEKPLVGEALARVKRAEKKWRDKREKLELETNIVYKEAKESVDALFVNSQYDQLQADTNIAMIHAADKRVHRIREAYLPELSVIPGVNVDIFEELKGRIFTAFFLYDARNVIKNGDFNNGLSCWNVKGHVDVEEQNNHRSVLVVPEWEAEVSQEVRVCPGRGYILRVTAYKEGYGEGCVTIHEIENNTDELKFSNCVEEEVYPNNTVTCNDYTANQEEYGGAYTSRNRGYDETYGSNSSVPADYASVYEEKSYTDGRRDNPCESNRGYGDYTPLPAGYVTKELEYFPETDKVWIEIGETEGTFIVDSVELLLMEE

SEQ ID NO: 131 - protein, 1169 aa, Bacillus thuringiensis
  REGION 1..1169: note = subsp. morrisoni
MKNNIQNQCVPYNCLSNPEVEILSEERSTGRLPLDISLSLTRFLLSEFVPGVGVAFGLFDLIWGFITPSEWSLFLLQIEQLIEQRIETLERNRAITTLRGLADSYEVYLEALREWEENPNNAQLREDVRIRFANTDDALITAINNFTLTSFEIPLLSVYVQAANLHLSLLRDAVSFGQGWGLDIATVNNHYNRLINLIHRYTEHCLDTYNQGLENLRGTNTRQWSRFNQFRRELTLTVLDIVALFPNYDARAYPIQTSSQLTREIYTSSVIEDSPVSANIPNGFNRAEFGVRPPHLMDFMNSLFVTAETVRSQTVWGGHLVSSRNTAGNPINFPIYGVFNPGGAIWIADEDPRPFYRTLSDPVFVRGGFGNPHYVLGLRGVGFQQTGTNHTRTFRNSGTIDSLDEIPPQDNSGAPWNDYSHVLNHVTFVRWPGEIAGSDSWRAPMFSWTHRSADRTNIINPNIITQIPAVKAHNLHSGSTVVRGPGFTGGDLLRRTNTGTFADIRVNITGPLSQRYRVRIRYASTTDLQFFTRINGTSVNQGNFQRTMNRGGNLESGNFRTAGFSTPFSFSNAQSTFTLGTQAFSNQEVYIDRIEFVPAEVTFEAESDLERAQKAVNALFTSTSQLGLKTNVTGYHIDQVSNLVACLSDEFCLDEKRELSEKVKHAKRLSDKRNLLQDPNFRGINRQPDHGWRGSTDITIQGGDDVFKENYVTLPGTFDECYPTYLYQKIDESKLKAYTRYQLRGYIEDSQDLEIYLIRYNSKHEIVNVPGTGSLWPLSVENQIGPCGEPNRCAPHLEWNPDLHCSCRDGEKCVHHSHHFSLDIDVGCTDLNEDLGVWLIFKIKTQDGHARLGNLEFLEEEPLLGEALARVKRAEKKWRDKREKLQLETNIVYKEAKESVDALFVNSQYDRLQADTNIAMIHAADKRVHRIREAYLPELSVIPGVNAAIFEELEGRIFTAYSLYDARNVIKNGNFNNGLLCWNVKGHVDVEEQNNHRSVLVVPEWEAEVSQEVRVCPGRGYILRVTAYKEGYGEGCVTIHEVDNNTDELKFSSNCEKEQVYPGNTVACNDYNKNHGANACSSRNGGYDESYESNSSIPADYAPVYEEEAYTDGQRGNPCEFNRGHTPLPAGYVTAELEYFPETDTVWVEIGETEGTFIVDSVELLLMEE

SEQ ID NO: 132 - protein, 1166 aa, Bacillus thuringiensis
MEISDQNQYIPYNCLNNPESEIFNARNSNFGLVSQVSSGLTRFLLEAAVPEAGFALGLFDIIWGALGVDQWSLFLRQIEQLIRQEITELERNRATAILTGLSSSYNLYVEALREWENDPNNPASQERVRTRFRLTDDAIVTGLPTLAIRNLEVVNLSVYTQAANLHLSLLRDAVYFGERWGLTQANIEDLYTRLTSNIQEYSDHCARWYNQGLNEIGGISRRYLDFQRDLTISVLDIVALFPNYDIRTYPIPTQSQLTREIYTSPVVAGNINFGLSIANVLRAPHLMDFIDRIVIYTNSVRSTPYWAGHEVISRRTGQGQGNEIRFPLYGVAANAEPPVTIRPTGFTDEQRQWYRARSRVVSFRSSGQDFSLVDAVGFLTIFSAVSIYRNGFGFNTDTIDEIPIEGTDPFTGYSHRLCHVGFLASSPFISQYARAPIFSWTHRSATLTNTIAPDVITQIPLVKAFNLHSGATIVKGPGFTGGDILRRTNVGSFGDMRVNITAPLSQRYRVRIRYASTTDLQFYTNINGTTINIGNFSSTMDSGDDLQYGRFRVAGFTTPFTFSDANSTFTIGAFGFSPNNEVYIDRIEFVPAEVTFEAEYDLEKAQKAVNALFTSSNQIGLKTDVTDYHIDKVSNLVECLSDEFCLDEKRELSEKVKHAKRLSDERNLLQDPNFRGINRQPDRGWRGSTDITIQGGDDVFKENYVTLPGTFDGCYPTYLYQKIDESKLKVYTRYQLRGYIEDSQDLEIYLIRYNAKHETVNVPGTGSLWPLSAQSPIGKCGEPNRCAPHLEWNPDLDCSCRNGEKCAHHSHHFSLDIDVGCTDLNEDLGVWVIFKIKTQDGHARLGNLEFLEEKPLLGEALARVKRAEKKWRDKREKLELETNIVYKEAKESVDALFVNSQYDQLQADTNIAMIHAADKRVHSIREAYLPELSVIPGVNAAIFEELEGRIFTAFSLYDARNVIKNGDFNNGLSCWNVKGHVDVEEQNNHRSVLVVPEWEAEVSQEVRVCPGRGYILRVTAYKEGYGEGCVTIHEIENNTDELKFSNCVEEEVYPNNTVTCNDYTANQEEYKGAYTSHNRGYDEAYGNNPSVPADYTPVYEEKAYTDGRRENPCESNRGYGDYTPLPAGYVTKELEYFPETDKVWIEIGETEGTFIVESVELLLMEE

SEQ ID NO: 133 - protein, 1169 aa, Bacillus thuringiensis
  REGION 1..1169: note = subsp. wuhanensis
MEINNQNQCVPYNCLNNPESEILNVAIFSSEQVAEIHLKITRLILENFLPGGSFAFGLFDLIWGIFNEDQWSAFLRQVEELINQRITEFARGQAIQRLVGFGRSYDEYILALKEWENDPDNPASKERVRTRFRTTDDALLTGVPLMAIPGFELATLSVYAQSANLHLALLRDAVFFGERWGLTQTNINDLYSRLKNSIRDYTNHCVRFYNIGLGNLNVIRPEYYRFQRELTISVLDLVALFPNYDIRTYPIPTKSQLTREIYTDPIISPGAQAGYTLQDVLREPHLMDFLNRLIIYTGEYRGIRHWAGHEVESSRTGMMTNIRFPLYGTAATAEPTRFITPSTFPGLNLFYRTLSAPIFRDEPGANIIIRYRTSLVEGVGFIQPNNGEQLYRVRGTLDSLDQLPLEGESSLTEYSHRLCHVRFAQSLRNAEPLDYARVPMFSWTHRSATPTNTIDPDVITQIPLVKAFNLHSGATVVRGPGFTGGDILRRTNAGNFGDMRVNITAPLSQRYRVRIRYASTANLQFHTSINGRAINQANFPATMNSGENLQSGSFRVAGFTTPFTFSDALSTFTIGAFSFSSNNEVYIDGIEFVPAEVTFATESDQDRAQKAVNALFTSSNQIGLKTDVTNYHIDQVSNLVECLSDEFCLDEKRELSEKVKHAKRLCDERNLLQDPNFRGINREPDRGWRGSTDITIQRGDDVFKENYVTLPGTFDECYPTYLYQKIDESKLKAYTRYELRGYIEDSQDLEIYLIRYNAKHETVNVPGTGSLWPLSAQSPIGKCGEPNRCATHLEWNPDLDCSCRDGEKCAHHSHHFSLDIDVGCTDLNEDLGVWVIFKIKTQDGHARLGNLEFLEEKPLLGEALARVKRAEKKWRDKREKLELETNIVYKEAKKSVDALFVNSQYDRLQADTNIAIIHAADKRVHSIREAYLPELSVIPGVNAAIFEELEGRIFTAYSLYDARNVIKNGDFNNGLSCWNVKGHVDVEEQNNHRSVLVVPEWEAEVSQEVRVCPGRGYILRVTAYKEGYGEGCVTIHEIEDNTDELKFSNCVEEEIYPNNTVTCNDYTATQEEYEGTYTSRNRGYDGAYESNSSVPADYASAYEEKAYTDGRRDNTCESNRGYGDYTPLPAGYVTKELEYFPETDKVWIEIGETEGTFIVDSVELLLMEE

SEQ ID NO: 134 - protein, 1172 aa, Bacillus thuringiensis
MEIINNQNQYVPYNCLSNPENEILDIESLSSRSREQVAEISLGLTRFLLESLLPGASFGFALFDIIWGVIGPDQWNLFLAQIEQLIDQRIEAHVRNQAISRLEGLGDSYEVYIESLREWEASPNNEALQQDVRNRFSNTDNALITAIPILREQGFEIPLLSVYVQAANLHLSLLRDAVYFGQRWGLDTVTVNNHYNRLINLINTYSDHCAQWFNRGLDNFGGVSARYLDFQREVTISVLDIVALFPNYDIRTYPISTQSQLTREIYTSPVAEPGASLNANLQNILREPHLMDFLTRLVIYTGVQSGIYHWAGHEISSRTTGNLSSNIQFPLYGTAASADRAFNMNIHHSETIYRTLSAPIYSVSGGISPNRTRVVEGVRFLIARDNNLDSLPFLYRKEGTLDSFTELPPEDESTPPYIGYSHRLCHARFARSPVILEPSNFARLPVFSWTHRSASPTNEVSPSRITQIPWVKAHTLASGASVIKGPGFTGGDIMTRNNINLGDLGTLRVTVTGRLPQSYYIRLRYASVANSSGVFRHLPQPSYGISFPRTMGTDEPLTSRSFALTTLFTPITLTRAQEEFNLTIPRGVYIDRIEFVPVDATFEAGYDLERAQKAVNALFTSTNQRGLKTDITDYHIDQVSNLVECLSDEFCLDEKRELSEKVKHAKRLSDGRNLLQDRNFISINGLLDRGWRGSTDITIQGSDDVFKENYVTLPGTFDECYPTYLYQKIDESKLKAYTRYQLRGYIEDSQDLEIYLIRYNAKHEIVNVPGTGSLWPLSVENSIGPCGESNRCAPHLEWNPNLDCSCRDGEKCAHHSHHFSLDIDVGCTDLNEDLGVWVIFKIKTQDGHARIGNLEFLEEKPLVGEALARVKRAEKKWRDKRKKLEFETNIVYKEAKESVDALFVNSQYDKLKADTNIAMIHAADKRVHRIREAYLPELSVIPGVNADIFEELEGRIFTAYSLYDARNVIKNGDFNNGLLCWNVKGHVDVEEQNNHRSVLVVPEWEAEVSQEVRVCPGRGYILRVTAYKEGYGEGCVTIHEIEDNTDELKFSNCVEEEVYPSNTVTCNDYTANQEEYEGTYTSRNQGYDEAYESNSSVPANYASVYEEKAYTDGRRENSCEFNRGYRDYTPLPAGYVTKELEYFPGTAKVWIEIGETEGTFIVDSVELLLMEE

SEQ ID NO: 135 - protein, 1155 aa, Bacillus thuringiensis
  REGION 1..1155: note = subsp. morrisoni
MEVNHQNECVPYNCLKNPKIEMLDIEGISSRSREQVAEISLGLTRFLLESLLPGASFGFGLFDIIWGVIGPDQWSLFLTQIEQLIDQRIEAHVRNQAISRLEGLGDSYEVYIESLREWEASPNNESLQQDVRNRFSNTDNALITAIPILREQGFEIPLLTVYVQAANLHLSLLRDAVYFGQRWGLDTATVNNHYNRLINLINTYSDHCAQWFNRGLDNFGVVTARYLDFQREVTISVLDIVALFPNYDIRTYPIQTLSQLTREIYTSPVAEPGASLNVDLRNILREPHLMDFLTRLVIYTGVQGGIYHWAGHEISSRTTGNLSSNIQFPLYGTSANADRPFNLAIHYSETIYRTLSAPIYSVSGGISPNRTRAVEGVRFLTARDNNLNSLPFLYRKEGSLDSFTELPPEDENEPPYIGYSHRLCHARFARSSVVLEPSNFARIPVFSWTHRSAGPTNEVSSSRITQIPWVKAHTLDSGAFVIKGPGFTGGDILTRPNLGTLGALRVTLTGQLPQTYNIRIRYASIANRGGTLIFSQPPSYGLTFPKTMDIDEPLTSRSFARTTLFTPITFTQAQAELNLTIQQGVYIDRIEFIPVNATFEAEYDLERAQEAVNALFTSSNQLGLKTDLTDYHIDQVSNLVDCLSDEFCIDEKRELSEKVKHAKRLSDERNLLQDSNFRGINRQPDRGWRGSTDITIQGGNDVFKENYVTLPGTFDECYPTYLYQKIDESKLKAYTRYQLRGYIEDSQDLEIYLIRYNAKHETVNVPGTGSLWPLSVESPIGKCGEPNRCVPQLEWNSNLDCSCRDGEKCAHHSHHFSLDIDVGCTDLNEDLGVWVIFKIKTQDGHARLGNLEFLEEKPLLGEALARVKRAEKKWRDKRETLQLETNIVYKEAKESVDALFANSQYNRLQADTNIAMIHAADKRVHRIREAYLPELSVIPGVNAGIFEELEGRIFTAFSLYDARNVIKNSDFNNGLSCWNVKGHVDIEEQNNHRSVLVVPEWEAEVSQKVHVCPGRGYILRVTAYKEGYGEGCVTIHEIEDHTDELKFRNCEEDEVYPNNTRTCNAYPADQEGYEGACTSRNRGYDEVYGNTPSLPADYAPIYEENAYTDGRRGNPCESSRGYGDYTPLPAGYETKELEYFPETDTVWPRNRYSVD

SEQ ID NO: 136 - protein, 719 aa, Bacillus thuringiensis
  REGION 1..719: note = subsp. kurstaki
MKLKNQDKHQSFSSNAKVDKISTDSLKNETDIELQNINHEDCLKMSEYENVEPFVSASTIQTGIGIAGKILGTLGVPFAGQVASLYSFILGELWPKGKNQWEIFMEHVEEIINQKISTYARNKALTDLKGLGDALAVYHDSLESWVGNRNNTRARSVVKSQYIALELMFVQKLPSFAVSGEEVPLLPIYAQAANLHLLLLRDASIFGKEWGLSSSEISTFYNRQVERAGDYSDHCVKWYSTGLNNLRGTNAESWVRYNQFRRDMTLMVLDLVALFPSYDTQMYPIKTTAQLTREVYTDAIGTVHPHPSFTSTTWYNNNAPSFSAIEAAVVRNPHLLDFLEQVTIYSLLSRWSNTQYMNMWGGHKLEFRTIGGTLNISTQGSTNTSINPVTLPFTSRDVYRTESLAGLNLFLTQPVNGVPRVDFHWKFVTHPIASDNFYYPGYAGIGTQLQDSENELPPEATGQPNYESYSHRLSHIGLISASHVKALVYSWTHRSADRTNTIEPNSITQIPLVKAFNLSSGAAVVRGPGFTGGDILRRTNTGTFGDIRVNINPPFAQRYRVRIRYASTTDLQFHTSINGKAINQGNFSATMNRGEDLDYKTFRTVGFTTPFSFLDVQSTFTIGAWNFSSGNEVYIDRIEFVPVEVTYEAEYDFEKAQEKVTALFTSTNPRGLKTDVKDYHIDQVSNLVESLSDEFYLDEKRELFEIVKYAKQLHIERNM

SEQ ID NO: 137 - protein, 719 aa, Bacillus thuringiensis
  REGION 1..719: note = subsp. entomocidus
MKLKNPDKHQSLSSNAKVDKIATDSLKNETDIELKNMNNEDYLRMSEHESIDPFVSASTIQTGIGIAGKILGTLGVPFAGQIASLYSFILGELWPKGKSQWEIFMEHVEEIINQKILTYARNKALSDLRGLGDALAVYHESLESWVENRNNTRARSVVKNQYIALELMFVQKLPSFAVSGEEVPLLPIYAQAANLHLLLLRDASIFGKEWGLSASEISTFYNRQVERTRDYSDHCIKWYNTGLNNLRGTNAKSWVRYNQFRKDMTLMVLDLVALFPSYDTLVYPIKTTSQLTREVYTDAIGTVHPNQAFASTTWYNNNAPSFSAIEAAVIRSPHLLDFLEKVTIYSLLSRWSNTQYMNMWGGHRLESRPIGGALNTSTQGSTNTSINPVTLQFTSRDVYRTESLAGLNLFLTQPVNGVPRVDFHWKFPTLPIASDNFYYLGYAGVGTQLQDSENELPPETTGQPNYESYSHRLSHIGLISASHVKALVYSWTHRSADRTNTIEPNSITQIPLVKAFNLSSGAAVVRGPGFTGGDILRRTNTGTFGDIRVNINPPFAQRYRVRIRYASTTDLQFHTSINGKAINQGNFSATMNRGEDLDYKTFRTIGFTTPFSFSDVQSTFTIGAWNFSSGNEVYIDRIEFVPVEVTYEAEYDFEKAQEKVTALFTSTNPRGLKTDVKDYHIDQVSNLVESLSDEFYLDEKRELFEIVKYAKQIHIERNM

SEQ ID NO: 138 - protein, 719 aa, Bacillus thuringiensis
MKLKNPDKHQTLSSNAKVDKIATDSLKNETDIELKNMNNEDYLRMSEHESIDPFVSASTIQTGIGIAGKILGTLGVPFPGQIASLYSFILGELWPKGKSQWEIFMEHVEAIINRKISTYARNKALTDLKGLGDALAVYHESLESWVGNRNNTRARSVVKNQYIALELMFVQKLPSFAVSGEEVPLLPIYAQAANLHLLLLRDASIFEKNGGLSASEISTFYNRQVERTRDYSYHCVKWNNTGLNNLRATNGQSWVRYNQFRKDIELMVLDLVRVFPSYDTLVYPIKTTSQLTREVYTDAIGTVDPNQALRSTTWYNNNAPSFSAIEAAVIRSPHLLDFLEKVTIYSLLSRWSNTQYMNMWGGHRLESRPIGGALNTSTQGSTNTSINPVTLQFTSRDFYRTESWAGLNLFLTQPVNGVPRVDFHWKFPTLPIASDNFYYLGYAGVGTQLQDSENELPPETTGQPNYESYSHRLSHIGLISGSHVKALVYSWTHRSADRTNTIEPNSITQIPLVKAFNLSSGAAVVRGPGFTGGHILRRTKSGTFGHIRVNINPPFAQRYRVRMSYASTTDLQFHTSINGKAINQGNFSATMNRGEDLDYKTFRTVGFTTPFSFSDVQSTFTIGAWNFSSGNEVYIGRIEFVPVEVTYEAEYDFEKAQEKVTALFTSTNPRGLKTDVKDYHIDQVSNLVESLSDELYLDEKRELFEIVKYAKQIHIERNM

SEQ ID NO: 139 - protein, 719 aa, Bacillus thuringiensis
MKSKNQNMYRSFSSNATVDKSFTDPLEHNTNMELQNSNHEDCLKMSEYESVEPFVSVSTIQTGIGIAGKILGNLGVPFAGQVASLYSFILGELWPKGKSQWEIFMEHVEELINQKISTYARNKALADLKGLGDALAVYHESLESWIENRNNTRVRSVVKNQYIALELMFVQKLPSFAVSGEEVPLLPIYAQAANLHLLLLRDASIFGKEWGLSESEISTFYNRQSSQTQEYSDYCSEWYNTGLNRLRGTNAESWVRYNQFRRDMTLMVLDLVALFPSYDTRMYPIPTSAQLTREVYTDAIGTVHPNASFASTTWYNNNAPSFSTIEAAVVRNPHLLDFLEQVTIYSLLSRWSNTQYMNMWGGHKLEFRTIGGTLNTSTQGSTNTSINPVTLPFTSRDVYRTESLAGLNLFLTQPVNGVPRVDFHWKFVTHPIASDNFYYPGYAGIGTQLQDSENELPPETTGQPNYESYSHRLSHIGLISASHVKALVYSWTHRSADRTNTINSDSITQIPLVKAFNLPSGASVVRGPGFTGGDILQRTNTGTFGDIRVNINPPFAQRYRLRIRYASTTNLEFHTSINGKAINQGNFSATMNRGEDLDYKAFRTVGFTTPFSFSNAQSTFTIGAWNFSLGNEVYIDRIEFVPVEVTYEAEYDLKKAQDEITAMFTSTNLRRLKTNVTDCHIDQVSNLVESLSDEFYLDEKRELFEIVKYAKQLNIERNM

SEQ ID NO: 140 - protein, 1167 aa, Bacillus thuringiensis
MEINNQKQCIPYNCLSNPEEVLLDGERILPDIDPLEVSLSLLQFLLNNFVPGGGFISGLVDKIWGALRPSEWDLFLAQIERLIDQRIEATVRAKAITELEGLGRNYQIYAEAFKEWESDPDNEAAKSRVIDRFRILDGLIEANIPSFRIIGFEVPLLSVYVQAANLHLALLRDSVIFGERWGLTTKNVNDIYNRQIREIHEYSNHCVDTYNTELERLGFRSIAQWRIYNQFRRELTLTVLDIVALFPNYDSRLYPIQTFSQLTREIVTSPVSEFYYGVINSGNIIGTLTEQQIRRPHLMDFFNSMIMYTSDNRREHYWSGLEMTAYFTGFAGAQVSFPLVGTRGESAPPLTVRSVNDGIYRILSAPFYSAPFLGTIVLGSRGEKFDFALNNISPPPSTIYRHPGTVDSLVSIPPQDNSVPPHRGSSHRLSHVTMRASSPIFHWTHRSATTTNTINPNAIIQIPLVKAFNLHSGATVVRGPGFTGGDILRRTNTGTFADMRVNITGPLSQRYRVRIRYASTTDLQFFTRINGTSVNQGNFQRTMNRGDNLESGNFRTAGFSTPFSFSNAQSTFTLGTQAFSNQEVYIDRIEFVPAEVTFEAESDLERAQKAVNALFTSTNQLGLKTDVTDYQIDQVSNLVECLSDEFCLDEKRELSEKVKHAKRLSDKRNLLQDPNFTSINRQLDRGWRGSTDITIQGGNDVFKENYVTLPGTFDECYPTYLYQKIDESKLKAYTRYELRGYIEDSQDLEVYLIRYNAKHETVNVPGTGSLWPLSVESPIGRCGEPNRCVPHIEWNPDLDCSCRDGEKCAHHSHHFSLDIDVGCTDLNEDLGVWVIFKIKTQDGHARLGNLEFLEEKPLLGEALARVKRAEKKWRDKREQLQFETNIVYKEAKESVDALFVDSHYNRLQADTNITMIHAADKRVHRIREAYLPELSVIPGVNADIFEELEGLIFTAFSLYDARNIIKNGDFNNGLSCWNVKGHVDIQQNDHRSVLVVPEWESEVSQEVRVCPGRGYILRVTAYKEGYGEGCVTIHEIEDNTDELKFSNCIEEEVYPTDTGNDYTAHQGTTGCADACNSRNVGYEDGYEINTTASVNYKPTYEEEMYTDVRRDNHCEYDRGYGNHTPLPAGYVTKELEYFPETDTVWIEIGETEGTFIVDSVELLLMEE

SEQ ID NO: 141 - protein, 1170 aa, Bacillus thuringiensis
MEINNQNQCIPYNCLSNPEEVLLDGERILPDIDPLEVSMSLLQFLLNNFVPGGGFISGLFDKIWGALRPSDWELFLAQIEQLIDQRIEATVRAKAIAELEGLGRSFQLYVEAFKEWEETPDNTAARSRVTERFRIIDAQIEANIPSFRIPGFEVPLLSVYAQAANLHLALLRDSVIFGERWGLTTTNVNDIYNRQVKRIHEYSDHCVDTYKTELERLGFTSRAQWKIYNQFRRELTLTVLDIVAVFPNYDGKLYPIQTKSELTREIYTSPVSEYYYGAINNYNQNGIQTERQIRQPHLMDFFNTMTMYTSYNRREYYWSGLEMTAYFTGFAGPQVSFPLAGTRGDAAPPFNVRSVNDGIYRILSAPFYSAPFLGTSVLGSRGEEFMFALNNISPPPSARYRNPGTVDSLVSIPPQDNSVPPHRGSSHRLSHVTMRNSSPIFHWTHRSATTTNRINSDVITQIPMVKAYNLHAGATVVRGPGFTGGDILRRTSNGMVVTLRVDASAVRNQRYRIRFRYAATSNFYFVVRRGNLGVNGREIMKTMSTGEELKSASFVLGEFITPFNFFENQVPLQIEIQSLSPGGEVYLDKIEFIPADTTFEAEYDLERAQKAVNALFTSTNQRGLKTDVTDYHIDQVSNLVECLSDEFCLDEKRELSEKVKHAKRLSDERNLLQDPNFTSINGQLDRGWRGSTDITIQGGNDVFKENYVTLPGTFDECYPTYLYQKIDESKLKAYTRYELRGYIEDSQDLEVYLIRYNAKHETLNVPGTDSLRTLSVESQNGRCGELNRCMPHIKWNPDVDCSCRDGEKCAHHSHHFSLDIDVGCTDLQEDLGVWVVFKIKTQEGYARLGNLEFIEEKPLVGEALSRVKRAEKKWRDKREKLELETKRVYTEAKEAVDALFVDSQYDRLQADTNIGMIHAADKLVHRICETYLPELPFIPGINAIIFEELENRISTAFFLYEARNVINNGDFNNGLTCWNVKGHVDVQQSHHRSVLVIPEWEAEVSQKVRVCPGRGYILRVTAYKEGYGEGCVTIHEIEDNTDELKFRNCEEEGDYSNDTGTCNDYPASQGAAGCADVCNSRNVGYKDAYETNTSASVNYKPTYEEETYTDVREDNHCEYDRGYVNYPPLPAGYVTKELEYFPETDTVWIEIGETEGKFIVDSVELLLMEE

SEQ ID NO: 142 - protein, 1215 aa, Bacillus thuringiensis
  REGION 1..1215: note = subsp. morrisoni
MNSNRKNENEIINALSIPAVSNHSAQMDLSPDARIEDSLCVAEGNNIDPFVSASTVQTGISIAGRILGVLGVPFAGQLASFYSFLVGELWPSGRDPWEIFMEHVEQIVRQQQITDSVRDTAIARLEGLGRGYRSYQQALETWLDNRNDARSRSIIRERYIALELDITTAIPLFSIRNEEVPLLMVYAQAANLHLLLLRDASLFGSEWGMSSADVNQYYQEQIRYTEEYSNHCVQWYNTGLNRLRGTTAETWVRYNQFRRDLTLGVLDLVALFPSYDTRTYPIPTTAQLTREVYTDPNGVVAGPNNSWFRNGASFSAIENAIIRQPHLYDFLTNLTIYTRRSQVGTTIMNLWAGHRITFNRIQGGSTSEMVYGAITNPVSVSDIPFVNRDVYRTVSLAGGLGSLSGIRYGLTRVDFDMIFRNHPDIVTGLFYHPGHAGIATQVKDSDTELPPETTEQPNYRAFSHLLSHISMGPTTQDVPPVYSWTHQSADRTNTINSDRITQIPLVKAHTLQSGTTVVKGPGFTGGDILRRTSGGPFAFSNVNLDFNLSQRYRARIRYASTTNLRIYVTVAGERIFAGQFDKTMDAGAPLTFQSFSYATINTAFTFPERSSSLTIGADTFSSGNEVYVDRFELIQVTATFEAESDLERARKAVNALFTSTNPRGLKTDVTDYHIDQVSNLVECLSDEFCLDKKRELLEEVKYAKRLSDERNLLQDPTFTSISGQTDRGWIGSTGISIQGGDDIFKENYVRLPGTVDECYPTYLYQKIDESQLKSYTRYQLRGYIEDSQDLEIYLIRYNAKHETLSVPGTESPWPSSGVYPSGRCGEPNRCAPRIEWNPDLDCSCRYGEKCVHHSHHFSLDIDVGCTDLNEDLGVWVIFKIKTQDGHAKLGNLEFIEEKPLLGKALSRVKRAEKKWRDKYEKLQLETKRVYTEAKESVDALFVDSQYDKLQANTNIGIIHGADKQVHRIREPYLSELPVIPSINAAIFEELEGHIFKAYSLYDARNVIKNGDFNNGLSCWNVKGHVDVQQNHHRSVLVLSEWEAEVSQKVRVCPDRGYILRVTAYKEGYGEGCVTIHEFEDNTDVLKFRNFVEEEVYPNNTVTCNDYTTNQSAEGSTDACNSYNRGYEDGYENRYEPNPSAPVNYTPTYEEGMYTDTQGYNHCVSDRGYRNHTPLPAGYVTLELEYFPETEQVWIEIGETEGTFIVGSVELLLMEE

SEQ ID NO: 143 - protein, 137 aa, Xenorhabdus doucetiae; identical to SEQ ID NO: 8

SEQ ID NO: 144 - protein, 430 aa, Xenorhabdus doucetiae; identical to SEQ ID NO: 35

SEQ ID NO: 145 - protein, 414 aa, Xenorhabdus poinarii; identical to SEQ ID NO: 15
  REGION 1..414: note = G6

SEQ ID NO: 146 - protein, 135 aa, Xenorhabdus poinarii; identical to SEQ ID NO: 10
  REGION 1..135: note = G6

SEQ ID NO: 147 - protein, 111 aa, Vibrio parahaemolyticus; identical to SEQ ID NO: 16

SEQ ID NO: 148 - protein, 438 aa, Vibrio parahaemolyticus; identical to SEQ ID NO: 37

SEQ ID NO: 149 - protein, 431 aa, Pectobacterium odoriferum; identical to SEQ ID NO: 40

SEQ ID NO: 150 - protein, 420 aa, Photorhabdus luminescens; identical to SEQ ID NO: 44

SEQ ID NO: 151 - protein, 530 aa, Zeugodacus cucurbitae
CCYREIVRAGSGQMADFTYDLLNCVIFHQNFMVPQHIDYIITECYLRKNTKTAIQKDAFSFIQLPRANELKNITESLSKNNSAALDVRKPSILLLAIDSLSRINLRRTMPETLKYLQMNQWFELQGYNKIGDNTYPNLMPLLTSYNQTVADKKCLPKTVGGLNKPICNFIWNDFRRFGYKTAYAEDTSSMSTFNYIKKGFEQPPTDYYLRPMAMAIEKELKVTKEARLPYCVGRKHYGEYIYDYALQFANAYPEEPLFGLFWTNSFSHNAFDIEAKMDARILEYLKKLKTDGILERSIVIFLADHGMRWGPLLNLKSGFLEERLPMIFISLPLWYKQQHPDFVRILEINQKRLTTPYDIYATMKHILEVTQPEKQFPIRNGTMHGISIFQEIPENRTCKDAGIPEHWCTCIPYEVVPTSDAVAKNVTELVLNEINQYLVNKNISDKCAELKLTKIDRAEIKMFKVPNESTYRLEFEANPEKAKFQATVVLNVTTNTIKTNVEEISRLDSYAKTSNCIDLKEEKKYCLCKK

SEQ ID NO: 152 - protein, 367 aa, Zeugodacus cucurbitae
KPICNFIWNDFRRFGYKTAYAEDTSSMSTFNYIKKGFEQPPTDYYLRPMAMAIEKELKVTKEARLPYCVGRKHYGEYIYDYALQFANAYPEEPLFGLFWTNSFSHNAFDIEAKMDARILEYLKKLKTDGILERSIVIFLADHGMRWGPLLNLKSGFLEERLPMIFISLPLWYKQQHPDFVRILEINQKRLTTPYDIYATMKHILEVTQPEKQFPIRNGTMHGISIFQEIPENRTCKDAGIPEHWCTCIPYEVVSTSDAVAKNVTELVLNEINQYLFNKNISDKCAELKLTKIDRAEIKMFKVPNESTYRLEFEANPEKAKFQATVVLNITTNTIKTNVEEISRLDSYAKTSNCIDLKEEKKYCLCKK

SEQ ID NO: 153 - protein, 429 aa, Xenorhabdus nematophila; identical to SEQ ID NO: 13
  REGION 1..429: note = str. Websteri

SEQ ID NO: 154 - protein, 135 aa, Xenorhabdus nematophila; identical to SEQ ID NO: 12
  REGION 1..135: note = str. Websteri

SEQ ID NO: 155 - protein, 108 aa, Lygus hesperus
TMFEEYFDQIESLSNSYPDYNILINGDFNLPGSCWDGSNDDGLSLLPGDKGRVLLDFMQLLSLKQYNRYANSSNNLLDLCLSSIGILTLNAVSTPIFSIDPAHPPFEF

SEQ ID NO: 156 - protein, 106 aa, Lygus hesperus
MRSKRKSSVPKSLNVDGVTCSDPFTIAKALSDQFSSVYSATPIIAALSHPTDLPDNLDKSSTPFNLTNIESGEIDSAISSLDYNRSIGHDKLSSNIFKDNAITLAD

SEQ ID NO: 157 - protein, 140 aa, Xenorhabdus khoisanae; identical to SEQ ID NO: 20

SEQ ID NO: 158 - protein, 425 aa, Xenorhabdus khoisanae; identical to SEQ ID NO: 33

SEQ ID NO: 159 - protein, 431 aa, Pectobacterium peruviense; identical to SEQ ID NO: 39

SEQ ID NO: 160 - protein, 425 aa, Xenorhabdus sp.; identical to SEQ ID NO: 34
  REGION 1..425: note = GDc328

SEQ ID NO: 161 - protein, 140 aa, Xenorhabdus sp.; identical to SEQ ID NO: 21
  REGION 1..140: note = GDc328

SEQ ID NO: 162 - protein, 117 aa, Xenorhabdus eapokensis; identical to SEQ ID NO: 56

SEQ ID NO: 163 - protein, 141 aa, Xenorhabdus eapokensis; identical to SEQ ID NO: 24

SEQ ID NO: 164 - protein, 141 aa, Xenorhabdus thuongxuanensis; identical to SEQ ID NO: 22

SEQ ID NO: 165 - protein, 111 aa, Vibrio parahaemolyticus; identical to SEQ ID NO: 16
  REGION 1..111: note = v110

SEQ ID NO: 166 - protein, 438 aa, Vibrio parahaemolyticus; identical to SEQ ID NO: 37
  REGION 1..438: note = v110

SEQ ID NO: 167 - protein, 141 aa, Xenorhabdus vietnamensis; identical to SEQ ID NO: 31

SEQ ID NO: 168 - protein, 141 aa, Xenorhabdus beddingii; identical to SEQ ID NO: 29

SEQ ID NO: 169 - protein, 141 aa, Xenorhabdus ehlersii; identical to SEQ ID NO: 18

SEQ ID NO: 170 - protein, 132 aa, Xenorhabdus budapestensis; identical to SEQ ID NO: 32

SEQ ID NO: 171 - protein, 140 aa, Xenorhabdus miraniensis; identical to SEQ ID NO: 26

SEQ ID NO: 172 - protein, 404 aa, Xenorhabdus miraniensis; identical to SEQ ID NO: 53

SEQ ID NO: 173 - protein, 141 aa, Xenorhabdus ishibashii; identical to SEQ ID NO: 28

SEQ ID NO: 174 - protein, 141 aa, Xenorhabdus kozodoii; identical to SEQ ID NO: 30

SEQ ID NO: 175 - protein, 498 aa, Beauveria bassiana
MKVDADSALSFANTALTAAKDGVALDITDSDEIFPYMFSIFSIGVGLVPGVGPLLGSFAGLLGAIAFPKKSTDVNAIWNSLRGRVEALIGAKIQASHVNILQKNVEGFASNMEAFTRVLIDYEELTGNDKAKQAETLRILFNAFLTVLRAGIPAFQVHEYAVASLPLFTQAANIHLALLSDGIRNWEAWGFTERYRNDLQQQFDRLTVSSSKRIRAAVRDQDEPSDLDTIKECIAIGEAAGWDAKLIDTWKAALETLSEATALSRRATLTYPAYAKEYYEKGRTMIKPYTSIWEGSDKGLSEALALNALSDYDATMIKNVLTYAEFWPYLTGKEMPESAKLALDREIFLGPYGRYTGGATWNAKNAPPITTRGSNITAIKVRSWDNVDALQVQYGGRWGPLFGDAKGGAEHQANLAFDEYIQSIDVLHGHKLGQLTFFSNKDKIHGWYGTDKHARNRTSIKHQGYGLTNMVVTHWEKHVPPGCEGIIFGFRPLLTARG

SEQ ID NO: 176 - protein, 500 aa, Beauveria bassiana
MSDLKFDDEAALKLASAAFDAAKGGVSISASDGNAIYSYLFSVFALGVGLIPGAGPLLGSMCGLLGAIVFPTKEDPNAVWNSVRPRIEALIGEKLKDSQVKLLRQKVKGFADNMKAFTRVFNDFEKAEGDNKARQGETLRTHHTAFLAVLRAGIPEFQGEDYAVAALPLFTQAANMHLTLLADGVRNGETWGFTQDYISHSLQQEFDELTMSSSKRVRALRSRDETSQVDALKECIAAGEAAGWDQVLLDTWREALETLSKPTALTKRATLTYTGYAKEYYQKGRGLVKPYTANYYSGDRGAAEALHFNALSDYDAEMIKHVLTYAEFWPYLAGKKMPDSAKLALDREIFSGPYGRYTKNAPWNIKTPPPIKPRQANITAIKTRHWDGIDALQVQYGGQWGHLFGDAKGGVEAMANLAFDEYIQSIDARYGQKLGQLTFFSNKDKTYGTYGKGVNAGNHTLVKHEGFGLSSMTITNWEKSIPPGTEGIIFGFRPLLATRG

SEQ ID NO: 177 - protein, 419 aa, Photorhabdus luminescens; identical to SEQ ID NO: 48

SEQ ID NO: 178 - protein, 419 aa, Photorhabdus luminescens; identical to SEQ ID NO: 7

SEQ ID NO: 179 - protein, 419 aa, Photorhabdus luminescens; identical to SEQ ID NO: 47

SEQ ID NO: 180 - protein, 419 aa, Photorhabdus laumondii; identical to SEQ ID NO: 42
  REGION 1..419: note = subsp. clarkei

SEQ ID NO: 181 - protein, 419 aa, Photorhabdus sp.; identical to SEQ ID NO: 45
  REGION 1..419: note = S9-53

SEQ ID NO: 182 - protein, 419 aa, Photorhabdus sp.; identical to SEQ ID NO: 45
  REGION 1..419: note = S10-54

SEQ ID NO: 183 - protein, 419 aa, Photorhabdus sp.; identical to SEQ ID NO: 45
  REGION 1..419: note = S8-52

SEQ ID NO: 184 - protein, 419 aa, Photorhabdus sp.; identical to SEQ ID NO: 41
  REGION 1..419: note = HUG-39

SEQ ID NO: 185 - protein, 420 aa, Alcaligenes faecalis; identical to SEQ ID NO: 55

SEQ ID NO: 186 - protein, 132 aa, Alcaligenes faecalis; identical to SEQ ID NO: 23

SEQ ID NO: 187 - protein, 419 aa, Photorhabdus luminescens; identical to SEQ ID NO: 52
  REGION 1..419: note = subsp. mexicana

SEQ ID NO: 188 - protein, 419 aa, Photorhabdus heterorhabditis; identical to SEQ ID NO: 51

SEQ ID NO: 189 - protein, 419 aa, Photorhabdus luminescens; identical to SEQ ID NO: 50
  REGION 1..419: note = subsp. sonorensis

SEQ ID NO: 190 - protein, 135 aa, Xenorhabdus nematophila; identical to SEQ ID NO: 12

SEQ ID NO: 191 - protein, 419 aa, Photorhabdus luminescens; identical to SEQ ID NO: 38
  REGION 1..419: note = subsp. laumondii

SEQ ID NO: 192 - protein, 144 aa, Photorhabdus luminescens; identical to SEQ ID NO: 27
  REGION 1..144: note = subsp. laumondii

SEQ ID NO: 193 - protein, 429 aa, Xenorhabdus nematophila; identical to SEQ ID NO: 54

SEQ ID NO: 194 - protein, 419 aa, Photorhabdus kayaii; identical to SEQ ID NO: 41

SEQ ID NO: 195 - protein, 419 aa, Photorhabdus cinerea; identical to SEQ ID NO: 58

SEQ ID NO: 196 - protein, 429 aa, Xenorhabdus nematophila; identical to SEQ ID NO: 9
  REGION 1..429: note = strain ATCC 19061/DSM 3370/CCUG 14189/LMG 1036/NCIMB 9965/AN6

SEQ ID NO: 197 - protein, 135 aa, Xenorhabdus nematophila; identical to SEQ ID NO: 6
  REGION 1..135: note = strain ATCC 19061/DSM 3370/CCUG 14189/LMG 1036/NCIMB 9965/AN6

SEQ ID NO: 198 - protein, 425 aa, Xenorhabdus cabanillasii; identical to SEQ ID NO: 36
  REGION 1..425: note = JM26

SEQ ID NO: 199 - protein, 141 aa, Xenorhabdus cabanillasii; identical to SEQ ID NO: 17
  REGION 1..141: note = JM26

SEQ ID NO: 200 - DNA, 35 bp, synthetic construct
  misc_feature 1..35: note = Synthetic Construct
  source 1..35: mol_type = other DNA
ttgacagctagctcagtcctaggtataatgctagc

SEQ ID NO: 201 - protein, 429 aa, Xenorhabdus nematophila; identical to SEQ ID NO: 9
  REGION 1..429: note = F1

SEQ ID NO: 202 - protein, 135 aa, Xenorhabdus nematophila; identical to SEQ ID NO: 12
  REGION 1..135: note = F1

SEQ ID NO: 203 - protein, 133 aa, synthetic construct; identical to SEQ ID NO: 4
  REGION 1..133: note = Synthetic Construct

SEQ ID NO: 204 - protein, 444 aa, synthetic construct; identical to SEQ ID NO: 5
  REGION 1..444: note = Synthetic Construct

SEQ ID NO: 205 - protein, 1178 aa, synthetic construct; identical to SEQ ID NO: 112
  REGION 1..1178: note = Synthetic Construct

SEQ ID NO: 206 - DNA, 8359 bp, synthetic construct
  misc_feature 1..8359: note = Synthetic Construct
  source 1..8359: mol_type = other DNA
ttctgtttcctgtgtgaaattgttatccgctcacaattccacacattatacgagccgatgattaattgtcaacagctcatttcagaatatttgccagaaccgttatgatgtcggcgcaaaaaacattatccagaacgggagtgcgccttgagcgacacgaattatgcagtgatttacgacctgcacagccataccacagcttccgatggctgcctgacgccagaagcattggtgcaccgtgcagtcgataagctccggatcctctacgccggacgcatcgtggccggcatcaccggcgccacaggtgcggttgctggcgcctatatcgccgacatcaccgatggggaagatcgggctcgccacttcgggctcatgagcgcttgtttcggcgtgggtatggtggcaggccccgtggccgggggactgttgggcgccatctccttgcatgcaccattccttgcggcggcggtgctcaacggcctcaacctactactgggctgcttcctaatgcaggagtcgcataagggagagcgtcgaccgatgcccttgagagccttcaacccagtcagctccttccggtgggcgcggggcatgactatcgtcgccgcacttatgactgtcttctttatcatgcaactcgtaggacaggtgccggcagcgctctgggtcattttcggcgaggaccgctttcgctggagcgcgacgatgatcggcctgtcgcttgcggtattcggaatcttgcacgccctcgctcaagccttcgtcactggtcccgccaccaaacgtttcggcgagaagcaggccattatcgccggcatggcggccgacgcgctgggctacgtcttgctggcgttcgcgacgcgaggctggatggccttccccattatgattcttctcgcttccggcggcatcgggatgcccgcgttgcaggccatgctgtccaggcaggtagatgacgaccatcagggacagcttcaaggatcgctcgcggctcttaccagcctaacttcgatcactggaccgctgatcgtcacggcgatttatgccgcctcggcgagcacatggaacgggttggcatggattgtaggcgccgccctataccttgtctgcctccccgcgttgcgtcgcggtgcatggagccgggccacctcgacctgaatggaagccggcggcacctcgctaacggattcaccactccaagaattggagccaatcaattcttgcggagaactgtgaatgcgcaaaccaacccttggcagaacatatccatcgcgtccgccatctccagcagccgcacgcggcgcatctcgggcagcgttgggtcctggccacgggtgcgcatgatcgtgctcctgtcgttgaggacccggctaggctggcggggttgccttactggttagcagaatgaatcaccgatacgcgagcgaacgtgaagcgactgctgctgcaaaacgtctgcgacctgagcaacaacatgaatggtcttcggtttccgtgtttcgtaaagtctggaaacgcggaagtcagcgccctgcaccattatgttccggatctgcatcgcaggatgctgctggctaccctgtggaacacctacatctgtattaacgaagcgctggcattgaccctgagtgatttttctctggtcccgccgcatccataccgccagttgtttaccctcacaacgttccagtaaccgggcatgttcatcatcagtaacccgtatcgtgagcatcctctctcgtttcatcggtatcattacccccatgaacagaaattcccccttacacggaggcatcaagtgaccaaacaggaaaaaaccgcccttaacatggcccgctttatcagaagccagacattaacgcttctggagaaactcaacgagctggacgcggatgaacaggcagacatctgtgaatcgcttcacgaccacgctgatgagctttaccgcagctgcctcgcgcgtttcggtgatgacggtgaaaacctctgacacatgcagctcccggagacggtcacagcttgtctgtaagcggatgccgggagcagacaagcccgtcagggcgcgtcagcgggtgttggcgggtgtcggggcgcagccatgacccagtcacgtagcgatagcggagtgtatactggcttaactatgcggcatcagagcagattgtactgagagtgcaccatatgcggtgtgaaataccgcacagatgcgtaaggagaaaataccgcatcaggcgctcttccgcttcctcgctcactgactcgctgcgctcggtcgttcggctgcggcgagcggtatcagctcactcaaaggcggtaatacggttatccacagaatcaggggataacgcaggaaagaacatgtgagcaaaaggccagcaaaaggccaggaaccgtaaaaaggccgcgttgctggcgtttttccataggctccgcccccctgacgagcatcacaaaaatcgacgctcaagtcagaggtggcgaaacccgacaggactataaagataccaggcgtttccccctggaagctccctcgtgcgctctcctgttccgaccctgccgcttaccggatacctgtccgcctttctcccttcgggaagcgtggcgctttctcatagctcacgctgtaggtatctcagttcggtgtaggtcgttcgctccaagctgggctgtgtgcacgaaccccccgttcagcccgaccgctgcgccttatccggtaactatcgtcttgagtccaacccggtaagacacgacttatcgccactggcagcagccactggtaacaggattagcagagcgaggtatgtaggcggtgctacagagttcttgaagtggtggcctaactacggctacactagaaggacagtatttggtatctgcgctctgctgaagccagttaccttcggaaaaagagttggtagctcttgatccggcaaacaaaccaccgctggtagcggtggtttttttgtttgcaagcagcagattacgcgcagaaaaaaaggatctcaagaagatcctttgatcttttctacggggtctgacgctcagtggaacgaaaactcacgttaagggattttggtcatgagattatcaaaaaggatcttcacctagatccttttaaattaaaaatgaagttttaaatcaatctaaagtatatatgagtaaacttggtctgacagttaccaatgcttaatcagtgaggcacctatctcagcgatctgtctatttcgttcatccatagttgcctgactccccgtcgtgtagataactacgatacgggagggcttaccatctggccccagtgctgcaatgataccgcgagacccacgctcaccggctccagatttatcagcaataaaccagccagccggaagggccgagcgcagaagtggtcctgcaactttatccgcctccatccagtctattaattgttgccgggaagctagagtaagtagttcgccagttaatagtttgcgcaacgttgttgccattgctacaggcatcgtggtgtcacgctcgtcgtttggtatggcttcattcagctccggttcccaacgatcaaggcgagttacatgatcccccatgttgtgcaaaaaagcggttagctccttcggtcctccgatcgttgtcagaagtaagttggccgcagtgttatcactcatggttatggcagcactgcataattctcttactgtcatgccatccgtaagatgcttttctgtgactggtgagtactcaaccaagtcattctgagaatagtgtatgcggcgaccgagttgctcttgcccggcgtcaacacgggataataccgcgccacatagcagaactttaaaagtgctcatcattggaaaacgttcttcggggcgaaaactctcaaggatcttaccgctgttgagatccagttcgatgtaacccactcgtgcacccaactgatcttcagcatcttttactttcaccagcgtttctgggtgagcaaaaacaggaaggcaaaatgccgcaaaaaagggaataagggcgacacggaaatgttgaatactcatactcttcctttttcaatattattgaagcatttatcagggttattgtctcatgagcggatacatatttgaatgtatttagaaaaataaacaaaagagtttgtagaaacgcaaaaaggccatccgtcaggatggccttctgcttaatttgatgcctggcagtttatggcgggcgtcctgcccgccaccctccgggccgttgcttcgcaacgttcaaatccgctcccggcggatttgtcctactcaggagagcgttcaccgacaaacaacagataaaacgaaaggcccagtctttcgactgagcctttcgttttatttgatgcctggcagttccctactctcgcatggggagaccccacactaccatcggcgctacggcgtttcacttctgagttcggcatggggtcaggtgggaccaccgcgctactgccgccaggcaaattctgttttatcagaccgcttctgcgttctgatttaatctgtatcaggctgaaaatcttctctcatccgccaaaacagaagcttggctgcaggtcgacggatcccctatgtattactagaaaataacatagtaaaacggacatcactccgtttcaatggaggtgatgtccgtttttcattacaacaaattacttatctatttgtaatgctgctcttggacaattgatttgaaaacgatatttaaacctgagtttgcatgagactattcctccataaggagtaattccacgctgtccacgataaatgttccttccgtttctccaatctcaatccataccttatcggtttctgggaagtattctaattcttttgtcacataaccaactggtagtggcgtgtaatccctataccctctgttaaattcacaaggattctctcttcgtccatctgtatacgatttttcttcatagactgacgcataatcagctggtacggaaggagcttcgttatatcctcgattacgagaagtgtacgcacctccgtattcttcttgatttacagtataatcattacacgttaccgtgttatttggatagatttcctcttctacgcagttgctaaacttcagttcgtctgtattgttctcgatctcatgaatggttacgcaaccttctccatatccctccttgtacgctgtgacacgaaggatatagccacgacccggacagacacgaacttcttgtgacacttctgcttcccattccggaacaacaaggaccgaacgttggttgttttgttcttctacatctacatgccctttcacgttccagcaggataagccattattaaaatcaccatttttaatgacatttctcgcatcatatagggagaatgcagtgaaaatacgcccttctaattcttcaaaaatagccgcattgacacccggaatcacagacagctcaggcagataagcttctcgaatgctatgaacacgtttatctgccgcatgaatcatggcaatattcgtatccgcttgtaattgatcatattgagagtttacaaataaagcatctacagattcttttgcctctttataaacgatatttgtttcccattccaatttttcacgtttgtctctccattttttctccgctcttttcacacgagctagcgcttctcctactaatggtttctcttcgagaaactctagattccctagtcttgcgtgcccatcttgcgtcttaatcttaaagatcacccatacacctaggtcctcatttaagtctgtacatcctacatcaatgtctaaggagaaatgatgcgaatgatgggcacacttttctccatccctacacgaacaatctaagtcaggattccattcaaggtgtggcgcgcatcgattcggctctccacactttccgattggactttgggctgaaagcggccataaggaacccgtacctggcacatttactgtttcatgttttgcattgtagcgaattaaatagatttctaagtcttgactatcttcgatataccctcttaattgataacgggtaaaggcttttaattttgattcatcgattttttgatacaaatatgttggatagcactcatcaaaggtacctgatagtgtgacgtaattttctttaaatacgtcatcccctccttggatggtaatccctgtacttccgccccacccacgttctggttgcctattaatgtctttgaaatttgaatcttggagtaaattgcgttcatcactgagtcgcttcgcatgtttgactttctcggacaattctcgcttttcatccagacaaaattcatccgataaatacgtaactaaattggacacttgatcaatatgataatccgttacatttgtttttagccctagttggtttgtagacgtaaacagcgcattcaccgccttctgcgctctttccagattatattcagcctcgagtgttgcagtaactggaataaattcaaatctgtctattatcactcctgcagtcccactaaaatttctaacacctactatattacctaatgaagatgtaaaagcattggcactttcaaaataaccaaaatcacttgattgtagattatctaatgacgtagctgtagctggtactgtattggaaaaaatggatgaattaccccaattaacgttgaggtgaatcggggttacagaagcataccgtacacgaactcgatatctggtagatgtcgatgggaagtgaattggaacttcaatataccctctattctgaatgttatttccactactatttaatctaactaagtccccaccagtaaatcctggtcctgaaattacagaaccattaaaaagaaagtttcccttcactgcagggatttgagtaatactatccgatgcaattatattattaaattcagcactacgatgtatccaagagaacataggagctcttattatacttacactactattactaaagcctgaacgaaacattgaaacatggcttaatcgatgactaaatccttgcctaggtggcacgttgttattctgtggcggtatttcatccagcgaatctaccgttccgctttttctgtatacagcggatggcaaatttgaggaggttccataagcaaattctgtcccgtcaagaacagatagttgttgattatttatccctatattaaaaggtcttctatataaagtggacgataatgttctatacacgccctgacctagttgagcaacaatacgttgttgtggagctgcatttcccatagttccatatagcggaaaagtgaattctggccccgaaaaccctacaggagaagccattatttgatgccctgaccaataataataacccctatgagcatccgtatagatggttatactgttaagtatatccatcaaatgtggactcctaatacttctttctatgccctgagccgagcctcgaaaactaccatcaaaattttctaatactgggtttgtataaatttctcttgttaattgggaaactgttcgaattggatatcttctactatcataattcgggaacagagcaacgatatctaatacagttagtgttaattctcttctaaattgattataccttacccaatctctagaatccggtccccatacacgttctaatcccgtattgtaccagcgtacagcataatctgtatagttgccaataagcctagttaaatcattataacgactattgatagtcgcggcatcaaatccccacctttgtccaaacactgaaacatctctcaaaactgataaatgtaaatttgcagcttgaacatatactgataaaagaggaacttgataattttgaactgcaaaaagaggaatagcggttgtaagggcactgttcatgtcattgaattgaatacgcatctcttctcttaatgctggattagtaggatctgcttcccactctctaaaagattctgcgtaaatttgataaagattgcttagtccttctaatctagaaatggcttggttcctagcgaattcttctattctttggttaattaactgttcaatttgtacaagaaatgcgtcccattgagagggaccaaaaattccccatattatatcaactagtcctaacacaaatccagcaccgggaacaaattcactcaaaagaaattgcgttagcgacaaggaaatatcgattggggtgtaaccagtttctattctttctccacctaatacttctacttcagggttacttaaacaattataaggaatgcattcattgatgttcggattgttatccataagttacctccatctcttttattaagataccaattcattatgatataatactgtttttcattactacaatttaaaacatagggaa

SEQ ID NO: 207 - DNA, 35 bp, synthetic construct
  source 1..35: mol_type = other DNA
gtctttgtagtccatggtatatctccttcttaaag

SEQ ID NO: 208 - DNA, 40 bp, synthetic construct
  source 1..40: mol_type = other DNA
ttaccgccaatctagtatgataacaaagcccgaaaggaag

SEQ ID NO: 209 - DNA, 35 bp, synthetic construct
  source 1..35: mol_type = other DNA
tttcgggctttgttaatggactacaaagaccatga

SEQ ID NO: 210 - DNA, 35 bp, synthetic construct
  source 1..35: mol_type = other DNA
agaaggagatatacctcatactagattggcggtaa

SEQ ID NO: 211 - DNA, 39 bp, synthetic construct
  source 1..39: mol_type = other DNA
gctagtggtctcctaagtttacacaattaaggaggcttt

SEQ ID NO: 212 - DNA, 38 bp, synthetic construct
  source 1..38: mol_type = other DNA
gctagtggtctccgcattcatactagattggcggtaac

SEQ ID NO: 213 - DNA, 54 bp, synthetic construct
  source 1..54: mol_type = other DNA
gactggaaagcgggcagtgaaatcagagaatataaaaagccagattattaatcc

SEQ ID NO: 214 - DNA, 40 bp, synthetic construct
  source 1..40: mol_type = other DNA
accattcgatggtgtcaacgtaaatgccgcttcgccttcg

SEQ ID NO: 215 - DNA, 40 bp, synthetic construct
  source 1..40: mol_type = other DNA
cgaaggcgaagcggcatttacgttgacaccatcgaatggt

SEQ ID NO: 216 - DNA, 40 bp, synthetic construct
  source 1..40: mol_type = other DNA
gctttttatattctctgatttcactgcccgctttccagtc

SEQ ID NO: 217 - DNA, 78 bp, synthetic construct
  source 1..78: mol_type = other DNA
taattcctaatttttgttgacactctatcattgatagagttattttaccactccctatcagtgatagagaaaagtgaa

SEQ ID NO: 218 - DNA, 69 bp, synthetic construct
  source 1..69: mol_type = other DNA
ttgacaattaatcatcggctcgtataatgtgtggaattgtgagcggataacaatttcacacaggaaaca

SEQ ID NO: 219 - DNA, 19 bp, synthetic construct
  source 1..19: mol_type = other DNA
taatacgactcactatagg

SEQ ID NO: 220 - DNA, 61 bp, synthetic construct
  source 1..61: mol_type = other DNA
ctcggtaccaaattccagaaaagaggcctcccgaaaggggggccttttttcgttttggtcc

SEQ ID NO: 221 - DNA, 48 bp, synthetic construct
  source 1..48: mol_type = other DNA
caaaaaacccctcaagacccgtttagaggccccaaggggttatgctag

(19) United States
(12) Patent Application Publication
(10) Pub. No.: US 2025/0228247 A1
(43) Pub. Date: Jul. 17, 2025

(54) HIGH YIELD MINICELL AND PROTEIN PRODUCING BACTERIAL STRAINS

(71) Applicant: Invaio Sciences, Inc., Cambridge, MA (US)

(72) Inventors: Maier Steve AVENDAÑO AMADO, Chelsea, MA (US); Lydia Jane GRIFFIN, Brighton, MA (US); James Aaron KRAEMER, Cambridge, MA (US); Rama Krishna SIMHADRI, Natick, MA (US)

(73) Assignee: Invaio Sciences, Inc., Cambridge, MA (US)

(21) Appl. No.: 18/728,420

(22) PCT Filed: Jan. 12, 2023
(86) PCT No.: PCT/US2023/060565

§ 371 Date: Jul. 11, 2024

Related U.S. Application Data
(60) Provisional application No. 63/299,321, filed on Jan. 13, 2022.
(60) Provisional application No. 63/322,978, filed on Mar. 23, 2022.

(51) Int. Cl. A01N 63/20; A01N 25/14; A01N 63/50; A01P 7/04

(52) U.S. Cl. CPC A01N 63/20; A01N 25/14; A01N 63/50; A01P 7/04

(57) ABSTRACT

The present disclosure relates to mixtures of insecticidal minicells containing the insecticidal protein toxins Pir and Cry, and methods related to producing and using the same. The present disclosure also relates to mixtures of insecticidal minicells containing the insecticidal protein toxin Pir with a Bt-derived active ingredient, and methods related to producing and using the same.

### CROSS-REFERENCE TO RELATED APPLICATIONS

This application claims the benefit of priority of U.S. Provisional Patent Application No. 63/299,321 filed on Jan. 13, 2022, and U.S. Provisional Patent Application 63/322,978 filed on Mar. 23, 2022, in which the contents of the above applications are all incorporated by reference as if fully set forth herein in their entireties.

### REFERENCE TO AN ELECTRONIC SEQUENCE LISTING

The contents of the electronic sequence listing (165852002940seqlist.xml; Size: 305,619 bytes; and Date of Creation: Jan. 10, 2023) is herein incorporated by reference in its entirety.

### FIELD

The present disclosure relates generally to engineered bacterial cells for efficient minicell and protein production. The present disclosure also relates to mixtures of insecticidal minicells containing the insecticidal protein toxins Pir and Cry, and methods related to producing and using the same. The present disclosure also relates to mixtures of insecticidal minicells containing the insecticidal protein toxin Pir with a Bt-derived active ingredient, and methods related to producing and using the same.

### BACKGROUND

A need exists for delivery vectors capable of targeting cells and delivering biological agents. Further, a need exists for methods of delivering said vectors to cells, thereby modulating biological systems including animal, plant, and insect cells, tissues, and organisms. Delivery vectors capable of targeting cells and delivering biological agents are known, for example, from WO/2020123569. Applicant desires compositions containing such delivery vectors that provide improved efficacy, including, for example, for the biological agents therein.

### BRIEF SUMMARY

The disclosure provides compositions and methods for the manufacturing of minicell particles from parent bacterial cells (e.g., E. coli strains), having various genetic mutations that produce an increased number of minicell particles. Additionally, different expression cassettes for minicell-producing parent cells are provided that yield high levels of protein expression.

Several embodiments relate to a method of manufacturing a composition comprising a plurality of minicells that is substantially free of viable parental bacterial cells, the method comprising: (a) exposing a population of parental bacterial cells exhibiting a reduced level or activity of at least one cell division topological specificity factor to conditions allowing for the formation of minicells, wherein the parental bacterial cells are deficient in a gene involved in DNA repair; and (b) separating the minicells from the parental bacterial cells, thereby producing a composition comprising a plurality of minicells that is substantially free of viable parental bacterial cells. In some embodiments, the cell division topological specificity factor is selected from the group consisting of minC, minD, minE, and ftsZ. In some embodiments, the gene involved in DNA repair is selected from the group consisting of mutS, MutH, MutL, SSB, RecA, RecJ, ExoI, ExoVII, ExoX, UvrD, and DNA polymerase III. In some embodiments, the gene involved in DNA repair is RecA. In some embodiments, the parental bacterial cells comprise one or more of a T3, T7, K11 or SP6 polymerase or a nucleic acid encoding a T3, T7, K11 or SP6 polymerase. In some embodiments, the parental bacterial cells comprise a T7 polymerase or a nucleic acid encoding a T7 polymerase. In some embodiments, the bacterial cells are E. coli DH10BΔminCDE. In some embodiments, the composition comprises at least 10¹¹ minicells per liter of culture of parental bacterial cells. In some embodiments, the composition is an agricultural composition.

In some aspects, a method is provided for manufacturing a composition comprising a plurality of minicells loaded with protein, the composition being substantially free of viable parental bacterial cells, the method comprising: (a) exposing the parental bacterial cells exhibiting a reduced level or activity of at least one cell division topological specificity factor to conditions allowing for protein expression, wherein the parental bacterial cells are deficient in a gene involved in DNA repair; (b) exposing the parental bacterial cells to conditions allowing for the formation of minicells; and (c) separating the minicells from the parental cells, thereby producing a composition comprising a plurality of minicells loaded with protein that is substantially free of viable parental bacterial cells. In some embodiments, the parental bacterial cells comprise an expression vector. In some embodiments, the expression vector encodes one or more insecticidal proteins. In some embodiments, the gene encoding the protein is expressed under the control of T3, T7, K11 or SP6. In some embodiments, the composition comprises at least 100 ng protein per 109 minicells.

Several embodiments relate to a composition comprising: (a) a plurality of minicells, wherein the minicells are derived from a plurality of parental bacterial cells exhibiting a reduced level or activity of at least one cell division topological specificity factor; and (b) wherein the plurality of minicells comprise at least 100 ng protein per 109 minicells. In some embodiments, the cell division topological specificity factor is selected from the group consisting of minC, minD, minE, and ftsZ. In some embodiments, the parental bacterial cells are further deficient in a gene involved in DNA repair. In some embodiments, the gene involved in DNA repair is selected from the group consisting of mutS, MutH, MutL, SSB, RecA, RecJ, ExoI, ExoVII, ExoX, UvrD, and DNA polymerase III. In some embodiments, the gene involved in DNA repair is RecA. In some embodiments, the parental bacterial cells comprise one or more of a T3, T7, K11 or SP6 polymerase or a nucleic acid encoding a T3, T7, K11 or SP6 polymerase. In some embodiments, the parental bacterial cells comprise a T7 polymerase or a nucleic acid encoding a T7 polymerase. In some embodiments, the bacterial cells are E. coli DH10BΔminCDE. In some embodiments, the parental bacterial cells comprise an expression vector. In some embodiments, the expression vector encodes one or more insecticidal proteins (e.g., Pir, Cry, BT, etc.). In some embodiments, the gene encoding the protein is expressed under the control of T3, T7, K11 or SP6. In some embodiments, the composition is an agricultural composition. In some embodiments, the agricultural compositions comprises one or more heterologous insecticidal agents.

In some aspects, the disclosure provides a composition comprising a plurality of parental bacterial cells, wherein the parental bacterial cells (a) have a reduction in the level or activity of at least one cell division topological specificity factor; (b) are deficient in a gene involved in DNA repair; wherein the parental bacterial cells produce at least 10¹¹ minicells per liter of parental bacterial cell culture. In some embodiments, the gene involved in DNA repair is selected from the group consisting of mutS, MutH, MutL, SSB, RecA, RecJ, ExoI, ExoVII, ExoX, UvrD, and DNA polymerase III. In some embodiments, the gene involved in DNA repair is RecA. In some embodiments, the bacterial cells are E. coli DH10BΔminCDE.

Several embodiments relate to compositions containing delivery vectors and active ingredient mixtures for combating insect pests. Methods for reducing overall damage, reducing insect number, and reducing yield loss caused by insects are also disclosed. In many embodiments, the compositions and methods disclosed herein demonstrate surprisingly good insecticidal activity. Accordingly, in some embodiments, the present disclosure enables the production of minicells that contain an effective concentration of the insecticidal toxin Pir (e.g., PirAB) or minicells that contain an effective concentration of the insecticidal toxin Cry (e.g., Cry1Ac). In many embodiments, compositions of minicells containing Pir and minicells containing Cry produce a synergistic effect for killing agricultural insect pests.

In other embodiments, the present disclosure enables the production of minicells that contain an effective concentration of an insecticidal toxin Pir (e.g., PirAB). The present disclosure further enables the production of compositions containing these minicells and a Bt-derived active ingredient (e.g., Thuricide®). In many embodiments, compositions of minicells containing Pir and the Bt-derived active ingredient produce a synergistic effect for killing agricultural insect pests.

Several embodiments relate to a composition including: a liquid carrier phase; and a plurality of minicells dispersed in the carrier phase, wherein the plurality of minicells includes a mixture of a first minicell including a first effective amount of a first exogenous protein toxin including Pir and a second minicell including a second effective amount of a second exogenous protein toxin including Cry, wherein the first effective amount and the second effective amount are present at a ratio in the range of about 50:1-1:50. In some embodiments of this aspect, the first effective amount and the second effective amount are present at a ratio of about 46:1, 23:1, 11:1, 9:1, 6:1, 5:1, 3:1, or 1:1. In further embodiments of this aspect, which may be combined with any of the preceding embodiments, the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest. In other embodiments of this aspect, which may be combined with any of the preceding embodiments, a first particle concentration of the first minicell is in the range of about 1×10² to about 8×10¹⁴, and wherein a second particle concentration of the second minicell is in the range of about 1×10² to about 8×10¹⁴. In some embodiments of this aspect, which may be combined with any of the preceding embodiments, administering the composition to the insect pest includes an administration method selected from the group of delivering the composition to the insect pest for ingestion; contacting the insect pest with the composition; delivering the composition to at least one habitat where the insect pest grows, lives, reproduces, feeds, or infests; or applying the composition to a plant. In further embodiments of this aspect, the composition is applied to the plant as at least one of a foliar treatment, an injection treatment, a pre-emergence treatment, and a post-emergence treatment. In other embodiments of this aspect, which may be combined with any of the preceding embodiments, the composition is formulated as at least one of a Ready To Use (RTU) formulation, a suspension concentrate, a tank-mix, an aerosol, a seed treatment, a root dip, a soil treatment, an irrigation formulation, a sprinkler formulation, and a drench treatment.

Several embodiments relate to a composition including: a liquid carrier phase; a plurality of minicells dispersed in the carrier phase, wherein the plurality of minicells includes a first effective amount of an exogenous protein toxin including Pir; and a second effective amount of a Bt-derived active ingredient (“AI”), wherein the first effective amount and the second effective amount are present at a ratio in the range of about 50:1-1:50. In some embodiments of this aspect, the first effective amount and the second effective amount are present at a ratio of about 23:1, 22:1, 11:1, 6:1, 3:1, 2:1, or 1.5:1. In further embodiments of this aspect, which may be combined with any of the preceding embodiments, the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest. In other embodiments of this aspect, which may be combined with any of the preceding embodiments, a particle concentration of the minicell is in the range of about 1×10² to about 8×10¹⁴. In additional embodiments of this aspect, which may be combined with any of the preceding embodiments, the Bt-derived AI includes at least one of Bacillus thuringiensis, its fermentation solids, its spores, and its insecticidal toxins. In yet further embodiments of this aspect, which may be combined with any of the preceding embodiments, the Bt-derived AI includes at least two, at least three, or all of Bacillus thuringiensis, its fermentation solids, its spores, and its insecticidal toxins. In some embodiments of this aspect, which may be combined with any of the preceding embodiments, administering the composition to the insect pest includes an administration method selected from the group of delivering the composition to the insect pest for ingestion; contacting the insect pest with the composition; delivering the composition to at least one habitat where the insect pest grows, lives, reproduces, feeds, or infests; or applying the composition to a plant. In further embodiments of this aspect, the composition is applied to the plant as at least one of a foliar treatment, an injection treatment, a pre-emergence treatment, and a post-emergence treatment. In other embodiments of this aspect, which may be combined with any of the preceding embodiments, the composition is formulated as at least one of a Ready To Use (RTU) formulation, a suspension concentrate, a tank-mix, an aerosol, a seed treatment, a root dip, a soil treatment, an irrigation formulation, a sprinkler formulation, a drench treatment, a dust, an emulsifiable concentrate, a flowable concentrate, a formulation intermediate, a granular formulation, an impregnated materials formulation, a pelleted/tableted formulation, a soluble concentrate formulation, a technical chemical formulation, a water dispersable granule formulation, a water soluble packaging formulation, or a wettable powder formulation.

In some embodiments, which may be combined with any of the preceding embodiments, the first exogenous protein toxin includes PirAB or a functional component thereof. In further embodiments of this aspect, PirAB includes a PirA selected from the group of SEQ ID NO: 143, SEQ ID NO: 146, SEQ ID NO: 147, SEQ ID NO: 154, SEQ ID NO: 157, SEQ ID NO: 161, SEQ ID NO: 163, SEQ ID NO: 164, SEQ ID NO: 165, SEQ ID NO: 167, SEQ ID NO: 168, SEQ ID NO: 169, SEQ ID NO: 170, SEQ ID NO: 171, SEQ ID NO: 174, SEQ ID NO: 174, SEQ ID NO: 186, SEQ ID NO: 190, SEQ ID NO: 192, SEQ ID NO: 197, SEQ ID NO: 199, SEQ ID NO: 202, or SEQ ID NO: 203; and a PirB selected from the group of SEQ ID NO: 144, SEQ ID NO: 145, SEQ ID NO: 148, SEQ ID NO: 149, SEQ ID NO: 150, SEQ ID NO: 153, SEQ ID NO: 158, SEQ ID NO: 159, SEQ ID NO: 160, SEQ ID NO: 162, SEQ ID NO: 166, SEQ ID NO: 172, SEQ ID NO: 177, SEQ ID NO: 178, SEQ ID NO: 179, SEQ ID NO: 180, SEQ ID NO: 181, SEQ ID NO: 182, SEQ ID NO: 183, SEQ ID NO: 184, SEQ ID NO: 185, SEQ ID NO: 187, SEQ ID NO: 188, SEQ ID NO: 189, SEQ ID NO: 191, SEQ ID NO: 193, SEQ ID NO: 194, SEQ ID NO: 195, SEQ ID NO: 196, SEQ ID NO: 198, SEQ ID NO: 201, or SEQ ID NO: 204, or a functional component of any thereof. In additional embodiments of this aspect, the PirAB includes the PirA including SEQ ID NO: 203 and the PirB including SEQ ID NO: 204, or the PirAB includes the PirA including SEQ ID NO: 197 and the PirB including SEQ ID NO: 178.

In some embodiments, which may be combined with any of the preceding embodiments, the second exogenous protein toxin includes Cry1A, Cry1B, Cry1C, Cry1D, Cry1E, Cry1F, Cry1G, Cry1H, Cry1I, Cry1J, or Cry1K or a functional component thereof. In further embodiments of this aspect, the Cry1A includes a Cry1A selected from the group of SEQ ID NO: 105, SEQ ID NO: 106, SEQ ID NO: 107, SEQ ID NO: 108, SEQ ID NO: 109, SEQ ID NO: 110, SEQ ID NO: 111, SEQ ID NO: 112, SEQ ID NO: 113, SEQ ID NO: 114, SEQ ID NO: 115, SEQ ID NO: 151, SEQ ID NO: 152, or SEQ ID NO: 205; the Cry1B includes a Cry1B selected from the group of SEQ ID NO: 117, SEQ ID NO: 118, SEQ ID NO: 119, SEQ ID NO: 120, SEQ ID NO: 121, SEQ ID NO: 122, or SEQ ID NO: 155; the Cry1C includes a Cry1C selected from the group of SEQ ID NO: 123, SEQ ID NO: 124, SEQ ID NO: 125, or SEQ ID NO: 156; the Cry1D includes a Cry1D selected from the group of SEQ ID NO: 126, SEQ ID NO: 127, SEQ ID NO: 175, or SEQ ID NO: 176; the Cry1E includes a Cry1E selected from the group of SEQ ID NO: 128 or SEQ ID NO: 129; the Cry1F includes a Cry1F selected from the group of SEQ ID NO: 130 or SEQ ID NO: 131; the Cry1G includes a Cry1G selected from the group of SEQ ID NO: 132 or SEQ ID NO: 133; the Cry1H includes a Cry1H selected from the group of SEQ ID NO: 134 or SEQ ID NO: 135; the Cry1I includes a Cry1I selected from the group of SEQ ID NO: 136, SEQ ID NO: 137, SEQ ID NO: 138, or SEQ ID NO: 139; the Cry1J includes a Cry1J selected from the group of SEQ ID NO: 140 or SEQ ID NO: 141; or the Cry1K includes SEQ ID NO: 142, or a functional component of any thereof. In additional embodiments of this aspect, the second exogenous protein toxin includes the Cry1A including SEQ ID NO: 205.

In some embodiments of the second aspect, which may be combined with any of the preceding embodiments, the exogenous protein toxin includes PirAB or a functional component thereof. In further embodiments of this aspect, PirAB includes a PirA selected from the group of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, or SEQ ID NO: 32; and a PirB selected from the group of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, or SEQ ID NO: 58, or a functional component of any thereof. In additional embodiments of this aspect, the PirAB includes the PirA including SEQ ID NO: 4 and the PirB including SEQ ID NO: 5, or wherein PirAB includes the PirA including SEQ ID NO: 6 and the PirB including SEQ ID NO: 7. In yet further embodiments of this aspect, PirAB includes a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and wherein PirA is linked to a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58 by a linker sequence. In some embodiments of this aspect, which may be combined with any of the preceding embodiments, the Bt-derived AI includes a Bt-derived biological control product selected from the group of Thuricide®, Thuricide® HPC-O RTU, Thuricide® HPC, Thuricide® 48 LV Forestry, Thuricide® 76B, Thuricide® 76 LV, Bonide Bacillus Thuringiensis (BT) Moth Larvae (Caterpillar) Control, DiPel®, Security BT Dust Biological Insecticide, Fertilome Dipel Dust Biological Insecticide, Widestrike®, Plant Pesticide B.T. subsp. tenebrionis Colorado Potato Beetle Protein, SA-50 brand DiPel® dust, Ringer® Vegetable Insect Attack®, Bonide DiPel® 150 Dust For Vegetables, Green Light® DiPel® Dust, Green Light® BT Worm Killer, BT Sulfur 15-50 Dust, NEU1701I, FourStar® Briquets, FourStar® CRG, Britz Bt 25 Sulfur Dust, Thuricide® 32LV, Bonide Mosquito Beater® Water Soluble Pouches, Britz BT Dust, Summit Fallout Bti Granules, DiPel® 10G Sweet Corn Granules, DiPel® 10G Biological Insecticide Granules, DiPel® SG Plus Biological Insecticide Sand Granule, DiPel® 6L Worm Killer, VectoBac® G Biological Larvicide Granules, VectoBac® GR, Summit Mosquito Bits®, Mosquito Bits®, BMP 144 (200 G), Bti Granular Larvicide, FourStar® MBG, DiPel® 8L Worm Killer, TERROR Larvacide, VectoMax® FG Biological Larvicide Fine Granule, Chemsico Insect Granules ML, VectoBac® FG Biological Larvicide Granules, Bti Granules, RF2230 D-Granules, RF2248 U-Granules, AllPro Sustain BCG, BMP 144 (400 G), VectoPrime® FG Biological Larvicide Fine Granules, VectoBac® FG+Biological Larvicide Fine Granule, VectoBac® AS, DiPel® WP Home & Garden Insecticide, DiPel® Bio Garden Spray, WideStrike®, Meridian-02, BMP 144 (2X), grubGONE!® G, Bioprotec, Bioprotec Plus, Bioprotec HP, Bioprotec Caterpillar Insecticide Concentrate, BES0531, Novodor Biological Insecticide Flowable Concentrate, FourStar® Bti CRG, VBC-60092 (Bactimos Briquette), Summit B.t.i. BRIQUETS, Dunks, Sympatico Biological Insecticide, XenTari® AS Biological Insecticide Aqueous Suspension, B402 Biological Larvicide, VectoBac® 12 AS Biological Larvicide Aqueous Suspension, VectoBac® SC Biological Larvicide, BMP 144 (3X), CMP 123 (48 LC), Bactimos PT, Foray 48B, Foray 48BC, Foray 48F Biological Insecticide Flowable Concentrate, Foray 76B, Safer B.T. Caterpillar Killer Concentrate, Bacillus thuringiensis subsp. israelensis slurry, Bacillus thuringiensis subsp. kurstaki slurry, Trident® Biological Insecticide, VBC-60219 Biological Insecticide Slurry, Javelin, Bacillus thuringiensis subsp. aizawai slurry, FlorBac® Slurry Biological Insecticide, DiPel® ES, DiPel® ES-NT Biological Insecticide Emulsifiable Suspension, DiPel® (Worm Killer) Wettable Powder Biological Insecticide, Condor, Leap® ES Bacterial Disease Management Biological Insecticide Emulsifiable Suspension, Biobit® HPWP II Biological Insecticide, VectoBac® WDG Biological Larvicide Water Dispersible Granule, VectoBac® DT Biological Larvicide, Bactimos® WG, VectoBac® WG, BMP 123 (2X WP), Cutlass, Crymax®, Lepinox™ WDG, Crymax® WP, BMP 144 DF 3000, Condor WP, BTI WDG, Condor XL, XenTari® Biological Insecticide Water Dispersible Granule, Agree® WG, Agree® 50 WP, DiPel® DF Biological Insecticide Dry Flowable, XenTari® Biological Insecticide Dry Flowable, DiPel® DF Biological Insecticide, DiPel® 2X Biological Insecticide Wettable Powder, BioBit®® HP Biological Insecticide Wettable Powder, DiPel® WDG Biological Insecticide, VBC-60236 Biological Insecticide Dry Flowable, Foray 2WG Biological Insecticide (Water Dispersible Granules), Thuricide® HPWP, Foray WG, Thyllom beetleGONE!® Biological Insecticide, Javelin WP, ABG-6346 Biological Insecticide, ABG-6345 Technical Powder, Javelin WG, SAN 420 I WG, Javelin WG 2, BTK32, XenTari® Biological Insecticide Technical Powder, Phyllom SDS-502 MP, DiPel® Biological Insecticide Technical Powder, Novodor Technical, VBC-60225 Biological Insecticide Technical Grade Active Ingredient POW, Bonide Bacillus thuringiensis ‘O’, Chemsico HPC-O Concentrate, Thuricide® HPC-O for Home and Gardens, VectoBac® Technical Powder, VectoBac® Biological Larvicide Primary Powder, Bioprotec Technical, Summit BTI MP, BMP 144 Primary Powder, BMP 123 Primary Powder, BMP 144 Primary Powder OSF, Technical CGA-237218, Javelin Technical Concentrate, Thuricide® Technical Concentrate, SAN 420 I Technical Concentrate, CONDOR Technical Powder, Cutlass Technical Powder, Lepinox, BTT SDTC, BTT Liquid Technical Concentrate, or BTI Technical Powder BIOInsecticide.

In some embodiments, which may be combined with any of the preceding embodiments, the first minicell includes a first vector including a coding sequence of the first exogenous protein toxin. In further embodiments of this aspect, the first vector includes a CloDF origin of replication or a pMB1 origin of replication. In additional embodiments of this aspect, which may be combined with any of the preceding embodiments that has a first vector, the coding sequence of the first exogenous protein toxin is operably linked to a first promoter. In other embodiments of this aspect, the first promoter is an inducible promoter or a constitutive promoter. In some embodiments of this aspect, the inducible promoter includes Ptac, Ptet, or PT7. In some embodiments of this aspect, the constitutive promoter includes J23119 (SEQ ID NO: 200). In some embodiments, the promoter is selected from T3, T7, K11 or SP6. In additional embodiments of this aspect, which may be combined with any of the preceding embodiments that has a first vector, the first exogenous protein toxin includes a PirAB, wherein PirAB includes the PirA including SEQ ID NO: 203 and the PirB including SEQ ID NO: 204, and wherein the coding sequence of the PirA includes SEQ ID NO: 102 and the coding sequence of the PirB includes SEQ ID NO: 103. In further embodiments of this aspect, which may be combined with any of the preceding embodiments that has a first vector and an inducible promoter, expression of the first exogenous protein toxin is induced with aTc or IPTG.

In further embodiments of the second aspect, which may be combined with any of the preceding embodiments, plurality of minicells includes a vector including a coding sequence of the exogenous protein toxin. In further embodiments of this aspect, the vector includes a pMB1 origin of replication. In additional embodiments of this aspect, which may be combined with any of the preceding embodiments that has a vector, the coding sequence of the exogenous protein toxin is operably linked to a promoter. In other embodiments of this aspect, the promoter is an inducible promoter or a constitutive promoter. In some embodiments of this aspect, the inducible promoter includes Ptet. In additional embodiments of this aspect, which may be combined with any of the preceding embodiments that has a vector, the exogenous protein toxin includes a PirAB, wherein PirAB includes the PirA including SEQ ID NO: 4 and the PirB including SEQ ID NO: 5, and wherein the coding sequence of the PirA includes SEQ ID NO: 2 and the coding sequence of the PirB includes SEQ ID NO: 3. In further embodiments of this aspect, which may be combined with any of the preceding embodiments that has a vector and an inducible promoter, expression of the exogenous protein toxin is induced with aTc.

In further embodiments, which may be combined with any of the preceding embodiments, the second minicell includes a second vector including a coding sequence of the second exogenous protein toxin. In further embodiments of this aspect, the second vector includes a CloDF origin of replication or a pMB1 origin of replication. In additional embodiments of this aspect, which may be combined with any of the preceding embodiments that has a second vector, the coding sequence of the second exogenous protein toxin is operably linked to a second promoter. In other embodiments of this aspect, the second promoter is an inducible promoter or a constitutive promoter. In some embodiments of this aspect, the inducible promoter includes Ptac, Ptet, or PT7. In some embodiments of this aspect, the constitutive promoter includes J23119 (SEQ ID NO: 200). In some embodiments, the promoter is selected from T3, T7, K11 or SP6. In additional embodiments of this aspect, which may be combined with any of the preceding embodiments that has a second vector, the second exogenous protein toxin includes a Cry1A, wherein the Cry1A includes SEQ ID NO: 205, and wherein the coding sequence of the Cry1A includes SEQ ID NO: 104. In further embodiments of this aspect, which may be combined with any of the preceding embodiments that has a second vector and an inducible promoter, expression of the second exogenous protein toxin is induced with aTc or IPTG.

In additional embodiments of all of the forgoing aspects, which may be combined with any of the preceding embodiments including the control of an insect pest, control includes at least one of: a reduction in insect pest number, a reduction in insect pest weight, a reduction in physical damage caused by the insect pest, and an increase in insect pest mortality. In further embodiments of this aspect, the reduction in insect pest number is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction, the reduction in insect pest weight is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction, the reduction in physical damage is an at least 10% reduction, an at least 15% reduction, at least 20% reduction, an at least 25% reduction, an at least 30% reduction, an at least 40% reduction, an at least 50% reduction, an at least 60% reduction, an at least 70% reduction, or an at least 80% reduction, and the increase in insect pest mortality is an at least 10% increase, an at least 15% increase, an at least 20% increase, an at least 25% increase, an at least 30% increase, an at least 40% increase, an at least 50% increase, an at least 60% increase, an at least 70% increase, or an at least 80% increase. In some embodiments of this aspect, which may be combined with any of the preceding embodiments, control includes an observed insect pest mortality of at least about 55%, 60%, 65%, 70%, 75%, 80%, 85%, 90%, or 95%.

In further embodiments of all of the forgoing aspects, which may be combined with any of the preceding embodiments, the composition further includes agrochemical surfactants, wherein the agrochemical surfactants improve at least one of the characteristics of sprayability, spreadability, and injectability. In additional embodiments of this aspect, which may be combined with any of the preceding embodiments, the liquid carrier phase is aqueous or oil. In some embodiments of this aspect, which may be combined with any of the preceding embodiments including the control of an insect pest, the at least one insect pest is selected from the group of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., or Diptera spp.

An additional aspect of the disclosure includes a composition including: a liquid carrier phase; and a plurality of minicells dispersed in the carrier phase, wherein the plurality of minicells includes a minicell including a first effective amount of a first exogenous protein toxin including Pir and a second effective amount of a second exogenous protein toxin including Cry1, wherein the first effective amount and the second effective amount are present at a ratio in the range of about 50:1-1:50. In some embodiments of this aspect, the first effective amount and the second effective amount are present at a ratio of about 46:1, 23:1, 11:1, 9:1, 6:1, 5:1, 3:1, or 1:1. In some embodiments of this aspect, which may be combined with any of the preceding embodiments, the first effective amount and the second effective amount combined have a synergistic effect on the control of at least one insect pest when the composition is administered to the insect pest that that exceeds an effect of the first effective amount alone and an effect of the second effective amount alone on the control of at least one insect pest when the composition is administered to the insect pest.

An additional aspect of the disclosure includes a composition including: a liquid carrier phase; and a plurality of minicells dispersed in the carrier phase, wherein the plurality of minicells includes a minicell including a first effective amount of an exogenous protein toxin including Pir and a second effective amount of a Bt-derived AI, wherein the first effective amount and the second effective amount are present at a ratio in the range of about 50:1-1:50. In some embodiments of this aspect, the first effective amount and the second effective amount are present at a ratio of about 23:1, 22:1, 11:1, 6:1, 3:1, 2:1, or 1.5:1. In some embodiments of this aspect, which may be combined with any of the preceding embodiments, the first effective amount and the second effective amount combined have a synergistic effect on the control of at least one insect pest when the composition is administered to the insect pest that that exceeds an effect of the first effective amount alone and an effect of the second effective amount alone on the control of at least one insect pest when the composition is administered to the insect pest.

A further aspect of the disclosure includes a method of controlling an insect pest, the method including: administering the composition of any one of the preceding embodiments to an insect pest. In some embodiments of this aspect, administering the composition to the insect pest includes an administration method selected from the group of delivering the composition to the insect pest for ingestion; contacting the insect pest with the composition; delivering the composition to at least one habitat where the insect pest grows, lives, reproduces, feeds, or infests; or applying the composition to a plant. In other embodiments of this aspect, the composition is applied to the plant as at least one of a foliar treatment, an injection treatment, a pre-emergence treatment, and a post-emergence treatment. In further embodiments of this aspect, which may be combined with any of the preceding embodiments, the composition is formulated as at least one of a Ready To Use (RTU) formulation, a suspension concentrate, a tank-mix, an aerosol, a seed treatment, a root dip, a soil treatment, an irrigation formulation, a sprinkler formulation, a drench treatment, a dust, an emulsifiable concentrate, a flowable concentrate, a formulation intermediate, a granular formulation, an impregnated materials formulation, a pelleted/tableted formulation, a soluble concentrate formulation, a technical chemical formulation, a water dispersable granule formulation, a water soluble packaging formulation, or a wettable powder formulation. In additional embodiments of this aspect, which may be combined with any of the preceding embodiments, control includes at least one of: a reduction in insect pest number, a reduction in insect pest weight, a reduction in physical damage caused by the insect pest, and an increase in insect pest mortality. In further embodiments of this aspect, the reduction in insect pest number is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction, the reduction in insect pest weight is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction, the reduction in physical damage is an at least 10% reduction, an at least 15% reduction, at least 20% reduction, an at least 25% reduction, an at least 30% reduction, an at least 40% reduction, an at least 50% reduction, an at least 60% reduction, an at least 70% reduction, or an at least 80% reduction, and the increase in insect pest mortality is an at least 10% increase, an at least 15% increase, an at least 20% increase, an at least 25% increase, an at least 30% increase, an at least 40% increase, an at least 50% increase, an at least 60% increase, an at least 70% increase, or an at least 80% increase. In some embodiments of this aspect, which may be combined with any of the preceding embodiments, control includes an observed insect pest mortality of at least about 55%, 60%, 65%, 70%, 75%, 80%, 85%, 90%, or 95%. In some embodiments of this aspect, which may be combined with any of the preceding embodiments, the at least one insect pest is selected from the group of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., or Diptera spp.

Yet another aspect of the disclosure includes a wettable powder including: a plurality of dried minicells including a mixture of a first effective amount of a first minicell including a first exogenous protein toxin including Pir and a second effective amount of a second minicell including a second exogenous protein toxin including Cry, wherein the first effective amount and the second effective amount are present at a ratio in the range of about 50:1-1:50, and wherein the wettable powder is configured to be dispersed in an aqueous carrier to create a composition for controlling at least one insect pest when the composition is administered to an insect. In some embodiments of this aspect, the first effective amount and the second effective amount are present at a ratio of about 46:1, 23:1, 11:1, 9:1, 6:1, 5:1, 3:1, or 1:1. In other embodiments of this aspect, which may be combined with any of the preceding embodiments, the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest. In further embodiments of this aspect, which may be combined with any of the preceding embodiments, a first particle concentration of the first minicell is in the range of about 1×10² to about 8×10¹⁴, and wherein a second particle concentration of the second minicell is in the range of about 1×10² to about 8×10¹⁴. In additional embodiments of this aspect, which may be combined with any of the preceding embodiments, the wettable powder further includes an agrochemically acceptable solid carrier component including at least one of: a clay component, a kaolin component, a talc component, a chalk component, a calcite component, a quartz component, a pumice component, a diatomaceous earth component, a vermiculite component, a silicate component, a silicon dioxide component, a silica powder component, an aluminum component, an ammonium sulfate component, an ammonium phosphate component, a calcium carbonate component, an urea component, a sugar component, a starch component, a sawdust component, a ground coconut shell component, a ground corn cob component, and a ground tobacco stalk component. In some embodiments of this aspect, which may be combined with any of the preceding embodiments, the aqueous carrier includes water. In further embodiments of this aspect, which may be combined with any of the preceding embodiments, administering the composition to the insect pest includes an administration method selected from the group of delivering the composition to the insect pest for ingestion; contacting the insect with the composition; delivering the composition to at least one habitat where the insect pest grows, lives, reproduces, feeds, or infests; and applying the composition to a plant. In some embodiments of this aspect, the composition is applied to the plant as at least one of a foliar treatment, an injection treatment, a pre-emergence treatment, or a post-emergence treatment.

In some embodiments of this aspect, which may be combined with any of the preceding embodiments, the first exogenous protein toxin includes PirAB or a functional component thereof. In further embodiments of this aspect, PirAB includes a PirA selected from the group of SEQ ID NO: 143, SEQ ID NO: 146, SEQ ID NO: 147, SEQ ID NO: 154, SEQ ID NO: 157, SEQ ID NO: 161, SEQ ID NO: 163, SEQ ID NO: 164, SEQ ID NO: 165, SEQ ID NO: 167, SEQ ID NO: 168, SEQ ID NO: 169, SEQ ID NO: 170, SEQ ID NO: 171, SEQ ID NO: 174, SEQ ID NO: 174, SEQ ID NO: 186, SEQ ID NO: 190, SEQ ID NO: 192, SEQ ID NO: 197, SEQ ID NO: 199, SEQ ID NO: 202, or SEQ ID NO: 203; and a PirB selected from the group of SEQ ID NO: 144, SEQ ID NO: 145, SEQ ID NO: 148, SEQ ID NO: 149, SEQ ID NO: 150, SEQ ID NO: 153, SEQ ID NO: 158, SEQ ID NO: 159, SEQ ID NO: 160, SEQ ID NO: 162, SEQ ID NO: 166, SEQ ID NO: 172, SEQ ID NO: 177, SEQ ID NO: 178, SEQ ID NO: 179, SEQ ID NO: 180, SEQ ID NO: 181, SEQ ID NO: 182, SEQ ID NO: 183, SEQ ID NO: 184, SEQ ID NO: 185, SEQ ID NO: 187, SEQ ID NO: 188, SEQ ID NO: 189, SEQ ID NO: 191, SEQ ID NO: 193, SEQ ID NO: 194, SEQ ID NO: 195, SEQ ID NO: 196, SEQ ID NO: 198, SEQ ID NO: 201, or SEQ ID NO: 204, or a functional component of any thereof. In other embodiments of this aspect, PirAB includes the PirA including SEQ ID NO: 203 and the PirB including SEQ ID NO: 204, or PirAB includes the PirA including SEQ ID NO: 197 and the PirB including SEQ ID NO: 178.

In some embodiments of this aspect, which may be combined with any of the preceding embodiments, the second exogenous protein toxin includes Cry1A, Cry1B, Cry1C, Cry1D, Cry1E, Cry1F, Cry1G, Cry1H, Cry1I, Cry1J, or Cry1K or a functional component thereof. In further embodiments of this aspect, the Cry1A includes a Cry1A selected from the group of SEQ ID NO: 105, SEQ ID NO: 106, SEQ ID NO: 107, SEQ ID NO: 108, SEQ ID NO: 109, SEQ ID NO: 110, SEQ ID NO: 111, SEQ ID NO: 112, SEQ ID NO: 113, SEQ ID NO: 114, SEQ ID NO: 115, SEQ ID NO: 151, SEQ ID NO: 152, or SEQ ID NO: 205; the Cry1B includes a Cry1B selected from the group of SEQ ID NO: 117, SEQ ID NO: 118, SEQ ID NO: 119, SEQ ID NO: 120, SEQ ID NO: 121, SEQ ID NO: 122, or SEQ ID NO: 155; the Cry1C includes a Cry1C selected from the group of SEQ ID NO: 123, SEQ ID NO: 124, SEQ ID NO: 125, or SEQ ID NO: 156; the Cry1D includes a Cry1D selected from the group of SEQ ID NO: 126, SEQ ID NO: 127, SEQ ID NO: 175, or SEQ ID NO: 176; the Cry1E includes a Cry1E selected from the group of SEQ ID NO: 128 or SEQ ID NO: 129; the Cry1F includes a Cry1F selected from the group of SEQ ID NO: 130 or SEQ ID NO: 131; the Cry1G includes a Cry1G selected from the group of SEQ ID NO: 132 or SEQ ID NO: 133; the Cry1H includes a Cry1H selected from the group of SEQ ID NO: 134 or SEQ ID NO: 135; the Cry1I includes a Cry1I selected from the group of SEQ ID NO: 136, SEQ ID NO: 137, SEQ ID NO: 138, or SEQ ID NO: 139; the Cry1J includes a Cry1J selected from the group of SEQ ID NO: 140 or SEQ ID NO: 141; or the Cry1K includes SEQ ID NO: 142, or a functional component of any thereof. In other embodiments of this aspect, the second exogenous protein toxin includes the Cry1A including SEQ ID NO: 205.

Yet another aspect of the disclosure includes a wettable powder including: a plurality of dried minicells including a mixture of a first effective amount of a minicell including an exogenous protein toxin including Pir and a second effective amount of a Bt-derived AI, wherein the first effective amount and the second effective amount are present at a ratio in the range of about 50:1-1:50, and wherein the wettable powder is configured to be dispersed in an aqueous carrier to create a composition for controlling at least one insect pest when the composition is administered to an insect. In some embodiments of this aspect, the first effective amount and the second effective amount are present at a ratio of about 23:1, 22:1, 11:1, 6:1, 3:1, 2:1, or 1.5:1. In other embodiments of this aspect, which may be combined with any of the preceding embodiments, the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest. In further embodiments of this aspect, which may be combined with any of the preceding embodiments, a particle concentration of the minicell is in the range of about 1×10² to about 8×10¹. In additional embodiments of this aspect, which may be combined with any of the preceding embodiments, the Bt-derived AI includes at least one of Bacillus thuringiensis, its fermentation solids, its spores, and its insecticidal toxins. In yet further embodiments of this aspect, which may be combined with any of the preceding embodiments, the Bt-derived AI includes at least two, at least three, or all of Bacillus thuringiensis, its fermentation solids, its spores, and its insecticidal toxins. In additional embodiments of this aspect, which may be combined with any of the preceding embodiments, the wettable powder further includes an agrochemically acceptable solid carrier component including at least one of: a clay component, a kaolin component, a talc component, a chalk component, a calcite component, a quartz component, a pumice component, a diatomaceous earth component, a vermiculite component, a silicate component, a silicon dioxide component, a silica powder component, an aluminum component, an ammonium sulfate component, an ammonium phosphate component, a calcium carbonate component, an urea component, a sugar component, a starch component, a sawdust component, a ground coconut shell component, a ground corn cob component, and a ground tobacco stalk component. In some embodiments of this aspect, which may be combined with any of the preceding embodiments, the aqueous carrier includes water. In further embodiments of this aspect, which may be combined with any of the preceding embodiments, administering the composition to the insect pest includes an administration method selected from the group of delivering the composition to the insect pest for ingestion; contacting the insect with the composition; delivering the composition to at least one habitat where the insect pest grows, lives, reproduces, feeds, or infests; and applying the composition to a plant. In some embodiments of this aspect, the composition is applied to the plant as at least one of a foliar treatment, an injection treatment, a pre-emergence treatment, or a post-emergence treatment.

In some embodiments of this aspect, which may be combined with any of the preceding embodiments, the exogenous protein toxin includes PirAB or a functional component thereof. In further embodiments of this aspect, PirAB includes a PirA selected from the group of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, or SEQ ID NO: 32; and a PirB selected from the group of S SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, or SEQ ID NO: 58, or a functional component of any thereof. In other embodiments of this aspect, PirAB includes the PirA including SEQ ID NO: 4 and the PirB including SEQ ID NO: 5, or wherein PirAB includes the PirA including SEQ ID NO: 6 and the PirB including SEQ ID NO: 7. In yet another embodiment of this aspect, PirAB includes a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and wherein PirA is linked to a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58 by a linker sequence. In some embodiments of this aspect, which may be combined with any of the preceding embodiments, the Bt-derived AI includes Bt-derived biological control product selected from the group of Thuricide®, Thuricide® HPC-O RTU, Thuricide® HPC, Thuricide® 48 LV Forestry, Thuricide® 76B, Thuricide® 76 LV, Bonide Bacillus Thuringiensis (BT) Moth Larvae (Caterpillar) Control, DiPel®, Security BT Dust Biological Insecticide, Fertilome Dipel Dust Biological Insecticide, Widestrike®, Plant Pesticide B.T. subsp. tenebrionis Colorado Potato Beetle Protein, SA-50 brand DiPel® dust, Ringer® Vegetable Insect Attack®, Bonide DiPel® 150 Dust For Vegetables, Green Light® DiPel® Dust, Green Light® BT Worm Killer, BT Sulfur 15-50 Dust, NEU1701I, FourStar® Briquets, FourStar® CRG, Britz Bt 25 Sulfur Dust, Thuricide® 32LV, Bonide Mosquito Beater® Water Soluble Pouches, Britz BT Dust, Summit Fallout Bti Granules, DiPel® 10G Sweet Corn Granules, DiPel® 10G Biological Insecticide Granules, DiPel® SG Plus Biological Insecticide Sand Granule, DiPel® 6L Worm Killer, VectoBac® G Biological Larvicide Granules, VectoBac® GR, Summit Mosquito Bits®, Mosquito Bits®, BMP 144 (200 G), Bti Granular Larvicide, FourStar® MBG, DiPel® 8L Worm Killer, TERROR Larvacide, VectoMax® FG Biological Larvicide Fine Granule, Chemsico Insect Granules ML, VectoBac® FG Biological Larvicide Granules, Bti Granules, RF2230 D-Granules, RF2248 U-Granules, AllPro Sustain BCG, BMP 144 (400 G), VectoPrime® FG Biological Larvicide Fine Granules, VectoBac® FG+Biological Larvicide Fine Granule, VectoBac® AS, DiPel® WP Home & Garden Insecticide, DiPel® Bio Garden Spray, WideStrike®, Meridian-02, BMP 144 (2X), grubGONE!® G, Bioprotec, Bioprotec Plus, Bioprotec HP, Bioprotec Caterpillar Insecticide Concentrate, BES0531, Novodor Biological Insecticide Flowable Concentrate, FourStar® Bti CRG, VBC-60092 (Bactimos Briquette), Summit B.t.i. BRIQUETS, Dunks, Sympatico Biological Insecticide, XenTari® AS Biological Insecticide Aqueous Suspension, B402 Biological Larvicide, VectoBac® 12 AS Biological Larvicide Aqueous Suspension, VectoBac® SC Biological Larvicide, BMP 144 (3X), CMP 123 (48 LC), Bactimos PT, Foray 48B, Foray 48BC, Foray 48F Biological Insecticide Flowable Concentrate, Foray 76B, Safer B.T. Caterpillar Killer Concentrate, Bacillus thuringiensis subsp. israelensis slurry, Bacillus thuringiensis subsp. kurstaki slurry, Trident® Biological Insecticide, VBC-60219 Biological Insecticide Slurry, Javelin, Bacillus thuringiensis subsp. aizawai slurry, FlorBac® Slurry Biological Insecticide, DiPel® ES, DiPel® ES-NT Biological Insecticide Emulsifiable Suspension, DiPel® (Worm Killer) Wettable Powder Biological Insecticide, Condor, Leap® ES Bacterial Disease Management Biological Insecticide Emulsifiable Suspension, Biobit® HPWP II Biological Insecticide, VectoBac® WDG Biological Larvicide Water Dispersible Granule, VectoBac® DT Biological Larvicide, Bactimos® WG, VectoBac® WG, BMP 123 (2X WP), Cutlass, Crymax®, Lepinox™ WDG, Crymax® WP, BMP 144 DF 3000, Condor WP, BTI WDG, Condor XL, XenTari® Biological Insecticide Water Dispersible Granule, Agree® WG, Agree® 50 WP, DiPel® DF Biological Insecticide Dry Flowable, XenTari® Biological Insecticide Dry Flowable, DiPel® DF Biological Insecticide, DiPel® 2X Biological Insecticide Wettable Powder, BioBit®® HP Biological Insecticide Wettable Powder, DiPel® WDG Biological Insecticide, VBC-60236 Biological Insecticide Dry Flowable, Foray 2WG Biological Insecticide (Water Dispersible Granules), Thuricide® HPWP, Foray WG, Thyllom beetleGONE!® Biological Insecticide, Javelin WP, ABG-6346 Biological Insecticide, ABG-6345 Technical Powder, Javelin WG, SAN 420 I WG, Javelin WG 2, BTK32, XenTari® Biological Insecticide Technical Powder, Phyllom SDS-502 MP, DiPel® Biological Insecticide Technical Powder, Novodor Technical, VBC-60225 Biological Insecticide Technical Grade Active Ingredient POW, Bonide Bacillus thuringiensis ‘O’, Chemsico HPC-O Concentrate, Thuricide® HPC-O for Home and Gardens, VectoBac® Technical Powder, VectoBac® Biological Larvicide Primary Powder, Bioprotec Technical, Summit BTI MP, BMP 144 Primary Powder, BMP 123 Primary Powder, BMP 144 Primary Powder OSF, Technical CGA-237218, Javelin Technical Concentrate, Thuricide® Technical Concentrate, SAN 420 I Technical Concentrate, CONDOR Technical Powder, Cutlass Technical Powder, Lepinox, BTT SDTC, BTT Liquid Technical Concentrate, or BTI Technical Powder BIOInsecticide.

In additional embodiments of either of the preceding two aspects, which may be combined with any of the preceding embodiments, control includes at least one of: a reduction in insect pest number, a reduction in insect pest weight, a reduction in physical damage caused by the insect pest, and an increase in insect pest mortality. In further embodiments of this aspect, the reduction in insect pest number is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction, the reduction in insect pest weight is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction, the reduction in physical damage is an at least 10% reduction, an at least 15% reduction, at least 20% reduction, an at least 25% reduction, an at least 30% reduction, an at least 40% reduction, an at least 50% reduction, an at least 60% reduction, an at least 70% reduction, or an at least 80% reduction, and the increase in insect pest mortality is an at least 10% increase, an at least 15% increase, an at least 20% increase, an at least 25% increase, an at least 30% increase, an at least 40% increase, an at least 50% increase, an at least 60% increase, an at least 70% increase, or an at least 80% increase. In some embodiments of this aspect, which may be combined with any of the preceding embodiments, control includes an observed insect pest mortality of at least about 55%, 60%, 65%, 70%, 75%, 80%, 85%, 90%, or 95%. In some embodiments of this aspect, which may be combined with any of the preceding embodiments, the at least one insect pest is selected from the group of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., or Diptera spp.

Still another aspect of the disclosure includes a method of producing a wettable powder including: a) providing a first effective amount of a first dried minicell including a first exogenous protein toxin including Pir; b) a second effective amount of a second dried minicell including a second exogenous protein toxin including Cry; and c) mixing the first effective amount and the second effective amount at a ratio in the range of about 50:1-1:50, wherein the wettable powder is configured to be dispersed in an aqueous carrier to create a composition for controlling at least one insect pest when the composition is administered to an insect pest. In some embodiments of this aspect, the first effective amount and the second effective amount are mixed in a ratio of about 46:1, 23:1, 11:1, 9:1, 6:1, 5:1, 3:1, or 1:1.

Still another aspect of the disclosure includes a method of producing a wettable powder including: a) providing a first effective amount of a first dried minicell including an exogenous protein toxin including Pir; b) a second effective amount of a dried Bt-derived AI; and c) mixing the first effective amount and the second effective amount at a ratio in the range of about 50:1-1:50, wherein the wettable powder is configured to be dispersed in an aqueous carrier to create a composition for controlling at least one insect pest when the composition is administered to an insect pest. In some embodiments of this aspect, the first effective amount and the second effective amount are mixed in a ratio of about 23:1, 22:1, 11:1, 6:1, 3:1, 2:1, or 1.5:1.

A further aspect of the disclosure includes a plantable composition including: a seed; and a coating covering the seed, wherein the coating includes a plurality of minicells including a mixture of a first effective amount of a first minicell including a first exogenous protein toxin including Pir and a second effective amount of a second minicell including a second exogenous protein toxin including Cry, wherein the first effective amount and the second effective amount are present at a ratio in the range of about 50:1-1:50, and wherein the mixture is sufficient to result in insecticidal activity on at least one insect pest feeding on the seed or a seedling emerging therefrom. In some embodiments of this aspect, the first effective amount and the second effective amount are present at a ratio of about 46:1, 23:1, 11:1, 9:1, 6:1, 5:1, 3:1, or 1:1. In other embodiments of this aspect, which may be combined with any of the preceding embodiments, the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest. In further embodiments of this aspect, which may be combined with any of the preceding embodiments, a first particle concentration of the first minicell is in the range of about 1×10² to about 8×10¹⁴, and wherein a second particle concentration of the second minicell is in the range of about 1×10² to about 8×10¹⁴.

In some embodiments of this aspect, which may be combined with any of the preceding embodiments, the first exogenous protein toxin includes PirAB or a functional component thereof. In further embodiments of this aspect, PirAB includes a PirA selected from the group of SEQ ID NO: 143, SEQ ID NO: 146, SEQ ID NO: 147, SEQ ID NO: 154, SEQ ID NO: 157, SEQ ID NO: 161, SEQ ID NO: 163, SEQ ID NO: 164, SEQ ID NO: 165, SEQ ID NO: 167, SEQ ID NO: 168, SEQ ID NO: 169, SEQ ID NO: 170, SEQ ID NO: 171, SEQ ID NO: 174, SEQ ID NO: 174, SEQ ID NO: 186, SEQ ID NO: 190, SEQ ID NO: 192, SEQ ID NO: 197, SEQ ID NO: 199, SEQ ID NO: 202, or SEQ ID NO: 203; and a PirB selected from the group of SEQ ID NO: 144, SEQ ID NO: 145, SEQ ID NO: 148, SEQ ID NO: 149, SEQ ID NO: 150, SEQ ID NO: 153, SEQ ID NO: 158, SEQ ID NO: 159, SEQ ID NO: 160, SEQ ID NO: 162, SEQ ID NO: 166, SEQ ID NO: 172, SEQ ID NO: 177, SEQ ID NO: 178, SEQ ID NO: 179, SEQ ID NO: 180, SEQ ID NO: 181, SEQ ID NO: 182, SEQ ID NO: 183, SEQ ID NO: 184, SEQ ID NO: 185, SEQ ID NO: 187, SEQ ID NO: 188, SEQ ID NO: 189, SEQ ID NO: 191, SEQ ID NO: 193, SEQ ID NO: 194, SEQ ID NO: 195, SEQ ID NO: 196, SEQ ID NO: 198, SEQ ID NO: 201, or SEQ ID NO: 204, or a functional component of any thereof. In other embodiments of this aspect, PirAB includes the PirA including SEQ ID NO: 203 and the PirB including SEQ ID NO: 204, or PirAB includes the PirA including SEQ ID NO: 197 and the PirB including SEQ ID NO: 178.

In some embodiments of this aspect, which may be combined with any of the preceding embodiments, the second exogenous protein toxin includes Cry1A, Cry1B, Cry1C, Cry1D, Cry1E, Cry1F, Cry1G, Cry1H, Cry1I, Cry1J, or Cry1K or a functional component thereof. In further embodiments of this aspect, the Cry1A includes a Cry1A selected from the group of SEQ ID NO: 105, SEQ ID NO: 106, SEQ ID NO: 107, SEQ ID NO: 108, SEQ ID NO: 109, SEQ ID NO: 110, SEQ ID NO: 111, SEQ ID NO: 112, SEQ ID NO: 113, SEQ ID NO: 114, SEQ ID NO: 115, SEQ ID NO: 151, SEQ ID NO: 152, or SEQ ID NO: 205; the Cry1B includes a Cry1B selected from the group of SEQ ID NO: 117, SEQ ID NO: 118, SEQ ID NO: 119, SEQ ID NO: 120, SEQ ID NO: 121, SEQ ID NO: 122, or SEQ ID NO: 155; the Cry1C includes a Cry1C selected from the group of SEQ ID NO: 123, SEQ ID NO: 124, SEQ ID NO: 125, or SEQ ID NO: 156; the Cry1D includes a Cry1D selected from the group of SEQ ID NO: 126, SEQ ID NO: 127, SEQ ID NO: 175, or SEQ ID NO: 176; the Cry1E includes a Cry1E selected from the group of SEQ ID NO: 128 or SEQ ID NO: 129; the Cry1F includes a Cry1F selected from the group of SEQ ID NO: 130 or SEQ ID NO: 131; the Cry1G includes a Cry1G selected from the group of SEQ ID NO: 132 or SEQ ID NO: 133; the Cry1H includes a Cry1H selected from the group of SEQ ID NO: 134 or SEQ ID NO: 135; the Cry1I includes a Cry1I selected from the group of SEQ ID NO: 136, SEQ ID NO: 137, SEQ ID NO: 138, or SEQ ID NO: 139; the Cry1J includes a Cry1J selected from the group of SEQ ID NO: 140 or SEQ ID NO: 141; or the Cry1K includes SEQ ID NO: 142, or a functional component of any thereof. In other embodiments of this aspect, the second exogenous protein toxin includes the Cry1A including SEQ ID NO: 205.

A further aspect of the disclosure includes a plantable composition including: a seed; and a coating covering the seed, wherein the coating includes a coating covering the seed, wherein the coating includes a plurality of minicells including a mixture of a first effective amount of a minicell including an exogenous protein toxin including Pir and a second effective amount of a Bt-derived AI, wherein the first effective amount and the second effective amount are present at a ratio in the range of about 50:1-1:50, and wherein the mixture is sufficient to result in insecticidal activity on at least one insect pest feeding on the seed or a seedling emerging therefrom. In some embodiments of this aspect, the first effective amount and the second effective amount are present at a ratio of about 23:1, 22:1, 11:1, 6:1, 3:1, 2:1, or 1.5:1. In other embodiments of this aspect, which may be combined with any of the preceding embodiments, the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest. In further embodiments of this aspect, which may be combined with any of the preceding embodiments, a particle concentration of the minicells is in the range of about 1×10² to about 8×10¹⁴. In additional embodiments of this aspect, which may be combined with any of the preceding embodiments, the Bt-derived AI includes at least one of Bacillus thuringiensis, its fermentation solids, its spores, and its insecticidal toxins. In yet further embodiments of this aspect, which may be combined with any of the preceding embodiments, the Bt-derived AI includes at least two, at least three, or all of Bacillus thuringiensis, its fermentation solids, its spores, and its insecticidal toxins.

In some embodiments of this aspect, which may be combined with any of the preceding embodiments, the exogenous protein toxin includes PirAB or a functional component thereof. In further embodiments of this aspect, PirAB includes a PirA selected from the group of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, or SEQ ID NO: 32; and a PirB selected from the group of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, or SEQ ID NO: 58, or a functional component of any thereof. In other embodiments of this aspect, PirAB includes the PirA including SEQ ID NO: 4 and the PirB including SEQ ID NO: 5, or wherein PirAB includes the PirA including SEQ ID NO: 6 and the PirB including SEQ ID NO: 7. In yet further embodiments of this aspect, PirAB includes a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and wherein PirA is linked to a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58 by a linker sequence. In some embodiments of this aspect, which may be combined with any of the preceding embodiments, the Bt-derived AI includes a Bt-derived biological control product selected from the group of Thuricide® Thuricide® HPC-O RTU, Thuricide® HPC, Thuricide® 48 LV Forestry, Thuricide® 76B, Thuricide® 76 LV, Bonide Bacillus Thuringiensis (BT) Moth Larvae (Caterpillar) Control, DiPel®, Security BT Dust Biological Insecticide, Fertilome Dipel Dust Biological Insecticide, Widestrike®, Plant Pesticide B.T. subsp. tenebrionis Colorado Potato Beetle Protein, SA-50 brand DiPel® dust, Ringer® Vegetable Insect Attack®, Bonide DiPel® 150 Dust For Vegetables, Green Light® DiPel® Dust, Green Light® BT Worm Killer, BT Sulfur 15-50 Dust, NEU1701I, FourStar® Briquets, FourStar® CRG, Britz Bt 25 Sulfur Dust, Thuricide® 32LV, Bonide Mosquito Beater® Water Soluble Pouches, Britz BT Dust, Summit Fallout Bti Granules, DiPel® 10G Sweet Corn Granules, DiPel® 10G Biological Insecticide Granules, DiPel® SG Plus Biological Insecticide Sand Granule, DiPel® 6L Worm Killer, VectoBac® G Biological Larvicide Granules, VectoBac® GR, Summit Mosquito Bits®, Mosquito Bits®, BMP 144 (200 G), Bti Granular Larvicide, FourStar® MBG, DiPel® 8L Worm Killer, TERROR Larvacide, VectoMax® FG Biological Larvicide Fine Granule, Chemsico Insect Granules ML, VectoBac® FG Biological Larvicide Granules, Bti Granules, RF2230 D-Granules, RF2248 U-Granules, AllPro Sustain BCG, BMP 144 (400 G), VectoPrime® FG Biological Larvicide Fine Granules, VectoBac® FG+Biological Larvicide Fine Granule, VectoBac® AS, DiPel® WP Home & Garden Insecticide, DiPel® Bio Garden Spray, WideStrike®, Meridian-02, BMP 144 (2X), grubGONE!® G, Bioprotec, Bioprotec Plus, Bioprotec HP, Bioprotec Caterpillar Insecticide Concentrate, BES0531, Novodor Biological Insecticide Flowable Concentrate, FourStar® Bti CRG, VBC-60092 (Bactimos Briquette), Summit B.t.i. BRIQUETS, Dunks, Sympatico Biological Insecticide, XenTari® AS Biological Insecticide Aqueous Suspension, B402 Biological Larvicide, VectoBac® 12 AS Biological Larvicide Aqueous Suspension, VectoBac® SC Biological Larvicide, BMP 144 (3X), CMP 123 (48 LC), Bactimos PT, Foray 48B, Foray 48BC, Foray 48F Biological Insecticide Flowable Concentrate, Foray 76B, Safer B.T. Caterpillar Killer Concentrate, Bacillus thuringiensis subsp. israelensis slurry, Bacillus thuringiensis subsp. kurstaki slurry, Trident® Biological Insecticide, VBC-60219 Biological Insecticide Slurry, Javelin, Bacillus thuringiensis subsp. aizawai slurry, FlorBac® Slurry Biological Insecticide, DiPel® ES, DiPel® ES-NT Biological Insecticide Emulsifiable Suspension, DiPel® (Worm Killer) Wettable Powder Biological Insecticide, Condor, Leap® ES Bacterial Disease Management Biological Insecticide Emulsifiable Suspension, Biobit® HPWP II Biological Insecticide, VectoBac® WDG Biological Larvicide Water Dispersible Granule, VectoBac® DT Biological Larvicide, Bactimos® WG, VectoBac® WG, BMP 123 (2X WP), Cutlass, Crymax®, Lepinox™ WDG, Crymax® WP, BMP 144 DF 3000, Condor WP, BTI WDG, Condor XL, XenTari® Biological Insecticide Water Dispersible Granule, Agree® WG, Agree® 50 WP, DiPel® DF Biological Insecticide Dry Flowable, XenTari® Biological Insecticide Dry Flowable, DiPel® DF Biological Insecticide, DiPel® 2X Biological Insecticide Wettable Powder, BioBit®® HP Biological Insecticide Wettable Powder, DiPel® WDG Biological Insecticide, VBC-60236 Biological Insecticide Dry Flowable, Foray 2WG Biological Insecticide (Water Dispersible Granules), Thuricide® HPWP, Foray WG, Thyllom beetleGONE!® Biological Insecticide, Javelin WP, ABG-6346 Biological Insecticide, ABG-6345 Technical Powder, Javelin WG, SAN 420 I WG, Javelin WG 2, BTK32, XenTari® Biological Insecticide Technical Powder, Phyllom SDS-502 MP, DiPel® Biological Insecticide Technical Powder, Novodor Technical, VBC-60225 Biological Insecticide Technical Grade Active Ingredient POW, Bonide Bacillus thuringiensis ‘O’, Chemsico HPC-O Concentrate, Thuricide® HPC-O for Home and Gardens, VectoBac® Technical Powder, VectoBac® Biological Larvicide Primary Powder, Bioprotec Technical, Summit BTI MP, BMP 144 Primary Powder, BMP 123 Primary Powder, BMP 144 Primary Powder OSF, Technical CGA-237218, Javelin Technical Concentrate, Thuricide® Technical Concentrate, SAN 420 I Technical Concentrate, CONDOR Technical Powder, Cutlass Technical Powder, Lepinox, BTT SDTC, BTT Liquid Technical Concentrate, or BTI Technical Powder BIOInsecticide.

In some embodiments of either of the preceding two aspects, which may be combined with any of the preceding embodiments, the at least one insect pest is selected from the group of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., or Diptera spp. In further embodiments of this aspect, which may be combined with any of the preceding embodiments, the seed is from a plant selected from the group of alfalfa, almond, apple, apricot, artichoke, asparagus, avocado, banana, barley, bean, blueberry, cranberry, Brazil nut, cacao, calamansi, canola, Polish canola, broccoli, kale, cabbage, turnip, carnation, carrot, cashew, cassava, celery, cherry, chestnut, chickpea, chicory, chili pepper, chrysanthemum, citron, coconut, coffee, cotton, cowpea, fava bean, cucumber, currant, gooseberry, date, duckweed, eggplant, elderberry, eucalyptus, flax, geranium, ginger, ginseng, grapefruit, grape, guava, hazelnut, hemp, cannabis, hops, horseradish, iris, jackfruit, kiwifruit, kumquat, lemon, lentil, lettuce, lime, lychee, macadamia, maize, mandarin, mango, mangosteen, melon, millet, oat, oil palm, okra, olive, onion, orange, papaya, parsnip, passionfruit, pecan, peach, nectarine, pear, pea, peanut, peony, persimmon, petunia, pineapple, pistachio, plantain, plum, poinsettia, pomelo, poplar, potato, pumpkin, squash, quince, raspberry, rhubarb, rice, rose, rubber, rye, safflower, satsuma, sesame seed, sorghum, sour orange, soursop, soybean, strawberry, sugar beet, sugarcane, sunflower, sweet potato, tamarind, tangerine, tea, tobacco, tomatillo, tomato, tulip, walnut, watermelon, wheat, or yam.

These and other aspects of the invention are set forth in more detail in the description of the invention below.

### BRIEF DESCRIPTION OF THE DRAWINGS

FIGS. 1A-1B depict the size distribution of Minicell particles and protein production by E. coli strain DH10BΔminCDE (FIG. 1A), and E. coli strain DH10B(DE3)ΔminCDE (FIG. 1B).

FIG. 2 depicts the results of an artificial diet bioassay showing efficacy of Minicells comprising PirAB protein produced by strains AD16 (“AD2”) and AD17 (“AD3”)(DH10B chassis), tested at the indicated PirAB concentrations, against DBM.

FIG. 3 depicts the results of an artificial diet bioassay showing efficacy of the Minicells comprising Cry1Ac protein produced by strain AD28 (“AD14”; DH10B chassis), tested at the indicated Cry1Ac concentrations, against DBM.

FIG. 4 depicts the results of an artificial diet bioassay showing efficacy of Minicells comprising PirAB protein produced by strain AD19 (“AD5”; DH10B(DE3) chassis), tested at the indicated PirAB concentrations, against DBM.

FIGS. 5A-5C depict the green house (GH) efficacy against DBM in cabbage with toxins PirAB (AD18= “AD4”; AD16= “AD2”) and Cry expressed in the optimized DH10BΔminCDE chassis. FIG. 5A, Minicells comprising PirAB efficacy comparison between chassis strains; FIG. 5B, Minicells comprising PirAB dose response in GH; FIG. 5C, Minicells comprising Cry1Ac dose response in GH.

FIG. 6 depicts translational field trial efficacy against DBM in cabbage with Minicell-PirAB and Minicell-Cry1Ac.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

Several embodiments relate to a minicell producing bacterial chassis (strain) that maximizes minicell production yield and protein production yield. Maximizing the number of minicell particles and the active ingredient expression provides an efficacious concentration of the active ingredient. The present disclosure describes the production of a bacterial chassis that produces minicell particles production and protein expression each at a high yield. The chassis capabilities are demonstrated with multiple insecticidal toxins, e.g. PirAB, Cry1Ac, and Vip3Aa19.

### Minicell Producing Parent Cells

Minicells loaded with a heterologous functional agent (e.g., an insecticidal protein) may be derived from bacterial parent cells, as described herein. In some aspects, a composition comprising a plurality of minicells derived from a parent bacterium having a reduction in a level, activity, or expression of a cell division topological specificity factor is provided. In some aspects, a composition comprising a plurality of minicells, wherein the minicells do not comprise a cell division topological specificity factor and wherein the composition is substantially free of viable bacterial cells is provided. In some aspects, a composition comprising a plurality of minicells is provided, the composition being substantially free of viable bacterial cells, and being produced by a process comprising: (a) making, providing, or obtaining a plurality of parent bacteria having a reduction in the level or activity of a cell division topological specificity factor; (b) exposing the parent bacterium to conditions allowing the formation of a minicell, thereby producing the highly active minicells; and (c) separating the minicells from the parent bacterium, thereby producing a composition that is substantially free of viable bacterial cells. In some embodiments, the cell division topological specificity factor is a minE polypeptide. In some embodiments, the parent bacterium is E. coli and the minE polypeptide is E. coli minE. In other embodiments, the parent bacterium is Salmonella typhimurium and the minE polypeptide is S. typhimurium minE. Examples of species having minE polypeptides are provided in Rothfield et al., Nature Reviews Microbiology, 3:959-968, 2005, which is incorporated in its entirety herein. In some embodiments, the cell division topological specificity factor is a DivIVA polypeptide. Examples of species having DivIVA polypeptides are provided in Rothfield et al., Nature Reviews Microbiology, 3:959-968, 2005, which is incorporated in its entirety herein. In some embodiments, the parent bacterium is Bacillus subtilis and the cell division topological specificity factor is B. subtilis DivIVA.

In some embodiments, a minicell producing parent bacterium having the reduction in a level or activity of the cell division topological specificity factor also has a reduction in a level of one or more Z-ring inhibition proteins. In some embodiments, the Z ring inhibition protein is a minC polypeptide. In some embodiments, the Z ring inhibition protein is a minD polypeptide. In some embodiments, the Z ring inhibition protein is an E. coli minD polypeptide. In some embodiments, the ADAS or parent bacterium has a reduction in the level, activity, or expression of at least two Z-ring inhibition proteins. In some embodiments, the minicell producing parent bacterium has a reduction in expression of a minC polypeptide and a minD polypeptide. In some embodiments, the minicell producing parent bacterium has a reduction in expression of a minC polypeptide, a minD polypeptide, and a minE polypeptide, e.g., a deletion of the minCDE operon (ΔminCDE). In some embodiments, a minicell producing parent bacterium has a reduction in the level of RNA polymerase sigma-F factor (sigF). In some embodiments, sigF is involved in spore formation.

A reduction in the level, activity, or expression of a cell division topological specificity factor or a Z-ring inhibition protein in a parent bacterial cell, may be achieved using any suitable method. For example, in some embodiments, the reduction in the level or activity is caused by a loss-of-function mutation, e.g., a gene deletion. In some embodiments, the loss-of-function mutation is an inducible loss-of-function mutation and loss of function is induced by exposing the parent cell to an inducing condition, e.g., the inducible loss-of-function mutation is a temperature-sensitive mutation and wherein the inducing condition is a temperature condition.

In some embodiments, the parent cell has a deletion of the minCDE operon (ΔminCDE) or homologous operon.

### Increased Minicell Production Through Deletion or Mutation in a Gene Implicated in DNA Repair

In some embodiments, a parent bacterial cell has a deletion or a mutation in a gene implicated involved in DNA repair. In some embodiments, the gene involved in DNA repair is selected from the group consisting of mutS, MutH, MutL, SSB, RecA, RecJ, ExoI, ExoVII, ExoX, UvrD, and DNA polymerase III. In some embodiments, the gene involved in DNA repair is RecA and the parental cell is E. coli DH10B. In some embodiments, minicell production is increased in a bacterial cell that has a deletion or a mutation in a gene involved in DNA repair. In some embodiments, the parent bacterial cell is a gram-positive bacterial cell. In some embodiments, the parent bacterial cell is Bacillus subtilis or of the Bacillus species. In some embodiments, the parent bacterial cell is of the Lactobacillus species. In some embodiments, the parent bacterial cell is a Gram-negative bacterial cell. In some embodiments, the parent bacterial cell is from a genus of Escherichia, Acinetobacter, Agrobacterium, Anabaena, Anaplasma, Aquifex, Azoarcus, Azospirillum, Azotobacter, Bartonella, Bordetella, Bradyrhizobium, Brucella, Buchnera, Burkholderia, Candidatus, Chromobacterium, Coxiella, Crocosphaera, Dechloromonas, Desulfitobacterium, Desulfotalea, Erwinia, Francisella, Fusobacterium, Gloeobacter, Gluconobacter, Helicobacter, Legionella, Magnetospirillum, Mesorhizobium, Methylobacterium, Methylococcus, Neisseria, Nitrosomonas, Nostoc, Photobacterium, Photorhabdus, Phyllobacterium, Polaromonas, Prochlorococcus, Pseudomonas, Psychrobacter, Ralstonia, Rubrivivax, Salmonella, Shewanella, Shigella, Sinorhizobium, Synechococcus, Synechocystis, Thermosynechococcus, Thermotoga, Thermus, Thiobacillus, Trichodesmium, Vibrio, Wigglesworthia, Wolinella, Xanthomonas, Xylella, Yersinia, Bacillus, Bifidobacterium, Clostridium, Corynebacterium, Deinococcus, Enterococcus, Exiguobacterium, Geobacillus, Lactobacillus, Listeria, Leuconostoc, Moorella, Oceanobacillus, Rhizobium, Rickettsia, Staphylococcus, Streptococcus, Symbiobacterium, or Thermoanaerobacter bacteria.

### Minicells Comprising a Cargo

In some embodiments, a minicell produced by a parental bacteria as described herein includes a cargo contained in the interior of the minicell. A cargo may be any moiety disposed in the interior of a minicell (e.g., encapsulated by the minicell) or conjugated to the surface of the minicell. In some embodiments, the cargo comprises a nucleic acid, a plasmid, a polypeptide, a protein, an enzyme, an amino acid, a small molecule, a gene editing system, a hormone, an immune modulator, a carbohydrate, a lipid, an organic particle, an inorganic particle, or a ribonucleoprotein complex (RNP) or a combination of the foregoing. In some aspects, the cargo is delivered by the secretion system (e.g., T3SS). In other aspects, the cargo is not delivered by the T3SS.

In some embodiments, the cargo is a polypeptide. Polypeptides useful in agricultural applications include, for example, bacteriocins, lysins, antimicrobial peptides, nodule C-rich peptides, and bacteriocyte regulatory peptides. In some embodiments, polypeptides can be used to alter the level, activity, or metabolism of target microorganisms for increasing the fitness of insects, such as honeybees and silkworms. Examples of agriculturally useful polypeptides that may be provided as a minicell cargo include peptide toxins, such as those naturally produced by entomopathogenic bacteria e.g., Bacillus thuringiensis, Photorhabdus luminescens, Serratia entomophila, or Xenorhabdus nematophila). Embodiments of agriculturally useful polypeptides that may be provided as a minicell cargo include polypeptides (including small peptides such as cyclodipeptides or diketopiperazines) for controlling agriculturally important pests or pathogens, e.g., antimicrobial polypeptides or antifungal polypeptides for controlling diseases in plants, or pesticidal polypeptides (e.g., insecticidal polypeptides and/or nematicidal polypeptides) for controlling invertebrate pests such as insects or nematodes. Embodiments of agriculturally useful polypeptides that may be provided as a minicell cargo include antibodies, nanobodies, and fragments thereof, e.g., antibody or nanobody fragments that retain at least some (e.g., at least 10%) of the specific binding activity of the intact antibody or nanobody. Embodiments of agriculturally useful polypeptides that may be provided as a minicell cargo include transcription factors, e.g., plant transcription factors; see., e.g., the “AtTFDB” database listing the transcription factor families identified in the model plant Arabidopsis thaliana), publicly available at agris-knowledgebase[dot]org/AtTFDB/. Embodiments of agriculturally useful polypeptides that may be provided as a minicell cargo include nucleases, for example, exonucleases or endonucleases (e.g., Cas nucleases such as Cas9 or Cas12a). Embodiments of agriculturally useful polypeptides that may be provided as a minicell cargo further include cell-penetrating peptides, enzymes (e.g., amylases, cellulases, peptidases, lipases, chitinases), peptide pheromones (for example, yeast mating pheromones, invertebrate reproductive and larval signalling pheromones, see, e.g., Altstein (2004) Peptides, 25:1373-1376).

In some embodiments, the cargo is a nucleic acid. In some embodiments, the nucleic acid is a DNA, an RNA, or a plasmid. In some embodiments, the nucleic acid (e.g., DNA, RNA (e.g., mRNA, ASO, circular RNA, siRNA, shRNA, tRNA, dsRNA, or a combination thereof), or plasmid) encodes a protein. In some embodiments, the protein is transcribed and/or translated in the minicell. In some embodiments, the nucleic acid inhibits translation of a protein or polypeptide, e.g., is an siRNA or an antisense oligonucleotide (ASO).

In some embodiments, the cargo is a peptide. In some embodiments, the peptide is expressed from a vector comprising the peptide coding sequence operably linked to a promoter. In some embodiments, the promoter is an inducible promoter or a constitutive promoter. In some embodiments, the peptide is expressed from a vector comprising the peptide coding sequence operably linked to a Ptac, Ptet, or PT7 promoter. In some embodiments, the peptide is expressed from a vector comprising the peptide coding sequence operably linked to a T7, Ptac, or Ptet promoter. In some embodiments, the peptide is Cathelicidin (e.g., LL-37 (PDB: 4EYC), Fowlicidin-1 (PDB: 2AMN), CAP18 (PDB: 1LYP), Porcine Protogrin (PDB: 1KWI), SMAP29 (PDB: 1FRY)), Cecropin (e.g., Papiliocin (PDB: 2LA2), Cecropin A, Cecropin B (PDB: 2IGR), CECD (PDB: 2MMM), Cecropin P1), Defensin-beta (e.g., HBD-1 (PDB: 1E4S), HBD-2 (PDB: 1E4Q), AvBD7 (PDB: 5LCS), MBD-7 (PDB: 1E4T), MBD-8 (PDB: 1E4R)), Defensin-mammalian (e.g., HNP1 (2PM5), HD5 (PDB: 1ZMP), Crp4 (2GWP)), Frog AMP (e.g., Gaegurin-4 (PDB: 2G9L), Palustrin-Ca (PDB: 7P4X), Rantuerin-2CSA (PDB: 2K10)), esculentin, gaegurin, brevnin, rugosin, ranturein, Alpha/beta enterocin, Ant antimicrobial peptide, ponericin, Aphid Megourin, Apidaecin, Apolipoprotein A-II, Attacin, Aurein-like, Bactericidal permeability-increasing protein (BPI) 1, Bactericidal permeability-increasing protein (BPI) 2, Bacteriocin class II with double-glycine leader peptide, Bacteriocin class IIc cyclic gassericin A-like, Bacteriocin class IId cyclical uberolysin-like, Bacteriocin, heterocycloanthracin, sonorensin, Bee antimicrobial peptide, abaecin, Bombinin, Caerin 1 protein, CAP18 C terminal, Class II bacteriocin, Clavanin, Coleoptericin, Cupiennin, Cyclotide, Cystatin, Cystatin-like domain, Defensin-actinodefensins, Defensin-alpha, Defensin-beta 136, Defensin-beta 2, Defensin-beta 50, Defensin-big, Defensin-fungal copsin, Defensin-plant thionin, Defensin-scorpion-like, Defensin-like domain BmBKTx1-like, Delta lysin, Dermaseptin, Dermcidin, DUF3254, Formaecin, Frog AMP class 22, Frog AMP class 24, Frog AMP propeptide, Frog AMP: brevinin-1, esculentin-2, ranaturin-2, temporin, Gallidermin, Gibberellin regulated protein, Gloverin, GPR15L-like AMP, Granulin, Halocidin, Lactocin 705, Lactococcin 972, Lactococcin G-beta, Lactococcin G-beta, Enterocin 1071B family bacteriocin, Latarcin, Laterosporulin defensin-like peptide, LCI, Bacillus cereus group AMP, Lipid-transfer protein, Liver-expressed antimicrobial peptide 2, Macin, Mastoparan, Mastoparan 2, Meleagrin, Cygnin family, Melittin, MiAMP1, microcin-V, colicin V, Moricin, Myotoxin, crotamine, Myticin pre-proprotein, Nematode AMP 25, Ocellatin, Pardaxin, Pelovaterin, Penaeidin, Pilosulin, Plant AMP 21, Plant thionin, Platypus intermediate defensin-like peptide, Pleurocidin, Ponericin L, Potassium channel toxin, Pseudin, Ranacyclin, Saposin A-type domain, Saposin B-type domain, Saposin-like type B, region 1, Saposin-like type B, region 2, Scorpion antimicrobial peptide, SdpC, ShK domain-like, Spider antimicrobial peptide, oxyopinin, Stomoxyn, Styelin, Sublancin, Subtilosin A, Tachystatin A, Tachystatin B, Type A lantibiotic, Uperin, Vicilin N terminal region/MiAMP2, Whey Acidic Protein (WAP-type)′four-disulfide core, Peptide Domain, Antifungal Peptide (e.g., PAFP-S(PDB: 1DKC), ALO3 (1Q3J)), Antifungal Protein (e.g., PAF (PDB: 2KCN), NFAP (PDB: 50QS), PAFB (PDB: 7BAD), AFP (PDB: AFP1)), Defensin-antifungal-like (e.g., Egk (PDB: 7C2P), DEF4 (PDB: 2LR3), VvK1 (PDB: 7C31), OsAFP1 (6LCQ), PsDef1 (5NCE)), Protease inhibitor, seed storage protien, lipid-transfer protein (e.g., Lentil lipid transfer protein (5LQV), Rice nsLTP2 (1L6H), Pea lipid transfer protein (2N81), Maize amaylase inhibitor (1BEA)), Termicin (e.g., Pseudacanthotermes termicin (PDB: 1MM0), Nasutitermes termicin, Tumulitermes termicin), Barwin family, Basal layer antifungal peptide (BAP), Beta/Gamma crystallin, Chitin recognition protein, Defensin-plant gamma thionin, Diapausin, DUF1962, Hepcidin, Hevein-like AMP, Late nodulin protein, Metchnikowin, Thaumatin family, Agatoxin, purotoxin, ctenitoxin, Spider neurotoxin (e.g., Omega-agatoxin-IVA (PDB: 2NDB), Omega-agatoxin-IVB (PDB: 1AGG), Delta-palutoxin IT1 (PDB: 1V90)) Cecropin (e.g., Papiliocin (PDB: 2LA2), Cecropin A, Cecropin B (PDB: 2IGR), CECD (PDB: 2MMM), Cecropin P1), Defensin antifungal-like (e.g., Egk (PDB: 7C2P), DEF4 (PDB: 2LR3), VvK1 (PDB: 7C31), OsAFP1 (6LCQ), PsDef1 (5NCE)), Fungal fruit body lectin (e.g., Sclerotium rolfsii lectin (PDB: 2OFC), Common edible mushroom lectin (PDB: 1Y2T), Boletus edulis lectin (PDB: 3QDS)), Snake nicotinic acetylcholine receptor toxin (e.g., Ringhalexin (PDB: 4ZQY), MT7: (PDB: 3FEV), Alpha-Bungarotoxin (PDB: 1KFH), Atratoxin-b (PDB: 1ONJ)), Bulb-type mannose-specific lectin, Conotoxin, Cyclotide, D-mannose binding lectin, Huwentoxin-II family, 12-superfamily conotoxins, Insecticidal Crystal Toxin, P42, Janus-atracotoxin, Magi 5 toxic peptide family, Magi peptide toxin family, MIT-like atracotoxin family, Omega-atracotoxin, PhTx neurotoxin family, Ponericin, Ptu family, Putidacin L1 family lectin-like bacteriocin, Scorpion toxin-like, Short spider neurotoxins, Spider insecticidal peptide, Spider calcium ion channel toxins, Cry1, Cry2, Cry3, Cry4, Cyt, Cry16A, Cry17A, Cry cbm17.1, Cry cbm17.2, ISP1A, ISP2A, Mcf, MrxA, PirA, PirB, PirA, PirB, SepA, SepB, SepC, Sip, Tc complex A, Tc complex B, Tc complex C, TccC, txp40, Vip1, Vip2, Vip3, Vip3Aa, Vip3Aa14, XaxA, XaxB, XptA1, XptB1, XptC1, YenA1, YenA2, YenB, YenC1, or YenC2.

In some embodiments, the cargo is an agent that can modulate the microbiome of the target organism (e.g., a human, animal, plant, or insect microbiome), e.g., a polysaccharide, an amino acid, an anti-microbial agent (e.g., an anti-infective or antimicrobial peptide, protein, and/or natural product), a short chain fatty acid, or a combination thereof. In some examples, the agent that can modulate the host microbiome is a probiotic agent.

In some embodiments, the cargo is an enzyme. The enzyme may be an enzyme that performs a catalytic activity in a target cell or organism (e.g., in a human, animal, plant, or insect). In some embodiments, the catalytic activity is extracellular matrix (ECM) digestion (e.g., the enzyme is hyaluronidase and the catalytic activity is ECM digestion) or removal of toxins. In some embodiments, the enzyme is an enzyme replacement therapy, e.g., is phenylalanine hydroxylase. In some embodiments, the enzyme is a UDP-glucuronosyltransferase. In some embodiments, the enzyme has hepatic enzymatic activity (e.g., porphobilinogen deaminase (PBGD), e.g., human PBGD (hPBGD)). In some embodiments, the enzyme is a protease, oxidoreductase, or a combination thereof. In some embodiments, the enzyme alters a substrate to produce a target product. In some embodiments, the substrate is present in the minicell and the target product is produced in the minicell. In other embodiments, the substrate is present in a target cell or environment to which the minicell is delivered.

In certain embodiments, the cargo is modified for improved stability compared to an unmodified version of the cargo. “Stability” of a cargo is a unitless ratio of half-life of unmodified cargo and modified cargo half-life, as measured in the same environmental conditions. In some embodiments the environment is experimentally controlled, e.g., a simulated body fluid, RNAse free water, cell cytoplasm, extracellular space, or “minicell plasm” (i.e., the content of the interior volume of an minicell, e.g., after lysis). In some applications it is an agricultural environment, e.g., variable field soil, river water, or ocean water. In other embodiments, the environment is an actual or simulated environment: animal gut, animal skin, animal reproductive tract, animal respiratory tract, animal blood stream, or animal extracellular space. In certain embodiments, the minicell does not substantially degrade the cargo.

In certain embodiments, the cargo comprises a protein. In certain embodiments, the protein has stability greater than about: 1.01, 1.1, 10, 100, 1000, 10000, 100000, 100000, 10000000 in cell cytoplasm or other environments. The protein can be any protein, including growth factors; enzymes; hormones; immune-modulatory proteins; antibiotic proteins, such as antibacterial, antifungal, insecticide, proteins, etc.; targeting agents, such as antibodies or nanobodies, etc. In some embodiments, the protein is a hormone, e.g., paracrine, endocrine, autocrine.

In some embodiments, the cargo comprises a plant hormone, such as abscisic acid, auxin, cytokinin, ethylene, gibberellin, or a combination thereof.

In some embodiments, the cargo is an anti-inflammatory agent, e.g., a cytokine (e.g., a heterologously expressed anti-inflammatory cytokine or mutein thereof (e.g., IL-10, TGF-Beta, IL-22, IL-2) or antibody (e.g., an antibody or antibody fragment targeting tumor necrosis factor (TNF) (e.g., an anti-TNF antibody); an antibody or antibody fragment targeting IL-12 (e.g., an anti-IL-12 antibody); or an antibody or antibody fragment targeting IL-23 (e.g., an anti-IL-23 antibody).

In certain embodiments, the cargo is an immune modulator. Immune modulators include, e.g., immune stimulators; checkpoint inhibitors (e.g., inhibitors of PD-1, PD-L1, or CTLA-4); chemotherapeutic agents; immune suppressors; antigens; super antigens; and small molecules (e.g., cyclosporine A, cyclic dinucleotides (CDNs), or STING agonists (e.g., MK-1454)). In some embodiments, the immune modulator is a moiety that induces tolerance in a subject, e.g., an allergen, a self-antigen (e.g., a disease-associated self-antigen), or a microbe-specific antigen. In some embodiments, the immune modulator is a vaccine, e.g., an antigen from a pathogen (e.g., a virus (e.g., a viral envelope protein) or a bacteria). In some embodiments, the antigen is a cancer neo-antigen. In some embodiments, the pathogen is a coronavirus, e.g., SARS-CoV-2. In some embodiments, the cargo an adjuvant, e.g., an immunomodulatory molecule or a molecule that alters the compartmentalization, presentation, or profile of one or more co-stimulatory molecules associated with a vaccine antigen. In some examples, the adjuvant is an activator of an immune pathway upstream of a desired immune response (e.g., an activator of an innate immune pathway upstream of an adaptive immune response). In other examples, the adjuvant enhances the presentation of an antigen on an immune cell or immune moiety (e.g., MHC class 1) in the target organism. In some examples, the adjuvant is listeriolysin O (LLO). In some embodiments, a minicell comprises an antigen and one or more adjuvants.

In some embodiments, the cargo is an agent for treatment or prevention of a cancer, e.g., an agent that decreases the likelihood that a patient will develop a cancer or an agent that treats a cancer (e.g., an agent that increases progression-free survival and/or overall survival in an individual having a cancer). Agents for the prevention of cancer include, but are not limited to anti-inflammatory agents and growth inhibitors. Agents for the treatment of cancer (e.g., a solid tumor cancer) include, but are not limited to anti-inflammatory agents, growth inhibitors, chemotherapy agents, immunotherapy agents, anti-cancer antibodies or antibody fragments (e.g., antibodies or antibody fragments targeting cancer antigens (e.g., cancer neo-antigens)), cancer vaccines (e.g., vaccines comprising a cancer neo-antigen), agents that induce autophagy (e.g., activators such as listeria-lysin-o), cytotoxins, inflammasome inhibiting agents, immune checkpoint inhibitors (e.g., inhibitors of PD-1, PD-L1, or CTLA-4), transcription factor inhibitors, and agents that disrupt the cytoskeleton.

In some embodiments, the cargo is an RNA, such as circular RNA, mRNA, siRNA, shRNA, ASO, tRNA, dsRNA, or a combination thereof. In certain embodiments, the RNA has stability greater than about: 1.01, 1.1, 10, 100, 1000, 10000, 100000, 100000, 10000000, e.g., in minicell cytoplasm. The RNA cargo can be stabilized, in certain embodiments, e.g., with an appended step-loop structure, such as a tRNA scaffold. For example, non-human tRNALys3 and E. coli tRNAMet (Nat. Methods, Ponchon 2007). Both have been well characterized and expressed recombinantly. However, a variety of other types could be used as well, such as aptamers, lncRNA, ribozymes, etc. RNA can also be stabilized where the minicell is obtained from a parental strain null (or hypomorphic) for one or more ribonucleases. In some particular embodiments, the RNA is a protein-coding mRNA. In more particular embodiments, the protein-coding mRNA encodes an enzyme (e.g., and enzyme that imparts hepatic enzymatic activity, such as human PBGD (hPBGD) mRNA) or an antigen, e.g., that elicits an immune response (such as eliciting a potent and durable neutralizing antibody titer), such as mRNA encoding CMV glycoproteins gB and/or pentameric complex (PC)). In certain particular embodiments, the RNA is a small non-coding RNA, such as shRNA, ASO, tRNA, dsRNA, or a combination thereof.

### Minicells Comprising a Secretion System

In certain embodiments, a minicell comprises a bacterial secretion system (e.g., an endogenous bacterial secretion system or a heterologous secretion system). A “bacterial secretion system” is a protein, or protein complex, that can export a cargo from the cytoplasm of a bacterial cell (or, for example, a minicell derived therefrom). In some embodiments, the bacterial secretion system works by an active (e.g., ATP-dependent or PMF-dependent) process, and in certain embodiments the bacterial secretion system comprises a tube or a spike spanning the host cell (or minicell) to a target cell. In other embodiments the bacterial secretion system is a transmembrane channel. Examples of bacterial secretion systems that may be comprised in a minicell include T3SS and T4SS (and T3/T4SS, as defined, below), which are tube-containing structures where the cargo traverses through the inside of a protein tube and T6SS, which carries the cargo at the end of a spike. Other examples of bacterial secretion systems which may be comprised in a minicell include T1SS, T2SS, T5SS, T7SS, Sec, and Tat, which are transmembrane.

In some embodiments, the parent bacterial cell comprises one or more heterologous nucleotide sequences encoding the components of the T3SS. In some embodiments, the one or more nucleotide sequences encoding the components of the T3SS are carried on a vector. In some embodiments, the parent bacterial cell has been transiently transformed with the vector. In some embodiments, the parent bacterial cell has been stably transformed with the vector. In some embodiments, the parent bacterial cell further comprises a moiety that increases the level of the T3SS in the minicell.

In some embodiments, a minicell is derived from a parent bacterial cell comprising a bacterial Type 3 secretion system (T3SS) that is endogenous to the parent bacterial cell. In some embodiments, the parent bacterial cell has been modified to reduce the level of an endogenous protein or polypeptide capable of being secreted by the T3SS. In some embodiments, the parent cell bacterial has been modified by deleting a transcriptional activator of the endogenous protein or polypeptide capable of being secreted by the T3SS.

Minicells Lacking Proteases, RNases, and/or LPS

Several embodiments relate to a composition comprising a plurality of minicells, wherein the minicells have a reduced protease level or activity relative to a minicell produced from a wild-type parent bacterium. In some aspects, the minicell is produced from a parent bacterium that has been modified to reduce or eliminate expression of at least one protease.

In some embodiments, a minicell has a reduced RNAse level or activity relative to a minicell produced from a wild-type parent bacterium. In some aspects, the minicell is produced from a parent bacterium that has been modified to reduce or eliminate expression of at least one RNAse. In some embodiments, the RNase is an endoribonuclease or an exoribonuclease.

In another aspect, a minicell producing parental cell and/or minicell has been modified to have reduced lipopolysaccharide (LPS). In some embodiments, the modification is a mutation in Lipid A biosynthesis myristoyltransferase (msbB).

In certain embodiments, a minicell lacks one or more metabolically non-essential proteins. A “metabolically non-essential protein” non-exhaustively includes: fimbriae, flagella, undesired secretion systems, transposases, effectors, phage elements, or their regulatory elements, such as flhC or OmpA. In some embodiments, a minicell lacks one or more of an RNAse, a protease, or a combination thereof, and, in particular embodiments, lacks one or more endoribonucleases (such as RNAse A, RNAse H, RNAse III, RNAse L, RNAse PhyM) or exoribonucleases (such as RNAse R, RNAse PH, RNAse D); or serine, cysteine, threonine, aspartic, glutamic and metallo-proteases; or a combination of any of the foregoing.

### Minicells Comprising Additional Moieties

A minicell, in certain embodiments, includes a functional ATP synthase and, in some embodiments, a membrane embedded proton pump. Minicells can be derived from different sources including: a parental bacterial strain (“parental strain”) engineered or induced to produce genome-free enclosed membrane systems, a genome-excised bacterium, a bacterial cell preparation extract (e.g., by mechanical or other means), or a total synthesis, optionally including fractions of a bacterial cell preparation. In some embodiments, a minicell has an ATP synthase concentration of at least: 1 per 10000 nm2, 1 per 5000 nm2, 1 per 3500 nm2, 1 per 1000 nm2.

Minicells can include a variety of additional components, including, for example, photovoltaic pumps, retinals and retinal-producing cassettes, metabolic enzymes, targeting agents, cargo, bacterial secretion systems, and transporters, including combinations of the foregoing, including certain particular embodiments described, below. In certain embodiments, minicells and/or minicell producing parental cells lack other elements, such as metabolically non-essential genes and/or certain enzymes, nucleases or proteases.

In certain embodiments, a minicell and/or minicell producing parental cell comprises an ATP synthase, optionally lacking a regulatory domain, such as lacking an epsilon domain. Deletion can be accomplished by a variety of means. In certain embodiments, the deletion in by inducible deletion of the native epsilon domain. In certain embodiments, deletion can be accomplished by flanking with LoxP sites and inducible Cre expression or CRISPR knockout, or be inducible (place on plasmid under a tTa tet transactivator in an ATP synthase knockout strain)

In some embodiments, a minicell and/or minicell producing parental cell can include a photovoltaic proton pump. In certain embodiments, the photovoltaic proton pump is a proteorhodopsin. In more particular embodiments, the proteorhodopsin comprises the amino acid sequence of proteorhodopsin from the uncultured marine bacterial clade SAR86, GenBank Accession: AAS73014.1. In other embodiments, the photovoltaic proton pump is a gloeobacter rhodopsin. In certain embodiments, the photovoltaic proton pump is a bacteriorhodopsin, deltarhodopsin, or halorhodopsin from Halobium salinarum, Natronomonas pharaonis, Exiguobacterium sibiricum, Haloterrigena turkmenica, or Haloarcula marismortui.

In some embodiments, minicell and/or minicell producing parental cell further comprising retinal. In certain embodiments, minicell and/or minicell producing parental cell comprises a retinal synthesizing protein (or protein system), or a nucleic acid encoding the same.

In certain embodiments, minicell and/or minicell producing parental cell comprises one or more glycolysis pathway proteins. In some embodiments, the glycolysis pathway protein is a phosphofructokinase (Pfk-A), e.g., comprising the amino acid sequence of UniProt accession POA796 or a functional fragment thereof. In other embodiments the glycolysis pathway protein is triosephosphate isomerase (tpi), e.g., comprising the amino acid sequence of UniProt accession POA858, or a functional fragment thereof.

### Minicell Compositions and Formulations

Several embodiments relate to compositions or preparations that contain a minicell as described herein, including, inter alia, a minicell preparation wherein a plurality of individual minicells lack a cell division topological specificity factor, e.g., lack a minE gene product, and optionally wherein the minicell preparation is substantially free of viable cells. In some embodiments, a minicell composition contains at least about: 80, 81, 82, 83, 84, 85, 90, 95, 96, 97, 98, 99, 99.1, 99.2, 99.3, 99.4, 99.5, 99.6, 99.7, 99.8, 99.9%, or more minicells that contain a bacterial secretion system. In particular embodiments, the bacterial secretion system is one of T3SS, T4SS, T3/4SS, or T6SS. In some embodiments, a minicell composition contains minicells that contain a T3SS, where the minicells comprise a mean T3SS membrane density greater than 1 in about: 40000, 35000, 30000, 25000, 19600, 15000, 10000, or 5000 nm2. In certain particular embodiments, the minicell is derived from a Agrobacterium tumefaciens, S. typhimurium or E. coli parental strain. In some embodiments, a minicell composition comprises at least about: 80, 81, 82, 83, 84, 85, 90, 95, 96, 97, 98, 99, 99.1, 99.2, 99.3, 99.4, 99.5, 99.6, 99.7, 99.8, 99.9%, or more of minicells containing a bacterial secretion system, including T3, T4, T3/4SS, T6SS, and optionally including one or more of: exogenous carbohydrates, phosphate producing synthases, light responsive proteins, import proteins, enzymes, functional cargo, organism-specific effectors, fusion proteins.

Minicell compositions can be prepared in any suitable formulation. For example, the formulation can be suitable for IP, IV, IM, oral, topical (cream, gel, ointment, transdermal patch), aerosolized, or nebulized administration. In some embodiments, a formulation is a liquid formulation. In other embodiments, the formulation is a lyophilized formulation.

In some embodiments, a minicell composition described herein comprises less than 100 colony-forming units (CFU/mL) of viable bacterial cells, e.g., less than 50 CFU/mL, less than 20 CFL/mL, less than 10 CFU/mL, less than 1 CFU/mL, or less than 0.1 CFU/mL of viable bacterial cells.

In some embodiments, a minicell composition comprises minicells that are lyophilized and reconstituted, and wherein the reconstituted minicells have an ATP concentration that is at least 90% of the ATP concentration of a minicell that has not been lyophilized, e.g., at least 95%, 98%, or at least equal to the ATP concentration of a minicell that has not been lyophilized.

Several embodiments relate to a minicell composition wherein the minicells are stored, e.g., stored at 4° C., wherein after storage, the minicells have an ATP concentration that is at least 90% of the ATP concentration of a minicell that has not been stored, e.g., at least 95%, 98%, or at least equal to the ATP concentration of a minicell that has not been stored. In some embodiments, the storage is for at least one day, at least one week, at least two weeks, at least three weeks, at least one month, at least two months, at least six months, or at least a year.

In some embodiments, minicells may be preserved or otherwise in a “quiescent” state and then rapidly become activated.

In some embodiments, a minicell composition is formulated for delivery to an animal, e.g., formulated for intraperitoneal, intravenous, intramuscular, oral, topical, aerosolized, or nebulized administration.

In some embodiments, a minicell composition is formulated for delivery to a plant. In some aspects, the composition includes an adjuvant, e.g., a surfactant (e.g., a nonionic surfactant, a surfactant plus nitrogen source, an organo-silicone surfactant, or a high surfactant oil concentrate), a crop oil concentrate, a vegetable oil concentrate, a modified vegetable oil, a nitrogen source, a deposition (drift control) and/or retention agent (with or without ammonium sulfate and/or defoamer), a compatibility agent, a buffering agent and/or acidifier, a water conditioning agent, a basic blend, a spreader-sticker and/or extender, an adjuvant plus foliar fertilizer, an antifoam agent, a foam marker, a scent, or a tank cleaner and/or neutralizer. In some embodiments, the adjuvant is an adjuvant described in the Compendium of Herbicide Adjuvants (Young et al. (2016). Compendium of Herbicide Adjuvants (13th ed.), Purdue University).

In some embodiments, a minicell composition is formulated for delivery to an invertebrate, (e.g., arthropod (e.g., insect or arachnid), nematode, protozoan, or annelid). In some embodiments, a minicell composition is formulated for delivery to an insect.

In some embodiments, a minicell composition is formulated as a liquid, a solid, an aerosol, a paste, a gel, or a gas composition.

### Making Minicells

In some aspects, production of minicells features a method for manufacturing a composition comprising a plurality of minicells, the composition being substantially free of viable bacterial cells, the method comprising (a) making, providing, or obtaining a plurality of parent bacteria having a reduction in the level or activity of a cell division topological specificity factor; (b) exposing the parent bacteria to conditions allowing the formation of a minicell; and (c) separating the minicells from the parent bacteria, thereby producing a composition that is substantially free of viable bacterial cells.

Parent bacteria include any suitable bacterial species from which a minicell may be generated (e.g., species that may be modified using methods described herein to produce minicells). The following provides a non-limiting list of suitable genera from which minicells and/or minicell producing parent cells can be derived: Escherichia, Acinetobacter, Agrobacterium, Anabaena, Anaplasma, Aquifex, Azoarcus, Azospirillum, Azotobacter, Bartonella, Bordetella, Bradyrhizobium, Brucella, Buchnera, Burkholderia, Candidatus, Chromobacterium, Coxiella, Crocosphaera, Dechloromonas, Desulfitobacterium, Desulfotalea, Erwinia, Francisella, Fusobacterium, Gloeobacter, Gluconobacter, Helicobacter, Legionella, Magnetospirillum, Mesorhizobium, Methylobacterium, Methylococcus, Neisseria, Nitrosomonas, Nostoc, Photobacterium, Photorhabdus, Phyllobacterium, Polaromonas, Prochlorococcus, Pseudomonas, Psychrobacter, Ralstonia, Rubrivivax, Salmonella, Shewanella, Shigella, Sinorhizobium, Synechococcus, Synechocystis, Thermosynechococcus, Thermotoga, Thermus, Thiobacillus, Trichodesmium, Vibrio, Wigglesworthia, Wolinella, Xanthomonas, Xylella, Yersinia, Bacillus, Bifidobacterium, Clostridium, Corynebacterium, Deinococcus, Enterococcus, Exiguobacterium, Geobacillus, Lactobacillus, Listeria, Leuconostoc, Moorella, Oceanobacillus, Rhizobium, Rickettsia, Staphylococcus, Streptococcus Symbiobacterium, or Thermoanaerobacter.

In some aspects, methods for manufacturing any of the minicell compositions described herein are provided. For example, provided herein are methods for making minicells and/or minicell producing parent cells; methods for making minicells and/or minicell producing parent cells lacking a cell division topological specificity factor and, optionally, lacking a Z-ring inhibition protein (e.g., methods of making minicells from ΔminCDE parent bacteria), and methods for making any of the minicells and/or minicell producing parent cells mentioned herein, wherein the minicell comprises a cargo.

In some embodiments, minicells are made from a parental strain that is a plant bacterium, such as a plant commensal bacterium (e.g., Bacillus subtilis or Pseudomonas putida), a plant pathogen bacterium (e.g., Xanthomonas sp. or Pseudomonas syringae), or a bacterium that is capable of plant rhizosphere colonization and/or root nodulation, e.g., a Rhizobia bacterium.

In some embodiments, minicells are made from a parental strain that is a symbiont of an invertebrate, e.g., a symbiont of an arthropod (e.g., insect or arachnid), nematode, protozoan, or annelid. In embodiments, the invertebrate is a pest or a pathogen of a plant or of an animal.

In some embodiments, minicells are made from a parental strain that is capable of genetic transformation, e.g., Agrobacterium.

In some embodiments, minicells are made from a parent strain that is a human bacterium, such as a commensal human bacterium (e.g., E. coli, Staphylococcus sp., Bifidobacterium sp., Micrococcus sp., Lactobacillus sp., or Actinomyces sp.) or a pathogenic human bacterium (e.g., Escherichia coli EHEC, Salmonella typhimurium, Shigella flexneri, Yersinia enterolitica, or Helicobacter pylori), or an extremophile.

In some embodiments, the minicells and/or minicell producing parent strain is a functionalized derivative of any of the foregoing, for example including a functional cassette, such as a functional cassette that induces the bacterium to do one or more of: secrete antimicrobials, digest plastic, secrete insecticides (e.g., insecticidal peptides such as Pir, Bt, Cry, etc.), survives extreme environments, make nanoparticles, integrate within other organisms, respond to the environment, and create reporter signals.

Parent bacteria may include functionalized derivatives of any of the foregoing, for example including a functional cassette, such as a functional cassette that induces the bacterium to do one or more of: secrete antimicrobials, digest plastic, secrete insecticides (e.g., insecticidal peptides such as Pir, Bt, Cry, etc.), survives extreme environments, make nanoparticles, integrate within other organisms, respond to the environment, and create reporter signals.

In some embodiments, a minicell is derived from a parental strain engineered or induced to overexpress ATP synthase. In some more particular embodiments, the ATP synthase is heterologous to the parental strain. In certain particular embodiments, the parental strain is modified to express a functional FoF1 ATP synthase.

In certain embodiments, a minicell is obtained from a parental strain cultured under a condition selected from: applied voltage (e.g., 37 mV), non-atmospheric oxygen concentration (e.g., 1-5% O2, 5-10% O2, 10-15% O2, 25-30% O2), low pH (about: 4.5, 5.0, 5.5, 6.0, 6.5), or a combination thereof.

In some embodiments, a minicell is made from an extremophile, including functionalized derivatives of any of the foregoing, for example including a functional cassettes, such as a functional cassette that induces the bacterium to do one or more of: secrete antimicrobials, digest plastic, secrete insecticides, survives extreme environments, make nanoparticles, integrate within other organisms, respond to the environment, and create reporter signals.

Owing to the diversity of bacterium, minicells and/or minicell producing parent strain can be made with modified membranes, e.g., to improve the biodistribution of the minicells upon administration to a target cell. In certain embodiments, the membrane is modified to be less immunogenic or immunostimulatory in plants or animals. For example, in certain embodiments, the minicell is obtained from a parental strain, wherein the immunostimulatory capabilities of the parental strain are reduced or eliminated through post-production treatment with detergents, enzymes, or functionalized with PEG. In certain embodiments, the minicell is made from a parental strain and the membrane is modified through knockout of LPS synthesis pathways in the parental strain, e.g., by knocking out msbB. In other particular embodiments, the minicell is made from a parental strain that produces cell wall-deficient particles through exposure to hyperosmotic conditions.

In some embodiments, the methods include transforming a parental strain with an inducible DNAse system, such as the exoI (NCBI GeneID: 946529) & sbcD (NCBI GeneID: 945049) nucleases, or the I-CeuI (e.g., Swissprot: P32761.1) nuclease. In more particular embodiments, the methods include using a single, double, triple, or quadruple auxotrophic strain and having the complementary genes on the plasmid encoding the inducible nucleases.

In some embodiments, the parental strain is cultured under a condition selected from: applied voltage (e.g., 37 mV), non-atmospheric oxygen concentration (e.g., 1-5% O2, 5-10% O2, 10-15% O2, 25-30% O2), low pH (4.5-6.5), or a combination thereof.

In certain embodiments, the parental strain lacks flagella and undesired secretion systems, optionally where the flagella and undesired secretion systems are removed using lambda red recombineering. In some embodiments, flagella control components are excised from the parental strain genome via, for example, insertion of a plasmid containing a CRISPR domain that is targeted towards flagella control genes, such as flhD and flhC.

In certain embodiments, the parental strain comprises a cargo. In some embodiments, the parent strain contains a nucleic acid sequence encoding a set of genes that synthesize a small molecule cargo.

### Insecticidal Compositions and Formulations Thereof

An aspect of the disclosure includes a composition including: a liquid carrier phase; and a plurality of minicells dispersed in the carrier phase, wherein the plurality of minicells includes a mixture of a first minicell including a first effective amount of a first exogenous protein toxin including Pir and a second minicell including a second effective amount of a second exogenous protein toxin including Cry, wherein the first effective amount and the second effective amount are present at a ratio in the range of about 50:1-1:50. The ratio may be about 50:1, 45:1, 40:1, 35:1, 30:1, 25:1, 20:1, 15:1, 10:1, 5:1, 1:1, 1:5, 1:10, 1:15, 1:20, 1:25, 1:30, 1:35, 1:40, 1:45, or 1:50. In some embodiments of this aspect, the first effective amount and the second effective amount are present at a ratio of about 46:1, 23:1, 11:1, 9:1, 6:1, 5:1, 3:1, or 1:1. In further embodiments of this aspect, which may be combined with any of the preceding embodiments, the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest. The synergistic effect allows a lower effective amount of each exogenous protein toxin to be used, while maintaining their efficacy in agricultural applications. In other embodiments of this aspect, which may be combined with any of the preceding embodiments, a first particle concentration of the first minicell is in the range of about 1×10² to about 8×10¹⁴, and wherein a second particle concentration of the second minicell is in the range of about 1×10² to about 8×10¹⁴. In some embodiments of this aspect, which may be combined with any of the preceding embodiments, administering the composition to the insect pest includes an administration method selected from the group of delivering the composition to the insect pest for ingestion; contacting the insect pest with the composition; delivering the composition to at least one habitat where the insect pest grows, lives, reproduces, feeds, or infests; or applying the composition to a plant. In further embodiments of this aspect, the composition is applied to the plant as at least one of a foliar treatment, an injection treatment, a pre-emergence treatment, and a post-emergence treatment. In other embodiments of this aspect, which may be combined with any of the preceding embodiments, the composition is formulated as at least one of a Ready To Use (RTU) formulation, a suspension concentrate, a tank-mix, an aerosol, a seed treatment, a root dip, a soil treatment, an irrigation formulation, a sprinkler formulation, and a drench treatment.

In some embodiments of this aspect, which may be combined with any of the preceding embodiments, the first exogenous protein toxin includes PirAB or a functional component thereof. In further embodiments of this aspect, PirAB includes a PirA selected from the group of SEQ ID NO: 143, SEQ ID NO: 146, SEQ ID NO: 147, SEQ ID NO: 154, SEQ ID NO: 157, SEQ ID NO: 161, SEQ ID NO: 163, SEQ ID NO: 164, SEQ ID NO: 165, SEQ ID NO: 167, SEQ ID NO: 168, SEQ ID NO: 169, SEQ ID NO: 170, SEQ ID NO: 171, SEQ ID NO: 174, SEQ ID NO: 174, SEQ ID NO: 186, SEQ ID NO: 190, SEQ ID NO: 192, SEQ ID NO: 197, SEQ ID NO: 199, SEQ ID NO: 202, or SEQ ID NO: 203; and a PirB selected from the group of SEQ ID NO: 144, SEQ ID NO: 145, SEQ ID NO: 148, SEQ ID NO: 149, SEQ ID NO: 150, SEQ ID NO: 153, SEQ ID NO: 158, SEQ ID NO: 159, SEQ ID NO: 160, SEQ ID NO: 162, SEQ ID NO: 166, SEQ ID NO: 172, SEQ ID NO: 177, SEQ ID NO: 178, SEQ ID NO: 179, SEQ ID NO: 180, SEQ ID NO: 181, SEQ ID NO: 182, SEQ ID NO: 183, SEQ ID NO: 184, SEQ ID NO: 185, SEQ ID NO: 187, SEQ ID NO: 188, SEQ ID NO: 189, SEQ ID NO: 191, SEQ ID NO: 193, SEQ ID NO: 194, SEQ ID NO: 195, SEQ ID NO: 196, SEQ ID NO: 198, SEQ ID NO: 201, or SEQ ID NO: 204, or a functional component of any thereof. In additional embodiments of this aspect, the PirAB includes the PirA including SEQ ID NO: 203 and the PirB including SEQ ID NO: 204, or PirAB includes the PirA including SEQ ID NO: 197 and the PirB including SEQ ID NO: 178.

In some embodiments of this aspect, which may be combined with any of the preceding embodiments, the second exogenous protein toxin includes Cry1A, Cry1B, Cry1C, Cry1D, Cry1E, Cry1F, Cry1G, Cry1H, Cry1I, Cry1J, or Cry1K or a functional component thereof. In further embodiments of this aspect, the Cry1A includes a Cry1A selected from the group of SEQ ID NO: 105, SEQ ID NO: 106, SEQ ID NO: 107, SEQ ID NO: 108, SEQ ID NO: 109, SEQ ID NO: 110, SEQ ID NO: 111, SEQ ID NO: 112, SEQ ID NO: 113, SEQ ID NO: 114, SEQ ID NO: 115, SEQ ID NO: 151, SEQ ID NO: 152, or SEQ ID NO: 205; the Cry1B includes a Cry1B selected from the group of SEQ ID NO: 117, SEQ ID NO: 118, SEQ ID NO: 119, SEQ ID NO: 120, SEQ ID NO: 121, SEQ ID NO: 122, or SEQ ID NO: 155; the Cry1C includes a Cry1C selected from the group of SEQ ID NO: 123, SEQ ID NO: 124, SEQ ID NO: 125, or SEQ ID NO: 156; the Cry1D includes a Cry1D selected from the group of SEQ ID NO: 126, SEQ ID NO: 127, SEQ ID NO: 175, or SEQ ID NO: 176; the Cry1E includes a Cry1E selected from the group of SEQ ID NO: 128 or SEQ ID NO: 129; the Cry1F includes a Cry1F selected from the group of SEQ ID NO: 130 or SEQ ID NO: 131; the Cry1G includes a Cry1G selected from the group of SEQ ID NO: 132 or SEQ ID NO: 133; the Cry1H includes a Cry1H selected from the group of SEQ ID NO: 134 or SEQ ID NO: 135; the Cry1I includes a Cry1I selected from the group of SEQ ID NO: 136, SEQ ID NO: 137, SEQ ID NO: 138, or SEQ ID NO: 139; the Cry1J includes a Cry1J selected from the group of SEQ ID NO: 140 or SEQ ID NO: 141; or the Cry1K includes SEQ ID NO: 142, or a functional component of any thereof. In additional embodiments of this aspect, the second exogenous protein toxin includes the Cry1A including SEQ ID NO: 205.

In further embodiments of this aspect, which may be combined with any of the preceding embodiments, the first minicell includes a first vector including a coding sequence of the first exogenous protein toxin. In further embodiments of this aspect, the first vector includes a CloDF origin of replication or a pMB1 origin of replication. In additional embodiments of this aspect, which may be combined with any of the preceding embodiments that has a first vector, the coding sequence of the first exogenous protein toxin is operably linked to a first promoter. In other embodiments of this aspect, the first promoter is an inducible promoter or a constitutive promoter. In some embodiments of this aspect, the inducible promoter includes Ptac, Ptet, or PT7. In some embodiments of this aspect, the constitutive promoter includes J23119 (SEQ ID NO: 200). In additional embodiments of this aspect, which may be combined with any of the preceding embodiments that has a first vector, the first exogenous protein toxin includes a PirAB, wherein PirAB includes the PirA including SEQ ID NO: 203 and the PirB including SEQ ID NO: 204, and wherein the coding sequence of the PirA includes SEQ ID NO: 102 and the coding sequence of the PirB includes SEQ ID NO: 103. In further embodiments of this aspect, which may be combined with any of the preceding embodiments that has a first vector and an inducible promoter, expression of the first exogenous protein toxin is induced with aTc or IPTG.

In further embodiments of this aspect, which may be combined with any of the preceding embodiments, the second minicell includes a second vector including a coding sequence of the second exogenous protein toxin. In further embodiments of this aspect, the second vector includes a CloDF origin of replication or a pMB1 origin of replication. In additional embodiments of this aspect, which may be combined with any of the preceding embodiments that has a second vector, the coding sequence of the second exogenous protein toxin is operably linked to a second promoter. In other embodiments of this aspect, the second promoter is an inducible promoter or a constitutive promoter. In some embodiments of this aspect, the inducible promoter includes Ptac, Ptet, or PT7. In some embodiments of this aspect, the constitutive promoter includes J23119 (SEQ ID NO: 200). In additional embodiments of this aspect, which may be combined with any of the preceding embodiments that has a second vector, the second exogenous protein toxin includes a Cry1A, wherein the Cry1A includes SEQ ID NO: 205, and wherein the coding sequence of the Cry1A includes SEQ ID NO: 104. In further embodiments of this aspect, which may be combined with any of the preceding embodiments that has a second vector and an inducible promoter, expression of the second exogenous protein toxin is induced with aTc or IPTG.

Another aspect of the disclosure includes a composition including: a liquid carrier phase; a plurality of minicells dispersed in the carrier phase, wherein the plurality of minicells includes a first effective amount of an exogenous protein toxin including Pir; and a second effective amount of a Bt-derived AI, wherein the first effective amount and the second effective amount are present at a ratio in the range of about 50:1-1:50. The ratio may be about 50:1, 45:1, 40:1, 35:1, 30:1, 25:1, 20:1, 15:1, 10:1, 5:1, 1:1, 1:5, 1:10, 1:15, 1:20, 1:25, 1:30, 1:35, 1:40, 1:45, or 1:50. In some embodiments of this aspect, the first effective amount and the second effective amount are present at a ratio of about 23:1, 22:1, 11:1, 6:1, 3:1, 2:1, or 1.5:1. In further embodiments of this aspect, which may be combined with any of the preceding embodiments, the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest. The synergistic effect allows a lower effective amount of each active ingredient (e.g., exogenous protein toxin; Bt-derived AI) to be used, while maintaining their efficacy in agricultural applications. In other embodiments of this aspect, which may be combined with any of the preceding embodiments, a particle concentration of the minicell is in the range of about 1×10² to about 8×10¹⁴. In additional embodiments of this aspect, which may be combined with any of the preceding embodiments, the Bt-derived AI includes at least one of Bacillus thuringiensis, its fermentation solids, its spores, and its insecticidal toxins. In yet further embodiments of this aspect, which may be combined with any of the preceding embodiments, the Bt-derived AI includes at least two, at least three, or all of Bacillus thuringiensis, its fermentation solids, its spores, and its insecticidal toxins. In some embodiments of this aspect, which may be combined with any of the preceding embodiments, administering the composition to the insect pest includes an administration method selected from the group of delivering the composition to the insect pest for ingestion; contacting the insect pest with the composition; delivering the composition to at least one habitat where the insect pest grows, lives, reproduces, feeds, or infests; or applying the composition to a plant. In further embodiments of this aspect, the composition is applied to the plant as at least one of a foliar treatment, an injection treatment, a pre-emergence treatment, and a post-emergence treatment. In other embodiments of this aspect, which may be combined with any of the preceding embodiments, the composition is formulated as at least one of a Ready To Use (RTU) formulation, a suspension concentrate, a tank-mix, an aerosol, a seed treatment, a root dip, a soil treatment, an irrigation formulation, a sprinkler formulation, a drench treatment, a dust, an emulsifiable concentrate, a flowable concentrate, a formulation intermediate, a granular formulation, an impregnated materials formulation, a pelleted/tableted formulation, a soluble concentrate formulation, a technical chemical formulation, a water dispersable granule formulation, a water soluble packaging formulation, or a wettable powder formulation.

In some embodiments of this aspect, which may be combined with any of the preceding embodiments, the exogenous protein toxin includes PirAB or a functional component thereof. In further embodiments of this aspect, PirAB includes a PirA selected from the group of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, or SEQ ID NO: 32; and a PirB selected from the group of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, or SEQ ID NO: 58, or a functional component of any thereof. In additional embodiments of this aspect, the PirAB includes the PirA including SEQ ID NO: 4 and the PirB including SEQ ID NO: 5, or wherein PirAB includes the PirA including SEQ ID NO: 6 and the PirB including SEQ ID NO: 7. In yet further embodiments of this aspect, PirAB includes a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and wherein PirA is linked to a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58 by a linker sequence. The linker sequence will be of a structure sufficient to enable the fusion to perform insecticidal activity in the range of 0.7X to 1.5X, wherein X is the insecticidal activity of the same PirA and PirB that are unlinked. An exemplary linker may include (Gly₄Ser)₃ (SEQ ID NO: 59), SEQ ID NO: 60, SEQ ID NO: 61, SEQ ID NO: 62, SEQ ID NO: 63, or SEQ ID NO: 64.

In some embodiments of this aspect, which may be combined with any of the preceding embodiments, the Bt-derived AI includes a Bt-derived biological control product selected from the group of Thuricide®, Thuricide® HPC-O RTU, Thuricide® HPC, Thuricide® 48 LV Forestry, Thuricide® 76B, Thuricide® 76 LV, Bonide Bacillus Thuringiensis (BT) Moth Larvae (Caterpillar) Control, DiPel®, Security BT Dust Biological Insecticide, Fertilome Dipel Dust Biological Insecticide, Widestrike®, Plant Pesticide B.T. subsp. tenebrionis Colorado Potato Beetle Protein, SA-50 brand DiPel® dust, Ringer® Vegetable Insect Attack®, Bonide DiPel® 150 Dust For Vegetables, Green Light® DiPel® Dust, Green Light® BT Worm Killer, BT Sulfur 15-50 Dust, NEU1701I, FourStar® Briquets, FourStar® CRG, Britz Bt 25 Sulfur Dust, Thuricide® 32LV, Bonide Mosquito Beater® Water Soluble Pouches, Britz BT Dust, Summit Fallout Bti Granules, WDiPel® 10G Sweet Corn Granules, DiPel® 10G Biological Insecticide Granules, DiPel® SG Plus Biological Insecticide Sand Granule, DiPel® 6L Worm Killer, VectoBac® G Biological Larvicide Granules, VectoBac® GR, Summit Mosquito Bits®, Mosquito Bits®, BMP 144 (200 G), Bti Granular Larvicide, FourStar® MBG, DiPel® 8L Worm Killer, TERROR Larvacide, VectoMax® FG Biological Larvicide Fine Granule, Chemsico Insect Granules ML, VectoBac® FG Biological Larvicide Granules, Bti Granules, RF2230 D-Granules, RF2248 U-Granules, AllPro Sustain BCG, BMP 144 (400 G), VectoPrime® FG Biological Larvicide Fine Granules, VectoBac® FG+Biological Larvicide Fine Granule, VectoBac® AS, DiPel® WP Home & Garden Insecticide, DiPel® Bio Garden Spray, WideStrike®, Meridian-02, BMP 144 (2X), grubGONE!® G, Bioprotec, Bioprotec Plus, Bioprotec HP, Bioprotec Caterpillar Insecticide Concentrate, BES0531, Novodor Biological Insecticide Flowable Concentrate, FourStar® Bti CRG, VBC-60092 (Bactimos Briquette), Summit B.t.i. BRIQUETS, Dunks, Sympatico Biological Insecticide, XenTari® AS Biological Insecticide Aqueous Suspension, B402 Biological Larvicide, VectoBac® 12 AS Biological Larvicide Aqueous Suspension, VectoBac® SC Biological Larvicide, BMP 144 (3X), CMP 123 (48 LC), Bactimos PT, Foray 48B, Foray 48BC, Foray 48F Biological Insecticide Flowable Concentrate, Foray 76B, Safer B.T. Caterpillar Killer Concentrate, Bacillus thuringiensis subsp. israelensis slurry, Bacillus thuringiensis subsp. kurstaki slurry, Trident® Biological Insecticide, VBC-60219 Biological Insecticide Slurry, Javelin, Bacillus thuringiensis subsp. aizawai slurry, FlorBac® Slurry Biological Insecticide, DiPel® ES, DiPel® ES-NT Biological Insecticide Emulsifiable Suspension, DiPel® (Worm Killer) Wettable Powder Biological Insecticide, Condor, Leap® ES Bacterial Disease Management Biological Insecticide Emulsifiable Suspension, Biobit® HPWP II Biological Insecticide, VectoBac® WDG Biological Larvicide Water Dispersible Granule, VectoBac® DT Biological Larvicide, Bactimos® WG, VectoBac® WG, BMP 123 (2X WP), Cutlass, Crymax®, Lepinox™ WDG, Crymax® WP, BMP 144 DF 3000, Condor WP, BTI WDG, Condor XL, XenTari® Biological Insecticide Water Dispersible Granule, Agree® WG, Agree® 50 WP, DiPel® DF Biological Insecticide Dry Flowable, XenTari® Biological Insecticide Dry Flowable, DiPel® DF Biological Insecticide, DiPel® 2X Biological Insecticide Wettable Powder, BioBit®® HP Biological Insecticide Wettable Powder, DiPel® WDG Biological Insecticide, VBC-60236 Biological Insecticide Dry Flowable, Foray 2WG Biological Insecticide (Water Dispersible Granules), Thuricide® HPWP, Foray WG, Thyllom beetleGONE!® Biological Insecticide, Javelin WP, ABG-6346 Biological Insecticide, ABG-6345 Technical Powder, Javelin WG, SAN 420 I WG, Javelin WG 2, BTK32, XenTari® Biological Insecticide Technical Powder, Phyllom SDS-502 MP, DiPel® Biological Insecticide Technical Powder, Novodor Technical, VBC-60225 Biological Insecticide Technical Grade Active Ingredient POW, Bonide Bacillus thuringiensis ‘O’, Chemsico HPC-O Concentrate, Thuricide® HPC-O for Home and Gardens, VectoBac® Technical Powder, VectoBac® Biological Larvicide Primary Powder, Bioprotec Technical, Summit BTI MP, BMP 144 Primary Powder, BMP 123 Primary Powder, BMP 144 Primary Powder OSF, Technical CGA-237218, Javelin Technical Concentrate, Thuricide® Technical Concentrate, SAN 420 I Technical Concentrate, CONDOR Technical Powder, Cutlass Technical Powder, Lepinox, BTT SDTC, BTT Liquid Technical Concentrate, or BTI Technical Powder BIOInsecticide.

In further embodiments of this aspect, which may be combined with any of the preceding embodiments, plurality of minicells includes a vector including a coding sequence of the exogenous protein toxin. In further embodiments of this aspect, the vector includes a pMB1 origin of replication. In additional embodiments of this aspect, which may be combined with any of the preceding embodiments that has a vector, the coding sequence of the exogenous protein toxin is operably linked to a promoter. In other embodiments of this aspect, the promoter is an inducible promoter or a constitutive promoter. In some embodiments of this aspect, the inducible promoter includes Ptet. In additional embodiments of this aspect, which may be combined with any of the preceding embodiments that has a vector, the exogenous protein toxin includes a PirAB, wherein PirAB includes the PirA including SEQ ID NO: 4 and the PirB including SEQ ID NO: 5, and wherein the coding sequence of the PirA includes SEQ ID NO: 2 and the coding sequence of the PirB includes SEQ ID NO: 3. In further embodiments of this aspect, which may be combined with any of the preceding embodiments that has a vector and an inducible promoter, expression of the exogenous protein toxin is induced with aTc.

In additional embodiments of either of the preceding two aspects, which may be combined with any of the preceding embodiments including the control of an insect pest, control includes at least one of: a reduction in insect pest number, a reduction in insect pest weight, a reduction in physical damage caused by the insect pest, and an increase in insect pest mortality. In some embodiments of this aspect, the reduction in insect pest number, reduction in insect pest weight, reduction in physical damage caused by the insect pest, or increase in insect pest mortality is as compared to an insect pest that has not been administered the composition. In further embodiments of this aspect, the reduction in insect pest number is an at least 10% reduction, an at least 15% reduction, an at least 20% reduction, an at least 25% reduction, an at least 30% reduction, an at least 35% reduction, an at least 40% reduction, an at least 45% reduction, an at least 50% reduction, an at least 55% reduction, an at least 60% reduction, an at least 65% reduction, an at least 70% reduction, an at least 75% reduction, or an at least 80% reduction, the reduction in insect pest weight is an at least 10% reduction, an at least 15% reduction, an at least 20% reduction, an at least 25% reduction, an at least 30% reduction, an at least 35% reduction, an at least 40% reduction, an at least 45% reduction, an at least 50% reduction, an at least 55% reduction, an at least 60% reduction, an at least 65% reduction, an at least 70% reduction, an at least 75% reduction, or an at least 80% reduction, the reduction in physical damage is an at least 10% reduction, an at least 15% reduction, an at least 20% reduction, an at least 25% reduction, an at least 30% reduction, an at least 35% reduction, an at least 40% reduction, an at least 45% reduction, an at least 50% reduction, an at least 55% reduction, an at least 60% reduction, an at least 65% reduction, an at least 70% reduction, an at least 75% reduction, or an at least 80% reduction, and the increase in insect pest mortality is an at least 10% increase, an at least 15% increase, an at least 20% increase, an at least 25% increase, an at least 30% increase, an at least 35% increase, an at least 40% increase, an at least 45% increase, an at least 50% increase, an at least 55% increase, an at least 60% increase, and at least 65% increase, an at least 70% increase, an at least 75% increase, or an at least 80% increase. In some embodiments of this aspect, which may be combined with any of the preceding embodiments, control includes an observed insect pest mortality of at least about 55%, 60%, 65%, 70%, 75%, 80%, 85%, 90%, or 95%.

In further embodiments of either of the preceding two aspects, which may be combined with any of the preceding embodiments, the composition further includes agrochemical surfactants, wherein the agrochemical surfactants improve at least one of the characteristics of sprayability, spreadability, and injectability. In additional embodiments of this aspect, which may be combined with any of the preceding embodiments, the liquid carrier phase is aqueous or oil. In some embodiments of this aspect, which may be combined with any of the preceding embodiments including the control of an insect pest, the at least one insect pest is selected from the group of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., or Diptera spp.

An additional aspect of the disclosure includes a composition including: a liquid carrier phase; and a plurality of minicells dispersed in the carrier phase, wherein the plurality of minicells includes a minicell including a first effective amount of a first exogenous protein toxin including Pir and a second effective amount of a second exogenous protein toxin including Cry1, wherein the first effective amount and the second effective amount are present at a ratio in the range of about 50:1-1:50. The ratio may be about 50:1, 45:1, 40:1, 35:1, 30:1, 25:1, 20:1, 15:1, 10:1, 5:1, 1:1, 1:5, 1:10, 1:15, 1:20, 1:25, 1:30, 1:35, 1:40, 1:45, or 1:50. In some embodiments of this aspect, the first effective amount and the second effective amount are present at a ratio of about 46:1, 23:1, 11:1, 9:1, 6:1, 5:1, 3:1, or 1:1. In some embodiments of this aspect, which may be combined with any of the preceding embodiments, the first effective amount and the second effective amount combined have a synergistic effect on the control of at least one insect pest when the composition is administered to the insect pest that that exceeds an effect of the first effective amount alone and an effect of the second effective amount alone on the control of at least one insect pest when the composition is administered to the insect pest. The synergistic effect allows a lower effective amount of each exogenous protein toxin to be used, while maintaining their efficacy in agricultural applications.

An additional aspect of the disclosure includes a composition including: a liquid carrier phase; and a plurality of minicells dispersed in the carrier phase, wherein the plurality of minicells includes a minicell including a first effective amount of an exogenous protein toxin including Pir and a second effective amount of a Bt-derived AI, wherein the first effective amount and the second effective amount are present at a ratio in the range of about 50:1-1:50. The ratio may be about 50:1, 45:1, 40:1, 35:1, 30:1, 25:1, 20:1, 15:1, 10:1, 5:1, 1:1, 1:5, 1:10, 1:15, 1:20, 1:25, 1:30, 1:35, 1:40, 1:45, or 1:50. In some embodiments of this aspect, the first effective amount and the second effective amount are present at a ratio of about 23:1, 22:1, 11:1, 6:1, 3:1, 2:1, or 1.5:1. In some embodiments of this aspect, which may be combined with any of the preceding embodiments, the first effective amount and the second effective amount combined have a synergistic effect on the control of at least one insect pest when the composition is administered to the insect pest that that exceeds an effect of the first effective amount alone and an effect of the second effective amount alone on the control of at least one insect pest when the composition is administered to the insect pest. The synergistic effect allows a lower effective amount of each active ingredient (e.g., exogenous protein toxin; Bt-derived AI) to be used, while maintaining their efficacy in agricultural applications.

Yet another aspect of the disclosure includes a wettable powder including: a plurality of dried minicells including a mixture of a first effective amount of a first minicell including a first exogenous protein toxin including Pir and a second effective amount of a second minicell including a second exogenous protein toxin including Cry, wherein the first effective amount and the second effective amount are present at a ratio in the range of about 50:1-1:50, and wherein the wettable powder is configured to be dispersed in an aqueous carrier to create a composition for controlling at least one insect pest when the composition is administered to an insect. The ratio may be about 50:1, 45:1, 40:1, 35:1, 30:1, 25:1, 20:1, 15:1, 10:1, 5:1, 1:1, 1:5, 1:10, 1:15, 1:20, 1:25, 1:30, 1:35, 1:40, 1:45, or 1:50. In some embodiments of this aspect, the first effective amount and the second effective amount are present at a ratio of about 46:1, 23:1, 11:1, 9:1, 6:1, 5:1, 3:1, or 1:1. In other embodiments of this aspect, which may be combined with any of the preceding embodiments, the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest. The synergistic effect allows a lower effective amount of each exogenous protein toxin to be used, while maintaining their efficacy in agricultural applications. In further embodiments of this aspect, which may be combined with any of the preceding embodiments, a first particle concentration of the first minicell is in the range of about 1×10² to about 8×10¹⁴, and wherein a second particle concentration of the second minicell is in the range of about 1×10² to about 8×10¹⁴. In additional embodiments of this aspect, which may be combined with any of the preceding embodiments, the wettable powder further includes an agrochemically acceptable solid carrier component including at least one of: a clay component, a kaolin component, a talc component, a chalk component, a calcite component, a quartz component, a pumice component, a diatomaceous earth component, a vermiculite component, a silicate component, a silicon dioxide component, a silica powder component, an aluminum component, an ammonium sulfate component, an ammonium phosphate component, a calcium carbonate component, an urea component, a sugar component, a starch component, a sawdust component, a ground coconut shell component, a ground corn cob component, and a ground tobacco stalk component. In some embodiments of this aspect, which may be combined with any of the preceding embodiments, the aqueous carrier includes water. In further embodiments of this aspect, which may be combined with any of the preceding embodiments, administering the composition to the insect pest includes an administration method selected from the group of delivering the composition to the insect pest for ingestion; contacting the insect with the composition; delivering the composition to at least one habitat where the insect pest grows, lives, reproduces, feeds, or infests; and applying the composition to a plant. In some embodiments of this aspect, the composition is applied to the plant as at least one of a foliar treatment, an injection treatment, a pre-emergence treatment, or a post-emergence treatment.

In some embodiments of this aspect, which may be combined with any of the preceding embodiments, the first exogenous protein toxin includes PirAB or a functional component thereof. In further embodiments of this aspect, PirAB includes a PirA selected from the group of SEQ ID NO: 143, SEQ ID NO: 146, SEQ ID NO: 147, SEQ ID NO: 154, SEQ ID NO: 157, SEQ ID NO: 161, SEQ ID NO: 163, SEQ ID NO: 164, SEQ ID NO: 165, SEQ ID NO: 167, SEQ ID NO: 168, SEQ ID NO: 169, SEQ ID NO: 170, SEQ ID NO: 171, SEQ ID NO: 174, SEQ ID NO: 174, SEQ ID NO: 186, SEQ ID NO: 190, SEQ ID NO: 192, SEQ ID NO: 197, SEQ ID NO: 199, SEQ ID NO: 202, or SEQ ID NO: 203; and a PirB selected from the group of SEQ ID NO: 144, SEQ ID NO: 145, SEQ ID NO: 148, SEQ ID NO: 149, SEQ ID NO: 150, SEQ ID NO: 153, SEQ ID NO: 158, SEQ ID NO: 159, SEQ ID NO: 160, SEQ ID NO: 162, SEQ ID NO: 166, SEQ ID NO: 172, SEQ ID NO: 177, SEQ ID NO: 178, SEQ ID NO: 179, SEQ ID NO: 180, SEQ ID NO: 181, SEQ ID NO: 182, SEQ ID NO: 183, SEQ ID NO: 184, SEQ ID NO: 185, SEQ ID NO: 187, SEQ ID NO: 188, SEQ ID NO: 189, SEQ ID NO: 191, SEQ ID NO: 193, SEQ ID NO: 194, SEQ ID NO: 195, SEQ ID NO: 196, SEQ ID NO: 198, SEQ ID NO: 201, or SEQ ID NO: 204, or a functional component of any thereof. In other embodiments of this aspect, PirAB includes the PirA including SEQ ID NO: 203 and the PirB including SEQ ID NO: 204, or PirAB includes the PirA including SEQ ID NO: 197 and the PirB including SEQ ID NO: 178.

In some embodiments of this aspect, which may be combined with any of the preceding embodiments, the second exogenous protein toxin includes Cry1A, Cry1B, Cry1C, Cry1D, Cry1E, Cry1F, Cry1G, Cry1H, Cry1I, Cry1J, or Cry1K or a functional component thereof. In further embodiments of this aspect, the Cry1A includes a Cry1A selected from the group of SEQ ID NO: 105, SEQ ID NO: 106, SEQ ID NO: 107, SEQ ID NO: 108, SEQ ID NO: 109, SEQ ID NO: 110, SEQ ID NO: 111, SEQ ID NO: 112, SEQ ID NO: 113, SEQ ID NO: 114, SEQ ID NO: 115, SEQ ID NO: 151, SEQ ID NO: 152, or SEQ ID NO: 205; the Cry1B includes a Cry1B selected from the group of SEQ ID NO: 117, SEQ ID NO: 118, SEQ ID NO: 119, SEQ ID NO: 120, SEQ ID NO: 121, SEQ ID NO: 122, or SEQ ID NO: 155; the Cry1C includes a Cry1C selected from the group of SEQ ID NO: 123, SEQ ID NO: 124, SEQ ID NO: 125, or SEQ ID NO: 156; the Cry1D includes a Cry1D selected from the group of SEQ ID NO: 126, SEQ ID NO: 127, SEQ ID NO: 175, or SEQ ID NO: 176; the Cry1E includes a Cry1E selected from the group of SEQ ID NO: 128 or SEQ ID NO: 129; the Cry1F includes a Cry1F selected from the group of SEQ ID NO: 130 or SEQ ID NO: 131; the Cry1G includes a Cry1G selected from the group of SEQ ID NO: 132 or SEQ ID NO: 133; the Cry1H includes a Cry1H selected from the group of SEQ ID NO: 134 or SEQ ID NO: 135; the Cry1I includes a Cry1I selected from the group of SEQ ID NO: 136, SEQ ID NO: 137, SEQ ID NO: 138, or SEQ ID NO: 139; the Cry1J includes a Cry1J selected from the group of SEQ ID NO: 140 or SEQ ID NO: 141; or the Cry1K includes SEQ ID NO: 142, or a functional component of any thereof. In other embodiments of this aspect, the second exogenous protein toxin includes the Cry1A including SEQ ID NO: 205.

Yet another aspect of the disclosure includes a wettable powder including: a plurality of dried minicells including a mixture of a first effective amount of a minicell including an exogenous protein toxin including Pir and a second effective amount of a Bt-derived AI, wherein the first effective amount and the second effective amount are present at a ratio in the range of about 50:1-1:50, and wherein the wettable powder is configured to be dispersed in an aqueous carrier to create a composition for controlling at least one insect pest when the composition is administered to an insect. The ratio may be about 50:1, 45:1, 40:1, 35:1, 30:1, 25:1, 20:1, 15:1, 10:1, 5:1, 1:1, 1:5, 1:10, 1:15, 1:20, 1:25, 1:30, 1:35, 1:40, 1:45, or 1:50. In some embodiments of this aspect, the first effective amount and the second effective amount are present at a ratio of about 23:1, 22:1, 11:1, 6:1, 3:1, 2:1, or 1.5:1. In other embodiments of this aspect, which may be combined with any of the preceding embodiments, the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest. The synergistic effect allows a lower effective amount of each active ingredient (e.g., exogenous protein toxin; Bt-derived AI) to be used, while maintaining their efficacy in agricultural applications. In further embodiments of this aspect, which may be combined with any of the preceding embodiments, a particle concentration of the minicell is in the range of about 1×10² to about 8×10¹. In additional embodiments of this aspect, which may be combined with any of the preceding embodiments, the Bt-derived AI includes at least one of Bacillus thuringiensis, its fermentation solids, its spores, and its insecticidal toxins. In yet further embodiments of this aspect, which may be combined with any of the preceding embodiments, the Bt-derived AI includes at least two, at least three, or all of Bacillus thuringiensis, its fermentation solids, its spores, and its insecticidal toxins. In additional embodiments of this aspect, which may be combined with any of the preceding embodiments, the wettable powder further includes an agrochemically acceptable solid carrier component including at least one of: a clay component, a kaolin component, a talc component, a chalk component, a calcite component, a quartz component, a pumice component, a diatomaceous earth component, a vermiculite component, a silicate component, a silicon dioxide component, a silica powder component, an aluminum component, an ammonium sulfate component, an ammonium phosphate component, a calcium carbonate component, an urea component, a sugar component, a starch component, a sawdust component, a ground coconut shell component, a ground corn cob component, and a ground tobacco stalk component. In some embodiments of this aspect, which may be combined with any of the preceding embodiments, the aqueous carrier includes water. In further embodiments of this aspect, which may be combined with any of the preceding embodiments, administering the composition to the insect pest includes an administration method selected from the group of delivering the composition to the insect pest for ingestion; contacting the insect with the composition; delivering the composition to at least one habitat where the insect pest grows, lives, reproduces, feeds, or infests; and applying the composition to a plant. In some embodiments of this aspect, the composition is applied to the plant as at least one of a foliar treatment, an injection treatment, a pre-emergence treatment, or a post-emergence treatment.

In some embodiments of this aspect, which may be combined with any of the preceding embodiments, the exogenous protein toxin includes PirAB or a functional component thereof. In further embodiments of this aspect, PirAB includes a PirA selected from the group of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, or SEQ ID NO: 32; and a PirB selected from the group of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, or SEQ ID NO: 58, or a functional component of any thereof. In other embodiments of this aspect, PirAB includes the PirA including SEQ ID NO: 4 and the PirB including SEQ ID NO: 5, or wherein PirAB includes the PirA including SEQ ID NO: 6 and the PirB including SEQ ID NO: 7. In yet another embodiment of this aspect, PirAB includes a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and wherein PirA is linked to a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58 by a linker sequence. The linker sequence will be of a structure sufficient to enable the fusion to perform insecticidal activity in the range of 0.7X to 1.5X, wherein X is the insecticidal activity of the same PirA and PirB that are unlinked. An exemplary linker may include (Gly₄Ser)₃ (SEQ ID NO: 59), SEQ ID NO: 60, SEQ ID NO: 61, SEQ ID NO: 62, SEQ ID NO: 63, or SEQ ID NO: 64.

In some embodiments of this aspect, which may be combined with any of the preceding embodiments, the Bt-derived AI includes Bt-derived biological control product selected from the group of Thuricide®, Thuricide® HPC-O RTU, Thuricide® HPC, Thuricide® 48 LV Forestry, Thuricide® 76B, Thuricide® 76 LV, Bonide Bacillus Thuringiensis (BT) Moth Larvae (Caterpillar) Control, DiPel®, Security BT Dust Biological Insecticide, Fertilome Dipel Dust Biological Insecticide, Widestrike®, Plant Pesticide B.T. subsp. tenebrionis Colorado Potato Beetle Protein, SA-50 brand DiPel® dust, Ringer® Vegetable Insect Attack®, Bonide DiPel® 150 Dust For Vegetables, Green Light® DiPel® Dust, Green Light® BT Worm Killer, BT Sulfur 15-50 Dust, NEU1701I, FourStar® Briquets, FourStar® CRG, Britz Bt 25 Sulfur Dust, Thuricide® 32LV, Bonide Mosquito Beater® Water Soluble Pouches, Britz BT Dust, Summit Fallout Bti Granules, DiPel® 10G Sweet Corn Granules, DiPel® 10G Biological Insecticide Granules, DiPel® SG Plus Biological Insecticide Sand Granule, DiPel® 6L Worm Killer, VectoBac® G Biological Larvicide Granules, VectoBac® GR, Summit Mosquito Bits®, Mosquito Bits®, BMP 144 (200 G), Bti Granular Larvicide, FourStar® MBG, DiPel® 8L Worm Killer, TERROR Larvacide, VectoMax® FG Biological Larvicide Fine Granule, Chemsico Insect Granules ML, VectoBac® FG Biological Larvicide Granules, Bti Granules, RF2230 D-Granules, RF2248 U-Granules, AllPro Sustain BCG, BMP 144 (400 G), VectoPrime® FG Biological Larvicide Fine Granules, VectoBac® FG+Biological Larvicide Fine Granule, VectoBac® AS, DiPel® WP Home & Garden Insecticide, DiPel® Bio Garden Spray, WideStrike®, Meridian-02, BMP 144 (2X), grubGONE!® G, Bioprotec, Bioprotec Plus, Bioprotec HP, Bioprotec Caterpillar Insecticide Concentrate, BES0531, Novodor Biological Insecticide Flowable Concentrate, FourStar® Bti CRG, VBC-60092 (Bactimos Briquette), Summit B.t.i. BRIQUETS, Dunks, Sympatico Biological Insecticide, XenTari® AS Biological Insecticide Aqueous Suspension, B402 Biological Larvicide, VectoBac® 12 AS Biological Larvicide Aqueous Suspension, VectoBac® SC Biological Larvicide, BMP 144 (3X), CMP 123 (48 LC), Bactimos PT, Foray 48B, Foray 48BC, Foray 48F Biological Insecticide Flowable Concentrate, Foray 76B, Safer B.T. Caterpillar Killer Concentrate, Bacillus thuringiensis subsp. israelensis slurry, Bacillus thuringiensis subsp. kurstaki slurry, Trident® Biological Insecticide, VBC-60219 Biological Insecticide Slurry, Javelin, Bacillus thuringiensis subsp. aizawai slurry, FlorBac® Slurry Biological Insecticide, DiPel® ES, DiPel® ES-NT Biological Insecticide Emulsifiable Suspension, DiPel® (Worm Killer) Wettable Powder Biological Insecticide, Condor, Leap® ES Bacterial Disease Management Biological Insecticide Emulsifiable Suspension, Biobit® HPWP II Biological Insecticide, VectoBac® WDG Biological Larvicide Water Dispersible Granule, VectoBac® DT Biological Larvicide, Bactimos® WG, VectoBac® WG, BMP 123 (2X WP), Cutlass, Crymax®, Lepinox™ WDG, Crymax® WP, BMP 144 DF 3000, Condor WP, BTI WDG, Condor XL, XenTari® Biological Insecticide Water Dispersible Granule, Agree® WG, Agree® 50 WP, DiPel® DF Biological Insecticide Dry Flowable, XenTari® Biological Insecticide Dry Flowable, DiPel® DF Biological Insecticide, DiPel® 2X Biological Insecticide Wettable Powder, BioBit®® HP Biological Insecticide Wettable Powder, DiPel® WDG Biological Insecticide, VBC-60236 Biological Insecticide Dry Flowable, Foray 2WG Biological Insecticide (Water Dispersible Granules), Thuricide® HPWP, Foray WG, Thyllom beetleGONE!® Biological Insecticide, Javelin WP, ABG-6346 Biological Insecticide, ABG-6345 Technical Powder, Javelin WG, SAN 420 I WG, Javelin WG 2, BTK32, XenTari® Biological Insecticide Technical Powder, Phyllom SDS-502 MP, DiPel® Biological Insecticide Technical Powder, Novodor Technical, VBC-60225 Biological Insecticide Technical Grade Active Ingredient POW, Bonide Bacillus thuringiensis ‘O’, Chemsico HPC-O Concentrate, Thuricide® HPC-O for Home and Gardens, VectoBac® Technical Powder, VectoBac® Biological Larvicide Primary Powder, Bioprotec Technical, Summit BTI MP, BMP 144 Primary Powder, BMP 123 Primary Powder, BMP 144 Primary Powder OSF, Technical CGA-237218, Javelin Technical Concentrate, Thuricide® Technical Concentrate, SAN 420 I Technical Concentrate, CONDOR Technical Powder, Cutlass Technical Powder, Lepinox, BTT SDTC, BTT Liquid Technical Concentrate, or BTI Technical Powder BIOInsecticide.

In additional embodiments of either of the preceding two aspects, which may be combined with any of the preceding embodiments, control includes at least one of: a reduction in insect pest number, a reduction in insect pest weight, a reduction in physical damage caused by the insect pest, and an increase in insect pest mortality. In some embodiments of this aspect, the reduction in insect pest number, reduction in insect pest weight, reduction in physical damage caused by the insect pest, or increase in insect pest mortality is as compared to an insect pest that has not been administered the composition. In further embodiments of this aspect, the reduction in insect pest number is an at least 10% reduction, an at least 15% reduction, an at least 20% reduction, an at least 25% reduction, an at least 30% reduction, an at least 35% reduction, an at least 40% reduction, an at least 45% reduction, an at least 50% reduction, an at least 55% reduction, an at least 60% reduction, an at least 65% reduction, an at least 70% reduction, an at least 75% reduction, or an at least 80% reduction, the reduction in insect pest weight is an at least 10% reduction, an at least 15% reduction, an at least 20% reduction, an at least 25% reduction, an at least 30% reduction, an at least 35% reduction, an at least 40% reduction, an at least 45% reduction, an at least 50% reduction, an at least 55% reduction, an at least 60% reduction, an at least 65% reduction, an at least 70% reduction, an at least 75% reduction, or an at least 80% reduction, the reduction in physical damage is an at least 10% reduction, an at least 15% reduction, an at least 20% reduction, an at least 25% reduction, an at least 30% reduction, an at least 35% reduction, an at least 40% reduction, an at least 45% reduction, an at least 50% reduction, an at least 55% reduction, an at least 60% reduction, an at least 65% reduction, an at least 70% reduction, an at least 75% reduction, or an at least 80% reduction, and the increase in insect pest mortality is an at least 10% increase, an at least 15% increase, an at least 20% increase, an at least 25% increase, an at least 30% increase, an at least 35% increase, an at least 40% increase, an at least 45% increase, an at least 50% increase, an at least 55% increase, an at least 60% increase, and at least 65% increase, an at least 70% increase, an at least 75% increase, or an at least 80% increase. In some embodiments of this aspect, which may be combined with any of the preceding embodiments, control includes an observed insect pest mortality of at least about 55%, 60%, 65%, 70%, 75%, 80%, 85%, 90%, or 95%. In some embodiments of this aspect, which may be combined with any of the preceding embodiments, the at least one insect pest is selected from the group of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., or Diptera spp.

A further aspect of the disclosure includes a plantable composition including: a seed; and a coating covering the seed, wherein the coating includes a plurality of minicells including a mixture of a first effective amount of a first minicell including a first exogenous protein toxin including Pir and a second effective amount of a second minicell including a second exogenous protein toxin including Cry, wherein the first effective amount and the second effective amount are present at a ratio in the range of about 50:1-1:50, and wherein the mixture is sufficient to result in insecticidal activity on at least one insect pest feeding on the seed or a seedling emerging therefrom. The ratio may be about 50:1, 45:1, 40:1, 35:1, 30:1, 25:1, 20:1, 15:1, 10:1, 5:1, 1:1, 1:5, 1:10, 1:15, 1:20, 1:25, 1:30, 1:35, 1:40, 1:45, or 1:50. In some embodiments of this aspect, the first effective amount and the second effective amount are present at a ratio of about 46:1, 23:1, 11:1, 9:1, 6:1, 5:1, 3:1, or 1:1. In other embodiments of this aspect, which may be combined with any of the preceding embodiments, the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest. The synergistic effect allows a lower effective amount of each exogenous protein toxin to be used, while maintaining their efficacy in agricultural applications. In further embodiments of this aspect, which may be combined with any of the preceding embodiments, a first particle concentration of the first minicell is in the range of about 1×10² to about 8×10¹⁴, and wherein a second particle concentration of the second minicell is in the range of about 1×10² to about 8×10¹⁴.

In some embodiments of this aspect, which may be combined with any of the preceding embodiments, the first exogenous protein toxin includes PirAB or a functional component thereof. In further embodiments of this aspect, PirAB includes a PirA selected from the group of SEQ ID NO: 143, SEQ ID NO: 146, SEQ ID NO: 147, SEQ ID NO: 154, SEQ ID NO: 157, SEQ ID NO: 161, SEQ ID NO: 163, SEQ ID NO: 164, SEQ ID NO: 165, SEQ ID NO: 167, SEQ ID NO: 168, SEQ ID NO: 169, SEQ ID NO: 170, SEQ ID NO: 171, SEQ ID NO: 174, SEQ ID NO: 174, SEQ ID NO: 186, SEQ ID NO: 190, SEQ ID NO: 192, SEQ ID NO: 197, SEQ ID NO: 199, SEQ ID NO: 202, or SEQ ID NO: 203; and a PirB selected from the group of SEQ ID NO: 144, SEQ ID NO: 145, SEQ ID NO: 148, SEQ ID NO: 149, SEQ ID NO: 150, SEQ ID NO: 153, SEQ ID NO: 158, SEQ ID NO: 159, SEQ ID NO: 160, SEQ ID NO: 162, SEQ ID NO: 166, SEQ ID NO: 172, SEQ ID NO: 177, SEQ ID NO: 178, SEQ ID NO: 179, SEQ ID NO: 180, SEQ ID NO: 181, SEQ ID NO: 182, SEQ ID NO: 183, SEQ ID NO: 184, SEQ ID NO: 185, SEQ ID NO: 187, SEQ ID NO: 188, SEQ ID NO: 189, SEQ ID NO: 191, SEQ ID NO: 193, SEQ ID NO: 194, SEQ ID NO: 195, SEQ ID NO: 196, SEQ ID NO: 198, SEQ ID NO: 201, or SEQ ID NO: 204, or a functional component of any thereof. In other embodiments of this aspect, PirAB includes the PirA including SEQ ID NO: 203 and the PirB including SEQ ID NO: 204, or PirAB includes the PirA including SEQ ID NO: 197 and the PirB including SEQ ID NO: 178.

In some embodiments of this aspect, which may be combined with any of the preceding embodiments, the second exogenous protein toxin includes Cry1A, Cry1B, Cry1C, Cry1D, Cry1E, Cry1F, Cry1G, Cry1H, Cry1I, Cry1J, or Cry1K or a functional component thereof. In further embodiments of this aspect, the Cry1A includes a Cry1A selected from the group of SEQ ID NO: 105, SEQ ID NO: 106, SEQ ID NO: 107, SEQ ID NO: 108, SEQ ID NO: 109, SEQ ID NO: 110, SEQ ID NO: 111, SEQ ID NO: 112, SEQ ID NO: 113, SEQ ID NO: 114, SEQ ID NO: 115, SEQ ID NO: 151, SEQ ID NO: 152, or SEQ ID NO: 205; the Cry1B includes a Cry1B selected from the group of SEQ ID NO: 117, SEQ ID NO: 118, SEQ ID NO: 119, SEQ ID NO: 120, SEQ ID NO: 121, SEQ ID NO: 122, or SEQ ID NO: 155; the Cry1C includes a Cry1C selected from the group of SEQ ID NO: 123, SEQ ID NO: 124, SEQ ID NO: 125, or SEQ ID NO: 156; the Cry1D includes a Cry1D selected from the group of SEQ ID NO: 126, SEQ ID NO: 127, SEQ ID NO: 175, or SEQ ID NO: 176; the Cry1E includes a Cry1E selected from the group of SEQ ID NO: 128 or SEQ ID NO: 129; the Cry1F includes a Cry1F selected from the group of SEQ ID NO: 130 or SEQ ID NO: 131; the Cry1G includes a Cry1G selected from the group of SEQ ID NO: 132 or SEQ ID NO: 133; the Cry1H includes a Cry1H selected from the group of SEQ ID NO: 134 or SEQ ID NO: 135; the Cry1I includes a Cry1I selected from the group of SEQ ID NO: 136, SEQ ID NO: 137, SEQ ID NO: 138, or SEQ ID NO: 139; the Cry1J includes a Cry1J selected from the group of SEQ ID NO: 140 or SEQ ID NO: 141; or the Cry1K includes SEQ ID NO: 142, or a functional component of any thereof. In other embodiments of this aspect, the second exogenous protein toxin includes the Cry1A including SEQ ID NO: 205.

A further aspect of the disclosure includes a plantable composition including: a seed; and a coating covering the seed, wherein the coating includes a coating covering the seed, wherein the coating includes a plurality of minicells including a mixture of a first effective amount of a minicell including an exogenous protein toxin including Pir and a second effective amount of a Bt-derived AI, wherein the first effective amount and the second effective amount are present at a ratio in the range of about 50:1-1:50, and wherein the mixture is sufficient to result in insecticidal activity on at least one insect pest feeding on the seed or a seedling emerging therefrom. The ratio may be about 50:1, 45:1, 40:1, 35:1, 30:1, 25:1, 20:1, 15:1, 10:1, 5:1, 1:1, 1:5, 1:10, 1:15, 1:20, 1:25, 1:30, 1:35, 1:40, 1:45, or 1:50. In some embodiments of this aspect, the first effective amount and the second effective amount are present at a ratio of about 23:1, 22:1, 11:1, 6:1, 3:1, 2:1, or 1.5:1. In other embodiments of this aspect, which may be combined with any of the preceding embodiments, the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest. The synergistic effect allows a lower effective amount of each active ingredient (e.g., exogenous protein toxin; Bt-derived AI) to be used, while maintaining their efficacy in agricultural applications. In further embodiments of this aspect, which may be combined with any of the preceding embodiments, a particle concentration of the minicells is in the range of about 1×10² to about 8×10¹⁴.

In some embodiments of this aspect, which may be combined with any of the preceding embodiments, the exogenous protein toxin includes PirAB or a functional component thereof. In further embodiments of this aspect, PirAB includes a PirA selected from the group of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, or SEQ ID NO: 32; and a PirB selected from the group of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, or SEQ ID NO: 58, or a functional component of any thereof. In other embodiments of this aspect, PirAB includes the PirA including SEQ ID NO: 4 and the PirB including SEQ ID NO: 5, or wherein PirAB includes the PirA including SEQ ID NO: 6 and the PirB including SEQ ID NO: 7. In yet another embodiment of this aspect, PirAB includes a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and wherein PirA is linked to a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58 by a linker sequence. The linker sequence will be of a structure sufficient to enable the fusion to perform insecticidal activity in the range of 0.7X to 1.5X, wherein X is the insecticidal activity of the same PirA and PirB that are unlinked. An exemplary linker may include (Gly₄Ser)₃ (SEQ ID NO: 59), SEQ ID NO: 60, SEQ ID NO: 61, SEQ ID NO: 62, SEQ ID NO: 63, or SEQ ID NO: 64.

In some embodiments of this aspect, which may be combined with any of the preceding embodiments, the Bt-derived AI includes a Bt-derived biological control product selected from the group of Thuricide®, Thuricide® HPC-O RTU, Thuricide® HPC, Thuricide® 48 LV Forestry, Thuricide® 76B, Thuricide® 76 LV, Bonide Bacillus Thuringiensis (BT) Moth Larvae (Caterpillar) Control, DiPel®, Security BT Dust Biological Insecticide, Fertilome Dipel Dust Biological Insecticide, Widestrike®, Plant Pesticide B.T. subsp. tenebrionis Colorado Potato Beetle Protein, SA-50 brand DiPel® dust, Ringer® Vegetable Insect Attack®, Bonide DiPel® 150 Dust For Vegetables, Green Light® DiPel® Dust, Green Light® BT Worm Killer, BT Sulfur 15-50 Dust, NEU1701I, FourStar® Briquets, FourStar® CRG, Britz Bt 25 Sulfur Dust, Thuricide® 32LV, Bonide Mosquito Beater® Water Soluble Pouches, Britz BT Dust, Summit Fallout Bti Granules, DiPel® 10G Sweet Corn Granules, DiPel® 10G Biological Insecticide Granules, DiPel® SG Plus Biological Insecticide Sand Granule, DiPel® 6L Worm Killer, VectoBac® G Biological Larvicide Granules, VectoBac® GR, Summit Mosquito Bits®, Mosquito Bits®, BMP 144 (200 G), Bti Granular Larvicide, FourStar® MBG, DiPel® 8L Worm Killer, TERROR Larvacide, VectoMax® FG Biological Larvicide Fine Granule, Chemsico Insect Granules ML, VectoBac® FG Biological Larvicide Granules, Bti Granules, RF2230 D-Granules, RF2248 U-Granules, AllPro Sustain BCG, BMP 144 (400 G), VectoPrime® FG Biological Larvicide Fine Granules, VectoBac® FG+Biological Larvicide Fine Granule, VectoBac® AS, DiPel® WP Home & Garden Insecticide, DiPel® Bio Garden Spray, WideStrike®, Meridian-02, BMP 144 (2X), grubGONE!® G, Bioprotec, Bioprotec Plus, Bioprotec HP, Bioprotec Caterpillar Insecticide Concentrate, BES0531, Novodor Biological Insecticide Flowable Concentrate, FourStar® Bti CRG, VBC-60092 (Bactimos Briquette), Summit B.t.i. BRIQUETS, Dunks, Sympatico Biological Insecticide, XenTari® AS Biological Insecticide Aqueous Suspension, B402 Biological Larvicide, VectoBac® 12 AS Biological Larvicide Aqueous Suspension, VectoBac® SC Biological Larvicide, BMP 144 (3X), CMP 123 (48 LC), Bactimos PT, Foray 48B, Foray 48BC, Foray 48F Biological Insecticide Flowable Concentrate, Foray 76B, Safer B.T. Caterpillar Killer Concentrate, Bacillus thuringiensis subsp. israelensis slurry, Bacillus thuringiensis subsp. kurstaki slurry, Trident® Biological Insecticide, VBC-60219 Biological Insecticide Slurry, Javelin, Bacillus thuringiensis subsp. aizawai slurry, FlorBac® Slurry Biological Insecticide, DiPel® ES, DiPel® ES-NT Biological Insecticide Emulsifiable Suspension, DiPel® (Worm Killer) Wettable Powder Biological Insecticide, Condor, Leap® ES Bacterial Disease Management Biological Insecticide Emulsifiable Suspension, Biobit® HPWP II Biological Insecticide, VectoBac® WDG Biological Larvicide Water Dispersible Granule, VectoBac® DT Biological Larvicide, Bactimos® WG, VectoBac® WG, BMP 123 (2X WP), Cutlass, Crymax®, Lepinox™ WDG, Crymax® WP, BMP 144 DF 3000, Condor WP, BTI WDG, Condor XL, XenTari® Biological Insecticide Water Dispersible Granule, Agree® WG, Agree® 50 WP, DiPel® DF Biological Insecticide Dry Flowable, XenTari® Biological Insecticide Dry Flowable, DiPel® DF Biological Insecticide, DiPel® 2X Biological Insecticide Wettable Powder, BioBit®® HP Biological Insecticide Wettable Powder, DiPel® WDG Biological Insecticide, VBC-60236 Biological Insecticide Dry Flowable, Foray 2WG Biological Insecticide (Water Dispersible Granules), Thuricide® HPWP, Foray WG, Thyllom beetleGONE!® Biological Insecticide, Javelin WP, ABG-6346 Biological Insecticide, ABG-6345 Technical Powder, Javelin WG, SAN 420 I WG, Javelin WG 2, BTK32, XenTari® Biological Insecticide Technical Powder, Phyllom SDS-502 MP, DiPel® Biological Insecticide Technical Powder, Novodor Technical, VBC-60225 Biological Insecticide Technical Grade Active Ingredient POW, Bonide Bacillus thuringiensis ‘O’, Chemsico HPC-O Concentrate, Thuricide® HPC-O for Home and Gardens, VectoBac® Technical Powder, VectoBac® Biological Larvicide Primary Powder, Bioprotec Technical, Summit BTI MP, BMP 144 Primary Powder, BMP 123 Primary Powder, BMP 144 Primary Powder OSF, Technical CGA-237218, Javelin Technical Concentrate, Thuricide® Technical Concentrate, SAN 420 I Technical Concentrate, CONDOR Technical Powder, Cutlass Technical Powder, Lepinox, BTT SDTC, BTT Liquid Technical Concentrate, or BTI Technical Powder BIOInsecticide.

In some embodiments of either of the preceding two aspects, which may be combined with any of the preceding embodiments, the at least one insect pest is selected from the group of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., or Diptera spp. In further embodiments of this aspect, which may be combined with any of the preceding embodiments, the seed is from a plant selected from the group of row crop plants, fruit-producing plants and trees, vegetables, trees, and ornamental plants including ornamental flowers, shrubs, trees, groundcovers, or turf grasses. In some embodiments of this aspect, which may be combined with any of the preceding embodiments, plants are of any species of interest (e.g., commercially important cultivated crops, trees, and plants), including dicots and monocots. Examples of commercially important cultivated crops, trees, and plants include: alfalfa (Medicago sativa), almonds (Prunus dulcis), apples (Malus x domestica), apricots (Prunus armeniaca, P. brigantine, P. mandshurica, P. mume, P. sibirica), artichoke (Cynara cardunculus var. scolymus), asparagus (Asparagus officinalis), avocado (Persea americana), bananas (Musa spp.), barley (Hordeum vulgare), beans (Phaseolus spp.), blueberries and cranberries (Vaccinium spp.), Brazil nut (Bertholletia excelsa), cacao (Theobroma cacao), calamansi (Citrus x microcarpa), canola and rapeseed or oilseed rape, (Brassica napus), Polish canola (Brassica rapa), and related cruciferous vegetables including broccoli, kale, cabbage, and turnips (Brassica carinata, B. juncea, B. oleracea, B. napus, B. nigra, and B. rapa, and hybrids of these), carnation (Dianthus caryophyllus), carrots (Daucus carota sativus), cashew (Anacardium occidentale), cassava (Manihot esculentum), celery (Apium graveolens), cherry (Prunus avium), chestnut (Castanea spp.), chickpea or garbanzo (Cicer arietinum), chicory (Cichorium intybus), chili peppers and other capsicum peppers (Capsicum annuum, C. frutescens, C. chinense, C. pubescens, C. baccatum), chrysanthemums (Chrysanthemum spp.), citron (Citrus medica), coconut (Cocos nucifera), coffee (wild and domesticated Coffea spp. including Coffea arabica, Coffea canephora, and Coffea liberica), cotton (Gossypium hirsutum L.), cowpea (Vigna unguiculata and other Vigna spp.), fava beans (Vicia faba), cucumber (Cucumis sativus), currants and gooseberries (Ribes spp.), date (Phoenix dactylifera), duckweeds (family Lemnoideae), eggplant or aubergine (Solanum melongena), elderberries (Sambucus spp.), eucalyptus (Eucalyptus spp.), flax (Linum usitatissumum L.), geraniums (Pelargonium spp.), ginger (Zingiber officinale), ginseng (Panax spp.), grapefruit (Citrus x paradisi), grapes (Vitis spp.) including wine grapes (Vitis vinifera and hybrids thereof), guava (Psidium guajava), hazelnut (Corylus avellana, Corylus spp.), hemp and cannabis (Cannabis sativa and Cannabis spp.), hops (Humulus lupulus), horseradish (Armoracia rusticana), irises (Iris spp.), jackfruit (Artocarpus heterophyllus), kiwifruits (Actinidia spp.), kumquat (Citrus japonica), lemon (Citrus limon), lentil (Lens culinaris), lettuce (Lactuca sativa), limes (Citrus spp.), lychee (Litchi chinensis), macadamias (Macadamia spp.), maize or corn (Zea mays L.), mandarin (Citrus reticulata), mango (Mangifera indica), mangosteen (Garcinia mangostana), melon (Cucumis melo), millets (Setaria spp., Echinochloa spp., Eleusine spp., Panicum spp., Pennisetum spp.), oats (Avena sativa), oil palm (Ellis quineensis), okra (Abelmoschus esculentus), olive (Olea europaea), onion (Allium cepa) and other alliums (Allium spp.), orange (Citrus sinensis), papaya (Carica papaya), parsnip (Pastinaca sativa), passionfruit (Passiflora edulis), pecan (Carya illinoinensis), peaches and nectarines (Prunus persica), pear (Pyrus spp.), pea (Pisum sativum), peanut (Arachis hypogaea), peonies (Paeonia spp.), persimmons (Diospyros kaki, Diospyros spp.), petunias (Petunia spp.), pineapple (Ananas comosus), pistachio (Pistacia vera), plantains (Musa spp.), plum (Prunus domestica), poinsettia (Euphorbia pulcherrima), pomelo (Citrus maxima), poplar (Populus spp.), potato (Solanum tuberosum), pumpkins and squashes (Cucurbita pepo, C. maxima, C. moschata), quince (Cydonia oblonga), raspberries (Rubus idaeus, Rubus occidentalis, Rubus spp.), rhubarbs (Rheum spp.), rice (Oryza sativa L.), roses (Rosa spp.), rubber (Hevea brasiliensis), rye (Secale cereale), safflower (Carthamus tinctorius L), satsuma (Citrus unshiu), sesame seed (Sesame indium), sorghum (Sorghum bicolor), sour orange (Citrus x aurantium), soursop (Annona muricata), soybean (Glycine max L.), strawberries (Fragaria spp., Fragaria x ananassa), sugar beet (Beta vulgaris), sugarcanes (Saccharum spp.), sunflower (Helianthus annuus), sweet potato (Ipomoea batatas), tamarind (Tamarindus indica), tangerine (Citrus tangerina), tea (Camellia sinensis), tobacco (Nicotiana tabacum L.), tomatillo (Physalis philadelphica), tomato (Solanum lycopersicum or Lycopersicon esculentum), tulips (Tulipa spp.), walnuts (Juglans spp. L.), watermelon (Citrulus lanatus), wheat (Triticum aestivum), and yams (Discorea spp.). Wild relatives of domesticated plants are also of interest.

Further aspects of the disclosure include plantable compositions comprising a seed and a coating covering the seed, wherein the coating comprises a plurality of minicells comprising a first effective amount of first minicells comprising a first exogenous protein toxin comprising Pir or a plurality of minicells comprising a second effective amount of second minicells comprising a second exogenous protein toxin comprising Cry, and wherein a plurality of minicells comprising a second effective amount of second minicells comprising a second exogenous protein toxin comprising Cry or a plurality of minicells comprising a first effective amount of first minicells comprising a first exogenous protein toxin comprising Pir is applied after the composition is planted.

Further aspects of the disclosure include plantable compositions including a seed and a coating covering the seed, wherein the coating includes a plurality of minicells including a first effective amount of an exogenous protein toxin including Pir or a second effective amount of a Bt-derived AI. Additional embodiments of this aspect include a second effective amount of a Bt-derived AI or a plurality of minicells including a first effective amount of an exogenous protein toxin including Pir being applied after the composition is planted.

### Methods of Making Insecticidal Compositions

A further aspect of the disclosure includes a method of making an insecticidal minicell mixture, including the steps of: a) providing a first minicell produced from a first parent bacterium including at least one genetic mutation causing a modification in a cell partitioning function of the parent bacterium and further including a first vector comprising a coding sequence of a first exogenous protein toxin including Pir; b) providing a second minicell produced from a second parent bacterium including at least one genetic mutation causing a modification in a cell partitioning function of the parent bacterium and further including a second vector comprising a coding sequence of a second exogenous protein toxin including Cry; and c) mixing a first effective amount of the first minicells and a second effective amount of the second minicells, at a ratio in the range of about 50:1-1:50. The ratio may be about 50:1, 45:1, 40:1, 35:1, 30:1, 25:1, 20:1, 15:1, 10:1, 5:1, 1:1, 1:5, 1:10, 1:15, 1:20, 1:25, 1:30, 1:35, 1:40, 1:45, or 1:50. In some embodiments of this aspect, the first effective amount and the second effective amount are mixed in a ratio of about 46:1, 23:1, 11:1, 9:1, 6:1, 5:1, 3:1, or 1:1. The at least one genetic mutation in the parent bacterium may be disruption of a z-ring inhibition protein (e.g., minC or minD), disruption of z-ring inhibition proteins and a cell division topological specificity factor (e.g., minCDE), or over-expression of the septum machinery component FtsZ.

A further aspect of the disclosure includes a method of making an insecticidal minicell mixture, including the steps of: a) providing a minicell produced from a first parent bacterium including at least one genetic mutation causing a modification in a cell partitioning function of the parent bacterium and further including a vector including a coding sequence of an exogenous protein toxin including Pir; b) providing a Bt-derived AI; and c) mixing a first effective amount of the minicell and a second effective amount of the Bt-derived AI, at a ratio in the range of about 50:1-1:50. The ratio may be about 50:1, 45:1, 40:1, 35:1, 30:1, 25:1, 20:1, 15:1, 10:1, 5:1, 1:1, 1:5, 1:10, 1:15, 1:20, 1:25, 1:30, 1:35, 1:40, 1:45, or 1:50. In some embodiments of this aspect, the first effective amount and the second effective amount are mixed in a ratio of about 23:1, 22:1, 11:1, 6:1, 3:1, 2:1, or 1.5:1. The at least one genetic mutation in the parent bacterium may be disruption of a z-ring inhibition protein (e.g., minC or minD), disruption of z-ring inhibition proteins and a cell division topological specificity factor (e.g., minCDE), or over-expression of the septum machinery component FtsZ.

An additional aspect of the disclosure includes a method of making an insecticidal minicell mixture, including the steps of: a) providing a first minicell including a first exogenous protein toxin including Pir; b) providing a second minicell including a second exogenous protein toxin including Cry; and c) mixing a first effective amount of the first minicell and a second effective amount at a ratio in the range of about 50:1-1:50. The ratio may be about 50:1, 45:1, 40:1, 35:1, 30:1, 25:1, 20:1, 15:1, 10:1, 5:1, 1:1, 1:5, 1:10, 1:15, 1:20, 1:25, 1:30, 1:35, 1:40, 1:45, or 1:50. In some embodiments of this aspect, the first effective amount and the second effective amount are mixed in a ratio of about 46:1, 23:1, 11:1, 9:1, 6:1, 5:1, 3:1, or 1:1.

An additional aspect of the disclosure includes a method of making an insecticidal minicell mixture, including the steps of: a) providing a minicell including an exogenous protein toxin including Pir; b) providing a Bt-derived AI; and c) mixing a first effective amount of the minicell and a second effective amount of the Bt-derived AI at a ratio in the range of about 50:1-1:50. The ratio may be about 50:1, 45:1, 40:1, 35:1, 30:1, 25:1, 20:1, 15:1, 10:1, 5:1, 1:1, 1:5, 1:10, 1:15, 1:20, 1:25, 1:30, 1:35, 1:40, 1:45, or 1:50. In some embodiments of this aspect, the first effective amount and the second effective amount are mixed in a ratio of about 23:1, 22:1, 11:1, 6:1, 3:1, 2:1, or 1.5:1.

Still another aspect of the disclosure includes a method of producing a wettable powder including: a) providing a first effective amount of a first dried minicell including a first exogenous protein toxin including Pir; b) a second effective amount of a second dried minicell including a second exogenous protein toxin including Cry; and c) mixing the first effective amount and the second effective amount at a ratio in the range of about 50:1-1:50, wherein the wettable powder is configured to be dispersed in an aqueous carrier to create a composition for controlling at least one insect pest when the composition is administered to an insect pest. The ratio may be about 50:1, 45:1, 40:1, 35:1, 30:1, 25:1, 20:1, 15:1, 10:1, 5:1, 1:1, 1:5, 1:10, 1:15, 1:20, 1:25, 1:30, 1:35, 1:40, 1:45, or 1:50. In some embodiments of this aspect, the first effective amount and the second effective amount are mixed in a ratio of about 46:1, 23:1, 11:1, 9:1, 6:1, 5:1, 3:1, or 1:1.

Still another aspect of the disclosure includes a method of producing a wettable powder including: a) providing a first effective amount of a first dried minicell including an exogenous protein toxin including Pir; b) a second effective amount of a dried Bt-derived AI; and c) mixing the first effective amount and the second effective amount at a ratio in the range of about 50:1-1:50, wherein the wettable powder is configured to be dispersed in an aqueous carrier to create a composition for controlling at least one insect pest when the composition is administered to an insect pest. The ratio may be about 50:1, 45:1, 40:1, 35:1, 30:1, 25:1, 20:1, 15:1, 10:1, 5:1, 1:1, 1:5, 1:10, 1:15, 1:20, 1:25, 1:30, 1:35, 1:40, 1:45, or 1:50. In some embodiments of this aspect, the first effective amount and the second effective amount are mixed in a ratio of about 23:1, 22:1, 11:1, 6:1, 3:1, 2:1, or 1.5:1.

In additional embodiments of any of the above methods of making insecticidal compositions, the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest. The synergistic effect allows a lower effective amount of each active ingredient (e.g., exogenous protein toxin; Bt-derived AI) to be used, while maintaining their efficacy in agricultural applications.

### Methods of Controlling an Insect Pest

A further aspect of the disclosure includes a method of controlling an insect pest, the method including: administering the composition of any one of the preceding embodiments to an insect pest. In some embodiments of this aspect, administering the composition to the insect pest includes an administration method selected from the group of delivering the composition to the insect pest for ingestion; contacting the insect pest with the composition; delivering the composition to at least one habitat where the insect pest grows, lives, reproduces, feeds, or infests; or applying the composition to a plant. In other embodiments of this aspect, the composition is applied to the plant as at least one of a foliar treatment, an injection treatment, a pre-emergence treatment, and a post-emergence treatment. In further embodiments of this aspect, which may be combined with any of the preceding embodiments, the composition is formulated as at least one of a Ready To Use (RTU) formulation, a suspension concentrate, a tank-mix, an aerosol, a seed treatment, a root dip, a soil treatment, an irrigation formulation, a sprinkler formulation, or a drench treatment, a dust, an emulsifiable concentrate, a flowable concentrate, a formulation intermediate, a granular formulation, an impregnated materials formulation, a pelleted/tableted formulation, a soluble concentrate formulation, a technical chemical formulation, a water dispersable granule formulation, a water soluble packaging formulation, or a wettable powder formulation. In additional embodiments of this aspect, which may be combined with any of the preceding embodiments, control includes at least one of: a reduction in insect pest number, a reduction in insect pest weight, a reduction in physical damage caused by the insect pest, and an increase in insect pest mortality. In some embodiments of this aspect, the reduction in insect pest number, reduction in insect pest weight, reduction in physical damage caused by the insect pest, or increase in insect pest mortality is as compared to an insect pest that has not been administered the composition. In further embodiments of this aspect, the reduction in insect pest number is an at least 10% reduction, an at least 15% reduction, an at least 20% reduction, an at least 25% reduction, an at least 30% reduction, an at least 35% reduction, an at least 40% reduction, an at least 45% reduction, an at least 50% reduction, an at least 55% reduction, an at least 60% reduction, an at least 65% reduction, an at least 70% reduction, an at least 75% reduction, or an at least 80% reduction, the reduction in insect pest weight is an at least 10% reduction, an at least 15% reduction, an at least 20% reduction, an at least 25% reduction, an at least 30% reduction, an at least 35% reduction, an at least 40% reduction, an at least 45% reduction, an at least 50% reduction, an at least 55% reduction, an at least 60% reduction, an at least 65% reduction, an at least 70% reduction, an at least 75% reduction, or an at least 80% reduction, the reduction in physical damage is an at least 10% reduction, an at least 15% reduction, an at least 20% reduction, an at least 25% reduction, an at least 30% reduction, an at least 35% reduction, an at least 40% reduction, an at least 45% reduction, an at least 50% reduction, an at least 55% reduction, an at least 60% reduction, an at least 65% reduction, an at least 70% reduction, an at least 75% reduction, or an at least 80% reduction, and the increase in insect pest mortality is an at least 10% increase, an at least 15% increase, an at least 20% increase, an at least 25% increase, an at least 30% increase, an at least 35% increase, an at least 40% increase, an at least 45% increase, an at least 50% increase, an at least 55% increase, an at least 60% increase, and at least 65% increase, an at least 70% increase, an at least 75% increase, or an at least 80% increase. In some embodiments of this aspect, which may be combined with any of the preceding embodiments, control includes an observed insect pest mortality of at least about 55%, 60%, 65%, 70%, 75%, 80%, 85%, 90%, or 95%. In some embodiments of this aspect, which may be combined with any of the preceding embodiments, the at least one insect pest is selected from the group of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., or Diptera spp.

### Insect Pests of the Present Disclosure

Pests of the present disclosure include, but are not limited to, insect pests from the orders Anoplura, Coleoptera, Diptera, Hemiptera, Hymenoptera, Isoptera, Lepidoptera, Orthoptera, Psocoptera, Isoptera, Blattaria, Siphonoptera, Thysanoptera, and Thysanura. Examples of pests from the order Anoplura include Haematopinus spp., Linognathus spp., Pediculus spp., Pemphigus spp., and Phylloxera spp.

Examples of pests from the order Coleoptera include Acalymma vittatum, Acanthoscelides obtectus, Adoretus spp., Agelastica alni, Agrilus spp. such as A. anxius, A. planipennis, and A. sinuatus, Agriotes spp. such as A. fuscicollis, A. lineatus, and A. obscurus, Alphitobius diaperinus, Amphimallus solstitialis, Anisandrus dispar, Anisoplia austriaca, Anobium punctatum, Anomala corpulenta, Anomala rufocuprea, Anoplophora spp. such as A. glabripennis, Anthonomus spp. such as A. eugenii, A. grandis, and A. pomorum, Anthrenus spp., Aphthona euphoridae, Apion spp., Apogonia spp., Athous haemorrhoidalis, Atomaria spp. such as A. linearis, Attagenus spp., Aulacophora femoralis, Blastophagus piniperda, Blitophaga undata, Bruchidius obtectus, Bruchus spp. such as B. lentis, B. pisorum, and B. rufimanus, Byctiscus betulae, Callidiellum rufipenne, Callopistria floridensis, Callosobruchus chinensis, Cameraria ohridella, Cassida nebulosa, Cerotoma trifurcata, Cetonia aurata, Ceuthorhynchus spp. such as C. assimilis and C. nap, Chaetocnema tibialis, Cleonus mendicus, Conoderus spp. such as C. vespertinus; Conotrachelus nenuphar, Cosmopolites spp., Costelytra zealandica, Crioceris asparagi, Cryptolestes ferrugineus, Cryptorhynchus lapathi, Ctenicera spp. such as C. destructor; Curculio spp., Cylindrocopturus spp., Cyclocephala spp., Dactylispa balyi, Dectes texanus, Dermestes spp., Diabrotica spp. such as D. undecimpunctata, D. speciosa, D. longicornis, D. semipunctata, and D. virgifera, Diaprepes abbreviates, Dichocrocis spp., Dicladispa armigera, Diloboderus abderus, Diocalandra frumenti (Diocalandra stigmaticollis), Enaphalodes rufulus, Epilachna spp. such as E. varivestis and E. vigintioctomaculata, Epitrix spp. such as E. hirtipennis and E. similaris, Eutheola humilis, Eutinobothrus brasiliensis, Faustinus cubae, Gibbium psylloides, Gnathocerus cornutus, Hellula undalis, Heteronychus arator, Hylamorpha elegans, Hylobius abietis, Hylotrupes bajulus, Hypera spp. such as H. brunneipennis and H. postica, Hypomeces squamosus, Hypothenemus spp., Ips typographus, Lachnosterna consanguinea, Lasioderma serricorne, Latheticus oryzae, Lathridius spp., Lema spp. such as L. bilineata and L. melanopus, Leptinotarsa spp. such as L. decemlineata, Leptispa pygmaea, Limonius californicus, Lissorhoptrus oryzophilus, Lixus spp., Luperodes spp., Lyctus spp. such as L. bruneus, Liogenys fuscus, Macrodactylus spp. such as M. subspinosus, Maladera matrida, Megaplatypus mutates, Megascelis spp., Melanotus communis, Meligethes spp. such as M. aeneus, Melolontha spp. such as M. hippocastani and M. melolontha, Metamasius hemipterus, Microtheca spp., Migdolus spp. such as M. fryanus, Monochamus spp. such as M. alternatus, Naupactus xanthographus, Niptus hololeucus, Oberia brevis, Oemona hirta, Oryctes rhinoceros, Oryzaephilus surinamensis, Oryzaphagus oryzae, Otiorrhynchus sulcatus, Otiorrhynchus ovatus, Otiorrhynchus sulcatus, Oulema melanopus, Oulema oryzae, Oxycetonia jucunda, Phaedon spp. such as P. brassicae and P. cochleariae, Phoracantha recurva, Phyllobius pyri, Phyllopertha horticola, Phyllophaga spp. such as P. helleri, Phyllotreta spp. such as P. chrysocephala, P. nemorum, P. striolata, and P. vittula, Phyllopertha horticola, Popillia japonica, Premnotrypes spp., Psacothea hilaris, Psylliodes chrysocephala, Prostephanus truncates, Psylliodes spp., Ptinus spp., Pulga saltona, Rhynchophorus spp. such as R. billineatus, R. ferrugineus, R. palmarum, R. phoenicis, and R. vulneratus, Rhyzopertha dominica, Saperda candida, Scolytus schevyrewi, Scyphophorus acupunctatus, Sitona lineatus, Sitophilus spp. such as S. granaria, S. oryzae, and S. zeamais, Sphenophorus spp. such as S. levis, Stegobium paniceum, Sternechus spp. such as S. subsignatus, Strophomorphus ctenotus, Symphyletes spp., Tanymecus spp., Tenebrio molitor, Tenebrioides mauretanicus, Tribolium spp. such as T. castaneum, Trogoderma spp., Tychius spp., Xylotrechus spp. such as X. pyrrhoderus, and Zabrus spp. such as Z. tenebrioides.

Examples of pests from the order Diptera include Aedes spp. such as A. aegypti, A. albopictus, and A. vexans, Anastrepha ludens, Anopheles spp. such as A. albimanus, A. crucians, A. freeborni, A. gambiae, A. leucosphyrus, A. maculopennis, A. minimus, A. quadrimaculatus, and A. sinensis, Bactrocera invadens, Bibio hortulanus, Calliphora erythrocephala, Calliphora vicina, Ceratitis capitata, Chrysomyia spp. such as C. bezziana, C. hominivorax, and C. macellaria, Chrysops atlanticus, Chrysops discalis, Chrysops silacea, Cochliomyia spp. such as C. hominivorax, Contarinia spp. such as C. sorghicola, Cordylobia anthropophaga, Culex spp. such as C. nigripalpus, C. pipiens, C. quinquefasciatus, C. tarsalis, and C. tritaeniorhynchus, Culicoides furens, Culiseta inornata, Culiseta melanura, Cuterebra spp., Dacus cucurbitae, Dacus oleae, Dasineura brassicae, Dasineura oxycoccana, Delia spp. such as D. antique, D. coarctata, D. platura, and D. radicum, Dermatobia hominis, Drosophila spp. such as D. suzukii, Fannia spp. such as F. canicularis, Gasterophilus spp. such as G. intestinalis, Geomyza tipunctata, Glossina spp. such as G. fuscipes, G. morsitans, G. palpalis, and G. tachinoides, Haematobia irritans, Haplodiplosis equestris, Hippelates spp., Hylemyia spp. such as H. platura, Hypoderma spp. such as H. lineata, Hyppobosca spp., Hydrellia philippina, Leptoconops torrens, Liriomyza spp. such as L. sativae and L. trifolii, Lucilia spp. such as L. caprin, L. cuprina, and L. sericata, Lycoria pectoralis, Mansonia titillanus, Mayetiola spp. such as M. destructor, Musca spp. such as M. autumnalis and M. domestica, Muscina stabulans, Oestrus spp. such as O. ovis, Opomyza florum, Oscinella spp. such as O. frit, Orseolia oryzae, Pegomya hysocyami, Phlebotomus argentipes, Phorbia spp. such as P. antiqua, P. brassicae, and P. coarctata, Phytomyza gymnostoma, Prosimulium mixtum, Psila rosae, Psorophora columbiae, Psorophora discolor, Rhagoletis spp. such as R. cerasi, R. cingulate, R. indifferens, R. mendax, and R. pomonella, Rivellia quadrifasciata, Sarcophaga spp. such as S. haemorrhoidalis, Simulium vittatum, Sitodiplosis mosellana, Stomoxys spp. such as S. calcitrans, Tabanus spp. such as T. atratus, T. bovinus, T. lineola, and T. similis, Tannia spp., Thecodiplosis japonensis, Tipula oleracea, Tipula paludosa, and Wohlfahrtia spp.

Examples of pests from the order Hemiptera include Acizzia jamatonica, Acrosternum spp. such as A. hilare, Acyrthosiphon spp. such as A. onobrychis and A. pisum, Adelges laricis, Adelges tsugae, Adelphocoris spp., such as A. rapidus and A. superbus, Aeneolamia spp., Agonoscena spp., Aulacorthum solani, Aleurocanthus woglumi, Aleurodes spp., Aleurodicus disperses, Aleurolobus barodensis, Aleurothrixus spp., Amrasca spp., Anasa tristis, Antestiopsis spp., Anuraphis cardui, Aonidiella spp., Aphanostigma piri, Aphidula nasturtii, Aphis spp. such as A. craccivora, A. fabae, A. forbesi, A. gossypii, A. grossulariae, A. maidiradicis, A. pomi, A. sambuci, A. schneideri, and A. spiraecola, Arboridia apicalis, Arilus critatus, Aspidiella spp., Aspidiotus spp., Atanus spp., Aulacaspis yasumatsui, Aulacorthum solani, Bactericera cockerelli (Paratrioza cockerelli), Bemisia spp. such as B. argentifolii and B. tabaci (Aleurodes tabaci), Blissus spp. such as B. leucopterus, Brachycaudus spp. such as B. cardui, B. helichrysi, B. persicae, and B. prunicola, Brachycolus spp., Brachycorynella asparagi, Brevicoryne brassicae, Cacopsylla spp. such as C. fulguralis and C. pyricola (Psylla piri), Calligypona marginata, Calocoris spp., Campylomma livida, Capitophorus horni, Carneocephala fulgida, Cavelerius spp., Ceraplastes spp., Ceratovacuna lanigera, Ceroplastes ceriferus, Cerosipha gossypii, Chaetosiphon fragaefolii, Chionaspis tegalensis, Chlorita onukii, Chromaphis juglandicola, Chrysomphalus ficus, Cicadulina mbila, Cimex spp. such as C. hemibterus and C. lectularius, Coccomytilus halli, Coccus spp. such as C. hesperidum and C. pseudomagnoliarum, Corythucha arcuata, Creontiades dilutus, Cryptomyzus ribis, Chrysomphalus aonidum, Cryptomyzus ribis, Ctenarytaina spatulata, Cyrtopeltis notatus, Dalbulus spp., Dasynus piperis, Dialeurodes spp. such as D. citrifoli, Dalbulus maidis, Diaphorina spp. such as D. citri, Diaspis spp. such as D. bromeliae, Dichelops furcatus, Diconocoris hewetti, Doralis spp., Dreyfusia nordmannianae, Dreyfusia piceae, Drosicha spp., Dysaphis spp. such as D. plantaginea, D. pyri, and D. radicola, Dysaulacorthum pseudosolani, Dysdercus spp. such as D. cingulatus and D. intermedius, Dysmicoccus spp., Edessa spp., Geocoris spp., Empoasca spp. such as E. fabae and E. Solana, Epidiaspis leperii, Eriosoma spp. such as E. lanigerum and E. pyricola, Erythroneura spp., Eurygaster spp. such as E. integriceps, Euscelis bilobatus, Euschistus spp. such as E. heros, E. impictiventris, and E. servus, Fiorinia theae, Geococcus coffeae, Glycaspis brimblecombei, Halyomorpha spp. such as H. halys, Heliopeltis spp., Homalodisca vitripennis (=H. coagulata), Horcias nobilellus, Hyalopterus pruni, Hyperomyzus lactucae, Icerya spp. such as I. purchasi, Idiocerus spp., Idioscopus spp., Laodelphax striatellus, Lecanium spp., Lecanoideus floccissimus, Lepidosaphes spp. such as L. ulmi, Leptocorisa spp., Leptoglossus phyllopus, Lipaphis erysimi, Lygus spp. such as L. hesperus, L. lineolaris, and L. pratensis, Maconellicoccus hirsutus, Marchalina hellenica, Macropes excavatus, Macrosiphum spp. such as M. rosae, M. avenae, and M. euphorbiae, Macrosteles quadrilineatus, Mahanarva fimbriolata, Megacopta cribraria, Megoura viciae, Melanaphis pyrarius, Melanaphis sacchari, Melanocallis (=Tinocallis) caryaefoliae, Metcafiella spp., Metopolophium dirhodum, Monellia costalis, Monelliopsis pecanis, Myzocallis coryli, Murgantia spp., Myzus spp. such as M. ascalonicus, M. cerasi, M. nicotianae, M. persicae, and M. varians, Nasonovia ribisnigri, Neotoxoptera formosana, Neomegalotomus spp., Nephotettix spp. such as N. malayanus, N. nigropictus, N. parvus, and N. virescens, Nezara spp. such as N. viridula, Nilaparvata lugens, Nysius huttoni, Oebalus spp. such as O. pugnax, Oncometopia spp., Orthezia praelonga, Oxycaraenus hyalinipennis, Parabemisia myricae, Parlatoria spp., Parthenolecanium spp. such as P. corni and P. persicae, Pemphigus spp. such as P. bursarius and P. populivenae, Peregrinus maidis, Perkinsiella saccharicida, Phenacoccus spp. such as P. aceris and P. gossypii, Phloeomyzus passerinii, Phorodon humuli, Phylloxera spp. such as P. devastatrix, Piesma quadrata, Piezodorus spp. such as P. guildinii, Pinnaspis aspidistrae, Planococcus spp. such as P. citri and P. ficus, Prosapia bicincta, Protopulvinaria pyriformis, Psallus seriatus, Pseudacysta persea, Pseudaulacaspis pentagona, Pseudococcus spp. such as P. comstocki, Psylla spp. such as P. mali, Pteromalus spp., Pulvinaria amygdali, Pyrilla spp., Quadraspidiotus spp., such as Q. perniciosus, Quesada gigas, Rastrococcus spp., Reduvius senilis, Rhizoecus americanus, Rhodnius spp., Rhopalomyzus ascalonicus, Rhopalosiphum spp. such as R. pseudobrassicas, R. insertum, R. maidis, and R. padi, Sagatodes spp., Sahlbergella singularis, Saissetia spp., Sappaphis mala, Sappaphis mali, Scaptocoris spp., Scaphoides titanus, Schizaphis graminum, Schizoneura lanuginosa, Scotinophora spp., Selenaspidus articulatus, Sitobion avenae, Sogata spp., Sogatella furcifera, Solubea insularis, Spissistilus festinus (=Stictocephala festina), Stephanitis nashi, Stephanitis pyrioides, Stephanitis takeyai, Tenalaphara malayensis, Tetraleurodes perseae, Therioaphis maculate, Thyanta spp. such as T. accerra and T. perditor, Tibraca spp., Tomaspis spp., Toxoptera spp. such as T. aurantii, Trialeurodes spp. such as T. abutilonea, T. ricini, and T. vaporariorum, Triatoma spp., Trioza spp., Typhlocyba spp., Unaspis spp. such as U. citri and U. yanonensis, and Viteus vitifolii.

Examples of pests from the order Hymenoptera include Acanthomyops interjectus, Acromyrmex spp., Arge spp., Athalia rosae, Atta spp. such as A. capiguara, A. cephalotes, A. cephalotes, A. laevigata, A. robusta, A. sexdens, and A. texana, Bombus spp., Brachymyrmex spp., Camponotus spp. such as C. floridanus, C. pennsylvanicus, and C. modoc, Cardiocondyla nuda, Cephus spp., Chalibion spp., Crematogaster spp., Dasymutilla occidentalis, Diprion spp., Diprionidae spp., Dolichovespula maculata, Dorymyrmex spp., Dryocosmus kuriphilus, Formica spp., Gilpinia polytoma, Hoplocampa spp. such as H. minuta and H. testudinea, Iridomyrmex humilis, Lasius spp. such as L. niger, Linepithema humile, Liometopum spp., Leptocybe invasa, Monomorium spp. such as M. pharaonis, Neodiprion spp., Nylandria fulva, Pachycondyla chinensis, Paratrechina longicornis, Paravespula spp. such as P. germanica, P. pennsylvanica, and P. vulgaris, Pheidole spp. such as P. megacephala, Pogonomyrmex spp. such as P. barbatus, P. californicus, Polistes rubiginosa, Prenolepsis imparis, Pseudomyrmex gracilis, Schelipron spp., Sirex cyaneus, Solenopsis spp. such as S. geminata, S. invicta, S. molesta, S. richteri, and S. xyloni, Sphecius speciosus, Sphex spp., Tapinoma spp. such as T. melanocephalum and T. sessile, Tetramorium spp. such as T. caespitum and T. bicarinatum, Vespa spp. such as V. crabro, Vespula spp. such as V. squamosa, Wasmannia auropunctata, and Xylocopa spp.

Examples of pests from the order Isoptera include Calotermes flavicollis, Coptotermes spp. such as C. formosanus, C. gestroi, and C. acinaciformis, Cornitermes cumulans, Cryptotermes spp. such as C. brevis and C. cavifrons, Globitermes sulfureus, Heterotermes spp. such as H. aureus, H. longiceps, and H. tenuis, Leucotermes flavipes, Odontotermes spp., Incisitermes spp. such as I. minor and I. snyderi, Marginitermes hubbardi, Mastotermes spp. such as M. darwiniensis, Neocapritermes spp. such as N. opacus and N. parvus, Neotermes spp., Procornitermes spp., Reticulitermes spp. such as R. hesperus, R. tibialis, R. speratus, R. flavipes, R. grassei, R. lucifugus, R. santonensis, and R. virginicus, Termes natalensis, and Zootermopsis spp. such as Z. angusticollis and Z. nevadensis,

Examples of pests from the order Lepidoptera include Achroia grisella, Acleris spp. such as A. fimbriana, A. gloverana, and A. variana, Acrolepiopsis assectella, Acronicta major, Adoxophyes spp. such as A. cyrtosema and A. orana, Aedia leucomelas, Agrotis spp. such as A. exclamationis, A. fucosa, A. ipsilon, A. orthogoma, A. segetum, and A. subterranea, Alabama argillacea, Aleurodicus dispersus, Alsophila pometaria, Ampelophaga rubiginosa, Amyelois transitella, Anacampsis sarcitella, Anagasta kuehniella, Anarsia lineatella, Anisota senatoria, Antheraea pernyi, Anticarsia (=Thermesia) spp. such as A. gemmatalis, Apamea spp., Aproaerema modicella, Archips spp. such as A. argyrospila, A. fuscocupreanus, A. rosana, and A. xyloseanus, Argyresthia conjugella, Argyroploce spp., Argyrotaenia spp. such as A. velutinana, Athetis mindara, Austroasca viridigrisea, Autographa gamma, Autographa nigrisigna, Barathra brassicae, Bedellia spp., Bonagota salubricola, Borbo cinnara, Bucculatrix thurberiella, Bupalus piniarius, Busseola spp., Cacoecia spp. such as C. murinana and C. podana, Cactoblastis cactorum, Cadra cautella, Calingo braziliensis, Caloptilis theivora, Capua reticulana, Carposina spp. such as C. niponensis and C. sasakii, Cephus spp., Chaetocnema aridula, Cheimatobia brumata, Chilo spp. such as C. indicus, C. suppressalis, and C. partellus, Choreutis pariana, Choristoneura spp. such as C. conflictana, C. fumiferana, C. longicellana, C. murinana, C. occidentalis, and C. rosaceana, Chrysodeixis (=Pseudoplusia) spp. such as C. eriosoma and C. includens, Cirphis unipuncta, Clysia ambiguella, Cnaphalocerus spp., Cnaphalocrocis medinalis, Cnephasia spp., Cochylis hospes, Coleophora spp., Colias eurytheme, Conopomorpha spp., Conotrachelus spp., Copitarsia spp., Corcyra cephalonica, Crambus caliginosellus, Crambus teterrellus, Crocidosema (=Epinotia) aporema, Cydalima (=Diaphania) perspectalis, Cydia (=Carpocapsa) spp. such as C. pomonella and C. latiferreana, Dalaca noctuides, Datana integerrima, Dasychira pinicola, Dendrolimus spp. such as D. pini, D. spectabilis, and D. sibiricus, Desmia funeralis, Diaphania spp. such as D. nitidalis and D. hyalinata, Diatraea grandiosella, Diatraea saccharalis, Dipthera festiva, Earias spp. such as E. insulana and E. vittella, Ecdytolopha aurantianu, Egira (=Xylomyges) curialis, Elasmopalpus lignosellus, Eldana saccharina, Endopiza viteana, Ennomos subsignaria, Eoreuma loftini, Ephestia spp. such as E. cautella, E. elutella, and E. kuehniella, Epinotia aporema, Epiphyas postvittana, Erannis tiliana, Erionota thrax, Etiella spp., Eulia spp., Eupoecilia ambiguella, Euproctis chrysorrhoea, Euxoa spp., Evetria bouliana, Faronta albilinea, Feltia spp. such as F. subterranean, Galleria mellonella, Gracillaria spp., Grapholita spp. such as G. funebrana, G. molesta, and G. inopinata, Halysidota spp., Harrisina americana, Hedylepta spp., Helicoverpa spp. such as H. armigera (=Heliothis armigera) and H. zea (=Heliothis zea); Heliothis spp. such as H. assulta, H. subflexa, and H. virescens; Hellula spp. such as H. undalis and H. rogatalis, Helocoverpa gelotopoeon, Hemileuca oliviae, Herpetogramma licarsisalis, Hibernia defoliaria, Hofmannophila pseudospretella, Homoeosoma electellum, Homona magnanima, Hypena scabra, Hyphantna cunea, Hyponomeuta padella, Hyponomeuta malinellus, Kakivoria flavofasciata, Keiferia lycopersicella, Lambdina fiscellaria fiscellaria, Lambdina fiscellaria lugubrosa, Lamprosema indicata, Laspeyresia molesta, Leguminivora glycinivorella, Lerodea eufala, Leucinodes orbonalis, Leucoma salicis, Leucoptera spp. such as L. coffeella and L. scitella, Leuminivora lycinivorella, Lithocolletis blancardella, Lithophane antennata, Llattia octo (=Amyna axis), Lobesia botrana, Lophocampa spp., Loxagrotis albicosta, Loxostege spp. such as L. sticticalis and L. cereralis, Lymantria spp. such as L. dispar and L. monacha, Lyonetia clerkella, Lyonetia prunifoliella, Malacosoma spp. such as M. americanum, M. californicum, M. constrictum, and M. neustria, Mamestra spp. such as M. brassicae and M. configurata, Mamstra brassicae, Manduca spp. such as M. quinquemaculata and M. sexta, Marasmia spp., Marmara spp., Maruca testulalis, Megalopyge lanata, Melanchra picta, Melanitis leda, Mocis spp. such as M. latipes and M. repanda, Monochroa fragariae, Mythimna separata, Nemapogon cloacella, Neoleucinodes elegantalis, Nepytia spp., Nymphula spp., Oiketicus spp., Omiodes indicata, Omphisa anastomosalis, Operophtera brumata, Orgyia pseudotsugata, Oria spp., Orthaga thyrisalis, Ostrinia spp. such as O. nubilalis, Oulema oryzae, Paleacrita vernata, Panolis flammea, Parnara spp., Papaipema nebris, Papilio cresphontes, Paramyelois transitella, Paranthrene regalis, Paysandisia archon, Pectinophora spp. such as P. gossypiella, Peridroma saucia, Perileucoptera spp., such as P. coffeella, Phalera bucephala, Phryganidia californica, Phthorimaea spp. such as P. operculella; Phyllocnistis citrella, Phyllonorycter spp. such as P. blancardella, P. crataegella, P. issikii, and P. ringoniella, Pieris spp. such as P. brassicae, P. rapae, and P. napi, Pilocrocis tripunctata, Plathypena scabra, Platynota spp. such as P. flavedana, P. idaeusalis, and P. stultana; Platyptilia carduidactyla, Plebejus argus, Plodia interpunctella, Plusia spp., Plutella maculipennis, Plutella xylostella, Pontia protodica, Prays spp., Prodenia spp., Proxenus lepigone, Pseudaletia spp. such as P. sequax and P. unipuncta, Pyrausta nubilalis, Rachiplusia nu, Richia albicosta, Rhizobius ventralis, Rhyacionia frustrana, Sabulodes aegrotata, Schizura concinna, Schoenobius spp., Schreckensteinia festaliella, Scirpophaga spp. such as S. incertulas and S. innotata, Scotia segetum, Sesamia spp. such as S. inferens, Seudyra subflava, Sitotroga cerealella, Sparganothis pilleriana, Spilonota lechnaspis, Spilonota ocellana, Spodoptera (=Lamphygma) spp. such as S. cosmoides, S. eridania, S. exigua, S. frugiperda, S. latisfascia, S. littoralis, S. litura, and S. omithogalli, Stigmella spp., Stomopteryx subsecivella, Strymon bazochii, Sylepta derogata, Synanthedon spp. such as S. exitiosa, Tecia solanivora, Telehin licus, Thaumatopoea pityocampa, Thaumatotibia (=Cryptophlebia) leucotreta, Thaumetopoea pityocampa, Thecla spp., Theresimima ampelophaga, Thyrinteina spp., Tildenia inconspicuella, Tinea spp. such as T. cloacella and T. pellionella, Tineola bisselliella, Tortrix spp. such as T. viridana, Trichophaga tapetzella, Trichoplusia spp. such as T. ni, Tuta (=Scrobipalpula) absoluta, Udea spp. such as U. rubigalis, Virachola spp., Yponomeuta padella, and Zeiraphera canadensis.

Examples of pests from the order Mallophaga include Damalinea spp. and Trichodectes spp. Examples of pests from the order Orthoptera include Acheta domesticus, Calliptamus italicus, Chortoicetes terminifera, Ceuthophilus spp., Diastrammena asynamora, Dociostaurus maroccanus, Gryllotalpa spp. such as G. Africana and G. gryllotalpa; Gryllus spp., Hieroglyphus daganensis, Kraussaria angulifera, Locusta spp. such as L. migratoria and L. pardalina, Melanoplus spp. such as M. bivittatus, M. femurrubrum, M. mexicanus, M. sanguinipes, and M. spretus, Nomadacris septemfasciata, Oedaleus senegalensis, Scapteriscus spp., Schistocerca spp. such as S. americana and S. gregaria, Stemopelmatus spp., Tachycines asynamorus, and Zonozerus variegatus. Examples of pests from the order Psocoptera include Liposcelis spp. Examples of pests from the order Isoptera include Calotermes flavicollis, Coptotermes spp. such as C. formosanus, C. gestroi, and C. acinaciformis, Cornitermes cumulans, Cryptotermes spp. such as C. brevis and C. cavifrons, Globitermes sulfureus, Heterotermes spp. such as H. aureus, H. longiceps, and H. tenuis, Leucotermes flavipes, Odontotermes spp., Incisitermes spp. such as I. minor and I. snyder, Marginitermes hubbardi, Mastotermes spp. such as M. darwiniensis, Neocapritermes spp. such as N. opacus and N. parvus, Neotermes spp., Procornitermes spp., Zootermopsis spp. such as Z. angusticollis and Z. nevadensis, Reticulitermes spp. such as R. hesperus, R. tibialis, R. speratus, R. flavipes, R. grassei, R. lucifugus, R. santonensis, R. virginicus, and Termes natalensis. Examples of pests from the order include Blatta spp. such as B. orientalis and B. lateralis, Blattella spp. such as B. asahinae and B. germanica; Leucophaea maderae, Panchlora nivea, Periplaneta spp. such as P. americana, P. australasiae, P. brunnea, P. fuligginosa, and P. japonica, Supella longipalpa, Parcoblatta pennsylvanica, Eurycotis floridana, and Pycnoscelus surinamensis.

Examples of pests from the order Siphonoptera include Cediopsylla simplex, Ceratophyllus spp., Ctenocephalides spp. such as C. felis and C. canis, Xenopsylla cheopis, Pulex irritans, Trichodectes canis, Tunga penetrans, and Nosopsyllus fasciatus. Examples of pests from the order Thysanoptera include Baliothrips biformis, Dichromothrips corbetti, Dichromothrips ssp., Echinothrips americanus, Enneothrips flavens, Frankliniella spp. such as F. fusca, F. occidentalis, and F. tritici, Heliothrips spp., Hercinothrips femoralis, Kakothrips spp., Microcephalothrips abdominalis, Neohydatothrips samayunkur, Pezothrips kellyanus, Rhipiphorothrips cruentatus, Scirtothrips spp. such as S. citri, S. dorsalis, and S. perseae, Stenchaetothrips spp., Taeniothrips cardamoni, Taeniothrips inconsequens, Thrips spp. such as T. imagines, T. hawaiiensis, T. oryzae, T. palmi, T. parvispinus, and T. tabaci. Examples of pests from the order Thysanura include Lepisma saccharina, Ctenolepisma urbana, and Thermobia domestica.

Additional pests of the present disclosure include non-insect pests. The mixtures and methods of the present disclosure may be used on these non-insect pests as they would be used on the insect pests. Non-insect pests of the present disclosures include, but are not limited to, pests from the Class Arachnida for example Acari, e.g. of the families Argasidae, Ixodidae and Sarcoptidae, such as Amblyomma spp. (e.g. A. americanum, A. variegatum, and A. maculatum), Argas spp. such as A. persicus, Boophilus spp. such as B. annulatus, B. decoloratus, and B. microplus, Dermacentor spp. such as D. silvarum, D. andersoni, and D. variabilis, Hyalomma spp. such as H. truncatum, Ixodes spp. such as I. ricinus, I. rubicundus, I. scapularis, I. holocyclus, and I. pacificus, Rhipicephalus sanguineus, Ornithodorus spp. such as O. moubata, O. hermsi, and O. turicata, Ornithonyssus bacoti, Otobius megnini, Dermanyssus gallinae, Psoroptes spp. such as P. ovis, Rhipicephalus spp. such as R. sanguineus, R. appendiculatus, Rhipicephalus evertsi, Rhizoglyphus spp., Sarcoptes spp. such as S. scabiei, and Family Eriophyidae including Aceria spp. such as A. sheldoni, A. anthocoptes, Acallitus spp., Aculops spp. such as A. lycopersici and A. pelekassi, Aculus spp. such as A. schlechtendali, Colomerus vitis, Epitrimerus pyri, Phyllocoptruta oleivora, Eriophytes ribis and Eriophyes spp. such as Eriophyes sheldoni, Family Tarsonemidae including Hemitarsonemus spp., Phytonemus pallidus and Polyphagotarsonemus latus, Stenotarsonemus spp. Steneotarsonemus spinki, Family Tenuipalpidae including Brevipalpus spp. such as B. phoenicis, Family Tetranychidae including Eotetranychus spp., Eutetranychus spp., Oligonychus spp., Petrobia latens, Tetranychus spp. such as T. cinnabarinus, T. evansi, T. kanzawai, T. pacificus, T. phaseolus, T. telarius, and T. urticae, Bryobia praetiosa, Panonychus spp. such as P. ulmi and P. citri; Metatetranychus spp. and Oligonychus spp. such as O. pratensis, O. perseae, and Vasates lycopersici, Raoiella indica, Family Carpoglyphidae including Carpoglyphus spp., Penthaleidae spp. such as Halotydeus destructor, Family Demodicidae with species such as Dermodex spp., Family Trombicidea including Trombicula spp., Family Macronyssidae including Ornothonyssus spp., Family Pyemotidae including Pyemotes tritici; Tyrophagus putrescentiae, Family Acaridae including Acarus siro, Family Araneida including Latrodectus mactans, Tegenaria agrestis, Chiracanthium spp., Lycosa spp., Achaearanea tepidariorum, and Loxosceles reclusa; pests from the class Chilopoda, for example, Geophilus spp., and Scutigera spp. such as Scutigera coleoptrata; pests from the class Diplopoda for example Blaniulus guttulatus, Julus spp., and Narceus spp., pests from the class Symphyla for example Scutigerella immaculata; and pests from the order Isopoda for example, Armadillidium vulgare, Oniscus asellus, and Porcellio scaber.

### Definitions

The term “Bt-derived active ingredient” or “Bt-derived AI” as used herein means at least one of Bacillus thuringiensis, its fermentation solids, its spores, and its insecticidal toxins. Bacillus thuringiensis may be Bacillus thuringiensis subsp. kurstaki, Bacillus thuringiensis subsp. kurstaki strain SA-11, Bacillus thuringiensis subsp. kurstaki strain SA-12, Bacillus thuringiensis subsp. kurstaki strain ABTS-351, Bacillus thuringiensis subsp. kurstaki strain BMP123, Bacillus thuringiensis subsp. kurstaki strain EG2348, Bacillus thuringiensis subsp. kurstaki strain EG2371, Bacillus thuringiensis subsp. kurstaki strain EG7841, Bacillus thuringiensis subsp. kurstaki strain EG7826, Bacillus thuringiensis subsp. kurstaki strain EVB-113-19, Bacillus thuringiensis subsp. kurstaki strain VBTS 2546, Bacillus thuringiensis subsp. israelensis, Bacillus thuringiensis subsp. israelensis strain AM 65-52, Bacillus thuringiensis subsp. israelensis strain BMP 144, Bacillus thuringiensis subsp. israelensis strain EG2215, Bacillus thuringiensis subsp. tenebrionis, Bacillus thuringiensis subsp. tenebrionis strain SA-10, Bacillus thuringiensis subsp. tenebrionis strain NB-176, Bacillus thuringiensis var. aizawai, Bacillus thuringiensis var. aizawai strain GC-91, Bacillus thuringiensis var. aizawai strain ABTS 1857, Bacillus thuringiensis var. aizawai strain NB200, Bacillus thuringiensis subsp. galleriea, or Bacillus thuringiensis subsp. galleriea strain SDS-502. The Bt-derived AI may be formulated as dust, emulsifiable concentrate, flowable concentrate, formulation intermediate, granular, impregnated materials, pelleted/tableted, soluble concentrate, solution ready-to-use, technical chemical, water dispersable granules, water soluble packaging, or wettable powder. In end use, Bt-derived biological control products (containing Bt-derived AI) may include about 0.0005-100% of the Bt-derived AI and about 0-99.9995% of the inert. Specifically, end use products may include about 0.0005%, 0.001%, 0.0012%, 0.006%, 0.0183%, 0.049%, 0.064%, 0.1%, 0.1466%, 0.2%, 0.41%, 0.4365%, 0.47%, 0.49%, 0.7%, 0.72%, 1%, 1.16%, 1.6%, 1.7%, 1.94%, 2.15%, 2.19%, 2.3%, 2.5%, 2.6%, 2.8%, 2.86%, 3%, 3.5%, 4.5%, 4.95%, 5%, 5.35%, 5.71%, 6.07%, 6.38%, 6.4%, 6.6%, 7%, 8%, 9%, 9.5%, 9.83%, 10%, 10.3%, 10.31%, 10.4%, 10.8%, 11.61%, 12%, 12.3%, 12.65%, 12.74%, 14%, 14.32%, 14.4%, 14.49%, 14.6%, 15%, 16%, 17%, 17.19%, 17.6%, 17.8%, 18%, 18.44%, 19%, 21%, 22%, 23.7%, 24.5%, 25.5%, 34.11%, 37.4%, 40%, 43%, 45%, 48.1%, 50%, 54%, 58.2%, 63.5%, 67%, 70%, 76.2%, 76.5%, 80%, 83%, 84%, 85%, 89%, 90%, 91%, 92.6%, 98%, 98.35%, 99%, 99.3%, or 100% of the Bt-derived AI.

The term “insecticidal toxin,” as used herein, means a peptide or polypeptide which is capable of controlling an insect pest. Insecticidal toxins of the present disclosure include Cry and Pir toxins.

The term “effective amount,” as used herein, means an amount which controls an insect pest.

The term “control,” as used herein, means killing, reducing in numbers, and/or reducing growth, feeding or normal physiological development of any or all life stages of a plant pest, and/or reduction of the effects of a plant pest infection and/or infestation. An effective amount is an amount able to noticeably reduce pest growth, feeding, root penetration, maturation in the root, and/or general normal physiological development and/or symptoms resulting from the plant pest infection. In some embodiments the symptoms resulting from the plant pest infection and/or the number of plant pest particles are reduced by at least about 5%, at least about 10%, at least about 20%, at least about 30%, at least about 40%, at least about 50%, at least about 60%, at least about 70%, at least about 80%, or at least about 90% versus untreated controls.

For insect pests, the term “control,” as used herein, means killing, reducing in numbers, and/or reducing growth, feeding or normal physiological development of any or all life stages of insects, reduction of the effects of insect feeding and/or infestation, resistance of a plant to feeding and/or infestation by insects, resistance of a plant to the effects of insect feeding and/or infestation, tolerance of a plant to feeding and/or infestation by insects, tolerance of a plant to the effects of insect feeding and/or infestation, or any combination thereof. An effective amount is an amount able to noticeably reduce insect survival, growth, feeding, infestation, and/or general normal physiological development and symptoms resulting from insect feeding and/or infestation. In some embodiments symptoms and/or insects are reduced by at least about 5%, at least about 10%, at least about 20%, at least about 30%, at least about 40%, at least about 50%, at least about 60%, at least about 70%, at least about 80%, or at least about 90% versus untreated controls.

The term “minicell” or ADAS refers to an achromosomal, non-replicating, enclosed membrane system including at least one membrane and having an interior volume suitable for containing a cargo (e.g., one or more of a nucleic acid, a plasmid, a polypeptide, a protein, an enzyme, an amino acid, a small molecule, a gene editing system, a hormone, an immune modulator, a carbohydrate, a lipid, an organic particle, an inorganic particle, or a ribonucleoprotein complex (RNP)). Minicells are achromosomal cells that are products of aberrant cell division, and contain RNA and protein, but little or no chromosomal DNA. Minicells are capable of plasmid-directed synthesis. Minicells can be derived from a parent bacterial cell (e.g., a gram-negative or a gram-positive bacterial cell) using preferably genetic manipulation of the parent cell which—for example—disrupt the cell division machinery of the parent cell. In some embodiments, the minicell may include one or more endogenous or heterologous features of the parent cell surface, e.g., cell walls, cell wall modifications, flagella, or pili, and/or one or more endogenous or heterologous features of the interior volume of the parent cell, e.g., nucleic acids, plasmids, proteins, small molecules, transcription machinery, or translation machinery. In other embodiments, the minicell may lack one or more features of the parent cell. In still other embodiments, the minicell may be loaded or otherwise modified with a feature not included in the parent cell.

As used herein, the term “parent bacterial cell” is used interchangeably with “chassis” and refers to a cell (e.g., a gram-negative or a gram-positive bacterial cell) from which a minicell is derived. Parent bacterial cells are typically viable bacterial cells. The term “viable bacterial cell” refers to a bacterial cell that contains a genome and is capable of cell division. Parent bacterial cells may be derived from any of the following genera: Escherichia, Acinetobacter, Agrobacterium, Anabaena, Anaplasma, Aquifex, Azoarcus, Azospirillum, Azotobacter, Bartonella, Bordetella, Bradyrhizobium, Brucella, Buchnera, Burkholderia, Candidatus, Chromobacterium, Coxiella, Crocosphaera, Dechloromonas, Desulfitobacterium, Desulfotalea, Erwinia, Francisella, Fusobacterium, Gloeobacter, Gluconobacter, Helicobacter, Legionella, Magnetospirillum, Mesorhizobium, Methylobacterium, Methylococcus, Neisseria, Nitrosomonas, Nostoc, Photobacterium, Photorhabdus, Phyllobacterium, Polaromonas, Prochlorococcus, Pseudomonas, Psychrobacter, Ralstonia, Rubrivivax, Salmonella, Shewanella, Shigella, Sinorhizobium, Synechococcus, Synechocystis, Thermosynechococcus, Thermotoga, Thermus, Thiobacillus, Trichodesmium, Vibrio, Wigglesworthia, Wolinella, Xanthomonas, Xylella, Yersinia, Bacillus, Bifidobacterium, Clostridium, Corynebacterium, Deinococcus, Enterococcus, Exiguobacterium, Geobacillus, Lactobacillus, Listeria, Leuconostoc, Moorella, Oceanobacillus, Rhizobium, Rickettsia, Staphylococcus, Streptococcus Symbiobacterium, and Thermoanaerobacter. The parent bacterial cell includes at least one genetic mutation causing a modification in a cell partitioning function of the parent bacterium.

A composition or preparation that is “substantially free of” parent bacterial cells and/or viable bacterial cells is defined herein as a composition having no more than 500, e.g., 400, 300, 200, 150, 100 or fewer colony-forming units (CFU) per mL. A composition that is substantially free of parent bacterial cells or viable bacterial cells may include fewer than 50, fewer than 25, fewer than 10, fewer than 5, fewer than 1, fewer than 0.1, or fewer than 0.001 CFU/mL.

The term “cell division topological specificity factor” refers to a component of the cell division machinery in a bacterial species that is involved in the determination of the site of the septum and functions by restricting the location of other components of the cell division machinery, e.g., restricting the location of one or more Z-ring inhibition proteins. Exemplary cell division topological specificity factors include minE, which was first discovered in Escherichia coli and has since been identified in a broad range of gram negative bacterial species and gram-positive bacterial species (Rothfield et al., Nature Reviews Microbiology, 3:959-968, 2005). minE functions by restricting the Z-ring inhibition proteins minC and minD to the poles of the cell. A second exemplary cell division topological specificity factor is DivIVA, which was first discovered in Bacillus subtilis (Rothfield et al., Nature Reviews Microbiology, 3:959-968, 2005).

The term “Z-ring inhibition protein” refers to a component of the cell division machinery in a bacterial species that is involved in the determination of the site of the septum and functions by inhibiting the formation of a stable FtsZ ring or anchoring such a component to a membrane. The localization of Z-ring inhibition proteins may be modulated by cell division topological specificity factors, e.g., MinE and DivIVA. Exemplary Z-ring inhibition proteins include minC and minD, which were first discovered in E. coli and have since been identified in a broad range of gram-negative bacterial species and gram-positive bacterial species (Rothfield et al., Nature Reviews Microbiology, 3:959-968, 2005). In E. coli and in other species, minC, minD, and minE occur at the same genetic locus, which may be referred to as the “min operon”, the minCDE operon, or the min or minCDE genetic locus. The term “Amin” refers to a disruption of the minCDE operon.

As used herein, the term “reduction in the level or activity of a cell topological specificity factor,” refers to an overall reduction of any of 5%, 10%, 20%, 30%, 40%, 50%, 60%, 70%, 80%, 90%, 95%, 96%, 97%, 98%, 99%, or greater, in the level or activity of the cell topological specificity factor (e.g., protein or nucleic acid (e.g., gene or mRNA)), detected by standard methods, as compared to the level in a reference sample (for example, a minicell produced from a wild-type cell or a cell having a wild-type minCDE operon or wild-type divIVA gene), a reference cell (for example, a wild-type cell or a cell having a wild-type minC, minD, minE, divIVA, or minCDE gene or operon), a control sample, or a control cell. In some embodiments, a reduced level or activity refers to a decrease in the level or activity in the sample which is at least about 0.9×, 0.8×, 0.7×, 0.6×, 0.5×, 0.4×, 0.3×, 0.2×, 0.1×, 0.05×, or 0.01× the level or activity of the cell topological specificity factor in a reference sample, reference cell, control sample, or control cell.

As used herein, the term “endogenous Type 3 secretion system” or “endogenous T3SS” refers to a T3SS that is present on a cell (e.g., a parent cell), or a minicell derived therefrom, and is naturally encoded by the cell (e.g., is encoded by a wild-type version of the cell). The T3SS may be expressed by the endogenous genes of the cell, and/or may be encoded and expressed by a synthetic construct in the cell. Expression or abundance of an endogenous T3SS may be increased, e.g., by the addition of a moiety that increases the abundance of the T3SS (e.g., a transcriptional activator of the T3SS) or reduction or removal of a negative regulator of expression of the T3SS.

As used herein, the term “heterologous Type 3 secretion system” or “heterologous T3SS” refers to a T3SS that is present on a cell (e.g., a parent cell), or a minicell derived therefrom, and is not naturally encoded by the cell (e.g., is not encoded by a wild-type version of the cell).

As used herein, an “endogenous effector” of a secretion system (e.g., a T3SS, T4SS, or T6SS) is a moiety (e.g., a protein or polypeptide) that is naturally encoded by a cell from which the secretion system (e.g., T3SS) is derived (e.g., is encoded by a wild-type version of the cell) and is capable of being secreted by the secretion system. A secretion system and one or more of its endogenous effectors may be expressed in the cell in which they naturally occur or may be expressed heterologously, e.g., expressed by a cell that does not naturally encode the endogenous effector or the secretion system.

As used herein, an effector that is heterologous with respect to a secretion system (“heterologous effector”) is a moiety (e.g., a protein or polypeptide) that is not naturally encoded by a cell from which the secretion system (e.g., T3SS) is derived (e.g., is not encoded by a wild-type version of the cell) and is capable of being secreted by a secretion system of a cell from which the heterologous effector is derived. The effector may be capable of being secreted by the secretion system to which it is heterologous or may be modified to be secreted by the secretion system to which it is heterologous. In some embodiments, the heterologous effector is an effector of a T4SS or a T6SS that is secreted by a T3SS.

As used herein, the term “heterologous” means not native to a cell or composition in its naturally occurring state. In some embodiments “heterologous” refers to a molecule; for example, a cargo or payload (e.g., a polypeptide, a nucleic acid such as a protein-encoding RNA or tRNA, or small molecules) or a structure (e.g., a plasmid or a gene-editing system) that is not found naturally in an ADAS or the parent bacteria from which it is produced (e.g., a gram-negative or gram-positive bacterial cell).

As used herein, the term “gene involved in DNA repair” means a gene encoding for a polypeptide that plays a role in the cellular processes that are set in motion after DNA damage occurs in a cell. DNA damage affects the primary structure of the double helix; that is, the bases themselves are chemically modified. These modifications can, in turn, disrupt the molecules' regular helical structure by introducing non-native chemical bonds or bulky adducts that do not fit in the standard double helix. There are several types of DNA damage that can occur due either to normal cellular processes or due to the environmental exposure of cells to DNA damaging agents. DNA bases can be damaged by: (1) oxidative processes, (2) alkylation of bases, (3) base loss caused by the hydrolysis of bases, (4) bulky adduct formation, (5) DNA crosslinking, and (6) DNA strand breaks, including single and double stranded breaks.

DNA mismatch repair (MMR) is a highly conserved DNA repair system that greatly contributes to maintain genome stability through the correction of mismatched base pairs and small modifications of DNA bases, such as alkylation. The major source of mismatched base pairs is replication error, although it can arise also from other biological processes. In E. coli, methylation of the DNA is a common post-replicative modification. In mismatch DNA repair systems, strand discrimination is conducted, for example, by nicking endonucleases. In E. coli, MutH nicks the unmethylated strand of the duplex to generate the entry point of excision. Following the excision of the damaged or mismatched strand, helicases (such as UvrD) and exonucleases (such as ExoI) excise a short region of nucleotides from the damaged strand. DNA pol III or DNA pol & fills in the gap and DNA ligase repairs the backbone. Further, RecJ, ExoI, ExoVII, ExoX are exonucleases involved in this process. RecA is required for homologous recombination and catalyzes ATP-driven homologous pairing and strand exchange of DNA molecules necessary for DNA recombinational repair. Accordingly, MutS, MutH, MutL, SSB, RecA, RecJ, ExoI, ExoVII, ExoX, UvrD and DNA polymerase III are exemplary genes involved in DNA repair.

As referred herein, a T7 family polymerase refers to a member of the single subunit DNA-dependent RNAP (ssRNAP) family. In some embodiments, the T7 family polymerase is T7, T3, K11 or SP6 polymerase.

T7 polymerase is commonly used to transcribe DNA that is cloned in a vector that comprises a gene that is under the control of two different phase promotors in opposite direction. In some embodiments, an expression vector is used that integrates a T7 promoter and a gene of interest downstream of the promoter. In some embodiments, an expression vector comprising the T7 promotor is transformed into one of several relevant strains of E. coli, adding the extension “(DE3)” to the strain name. E. coli naturally possesses a gene encoding for T7 RNA polymerase. T7 RNA polymerase is responsible for initiating the transcription at the T7 promoter. To initiate transcription, an inducer binds to a lac repressor thereby preventing it from inhibiting the gene expression of the T7 gene. Thereafter, the T7 gene is normally transcribed to produce T7 RNA polymerase. T7 RNA polymerase, in turn, binds to the T7 promoter on the expression vector which initiates transcription of the downstream gene of interest. In some embodiments, IPTG is used as an inducer of this process.

The term “about” as used herein refers to the usual error range for the respective value readily known to the skilled person in this technical field. Reference to “about” a value or parameter herein includes (and describes) embodiments that are directed to that value or parameter per se.

As used herein and in the appended claims, the singular forms “a,” “an,” and “the” include plural reference unless the context clearly indicates otherwise. For example, reference to a “minicell” is a reference to from one to many minicells, such as particle concentrations, and includes equivalents thereof known to those skilled in the art, and so forth.

It is understood that aspect and embodiments of the present disclosure described herein include “comprising,” “consisting,” and “consisting essentially of” aspects and embodiments.

### EXAMPLES

The presently disclosed subject matter will be better understood by reference to the following Examples, which are provided as examples, and not by way of limitation.

### Example 1: Production of Minicells and Insecticidal Toxins

This example shows that minicells loaded and expressing insecticidal toxins may be produced from parent bacterial cells, e.g., E. coli strains, by various genetic mutations. In this example, minicells with toxins (listed in Table 1) can be produced by disruption of one or more genes involved in regulating parent cell partitioning functions, such as, disruption of z-ring inhibition proteins and a cell division topological specificity factor (e.g., minCDE).

### Materials and Methods

Production of Minicells Via Deletion of minCDE Operon

In the absence of the min system, proper localization of the septum machinery component FtsZ is dysregulated. This leads to the formation of cell division planes near the poles, and generates minicells. Disruption of the min operon was conducted by Lambda-RED recombineering (Datsenko and Wanner, PNAS, 97 (12): 6640-6645,2000). Briefly, primers encoding 40 bp of homology up and downstream of the min operon were used to amplify the camR resistance cassette from pKD3 by standard PCR. The purified PCR product was then transformed into E. coli cells harboring pKD46 encoding the Lambda-RED system by electroporation. Cells were then plated on LB plates with 35 μg/mL chloramphenicol at 37° C. to select for mutants. min disruption mutants were verified by PCR.

To remove the antibiotic marker, cells were first transformed with the plasmid pCP20 and plated on LB plates with 100 μg/mL carbenicillin at 30° C. An individual colony from this plate was struck on a fresh LB plate and cells were grown at 42° C. to express flipase and cause loss of the pCP20 plasmid. Individual colonies were patched onto selective and non-selective LB plates to verify the loss of antibiotic resistance and the pCP20 plasmid. The resulting strain contained an FRT scar at the min locus. The strain was then grown in LB and frozen as a glycerol stock.

### Isolation and Characterization of Minicells

To produce minicells, a seed culture was grown from the glycerol stock in LB overnight. The following day, the seed culture was diluted 1:200 in LB and grown at 37° C. The next day, the culture was processed to collect minicells that were produced overnight following a differentiation centrifugation. Briefly, bacterial cultures were diluted to an OD600=10, and centrifuged in 1-liter bottles at 4000×g (Sorval Lynx 6000) for 40 minutes using the slowest acceleration speed. The minicell rich supernatant was then centrifuged at 17,000 g for 1 hour to pellet minicells. The resulting pellet was then resuspended in 50 mL of fresh LB containing 200 μg/mL ceftriaxone and 20 μg/mL ciprofloxacin, and the culture was placed at 37° C. for 2 hours to remove any remaining parental bacteria. The solution was centrifuged in a swinging bucket rotor (Beckman Coulter) at 4,000×g for 15 min to remove the dead parental bacterial cells and large debris. The minicells were then pelleted at 20,000×g (Sorval Lynx 6000) for 20 min and resuspended in an equal volume of 0.2 μm-filtered PBS. This step was repeated for a total of 2 washes, and the resulting minicell pellet was resuspended in a final volume of 10 mL of 0.2 μm-filtered PBS.

Isolated minicells were validated by microscopy and particle size and distribution, as well as concentration, which was measured by counting with a Spectradyne nCS1. Particle concentrations of greater than 1e10, 1e11, and 1e12 per liter were collected from the 10 mL final volume, with an average size of 450 nm.

### Production of Minicells Including an Exogenous Insecticidal Toxin

Additionally, the gene sequence for an insecticidal protein (Table 1, below), for example, Cry1Ac toxin from Bacillus thuringensis, or PirAB toxin from Photorhabdus luminescens, was cloned into an expression vector. This vector had a CloDF or pMB1 origin of replication behind an inducible promoter (e.g., Ptac, Ptet, or PT7) or constitutive promoter. Expression of the insecticidal protein was induced with aTc or IPTG at an OD600=0.5 to produce and load the protein within the minicells. Isolation and characterization was as described above.

Protein concentration in each isolated minicell sample was measured by quantitative western blot. 10, 1, and 0.1 μL of minicells and a standard curve of purified 20, 10, 5, 2.5 ng BAP-FLAG (Sigma: P7457) or 100, 50, 25, 12.5 ng Cry1Ac (Sino Biological: 12008-A07E) were run on a 4-12% BIS-Tris SDS gel (Thermo Fisher: NW04125BOX), transferred to nitrocellulose with an iBlot (Thermo Fisher), and blotted with rabbit anti-FLAG (Sigma: F7425) or anti-Cry1A antibody (Abcam: ab51586) and goat anti-rabbit HRP conjugate (Sigma: AP307P). Westerns were imaged with an iBright (Thermo Fisher) and band intensities were quantified in ImageJ. For protein concentrations, see Tables 2A-2B, below.

### Results

Table 1, below, provides the designations for the minicells loaded and expressing insecticidal toxins, the insecticidal toxins, the parent cells, and the vectors. loaded and expressing multiple insecticidal toxins in the E. coli minicell strain chassis 1. Minicells AD1, AD2, and AD3 were tested as described in Example 2. Minicells AD4-AD14 are expected to show similar levels of Pir and Cry activity as the tested minicells AD1, AD2, and AD3 based on structural similarity. Minicells AD1 and AD2 were tested as described in Example 3. Minicells AD3-AD6 are expected to show similar levels of Pir activity as the tested minicells AD1 and AD2.

TABLE 1
Minicells loaded and expressing multiple insecticidal toxins.

| Minicell | Toxin | Parent Cell | Vector |
|---|---|---|---|
| AD1 | PirAB (PirA: WP162107660 | E. coli minicell strain | pMB1_Ptet-FLAG-pirAB (Vector = |
| | (SEQ ID NO: 203), | chassis 1 | SEQ ID NO: 101; PirA = SEQ |
| | PirB: WP113025844 (SEQ ID | | ID NO: 102; and PirB = SEQ ID |
| | NO: 204; FLAG-PirB = SEQ | | NO: 13) |
| | ID NO: 5) | | |
| AD2 | Cry1Ac (SEQ ID NO: 205) | E. coli minicell strain | pKK223-3_Plac-Cry1Ac (Vector = |
| | | chassis 1 | SEQ ID NO: 206; Cry1 Ac = |
| | | | SEQ ID NO: 14) |
| AD3 | PirAB_2 (pirA_XNC1_1143: | E. coli minicell strain | pMB1_Ptet-FLAG-pirAB(2) |
| | 22125637 (SEQ ID NO: 197; | chassis 1 | (sequence of vector for AD1 |
| | SEQ ID NO: 6), | | with Pir sequence replaced as |
| | C6H69_13865: 1353933384 | | indicated in “Toxin” column) |
| | (SEQ ID NO: 178; SEQ ID | | |
| | NO: 7) | | |
| AD4 | PirAB_3 (pirA_XDD1_2939: | E. coli minicell strain | pMB1_Ptet-FLAG-pirAB(3) |
| | 661562330 (SEQ ID NO: | chassis 1 | (sequence of vector for AD1 |
| | 143; SEQ ID NO: 8), | | with Pir sequence replaced as |
| | pirB_XNC1_1142: 22125637 | | indicated in “Toxin” column) |
| | (SEQ ID NO: 196; SEQ ID | | |
| | NO: 9) | | |
| AD5 | PirAB_4 (pirA_XPG1_1630: | E. coli minicell strain | pMB1_Ptet-FLAG-pirAB(4) |
| | 661564924 (SEQ ID NO: | chassis 1 | (sequence of vector for AD1 |
| | 145; SEQ ID NO: 10), pirB | | with Pir sequence replaced as |
| | XNC3_230002: 484362303 | | indicated in “Toxin” column) |
| | (SEQ ID NO: 201; SEQ ID | | |
| | NO: 11) | | |
| AD6 | PirAB_4 | E. coli minicell strain | pMB1_Ptet-FLAG-pirAB(4) |
| | (pirA_XNC3_230001: | chassis 1 | (sequence of vector for AD1 |
| | 484362302 (SEQ ID NO: | | with Pir sequence replaced as |
| | 202; SEQ ID NO: 12), | | indicated in “Toxin” column) |
| | pirB_XNW1_2850002: | | |
| | 733151312 (SEQ ID NO: | | |
| | 153; SEQ ID NO: 13) | | |
| AD7 | PirAB_4 | E. coli minicell strain | pMB1_Ptet-FLAG-pirAB(4) |
| | (pirA_XNW1_2850001: | chassis 1 | (sequence of vector for AD1 |
| | 733151311 (SEQ ID NO: | | with Pir sequence replaced as |
| | 154; SEQ ID NO: 14), | | indicated in “Toxin” column) |
| | pirB_XPG1 1629: | | |
| | 661564923 (SEQ ID NO: | | |
| | 145; SEQ ID NO: 15) | | |
| AD8 | CR1IA_BACTK (Q45752) | E. coli minicell strain | pKK223-3_Plac-CR1IA_BACTK |
| | (SEQ ID NO: 136) | chassis 1 | (Q45752) (sequence of vector |
| | | | for AD2 with Pir sequence |
| | | | replaced as indicated in “Toxin” |
| | | | column) |
| AD9 | CR1KA_BACTM (Q45715) | E. coli minicell strain | pKK223-3_Plac- |
| | (SEQ ID NO: 142) | chassis 1 | CR1KA_BACTM (Q45715) |
| | | | (sequence of vector for AD2 |
| | | | with Pir sequence replaced as |
| | | | indicated in “Toxin” column) |
| AD10 | CR1BD_BACTZ (Q9ZAZ5) | E. coli minicell strain | pKK223-3_Plac- |
| | (SEQ ID NO: 121) | chassis 1 | CR1BD_BACTZ (Q9ZAZ5) |
| | | | (sequence of vector for AD2 |
| | | | with Pir sequence replaced as |
| | | | indicated in “Toxin” column) |
| AD11 | CR1ID_BACTU (Q9XDL1) | E. coli minicell strain | pKK223-3_Plac-CR1ID_BACTU |
| | (SEQ ID NO: 139) | chassis 1 | (Q9XDL1) (sequence of vector |
| | | | for AD2 with Pir sequence |
| | | | replaced as indicated in “Toxin” |
| | | | column) |
| AD12 | CR1JB_BACTU (Q45716) | E. coli minicell strain | pKK223-3_Plac- |
| | (SEQ ID NO: 141) | chassis 1 | CR1JB_BACTU (Q45716) |
| | | | (sequence of vector for AD2 |
| | | | with Pir sequence replaced as |
| | | | indicated in “Toxin” column) |
| AD13 | CR1IB_BACTE (Q45709) | E. coli minicell strain | pKK223-3_Plac-CR1IB_BACTE |
| | (SEQ ID NO: 137) | chassis 1 | (Q45709) (sequence of vector |
| | | | for AD2 with Pir sequence |
| | | | replaced as indicated in “Toxin” |
| | | | column) |
| AD14 | PirAB (PirA: WP162107660 | E. coli minicell strain | pMB1_Ptet-FLAG-pirAB (Vector = |
| | (SEQ ID NO: 203), | chassis 1 | SEQ ID NO: 101; PirA = SEQ |
| | PirB: WP113025844 (SEQ ID | | ID NO: 102; and PirB = SEQ ID |
| | NO: 204)) + Cry1Ac (SEQ ID | | NO: 13) |
| | NO: 205) | | pKK223-3_Plac-Cry1Ac |
| | | | (Cry1Ac = SEQ ID NO: 14) |

### Example 2: Synergy of Minicell-PirAB and Minicell-Cry1Ac Against the Lepidopteran Diamondback Moth (DBM)

This example demonstrates the unexpected synergistic effect of a mixture of minicells expressing the insecticidal toxin PirAB and minicells expressing the insecticidal toxin Cry1Ac in a feeding assay using Diamondback moth (DBM).

### Materials and Methods

### Loaded Minicells

Minicells expressing PirAB and Cry1AC were used in the assay. These minicells corresponded to AD1, AD2, and AD3 in Table 1, above.

### Feeding Assay on Artificial Diet

Synergistic interactions of PirAB and Cry1Ac were assessed using a feeding assay on artificial diet. Diamondback moth (DBM) eggs (purchased from Benzon Research) were placed in containers filled with general noctuid artificial diet (purchased as dry powder from Southland Products Inc.). The diet was prepared by boiling water at 80° C. and mixing 33.4 g of diet per 200 ml water, then cooling the mixture to 70° C. and adding 1.07 ml linseed oil per 200 ml water. The diet was poured into containers (Sistema KLIP IT 33.8 oz container, Amazon cat #B00284AG7S) and allowed to cool and solidify.

The eggs on diet were incubated at 25° C. for four days until the emergence of the last 1st instar larvae. The day before the start of the feeding assay, 48-well plates were prepared by filling each well with 0.38 ml of the same artificial diet. On the day of the feeding assay, solutions containing the actives were prepared at the application rates shown in Tables 2A-2B.

Table 2A provides the results of the first setup (EXP 1), which tested the combination of AD1 and AD2 (see Table 1, above). Table 2B provides the results of the second setup (EXP 2), which tested the combination of AD3 and AD2 (see Table 1, above). 30 μl of these solutions were applied per well to the 48-well plate containing the diet. After the solutions had dried, one late 1st instar DBM larvae was placed per well, and the plates were sealed with Breathe Easier sealing film from Diversified Biotech to allow gas exchange. The plates were then placed in a 25° C. incubator with a 16 hour light 8 hour dark cycle setting. After three days, mortality was assessed by unsealing each plate and recording live and dead larvae in each plate.

### Results

The mortality data for the solutions tested and their application rates are shown in Tables 2A-2B, below. The values reported are in terms of % mortality. Colby's equation was used to determine insecticidal effects expected from the mixtures (Colby, S. R. (1967). Calculating Synergistic and Antagonistic Responses of Herbicide Combinations. Weeds, 15 (1), 20-22. doi.org/10.2307/4041058). Briefly, the following equation was used to calculate the expected activity of mixtures containing two active proteins, A and B:

Expected=A+B−(A×B/100) (1)

Where A is the observed efficacy of active ingredient A at the same concentration as used in the mixture, and B is the observed efficacy of active ingredient B at the same concentration as used in the mixture.

Tables 2A-2B, below, shows the results of the synergy experiments with mixtures of minicells including PirAB and minicells including Cry1Ac. In both tables, the values in parentheses provide the solo efficacy, in % mortality, for that specific concentration of that AD alone.

TABLE 2A
Results of the synergy experiment using AD1 and AD2 (EXP 1).

| | | DBM (EXP 1) | |
|---|---|---|---|
| Application Rate (EXP 1) | | Observed mortality (%) | Expected mortality (%) |
| AD1 (PirAB ng/μl) | AD2 (Cry1A ng/ μl) | of the combination | of the combination |
| 7.02 (66.67) | 0.154 (17.39) | 91.30 | 72.46 |
| 3.51 (33.34) | 0.154 | 79.17 | 44.93 |
| 1.76 (21.74) | 0.154 | 66.67 | 35.35 |
| 0.88 (45.45) | 0.154 | 68.18 | 54.94 |
| 0.44 (16.67) | 0.154 | 75.00 | 31.16 |

TABLE 2B
Results of the synergy experiment using AD3 and AD2 (EXP 2).

| | | DBM (EXP 2) | |
|---|---|---|---|
| Application Rate (EXP 2) | | Observed mortality (%) | Expected Mortality (%) |
| AD3 (PirAB ng/μl) | AD2 (Cry1A ng/μl) | of the combination | of the combination |
| 1.39 (60.87) | 0.154 (33.33) | 91.30 | 73.91 |
| 0.69 (65.22) | 0.154 | 91.30 | 76.81 |
| 0.35 (52.17) | 0.154 | 79.17 | 68.12 |
| 0.17 (8.70) | 0.154 | 54.17 | 39.13 |
| 0.09 (52.17) | 0.154 | 60.00 | 68.12 |

As can be seen from Tables 2A-2B, the observed mortality of the combination exceeded the expected mortality of the combination at almost all concentrations. In some cases, such as for 0.44 ng/μl AD1 (PirAB) and 0.154 ng/μl AD2 (Cry1A) (ratio of about 3:1), the observed mortality was about double that of the expected mortality (Table 2A). These results therefore demonstrate that the mixture of minicell-PirAB and minicell-Cry1Ac has a synergistic effect on DBM.

### Example 3: Synergy of Minicell-PirAB and BT-Derived AI Against Bt-Resistant Diamondback Moth (DBM)

This example demonstrates the unexpected synergistic effect of a mixture of minicells expressing the insecticidal toxin PirAB and the Bt-derived AI (obtained from Thuricide® in this example) in a feeding assay using Bt-resistant Diamondback moth (DBM). Thuricide® insecticide used in this example contained 15% Bt-derived AI.

### Materials and Methods

### Loaded Minicells and Mixture

Minicells expressing PirAB were used in the assay. These minicells corresponded to AD1 and AD2 in Table 1, above. The minicells were then mixed with the Bt-derived AI (obtained from Thuricide®) as described in Tables 3A-3B, below.

### Feeding Assay on Artificial Diet

Synergistic interactions of minicells expressing PirAB and the Bt-derived AI were assessed using a feeding assay on artificial diet. Bt-resistant diamondback moth (DBM) eggs (purchased from Benzon Research) were placed in containers filled with general noctuid artificial diet (purchased as dry powder from Southland Products Inc.). The diet was prepared by boiling water at 80° C. and mixing 33.4 g of diet per 200 ml water, then cooling the mixture to 70° C. and adding 1.07 ml linseed oil per 200 ml water. The diet was poured into containers (Sistema KLIP IT 33.8 oz container, Amazon cat #B00284AG7S) and allowed to cool and solidify.

The eggs on diet were incubated at 25° C. for four days until the emergence of the last 1st instar larvae. The day before the start of the feeding assay, 48-well plates were prepared by filling each well with 0.38 ml of the same artificial diet. On the day of the feeding assay, solutions containing the actives were prepared at the application rates shown in Tables 3A-3B.

Table 3A provides the results of the first setup (EXP 1), which tested the combination of AD1 (see Table 1, above) and the Bt-derived AI (obtained from Thuricide®). Table 3B provides the results of the second setup (EXP 2), which tested the combination of AD2 (see Table 1, above) and the Bt-derived AI (obtained from Thuricide®). 30 μl of these solutions were applied per well to the 48-well plate containing the diet. After the solutions had dried, one late 1st instar DBM larvae was placed per well, and the plates were sealed with Breathe Easier sealing film from Diversified Biotech to allow gas exchange. The plates were then placed in a 25° C. incubator with a 16 hour light 8 hour dark cycle setting. After three days, mortality was assessed by unsealing each plate and recording live and dead larvae in each plate.

### Results

The mortality data for the solutions tested and their application rates are shown in Tables 3A-3B, below. The values reported are in terms of % mortality. Colby's equation was used to determine insecticidal effects expected from the mixtures (Colby, S. R. (1967). Calculating Synergistic and Antagonistic Responses of Herbicide Combinations. Weeds, 15 (1), 20-22. doi.org/10.2307/4041058). Briefly, the following equation was used to calculate the expected activity of mixtures containing two active proteins, A and B:

Expected=A+B−(A×B/100) (1)

Where A is the observed efficacy of active ingredient A at the same concentration as used in the mixture, and B is the observed efficacy of active ingredient B at the same concentration as used in the mixture.

Tables 3A-3B, below, show the results of the synergy experiments with mixtures of minicells including PirAB and BT-derived AI (added as Thuricide®, which contains 15% Bt-derived AI, at 2 μl/ml). In both tables, the values in parentheses provide the solo efficacy, in % mortality, for that specific concentration of that AD alone.

TABLE 3A
Results of the synergy experiment using AD1 and Thuricide ® (EXP 1).

| | | DBM (EXP 1) | |
|---|---|---|---|
| Application Rate (EXP 1) | | Observed mortality (%) | Expected mortality (%) |
| AD1 (PirAB ng/μl) | BT-derived Al (μl/ml) | of the combination | of the combination |
| 7.02 (82.61) | 0.3 (0) | 95.83 | 82.61 |
| 3.51 (86.96) | 0.3 | 86.96 | 86.96 |
| 1.755 (60.87) | 0.3 | 91.67 | 60.87 |
| 0.8775 (33.33) | 0.3 | 70.83 | 33.33 |
| 0.43875 | 0.3 | 13.64 | 0 |

TABLE 3B
Results of the synergy experiment using AD2 and Thuricide ® (EXP 2).

| | | DBM (EXP 2) | |
|---|---|---|---|
| Application Rate (EXP 2) | | Observed mortality (%) | Expected Mortality (%) |
| AD2 (PirAB ng/μl) | BT-derived Al (μl/ml) | of the combination | of the combination |
| 13.33 (95.65) | 0.3 (0) | 95.83 | 95.65 |
| 6.66 (34.78) | 0.3 | 83.33 | 34.78 |
| 3.33 (45.83) | 0.3 | 91.67 | 45.83 |
| 1.67 (4.17) | 0.3 | 37.50 | 4.17 |
| 0.83 (4.17) | 0.3 | 8.33 | 4.17 |

As can be seen from Tables 3A-3B, the observed mortality of the combination matched or exceeded the expected mortality of the combination at all concentrations. In some cases, such as for 0.8775 ng/μl AD1 (PirAB) and 0.3 μl/ml BT-derived AI (ratio of about 3:1), the observed mortality was about double that of the expected mortality (Table 3A). These results therefore demonstrate that the mixture of minicell-PirAB and BT-derived AI has a synergistic effect on Bt-resistant DBM.

### Example 4: Production of a High Yield Minicell Strain

Lambda Red recombineering was used to disrupt the minCDE locus of the BW25113 and the DH10B E. coli strains to produce BW25113ΔminCDE and DH10B ΔminCDE. The camR resistance cassette from pKD3 was amplified with 40 bp homology to the 5′ and 3′ region of the minCDE locus. 5 mL of DH10BΔminCDE cells carrying the plasmid pKD46 were grown in LB+0.2% (w/v) arabinose at 30° C. to and OD600=0.5. The cells were washed five times in ice-cold 10% (v/v) glycerol and electroporated in a 0.2 mm cuvette with a Bio-Rad GenePulser Xcell using standard E. coli settings. The cells were resuspended in 1 mL of SOC and put to recover at 37° C. for 1 hour. The cells were then plated on LB-agar containing 20 μg/mL chloramphenicol at 37° C. to select for mutants. The resulting strain was then transformed with the pCP20 plasmid and plated on LB-agar containing 50 μg/mL carbenicillin at 37° C.

### Isolation and Characterization of Minicells

To produce minicells, a seed culture was grown from the glycerol stock in LB overnight. The following day, the seed was diluted 1:200 in LB and grown at 37° C. The next day the culture was processed to collect minicells that were produced overnight following a differentiation centrifugation. Briefly, bacterial cultures were diluted to an OD600=10, and centrifuged in 1-liter bottles at 4000 x g (Sorval Lynx 6000) for 40 minutes using the slowest acceleration speed. The minicell rich supernatant was then centrifuged at 17,000 g for 1 hour to pellet minicells. The resulting pellet was then resuspended in 50 mL of fresh LB containing 200 μg/mL ceftriaxone and 20 μg/mL ciprofloxacin, and the culture was placed at 37° C. for 2 hours to remove any remaining parental bacteria. The solution was centrifuged in a swinging bucket rotor (Beckman Coulter) at 4,000×g for 15 min to remove the dead parental bacterial cells and large debris. The minicells were then pelleted at 20,000×g (Sorval Lynx 6000) for 20 min and resuspended in an equal volume of 0.2 μm-filtered PBS. This step was repeated for a total of 2 washes, and the resulting minicell pellet was resuspended in a final volume of 10 mL of 0.2 μm-filtered PBS.

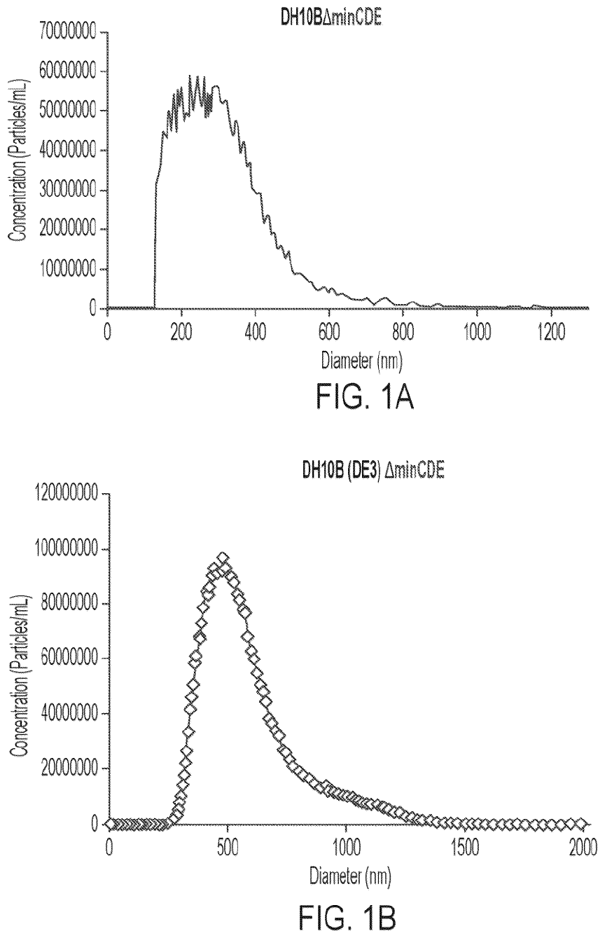

Isolated minicells were validated by microscopy, and particle size and distribution as well as minicell concentration were measured by counting with a Spectradyne nCS1. Minicells were collected from a 1 L culture, with an average size of 350 nm (FIG. 1A).

### Example 5: Production of High Yield Minicell and High Yield Protein Strain

### Generation of DH10BΔminCDE Carrying the λDE3 Prophage

In order to enable expression of cargoes expressed via T7 RNA polymerase (RNAP) via the T7 promoter (pT7), a strain of DH10BΔminCDE carrying the λDE3 prophage was generated. DE3 encodes for a mutant λ phage, which cannot enter the lytic cycle, encoding for the T7 RNAP gene behind the LacUV, lac-inducible promoter. Upon addition of IPTG to cells carrying the DE prophage, T7 RNAP is produced, which, in turn, transcribes mRNAs for genes behind pT7. λDE3 was introduced into the DH10BΔminCDE chromosome using a λDE3 lysogenization kit (Millipore Sigma 69734). DH10BΔminCDE cells were grown in LB containing 0.2% maltose and 10 mM MgSO4 to an OD600=0.5. 10 μL of cells were mixed with 108 pfu λDE3, 108 pfu helper phage, and 108 pfu selection phage and incubated at 37° C. for 20 min. The whole culture was then plated on an LB agar plate and incubated at 37° C. overnight. Colonies were screened for T7 RNAP induction by plaque assay on LB plates+/−IPTG and T7 tester phage. A clone showing few plaques on the −IPTG plate and a large number of plaques on the +IPTG plates was selected and frozen as a glycerol stock. Minicells were isolated as described in Example 4. Particle size distribution is shown in FIG. 1B.

### Expression Vectors for PirAB

To elucidate what minicell chassis strain maximizes both protein expression and minicell numbers, two expression vectors encoding for inducible expression of the entomotoxin PirAB were constructed: one comprising a tetracycline (tet)-dependent promotor, one comprising a T7 promoter (both plasmids encode for a kanamycin resistance gene and a pMB1 origin of replication). These plasmids were then transformed in the minicell chassis strains BW25113, DH10BΔminCDE, and DH10B(DE3) ΔminCDE described before.

PirAB was cloned into a Ptet_pMB1_kan plasmid by Golden Gate cloning. A gene block (IDT) encoding PirAB codon optimized for expression in E. coli (De Novo DNA) with flanking BsaI sites was synthesized. This was used to insert the PirAB gene behind the Tet promoter. In order to track expression of PirAB, a 3×FLAG tag was added by PCR and blunt end ligation. Briefly, primers containing the coding sequence for the 3×FLAG epitope tag and homology to the PirAB plasmid were using to amplify the whole plasmid. The PCR product containing the PirAB plasmid and 3×FLAG tag were then blunt end ligated with T4 ligase and transformed into DH10BΔminCDE E. coli. Expression from this promoter is repressed by the gene product of the TetR gene, also encoded on the plasmid behind a constitutive promoter. Upon addition of anhydrotetracycline (aTc) to the media, aTc binds to TetR and relieves repression of expression from Ptet.

3×FLAG PirAB was cloned into pET28a by Gibson Assembly. Primers containing homology to the NdeI and HindIII cut sites of pET28a were used to amplify 3×FLAG PirAB and linearize the pET28a vector. The PCR products were assembled into pet28a_PirAB by Gibson Assembly using NEB HiFi DNA Assembly Mix, following the manufacturer's guidelines. The assembly was transformed into chemically competent E. coli and selected on LB agar with μg/mL kanamycin.

PirAB Expression in the E. coli Strains BW, DH10B, and DH10B(DE3)

Expression of PirAB in the E. coli strains BW25113, DH10B, and DH10B(DE3) (all ΔminCDE) was tested by western blot. Cells were grown at 37° C. in LB with shaking to OD=0.5, and PirAB protein expression was induced with 100 ng/μL aTc or 1 mM IPTG for Tet- and T7-inducible systems respectively, for 16 hours. The amount of PirAB expression was quantified by western blot. 10, 1, and 0.1 μL of induced cells were loaded and run on a 4-12% Bis-Tris SDS-PAGE gel (Thermo) along with 2.5, 5, 10, and 20 ng of a pure BAP-FLAG fusion (Sigma) or GFP protein standard for 25 min at 200 V. The proteins were transferred to a nitrocellulose membrane using an iBlot 2 system (Thermo) using program VO. The membrane was subsequently blotted for 3×FLAG PirAB using a rabbit anti-FLAG polyclonal antibody (Sigma) and a goat anti-rabbit IgG HRP conjugate secondary antibody (Sigma). The blot was imaged on an iBright (Thermo) and band intensities quantified in ImageJ. Calculated protein levels were then normalized to the number of minicells (Table 4).

The immunoblotting results indicated that DH10BΔminCDE (strain AD16) produced about a 10-fold higher number of minicells per liter as compared to the BW25113ΔminCDE strain (strain AD15; Table 4). DH10B(DE3) ΔminCDE (strain AD19) produced a tenfold higher number of minicells as compared to strain AD15 and further, approximately 10 fold higher protein production yield as compared to strain AD16.

TABLE 4
Strains used, Minicell yield, and expressed protein yield.

| | | | | Minicell/Protein | |
|---|---|---|---|---|---|
| Mini- | | | | yield (1 L shake | |
| cell | Toxin | Chassis strain | Expression cassette | flask) | |
| AD15 | PirAB | BW25113 Δmin | pMB1_Ptet-FLAG-pirAB | 10\hat{ }10 Minicell/liter | |
| | | | | 0.5 | ng/uL |
| AD16 | PirAB | DH10B Δmin | pMB1_Ptet-FLAG-pirAB | 10\hat{ }11 Minicell/liter | |
| | | | | 5.6 | ng/uL |
| AD17 | PirAB | DH10B Δmin | CloDF_ampR_pTac_pir_mutantLacl | 83 | ng/uL |
| AD18 | PirAB | DH10B Δmin | pUC_camR_pTac_pirFLAG_{—} | 315 | ng/uL |
| | | | newLacl | | |
| AD19 | PirAB | DH10B(DE3) Δmin | pET28a(+)_pirFLAG | 10\hat{ }11 Minicell/liter | |
| | | | | 55 | ng/uL |
| AD20 | PirAB | DH10B Δmin | CloDF_ampR_pTac_pir_newLacl | 66 ng/10\hat{ }9 Minicell | |
| AD21 | PirAB | DH10B Δmin | ColE_camR_pTac_pirFLAG_{—} | 0.7 | ng/uL |
| | | | newLacl | | |
| AD22 | PirAB | DH10B Δmin | pMB1_camR_pTac_pirFLAG_{—} | 4.5 | ng/uL |
| | | | newLacl | | |
| AD23 | PirAB | NEB Express Δmin | CloDF_ampR_pTac_pir_mutantLacl | 19 | ng/uL |
| AD24 | PirAB | NEB Express Δmin | CloDF_ampR_pTac_pir_newLacl | 60 | ng/uL |
| AD25 | PirAB | NEB Express Δmin | pMB1 Ptet-FLAG-pirAB | 141 | ng/uL |
| AD26 | PirAB | NEB Express Δmin | pUC_camR_pTac_pirFLAG_{—} | 191 | ng/uL |
| | | | newLacl | | |
| AD27 | PirAB | NEB Express Δmin | pMB1_camR_pTac_pirFLAG | 244 | ng/uL |
| | | | newLacl | | |
| AD28 | Cry1Ac | DH10B Δmin | pKK223_3-Cry1Ac | 75.98 | ng/uL |
| AD29 | Cry1Ac | DH10B(DE3) Δmin | pET28a(+)_Cry1Ac | n.d. | |
| AD30 | Cry1Ac | DH10B Δmin | pUC_ampR_pTet_Cry1Ac | 9.52 | ng/uL |
| AD31 | Cry1Ac | DH10B Δmin | pMB1_ampR_pTet_Cry1Ac | 51.06 | ng/uL |
| AD32 | Cry1Ac | DH10B Δmin | pUC_camR_pTet_Cry1Ac | 16.2 | ng/uL |

| | | | | |
|---|---|---|---|---|
| AD33 | Cry1Ac | DH10B Δmin | CloDF_ampR_pTac_Cry1Ac_{—} | n.d. |

mutantLacl

| | | | | |
|---|---|---|---|---|
| AD34 | Vip3Aa19 | DH10B Δmin | pMB1_Ptet-FLAG-Vip3Aa19 | n.d. |
| AD35 | Vip3Aa19 | DH10B(DE3) Δmin | pET28a(+)_Vlp3Aa19 | n.d. |
| AD36 | Vip3Aa19 | DH10B Δmin | pUC_camR_pTac_Vip3Aa19 | n.d. |

newLacl

| | | | | |
|---|---|---|---|---|
| AD37 | Vip3Aa19 | DH10B Δmin | CloDF_ampR_pTac_Vip3Aa1 | n.d. |

9_mutantLacl

| | | | | |
|---|---|---|---|---|
| AD38 | Vip3Aa19 | DH10B Δmin | CloDF_ampR_pTac_Vlp3Aa1 | n.d. |

9_newLacl

| | | | | |
|---|---|---|---|---|
| AD39 | Vip3Aa19 | DH10B Δmin | ColE_camR_pTac_Vlp3Aa19 | n.d. |

newLacl

n.d .; not determined

### Further Optimization of Pir Protein Production by Testing Multiple Expression Cassettes

Additional expression cassettes (Table 4) were produced by standard molecular biology techniques. FLAG-PirAB was PCR amplified from the original expression cassette, pMB1_Ptet-FLAG-pirAB, using primers oJK225 (SEQ ID NO: 211) and oJK226 (SEQ ID NO: 212). The PCR product was then cloned into a vector containing the Ptac promoter (SEQ ID NO: 218) by TIIS cloning using BsaI using standard techniques known to a person having ordinary skill in the art, resulting in the expression cassette CloDF_ampR_pTac_pir_mutantLacI. Due to a spontaneous mutation in the LacI coding sequence, this expression cassette does not express functional LacI protein, resulting in constitutive expression of FLAG-Pir from the tac promoter. The pUC_camR_pTac_pirFLAG_newLacI expression cassette was generated by replacing the mutated copy of the LacI gene with a functional copy from pET28a via Gibson Assembly. Briefly, the LacI gene was amplified by PCR using primers oJK316 (SEQ ID NO: 215) and oJK317 (SEQ ID NO: 216), and the Pir containing plasmid backbone was amplified by PCR using primers oJK314 (SEQ ID NO: 213) and oJK315 (SEQ ID NO: 214). The two PCR products were then used for a Gibson Assembly using methods known in the art. The expression cassette pET28a(+)_pirFLAG was generated by Gibson Assembly. FLAG-Pir was amplified by PCR using primers oJK161 (SEQ ID NO: 209) and oJK162 (SEQ ID NO: 210) and pET28a(+) was amplified using primers oJK159 (SEQ ID NO: 207) and oJK160 (SEQ ID NO: 208). These PCR products were then used in a standard Gibson Assembly reaction to generate pET28a(+)_pirFLAG. Promotor and terminator sequences used are shown in Table 5.

TABLE 5
Promotors and terminator sequences used

| | |
|---|---|
| Ptet promoter | TAATTCCTAATTTTTGTTGAC |
| | ACTCTATCATTGATAGAGTTA |
| | TTTTACCACTCCCTATCAGTG |
| | ATAGAGAAAAGTGAA |
| | (SEQ ID NO: 217) |
| Ptac promoter | TTGACAATTAATCATCGGCTC |
| | GTATAATGTGTGGAATTGTGA |
| | GCGGATAACAATTTCACACAG |
| | GAAACA |
| | (SEQ ID NO: 218) |
| PT7 promoter | TAATACGACTCACTATAGG |
| | (SEQ ID NO: 219) |
| L3S2P21 | CTCGGTACCAAATTCCAGAAA |
| terminator | AGAGGCCTCCCGAAAGGGGGG |
| | CCTTTTTTCGTTTTGGTCC |
| | (SEQ ID NO: 220) |
| T7 terminator | CAAAAAACCCCTCAAGACCCG |
| | TTTAGAGGCCCCAAGGGGTTA |
| | TGCTAG |
| | (SEQ ID NO: 221) |

### Example 6: Production of High Yield Cry1Ac and Vip3Aa19 Minicell Strains

Expression cassettes of Cry1Ac and Vip3Aa19 were produced by standard molecular biology techniques. The Cry1Ac gene was obtained from strain JM103 (pOS4201) (Bacillus Genetic Stock Center) and cloned into the same library of expression cassettes as PirAB toxin above with or without a 3×FLAG tag. The gene for Vip3Aa19 was codon optimized for expression in E. coli using the De Novo DNA Opener Calc, and the gene synthesized by Twist Biosciences. This codon optimized gene was then cloned into the same expression cassette library as above with or without a 3×FLAG tag.

Expression of the pesticidal proteins was induced with aTc or IPTG at an OD600=0.5 to produce and load the protein within the minicells as in Example 4.

The protein concentration in each isolated minicell sample was measured by quantitative western blot (Table 4). Aliquots of 10, 1, and 0.1 μL of minicells and a standard curve of purified 20, 10, 5, 2.5 ng BAP-FLAG (Sigma: P7457) or 100, 50, 25, 12.5 ng Cry1Ac (Sino Biological: 12008-A07E) were run on a 4-12% BIS-Tris SDS gel (Thermo Fisher: NW04125BOX), transferred to nitrocellulose with an iBlot (Thermo Fisher), and blotted with rabbit anti-FLAG (Sigma: F7425) or anti-Cry1Ac antibody (Abcam: ab51586) and goat anti-rabbit HRP conjugate (Sigma: AP307P). Westerns were imaged with an iBright (Thermo Fisher) and band intensities were quantified in ImageJ. Results showed successful expression of at least Cry1AC in three different strains (AD30, AD31, and AD32).

### Example 7: Biological Efficacy of Minicell-PirAB and Minicell-Cry1Ac

### Feeding Assay on Artificial Diet

Efficacy of four minicell strains were assessed in an artificial diet assay: strains AD16 and AD17 comprising PirAB (DH10B chassis), strain AD28 comprising Cry1Ac (DH10B chassis) and strain AD19 comprising PirAB (DH10B(DE3) chassis). For these experiments, new batches of cells were used.

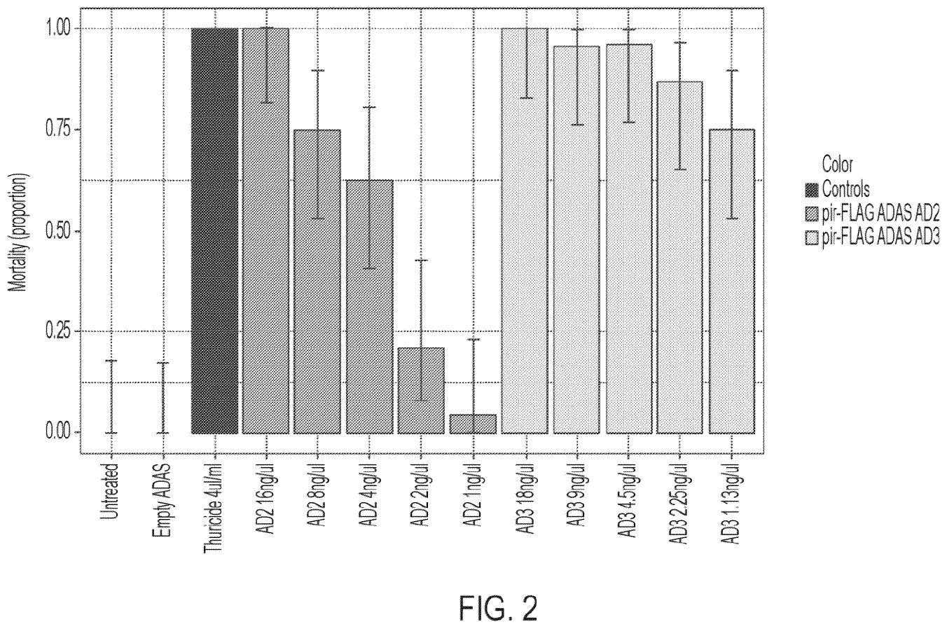

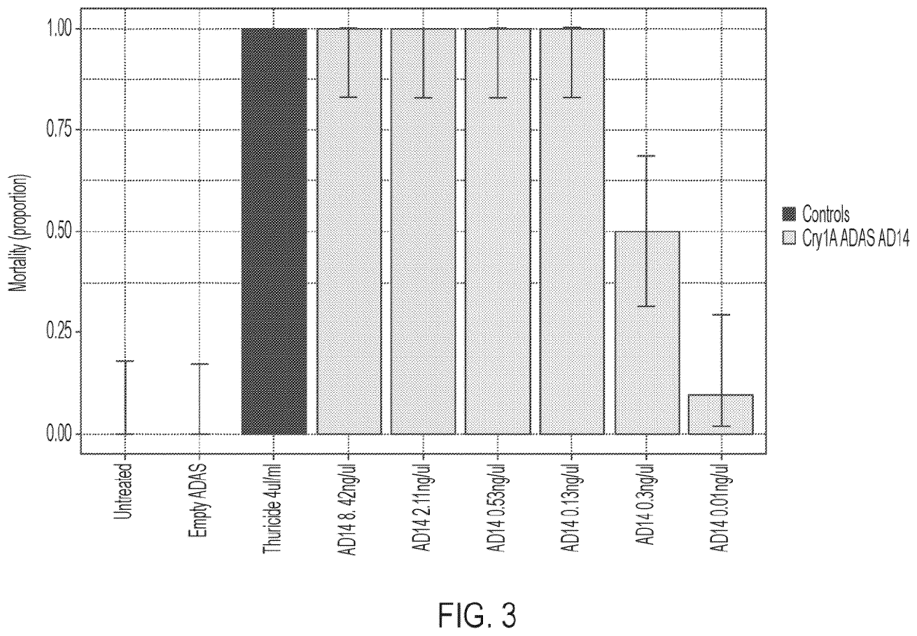

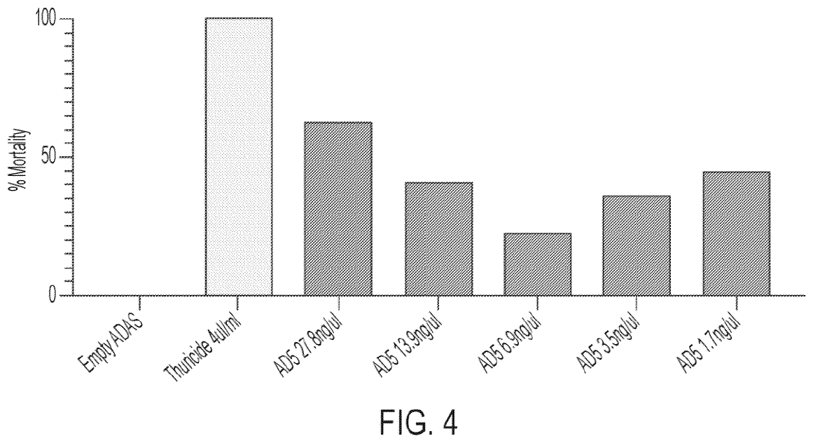

Diamondback moth (DBM) eggs (purchased from Benzon Research) were placed in containers filled with general noctuid artificial diet (purchased as dry powder from Southland Products Inc.). DBM eggs were incubated on artificial diet at 25° C. for four days until the emergence of the last 1st instar larvae. The day before the start of the feeding assay, 48-well plates were prepared by filling each well with 0.38 ml of the same artificial diet. On the day of the feeding assay, the solutions containing the actives were prepared as follows: PirAB-Minicells were diluted across four 2-fold serial dilutions starting from a concentration of 16-18 ng/μl of expressed protein (FIG. 2). Cry1Ac-Minicells (strain AD28) were diluted across five 4-fold serial dilutions, starting from a concentration 8.4 ng/μl of expressed protein (FIG. 3). PirAB-Minicells (strain AD19) were diluted across five 2-fold serial dilutions starting from a concentration of 27.8 ng/μl (FIG. 4). Aliquots of 30 μl of these solutions were applied per well to the 48-well plate containing artificial diet. After the solutions dried, one late 1st instar DBM larvae was placed per well, and the plates were sealed with Breathe Easier sealing film from Diversified Biotech to allow gas exchange. The plates were then placed in a 25° C. incubator with a 16 h light 8 h dark cycle setting. After three days, mortality was assessed by unsealing each plate and recording live and dead larvae in each plate.

### Green House Feeding Assays

Efficacy of Minicell-PirAB and Minicell-Cry1Ac against DBM were assessed using a whole plant assay in a greenhouse setting. Cabbage (Tiara variety) was grown in ProMix General Purpose soil and fertilized with controlled release Multicote until reaching a four-leaf stage. Approximately 300 Diamondback moth (DBM) eggs (purchased from Benzon Research) were placed in 1 mL tubes. On the day of the efficacy assay, 15 mLs of solutions of Minicell-PirAB and Minicell-Cry1Ac were sprayed per cabbage plant. Once the plant was dry, they were placed in individual cages. The 1 mL tube with DBM eggs were then opened and one was placed on its side at the base of each plant. Approximately 7 days later, plants were cut right above cotyledons and placed individually in paper bags. The whole plant was weighed, and a sample leaf was collected to capture percent leaf consumed. Then larvae per plant was counted and recorded.

### Translational Field Trials Assays

To assess Minicell-PirAB and Minicell-Cry1Ac field efficacy on Cabbage. Greenhouse grown Cabbage (Blue Lagoon) seedling plugs were transferred to fields and grown for a further five weeks. The field trial design incorporated a completely randomized block design 4 treatments and 4 reps. PirAB was tested at three concentrations—0.5X(27.5 mg/L), 1.0X(55 mg/L) and 2.0X(110 mg/L); Cry1AC was tested at three concentrations—0.5X(3.75 mg/L), 1.0X(7.5 mg/L) and 2.0X(15 mg/L) in a 1 liter spray volume each, and were applied using a hollow cone nozzle and CO₂ driven backpack sprayer at 40 Gal/Ac/and 22 psi operating pressure. Post applications 10 leaf discs/rep (40 leaf discs/treatment) were collected from the field plants. Each leaf disc was then subjected to the leaf disc assay with 2^{nd} instar DBM larvae. The leaf discs were placed on moistened filter paper discs, infested with two larvae, and incubated for 48 hrs before evaluations. The 20 larvae from each rep were categorized as dead, moribund, living and missing. The average from four reps were calculated for each category was calculated. Treatment efficacy was assessed as the combined percentage of dead and moribund larvae.

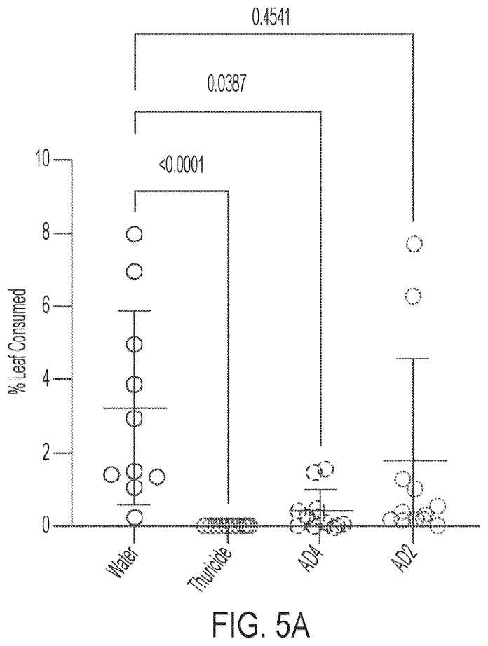

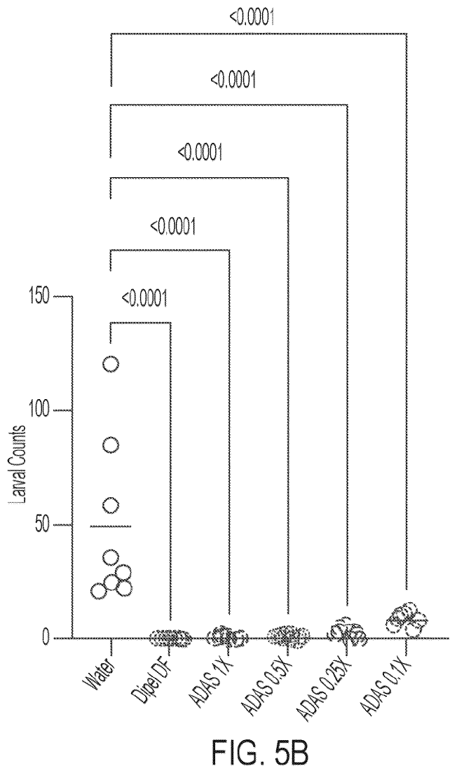

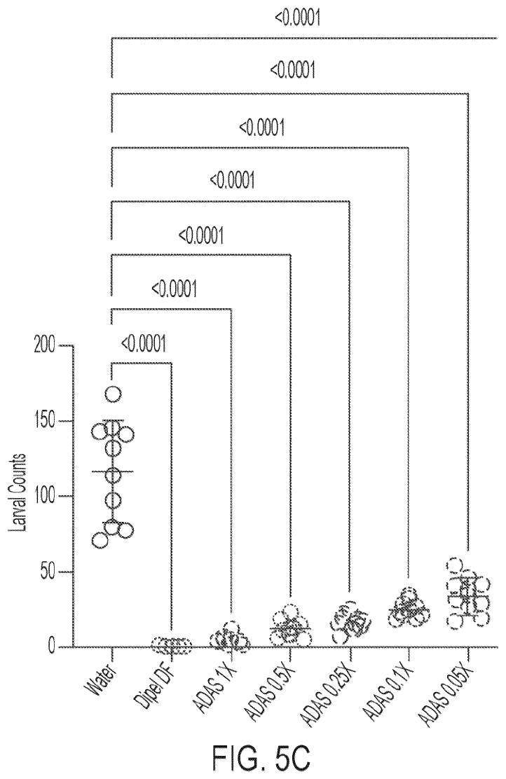

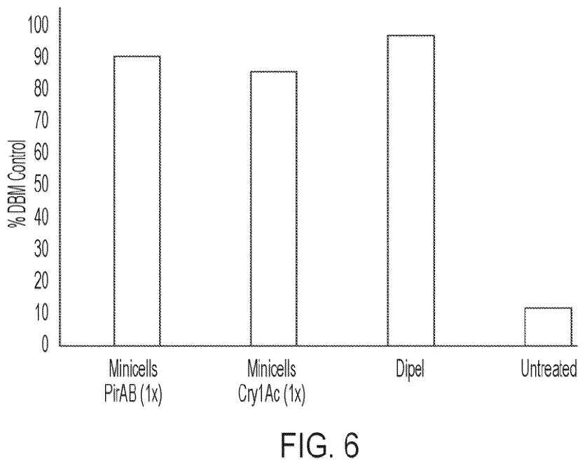

As seen in the artificial diet assay, Minicell-PirAB, Minicell-Cry1AC produced by either DH10B or DH10B(DE3) chassis are efficacious in controlling DBM, a lepidopteran insect, in a concentration-dependent manner (FIG. 2 to FIG. 4). FIG. 4 further confirms efficacy of Minicell-PirAB from strain AD18 and strain AD16 in a whole leaf assay. FIGS. 5A-5C confirms efficacy of Minicell-PirAB and Minicell-Cry1Ac towards DBM in greenhouse assays, and FIG. 6 confirms efficacy of Minicell-PirAB and Minicell-Cry1Ac towards DBM in a translational field trial assay.

Together these results demonstrate that minicells derived from DH10B and DH10B(DE) cells producing high minicell numbers can be used to express high yield of bioactives (e.g., toxin peptides) with a concentration-dependent efficacy for controlling insect agricultural pests.

### Example 8: Biological Efficacy of Minicell-Vip3Aa19

### Feeding Assay on Artificial Diet

Efficacy of Vip3Aa19-minicells produced in the DH10B and DH10B(DE) chassis (strains AD34-AD39) are assessed using a feeding assay on artificial diet. Diamondback moth (DBM) eggs (available from Benzon Research) are placed in containers filled with general noctuid artificial diet (available as dry powder from Southland Products Inc.). The eggs are incubated on artificial diet at 25° C. for four days until the emergence of the last 1st instar larvae. The day before the start of the feeding assay, 48-well plates are prepared by filling each well with 0.38 ml of artificial diet. On the day of the feeding assay, the solutions containing the actives are prepared. Vip3Aa19-Minicells are diluted across four 2-fold serial dilutions starting from a concentration of about 15 ng/μl of expressed protein. Aliquots of 30 μl of these solutions are applied per well to the 48-well plate containing the diet. The solutions are allowed to dry, and one late 1st instar DBM larvae is placed per well, and the plates are sealed with Breathe Easier sealing film from Diversified Biotech to allow gas exchange. The plates are then placed in a 25° C. incubator with a 16 h light 8 h dark cycle setting. After three days, mortality is assessed by unsealing each plate and recording live and dead larvae in each plate.

### Green House Feeding Assays

Green house efficacy of Vip3Aa19 comprised in minicells are assessed using a whole plant assay in a greenhouse setting. Cabbage (Tiara variety) is grown in ProMix General Purpose soil and fertilized with controlled release Multicote until reaching a four-leaf stage. Approximately 300 Diamondback moth (DBM) eggs (available from Benzon Research) are placed in 1 mL tubes. On the day of the Efficacy Assay, 15 mL of solutions of minicells comprising Vip3Aa19 are sprayed on each cabbage plant. Once the plant is dry, they are placed in individual cages. The 1 mL tube with DBM eggs are then opened and one is placed on its side at the base of each plant. Approximately 7 days later, plants are cut right above cotyledons and placed individually in paper bags. The whole plant is weighed, and a sample leaf is collected to capture percent leaf consumed. Then larvae per plant are counted and recorded.

### Translational Field Trials Assays

To assess Vip3Aa19 field efficacy on Cabbage, greenhouse grown Cabbage (Blue Lagoon) seedling plugs are transferred to fields and grown for a further five weeks. The field trial design incorporates a completely randomized block design of 4 treatments and 4 reps. Vip3Aa19 in minicells is tested at three concentrations—0.5X(27.5 mg/L), 1.0X(55 mg/L) and 2.0X(110 mg/L) in a 1 liter spray volume each, and are applied using a hollow cone nozzle and CO₂ driven backpack sprayer at 40 Gal/Ac/and 22 psi operating pressure. Post application, 10 leaf discs/rep (40 leaf discs/treatment) are collected from the field plants. Each leaf disc is placed on moistened filter paper discs, infested with two 2^{nd} instar DMB larvae, and incubated for 48 hrs before evaluations. The 20 larvae from each rep are categorized as dead, moribund, living and missing. The average from four reps are calculated for each category. Treatment efficacy is assessed as the combined percentage of dead and moribund larvae.

Minicells comprising Vip3Aa19 are expected to display a high efficacy in controlling a lepidopteran insect, in a concentration-dependent manner. Strains are also efficacious in a whole leaf assay and translational field trial assays towards DBM.

### Example 9: Production of Storage-Stable Pesticidal Minicells

This example demonstrates the ability to create a storage-stable pesticidal minicells that maintain activity.

To create a storage-stable pesticidal minicells in this example, minicells are freeze-dried via lyophilization. Isolated minicells are prepared as described above, and 1 mL of minicells are pelleted by centrifugation at 21,000 g for 15 min in 1.5 mL plastic tubes. The pellet is resuspended in and equal volume of Microbial Freeze Drying Buffer (OPS Diagnostics) is transferred into 15 mL conical tube, and flash frozen in liquid nitrogen. The pesticidal minicells are then freeze-dried for 16 hours using a FreeZone benchtop freeze dryer (Labconco) with autocollect settings. Tubes of freeze dried minicells are sealed with parafilm and stored at room temperature in the dark until use.

Freeze-dried minicells are stored for a period of 1, 2, 6, 12, or 24 months. Activity is measure after hydration. Briefly, powdered minicells are rehydrated with 1 mL of PBS. Maintenance of particle numbers is confirmed by concentration measurement on a Spectradyne nCS1. ATP content of minicells is measure as well to confirm stability.

### Example 10: Creation of a Wettable Powder (WP) Pesticidal Compositions

A lyophilized pesticidal minicell as produced in the previous examples is used to make a wettable powder (WP). Wettable powders include finely divided particles that disperse readily in water or other liquid carriers. The particles contain pesticidal minicells, typically in lyophilized form, retained in a solid matrix. Typical solid matrices include fuller's earth, kaolin clays, silicas and other readily wet organic or inorganic solids. Wettable powders may contain about 5% to about 95% of the pesticidal minicells plus a small amount of wetting, dispersing or emulsifying agent. Examples of wettable powders include those in Table 6.

TABLE 6
Examples of components of wettable powders.

| Ingredient | Example powder 1 | Example powder 2 |
|---|---|---|
| Pesticidal minicell | 50% pesticidal minicell A | 40% pesticidal minicell B (Bacillus |
| | (Photorhabdus derived) | derived) |
| Carrier | 43% kaolin clay | 55% fuller's earth |
| Wetting agent | 2% alkylaryl sulphonate | 2% alkylaryl sulphonate |
| Dispersing agent | 1% polyethoxylated alcohol | 1% polyethoxylated alcohol |
| Inert | 4% silica | 2% silica |

Those of skill in the art would also be able to produce water dispersible granules (WDGs) using the teachings contained herein.

### Example 11: Creation of a Suspension Concentration (SC) Pesticidal Composition

A minicell as produced in previous examples may be used to produce a suspension concentrate (SC). Suspension concentrates include aqueous formulations in which finely divided solid particles of pesticidal minicells are stably suspended. Such formulations include anti-settling agents and dispersing agents and may further include a wetting agent to enhance activity as well an anti-foam and a crystal growth inhibitor. Suspension concentrates are diluted in water and applied as a spray to the area to be treated. The amount of pesticidal minicells may range from about 0.5% to about 95% of the concentrate. An example of a suspension concentrate formulation is described in Table 7.

TABLE 7
Example suspension concentrate.

| Ingredient | Amount (% w/v) |
|---|---|
| Pesticidal minicell | 40 |
| Naphthalene sulfonate | 4 |
| condensate | |
| Nonionic polymeric | 1 |
| aqueous dispersant | |
| Xanthan gum | 0.5 |
| Preservative | 0.1 |
| Water | Balance |

### Example 12: Seed Treatment and Method of Creating a Plantable Composition

Minicells as produced in previous examples may be used to produce a seed treatment and a plantable composition. In such seed treatment compositions, in addition to the pesticidal minicell, the compositions may include other pesticides, surfactants, film-forming polymers, carriers, antifreeze agents, and other formulary additives and when used together provide compositions that are storage stable and are suitable for use in normal seed treatment equipment, such as a slurry seed treater, direct treater, on-farm hopper-boxes, planter-boxes, etc.

An example seed treatment composition is described in Table 8.

TABLE 8
Example seed treatment composition.

| Ingredient | Amount |
|---|---|
| Pesticidal minicell | 40% |
| EO/PO Block Co-polymer | 3% |
| Tristyrylphenol ethoxylate | 0.5% |
| Calcium salt, pigment red | 5% |
| Silicone Oil | 0.2% |
| Water | Balance |

A plantable composition may be created by coating a seed (e.g., a corn seed, a soybean seed, a canola seed, a rice seed, a wheat seed, etc.) with the seed treatment composition, thereby creating a novel composition having improved plantability characteristics.

### Enumerated Embodiments

1. A method for manufacturing an agricultural ADAS composition comprising a plurality of minicells that is substantially free of viable parental bacterial cells, the method comprising:
(a) exposing a population of parental bacterial cells exhibiting a reduced level or activity of at least one cell division topological specificity factor to conditions allowing for the formation of minicells, wherein the parental bacterial cells are deficient in a gene involved in DNA repair; and
(b) separating the minicells from the parental bacterial cells, thereby producing a composition comprising a plurality of minicells that is substantially free of viable parental bacterial cells.

2. The method of embodiment 1, wherein the cell division topological specificity factor is selected from the group consisting of minC, minD, minE, and ftsZ.

3. The method of embodiment 1, wherein the gene involved in DNA repair is selected from the group consisting of mutS, MutH, MutL, SSB, RecA, RecJ, ExoI, ExoVII, ExoX, UvrD, and DNA polymerase III.

4. The method of embodiment 1, wherein the gene involved in DNA repair is RecA.

5. The method of embodiment 4, wherein the bacterial cells are E. coli DH10BΔminCDE.

6. The method of embodiment 1, wherein the parental bacterial cells comprise a T3, T7, K11 or SP6 polymerase or a nucleic acid encoding a T3, T7, K11 or SP6 polymerase.

7. The method of embodiment 1, wherein the parental bacterial cells comprise a T7 polymerase or a nucleic acid encoding a T7 polymerase.

8. The method of embodiment 7, wherein the parental bacterial cells are E. coli DH10B(DE3)ΔminCDE.

9. The method of any of embodiments 1-8, wherein the composition comprises at least 10¹¹ minicells per liter of culture of parental bacterial cells.

10. A method for manufacturing an agricultural ADAS composition comprising a plurality of minicells loaded with protein, the composition being substantially free of viable parental bacterial cells, the method comprising:
(a) exposing the parental bacterial cells exhibiting a reduced level or activity of at least one cell division topological specificity factor to conditions allowing for protein expression, wherein the parental bacterial cells are deficient in a gene involved in DNA repair;
(b) exposing the parental bacterial cells to conditions allowing for the formation of minicells; and
(c) separating the minicells from the parental cells, thereby producing a composition comprising a plurality of minicells loaded with protein that is substantially free of viable parental bacterial cells.

11. The method of embodiment 10, wherein the cell division topological specificity factor is selected from the group consisting of minC, minD, minE, and ftsZ.

12. The method of embodiment 10, wherein the gene involved in DNA repair is selected from the group consisting of mutS, MutH, MutL, SSB, RecA, RecJ, ExoI, ExoVII, ExoX, UvrD, and DNA polymerase III.

13. The method of embodiment 10, wherein the gene involved in DNA repair is RecA.

14. The method of embodiment 13, wherein the bacterial cells are E. coli DH10BΔminCDE.

15. The method of embodiment 10, wherein the parental bacterial cells comprise a T3, T7, K11 or SP6 polymerase or a nucleic acid encoding a T3, T7, K11 or SP6 polymerase.

16. The method of embodiment 10, wherein the parental bacterial cells comprise a T7 polymerase or a nucleic acid encoding a T7 polymerase.

17. The method of embodiment 16, wherein the parental bacterial cells are E. coli

DH10B(DE3) ΔminCDE.

18. The method of any of embodiments 10-17, wherein the parental bacterial cell comprises an expression vector.

19. The method of embodiment 18, wherein the expression vector comprises a gene that encodes for the protein.

20. The method of embodiment 19, wherein the gene is under the control of T7, Ptac, Ptet, or a constitutive promoter.

21. The method of any of embodiments 18-20, wherein the protein is a pesticidal, herbicidal, or antimicrobial protein.

22. The method of embodiment 21, wherein the protein is selected from the group consisting of PirAB, Cry1AC and Vip3Aa19.

23. The method of embodiment 21, wherein the protein is PirAB.

24. The method of embodiment 21, wherein the protein is Cry1Ac.

25. The method of embodiment 22, wherein the protein is Vip3Aa19.

26. The method of any of embodiments 10-22, wherein the composition comprises at least 10¹¹ minicells per liter of culture of parental bacterial cells.

27. The method of any of embodiments 10-22, wherein the composition comprises at least 100 ng protein per 10⁹ minicells.

28. An agricultural ADAS composition comprising:
(a) a plurality of minicells, wherein the minicells are derived from a plurality of parental bacterial cells exhibiting a reduced level or activity of at least one cell division topological specificity factor; and
(b) wherein the plurality of minicells comprise at least 100 ng protein per 109 minicells.

29. The composition of embodiment 28, wherein the cell division topological specificity factor is selected from the group consisting of minC, minD, minE, and ftsZ.

30. The composition of embodiment 28, wherein the parental bacterial cells are deficient in a gene involved in DNA repair.

31. The composition of embodiment 28, wherein the gene involved in DNA repair is selected from the group consisting of mutS, MutH, MutL, SSB, RecA, RecJ, ExoI, ExoVII, ExoX, UvrD, and DNA polymerase III.

32. The composition of embodiment 28, wherein the gene involved in DNA repair is RecA.

33. The composition of embodiment 32, wherein the bacterial cells are E. coli DH10BΔminCDE.

34. The composition of embodiment 28, wherein the parental bacterial cells comprise a T3, T7, K11 or SP6 polymerase or a nucleic acid encoding a T3, T7, K11 or SP6 polymerase.

35. The composition of embodiment 28, wherein the parental bacterial cells comprise a T7 polymerase or a nucleic acid encoding a T7 polymerase.

36. The composition of embodiment 34, wherein the parental bacterial cells are E. coli DH10B(DE3)ΔminCDE.

37. The composition of any of embodiments 29-37, wherein the parental bacterial cell comprises an expression vector.

38. The composition of embodiment 37, wherein the expression vector comprises a gene that encodes for the protein.

39. The composition of embodiment 38, wherein the gene is under the control of T7, Ptac, Ptet, or a constitutive promoter.

40. The composition of embodiment 28, wherein the protein is a pesticidal, herbicidal, or antimicrobial protein.

41. The composition of embodiment 40, wherein the protein is selected from the group consisting of pirAB, Cry and Vip3Aa19.

42. The composition of embodiments 28-41, wherein the plurality of minicells comprises a mixture of a first minicell comprising a first effective amount of a first exogenous protein toxin comprising Pir and a second minicell comprising a second effective amount of a second exogenous protein toxin comprising Cry.

43. The composition of embodiments 42, wherein the first effective amount and the second effective amount are present at a ratio in the range of about 50:1-1:50.

44. The composition of embodiments 43, wherein the first effective amount and the second effective amount are present at a ratio of about 46:1, 23:1, 11:1, 9:1, 6:1, 5:1, 3:1, or 1:1.

45. The composition of embodiments 42-44, wherein wherein the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest.

46. The composition of embodiments 42-45, wherein wherein a first particle concentration of the first minicell is in the range of about 1×10² to about 8×10¹⁴, and wherein a second particle concentration of the second minicell is in the range of about 1×10² to about 8×10¹⁴.

47. The composition of embodiments 42-46, wherein the composition is formulated as at least one of a Ready To Use (RTU) formulation, a suspension concentrate, a tank-mix, an aerosol, a seed treatment, a root dip, a soil treatment, an irrigation formulation, a sprinkler formulation, and a drench treatment.

48. The composition of embodiments 42-47, wherein the first exogenous protein toxin comprises PirAB or a functional component thereof.

49. The composition of embodiment 48, wherein PirAB comprises a PirA selected from the group consisting of SEQ ID NO: 143, SEQ ID NO: 146, SEQ ID NO: 147, SEQ ID NO: 154, SEQ ID NO: 157, SEQ ID NO: 161, SEQ ID NO: 163, SEQ ID NO: 164, SEQ ID NO: 165, SEQ ID NO: 167, SEQ ID NO: 168, SEQ ID NO: 169, SEQ ID NO: 170, SEQ ID NO: 171, SEQ ID NO: 174, SEQ ID NO: 174, SEQ ID NO: 186, SEQ ID NO: 190, SEQ ID NO: 192, SEQ ID NO: 197, SEQ ID NO: 199, SEQ ID NO: 202, and SEQ ID NO: 203; and a PirB selected from the group consisting of SEQ ID NO: 144, SEQ ID NO: 145, SEQ ID NO: 148, SEQ ID NO: 149, SEQ ID NO: 150, SEQ ID NO: 153, SEQ ID NO: 158, SEQ ID NO: 159, SEQ ID NO: 160, SEQ ID NO: 162, SEQ ID NO: 166, SEQ ID NO: 172, SEQ ID NO: 177, SEQ ID NO: 178, SEQ ID NO: 179, SEQ ID NO: 180, SEQ ID NO: 181, SEQ ID NO: 182, SEQ ID NO: 183, SEQ ID NO: 184, SEQ ID NO: 185, SEQ ID NO: 187, SEQ ID NO: 188, SEQ ID NO: 189, SEQ ID NO: 191, SEQ ID NO: 193, SEQ ID NO: 194, SEQ ID NO: 195, SEQ ID NO: 196, SEQ ID NO: 198, SEQ ID NO: 201, and SEQ ID NO: 204, or a functional component of any thereof.

50. The composition of embodiment 49, wherein PirAB comprises the PirA comprising SEQ ID NO: 203 and the PirB comprising SEQ ID NO: 204, or wherein PirAB comprises the PirA comprising SEQ ID NO: 197 and the PirB comprising SEQ ID NO: 178.

51. The composition of embodiments 42-50, wherein the second exogenous protein toxin comprises Cry1A, Cry1B, Cry1C, Cry1D, Cry1E, Cry1F, Cry1G, Cry1H, Cry1I, Cry1J, or Cry1K or a functional component thereof.

52. The composition of embodiment 51, wherein the Cry1A comprises a Cry1A selected from the group consisting of SEQ ID NO: 105, SEQ ID NO: 106, SEQ ID NO: 107, SEQ ID NO: 108, SEQ ID NO: 109, SEQ ID NO: 110, SEQ ID NO: 111, SEQ ID NO: 112, SEQ ID NO: 113, SEQ ID NO: 114, SEQ ID NO: 115, SEQ ID NO: 151, SEQ ID NO: 152, and SEQ ID NO: 205; the Cry1B comprises a Cry1B selected from the group consisting of SEQ ID NO: 117, SEQ ID NO: 118, SEQ ID NO: 119, SEQ ID NO: 120, SEQ ID NO: 121, SEQ ID NO: 122, and SEQ ID NO: 155; the Cry1C comprises a Cry1C selected from the group consisting of SEQ ID NO: 123, SEQ ID NO: 124, SEQ ID NO: 125, and SEQ ID NO: 156; the Cry1D comprises a Cry1D selected from the group consisting of SEQ ID NO: 126, SEQ ID NO: 127, SEQ ID NO: 175, and SEQ ID NO: 176; the Cry1E comprises a Cry1E selected from the group consisting of SEQ ID NO: 128 and SEQ ID NO: 129; the Cry1F comprises a Cry1F selected from the group consisting of SEQ ID NO: 130 and SEQ ID NO: 131; the Cry1G comprises a Cry1G selected from the group consisting of SEQ ID NO: 132 and SEQ ID NO: 133; the Cry1H comprises a Cry1H selected from the group consisting of SEQ ID NO: 134 and SEQ ID NO: 135; the Cry1I comprises a Cry1I selected from the group consisting of SEQ ID NO: 136, SEQ ID NO: 137, SEQ ID NO: 138, and SEQ ID NO: 139; the Cry1J comprises a Cry1J selected from the group consisting of SEQ ID NO: 140 and SEQ ID NO: 141; or the Cry1K comprises SEQ ID NO: 142, or a functional component of any thereof.

53. The composition of embodiments 50 and 51, wherein the second exogenous protein toxin comprises the Cry1A comprising SEQ ID NO: 205.

54. An agricultural composition comprising a plurality of parental bacterial cells, wherein the parental bacterial cells
(a) have a reduction in the level or activity of at least one cell division topological specificity factor;
(b) are deficient in a gene involved in DNA repair;
wherein the parental bacterial cells produce at least 10¹¹ minicells per liter of parental bacterial cell culture.

55. The composition of embodiment 54, wherein the cell division topological specificity factor is selected from the group consisting of minC, minD, minE, and ftsZ.

56. The composition of embodiment 54, wherein the gene involved in DNA repair is selected from the group consisting of mutS, MutH, MutL, SSB, RecA, RecJ, ExoI, ExoVII, ExoX, UvrD, and DNA polymerase III.

57. The composition of embodiment 54, wherein the gene involved in DNA repair is RecA.

58. The composition of embodiment 57, wherein the bacterial cells are E. coli DH10BΔminCDE.

59. The composition of embodiment 54, wherein the parental bacterial cells comprise a T3, T7, K11 or SP6 polymerase or a nucleic acid encoding a T3, T7, K11 or SP6 polymerase.

60. The composition of embodiment 54, wherein the parental bacterial cells comprise a T7 polymerase or a nucleic acid encoding a T7 polymerase.

61. The composition of embodiment 60, wherein the parental bacterial cells are E. coli DH10B(DE3)ΔminCDE.

62. The composition of any of embodiments 54-60, wherein the parental bacterial cells comprise an expression vector.

63. The composition of embodiment 62, wherein the expression vector comprises a gene that encodes for a protein.

64. The composition of embodiment 62, wherein the gene is under the control of T7, Ptac, Ptet, or a constitutive promoter.

65. The composition of embodiment 63 or 64, wherein the protein is a pesticidal, herbicidal, or antimicrobial protein.

66. The composition of embodiment 65, wherein the protein is selected from the group consisting of pirAB, Cry and Vip3Aa19

67. The composition of any of embodiment 54-66, wherein the parental bacterial cells are capable of producing minicells with a protein concentration exceeding 100 ng per 109 minicells.

68. A method of reducing the viability of DBM larvae, the method comprising contacting DBM larvae with any of the compositions of embodiments 28-68, wherein the viability of the larvae contacted with the composition is lower than the viability of the larvae not contacted with the composition.

69. A wettable powder comprising:
a plurality of dried minicells comprising a mixture of a first effective amount of a first minicell comprising a first exogenous protein toxin comprising Pir and a second effective amount of a second minicell comprising a second exogenous protein toxin comprising Cry,
wherein the first effective amount and the second effective amount are present at a ratio in the range of about 50:1-1:50, and
wherein the wettable powder is configured to be dispersed in an aqueous carrier to create a composition for controlling at least one insect pest when the composition is administered to an insect.

70. The wettable powder of embodiment 69, wherein the first effective amount and the second effective amount are present at a ratio of about 46:1, 23:1, 11:1, 9:1, 6:1, 5:1, 3:1, or 1:1.

71. The wettable powder of embodiment 69 or embodiment 70, wherein the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest.

72. The wettable powder of any one of embodiments 69-71, wherein a first particle concentration of the first minicell is in the range of about 1×10² to about 8×10¹⁴, and wherein a second particle concentration of the second minicell is in the range of about 1×10² to about 8×10¹⁴.

73. The wettable powder of any one of embodiments 69-72, further comprising an agrochemically acceptable solid carrier component comprising at least one of: a clay component, a kaolin component, a talc component, a chalk component, a calcite component, a quartz component, a pumice component, a diatomaceous earth component, a vermiculite component, a silicate component, a silicon dioxide component, a silica powder component, an aluminum component, an ammonium sulfate component, an ammonium phosphate component, a calcium carbonate component, an urea component, a sugar component, a starch component, a sawdust component, a ground coconut shell component, a ground corn cob component, and a ground tobacco stalk component.

74. The wettable powder of any one of embodiments 69-73, wherein the aqueous carrier comprises water.

75. The wettable powder of any one of embodiments 69-74, wherein administering the composition to the insect pest comprises an administration method selected from the group consisting of delivering the composition to the insect pest for ingestion; contacting the insect with the composition; delivering the composition to at least one habitat where the insect pest grows, lives, reproduces, feeds, or infests; and applying the composition to a plant.

76. The composition of embodiment 75, wherein the composition is applied to the plant as at least one of a foliar treatment, an injection treatment, a pre-emergence treatment, and a post-emergence treatment.

77. The composition of any one of embodiments 69-76, wherein the first exogenous protein toxin comprises PirAB or a functional component thereof.

78. The composition of embodiment 77, wherein PirAB comprises a PirA selected from the group consisting of SEQ ID NO: 143, SEQ ID NO: 146, SEQ ID NO: 147, SEQ ID NO: 154, SEQ ID NO: 157, SEQ ID NO: 161, SEQ ID NO: 163, SEQ ID NO: 164, SEQ ID NO: 165, SEQ ID NO: 167, SEQ ID NO: 168, SEQ ID NO: 169, SEQ ID NO: 170, SEQ ID NO: 171, SEQ ID NO: 174, SEQ ID NO: 174, SEQ ID NO: 186, SEQ ID NO: 190, SEQ ID NO: 192, SEQ ID NO: 197, SEQ ID NO: 199, SEQ ID NO: 202, and SEQ ID NO: 203; and a PirB selected from the group consisting of SEQ ID NO: 144, SEQ ID NO: 145, SEQ ID NO: 148, SEQ ID NO: 149, SEQ ID NO: 150, SEQ ID NO: 153, SEQ ID NO: 158, SEQ ID NO: 159, SEQ ID NO: 160, SEQ ID NO: 162, SEQ ID NO: 166, SEQ ID NO: 172, SEQ ID NO: 177, SEQ ID NO: 178, SEQ ID NO: 179, SEQ ID NO: 180, SEQ ID NO: 181, SEQ ID NO: 182, SEQ ID NO: 183, SEQ ID NO: 184, SEQ ID NO: 185, SEQ ID NO: 187, SEQ ID NO: 188, SEQ ID NO: 189, SEQ ID NO: 191, SEQ ID NO: 193, SEQ ID NO: 194, SEQ ID NO: 195, SEQ ID NO: 196, SEQ ID NO: 198, SEQ ID NO: 201, and SEQ ID NO: 204, or a functional component of any thereof.

79. The composition of embodiment 78, wherein PirAB comprises the PirA comprising SEQ ID NO: 203 and the PirB comprising SEQ ID NO: 204, or wherein PirAB comprises the PirA comprising SEQ ID NO: 197 and the PirB comprising SEQ ID NO: 178.

80. The composition of any one of embodiments 69-79, wherein the second exogenous protein toxin comprises Cry1A, Cry1B, Cry1C, Cry1D, Cry1E, Cry1F, Cry1G, Cry1H, Cry1I, Cry1J, or Cry1K or a functional component thereof.

81. The composition of embodiment 80, wherein the Cry1A comprises a Cry1A selected from the group consisting of SEQ ID NO: 105, SEQ ID NO: 106, SEQ ID NO: 107, SEQ ID NO: 108, SEQ ID NO: 109, SEQ ID NO: 110, SEQ ID NO: 111, SEQ ID NO: 112, SEQ ID NO: 113, SEQ ID NO: 14, SEQ ID NO: 115, SEQ ID NO: 151, SEQ ID NO: 152, and SEQ ID NO: 205; the Cry1B comprises a Cry1B selected from the group consisting of SEQ ID NO: 117, SEQ ID NO: 118, SEQ ID NO: 119, SEQ ID NO: 120, SEQ ID NO: 121, SEQ ID NO: 122, and SEQ ID NO: 155; the Cry1C comprises a Cry1C selected from the group consisting of SEQ ID NO: 123, SEQ ID NO: 124, SEQ ID NO: 125, and SEQ ID NO: 156; the Cry1D comprises a Cry1D selected from the group consisting of SEQ ID NO: 126, SEQ ID NO: 127, SEQ ID NO: 175, and SEQ ID NO: 176; the Cry1E comprises a Cry1E selected from the group consisting of SEQ ID NO: 128 and SEQ ID NO: 129; the Cry1F comprises a Cry1F selected from the group consisting of SEQ ID NO: 130 and SEQ ID NO: 131; the Cry1G comprises a Cry1G selected from the group consisting of SEQ ID NO: 132 and SEQ ID NO: 133; the Cry1H comprises a Cry1H selected from the group consisting of SEQ ID NO: 134 and SEQ ID NO: 135; the Cry1I comprises a Cry1I selected from the group consisting of SEQ ID NO: 136, SEQ ID NO: 137, SEQ ID NO: 138, and SEQ ID NO: 139; the Cry1J comprises a Cry1J selected from the group consisting of SEQ ID NO: 140 and SEQ ID NO: 141; or the Cry1K comprises SEQ ID NO: 142 or a functional component of any thereof.

82. The composition of embodiment 81, wherein the second exogenous protein toxin comprises the Cry1A comprising SEQ ID NO: 205.

83. The composition of any one of embodiments 69-82, wherein control comprises at least one of:
a reduction in insect pest number,
a reduction in insect pest weight,
a reduction in physical damage caused by the insect pest, and
an increase in insect pest mortality.

84. The composition of embodiment 83, wherein
the reduction in insect pest number is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in insect pest weight is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in physical damage is an at least 10% reduction, an at least 15% reduction, at least 20% reduction, an at least 25% reduction, an at least 30% reduction, an at least 40% reduction, an at least 50% reduction, an at least 60% reduction, an at least 70% reduction, or an at least 80% reduction, and
the increase in insect pest mortality is an at least 10% increase, an at least 15% increase, an at least 20% increase, an at least 25% increase, an at least 30% increase, an at least 40% increase, an at least 50% increase, an at least 60% increase, an at least 70% increase, or an at least 80% increase.

85. The composition of any one of embodiments 69-84, wherein control comprises an observed insect pest mortality of at least about 55%, 60%, 65%, 70%, 75%, 80%, 85%, 90%, or 95%.

86. The composition of any one of embodiments 69-85, wherein the at least one insect pest is selected from the group consisting of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., and Diptera spp.

87. A method of producing a wettable powder comprising:
a) providing a first effective amount of a first dried minicell comprising a first exogenous protein toxin comprising Pir;
b) a second effective amount of a second dried minicell comprising a second exogenous protein toxin comprising Cry; and
c) mixing the first effective amount and the second effective amount at a ratio in the range of about 50:1-1:50,
wherein the wettable powder is configured to be dispersed in an aqueous carrier to create a composition for controlling at least one insect pest when the composition is administered to an insect pest.

88. The method of embodiment 87, wherein the first effective amount and the second effective amount are mixed in a ratio of about 46:1, 23:1, 11:1, 9:1, 6:1, 5:1, 3:1, or 1:1.

89. A plantable composition comprising:
a seed; and
a coating covering the seed, wherein the coating comprises a plurality of minicells comprising a mixture of a first effective amount of a first minicell comprising a first exogenous protein toxin comprising Pir and a second effective amount of a second minicell comprising a second exogenous protein toxin comprising Cry,
wherein the first effective amount and the second effective amount are present at a ratio in the range of about 50:1-1:50, and
wherein the mixture is sufficient to result in insecticidal activity on at least one insect pest feeding on the seed or a seedling emerging therefrom.

90. The plantable composition of embodiment 89, wherein the first effective amount and the second effective amount are present at a ratio of about 46:1, 23:1, 11:1, 9:1, 6:1, 5:1, 3:1, or 1:1.

91. The plantable composition of embodiments 89 or claim 90, wherein the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest.

92. The plantable composition of any one of embodiments 89-91, wherein a first particle concentration of the first minicells is in the range of about 1×10² to about 8×10¹⁴, and wherein a second particle concentration of the second minicells is in the range of about 1×10² to about 8×10¹⁴.

93. The plantable composition of any one of embodiments 89-92, wherein the first exogenous protein toxin comprises PirAB or a functional component thereof.

94. The plantable composition of embodiments 93, wherein PirAB comprises a PirA selected from the group consisting of SEQ ID NO: 143, SEQ ID NO: 146, SEQ ID NO: 147, SEQ ID NO: 154, SEQ ID NO: 157, SEQ ID NO: 161, SEQ ID NO: 163, SEQ ID NO: 164, SEQ ID NO: 165, SEQ ID NO: 167, SEQ ID NO: 168, SEQ ID NO: 169, SEQ ID NO: 170, SEQ ID NO: 171, SEQ ID NO: 174, SEQ ID NO: 174, SEQ ID NO: 186, SEQ ID NO: 190, SEQ ID NO: 192, SEQ ID NO: 197, SEQ ID NO: 199, SEQ ID NO: 202, and SEQ ID NO: 203; and a PirB selected from the group consisting of SEQ ID NO: 144, SEQ ID NO: 145, SEQ ID NO: 148, SEQ ID NO: 149, SEQ ID NO: 150, SEQ ID NO: 153, SEQ ID NO: 158, SEQ ID NO: 159, SEQ ID NO: 160, SEQ ID NO: 162, SEQ ID NO: 166, SEQ ID NO: 172, SEQ ID NO: 177, SEQ ID NO: 178, SEQ ID NO: 179, SEQ ID NO: 180, SEQ ID NO: 181, SEQ ID NO: 182, SEQ ID NO: 183, SEQ ID NO: 184, SEQ ID NO: 185, SEQ ID NO: 187, SEQ ID NO: 188, SEQ ID NO: 189, SEQ ID NO: 191, SEQ ID NO: 193, SEQ ID NO: 194, SEQ ID NO: 195, SEQ ID NO: 196, SEQ ID NO: 198, SEQ ID NO: 201, and SEQ ID NO: 204, or a functional component of any thereof.

95. The plantable composition of embodiment 94, wherein PirAB comprises the PirA comprising SEQ ID NO: 203 and the PirB comprising SEQ ID NO: 204, or wherein PirAB comprises the PirA comprising SEQ ID NO: 197 and the PirB comprising SEQ ID NO: 178.

96. The plantable composition of any one of embodiments 89-95, wherein the second exogenous protein toxin comprises Cry1A, Cry1B, Cry1C, Cry1D, Cry1E, Cry1F, Cry1G, Cry1H, Cry1I, Cry1J, or Cry1K or a functional component thereof.

97. The plantable composition of embodiment 96, wherein the Cry1A comprises a Cry1A selected from the group consisting of SEQ ID NO: 105, SEQ ID NO: 106, SEQ ID NO: 107, SEQ ID NO: 108, SEQ ID NO: 109, SEQ ID NO: 110, SEQ ID NO: 111, SEQ ID NO: 112, SEQ ID NO: 113, SEQ ID NO: 114, SEQ ID NO: 115, SEQ ID NO: 151, SEQ ID NO: 152, and SEQ ID NO: 205; the Cry1B comprises a Cry1B selected from the group consisting of SEQ ID NO: 117, SEQ ID NO: 118, SEQ ID NO: 119, SEQ ID NO: 120, SEQ ID NO: 121, SEQ ID NO: 122, and SEQ ID NO: 155; the Cry1C comprises a Cry1C selected from the group consisting of SEQ ID NO: 123, SEQ ID NO: 124, SEQ ID NO: 125, and SEQ ID NO: 156; the Cry1D comprises a Cry1D selected from the group consisting of SEQ ID NO: 126, SEQ ID NO: 127, SEQ ID NO: 175, and SEQ ID NO: 176; the Cry1E comprises a Cry1E selected from the group consisting of SEQ ID NO: 128 and SEQ ID NO: 129; the Cry1F comprises a Cry1F selected from the group consisting of SEQ ID NO: 130 and SEQ ID NO: 131; the Cry1G comprises a Cry1G selected from the group consisting of SEQ ID NO: 132 and SEQ ID NO: 133; the Cry1H comprises a Cry1H selected from the group consisting of SEQ ID NO: 134 and SEQ ID NO: 135; the Cry1I comprises a Cry1I selected from the group consisting of SEQ ID NO: 136, SEQ ID NO: 137, SEQ ID NO: 138, and SEQ ID NO: 139; the Cry1J comprises a Cry1J selected from the group consisting of SEQ ID NO: 140 and SEQ ID NO: 141; or the Cry1K comprises SEQ ID NO: 142, or a functional component of any thereof.

98. The plantable composition of embodiment 97, wherein the second exogenous protein toxin comprises the Cry1A comprising SEQ ID NO: 205.

99. The plantable composition of any one of embodiments 89-98, wherein the at least one insect pest is selected from the group consisting of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., and Diptera spp.

100. The plantable composition of any one of embodiments 89-99, wherein the seed is from a plant selected from the group consisting of alfalfa, almond, apple, apricot, artichoke, asparagus, avocado, banana, barley, bean, blueberry, cranberry, Brazil nut, cacao, calamansi, canola, Polish canola, broccoli, kale, cabbage, turnip, carnation, carrot, cashew, cassava, celery, cherry, chestnut, chickpea, chicory, chili pepper, chrysanthemum, citron, coconut, coffee, cotton, cowpea, fava bean, cucumber, currant, gooseberry, date, duckweed, eggplant, elderberry, eucalyptus, flax, geranium, ginger, ginseng, grapefruit, grape, guava, hazelnut, hemp, cannabis, hops, horseradish, iris, jackfruit, kiwifruit, kumquat, lemon, lentil, lettuce, lime, lychee, macadamia, maize, mandarin, mango, mangosteen, melon, millet, oat, oil palm, okra, olive, onion, orange, papaya, parsnip, passionfruit, pecan, peach, nectarine, pear, pea, peanut, peony, persimmon, petunia, pineapple, pistachio, plantain, plum, poinsettia, pomelo, poplar, potato, pumpkin, squash, quince, raspberry, rhubarb, rice, rose, rubber, rye, safflower, satsuma, sesame seed, sorghum, sour orange, soursop, soybean, strawberry, sugar beet, sugarcane, sunflower, sweet potato, tamarind, tangerine, tea, tobacco, tomatillo, tomato, tulip, walnut, watermelon, wheat, and yam.

101. A composition comprising:
a liquid carrier phase;
a plurality of minicells dispersed in the carrier phase,
wherein the plurality of minicells comprises a first effective amount of an exogenous protein toxin comprising Pir; and
a second effective amount of a Bt-derived active ingredient (“AI”);
wherein the first effective amount and the second effective amount are present at a ratio in the range of about 50:1-1:50.

102. The composition of embodiment 101, wherein the first effective amount and the second effective amount are present at a ratio of about 23:1, 22:1, 11:1, 6:1, 3:1, 2:1, or 1.5:1.

103. The composition of embodiment 101 or embodiment 102, wherein the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest.

104. The composition of any one of embodiments 101-103, wherein a particle concentration of the minicell is in the range of about 1×10² to about 8×10¹⁴.

105. The composition of any one of embodiments 101-104, wherein the Bt-derived AI comprises at least one of Bacillus thuringiensis, its fermentation solids, its spores, and its insecticidal toxins.

106. The composition of embodiment 105, wherein the Bt-derived AI comprises at least two, at least three, or all of Bacillus thuringiensis, its fermentation solids, its spores, and its insecticidal toxins.

107. The composition of any one of embodiments 101-106, wherein administering the composition to the insect pest comprises an administration method selected from the group consisting of delivering the composition to the insect pest for ingestion; contacting the insect pest with the composition; delivering the composition to at least one habitat where the insect pest grows, lives, reproduces, feeds, or infests; and applying the composition to a plant.

108. The composition of embodiment 107, wherein the composition is applied to the plant as at least one of a foliar treatment, an injection treatment, a pre-emergence treatment, and a post-emergence treatment.

109. The composition of any one of embodiments 101-108, wherein the composition is formulated as at least one of a Ready To Use (RTU) formulation, a suspension concentrate, a tank-mix, an aerosol, a seed treatment, a root dip, a soil treatment, an irrigation formulation, a sprinkler formulation, a drench treatment, a dust, an emulsifiable concentrate, a flowable concentrate, a formulation intermediate, a granular formulation, an impregnated materials formulation, a pelleted/tableted formulation, a soluble concentrate formulation, a technical chemical formulation, a water dispersable granule formulation, a water soluble packaging formulation, or a wettable powder formulation.

110. The composition of any one of embodiments 101-109, wherein the exogenous protein toxin comprises PirAB or a functional component thereof.

111. The composition of embodiment 110, wherein PirAB comprises a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58, or a functional component of any thereof.

112. The composition of embodiment 111, wherein PirAB comprises the PirA comprising SEQ ID NO: 4 and the PirB comprising SEQ ID NO: 5, or wherein PirAB comprises the PirA comprising SEQ ID NO: 6 and the PirB comprising SEQ ID NO: 7.

113. The composition of embodiment 110, wherein PirAB comprises a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and wherein PirA is linked to a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58 by a linker sequence.

114. The composition of any one of embodiments 101-113, wherein the Bt-derived AI comprises a Bt-derived biological control product selected from the group of Thuricide®, Thuricide® HPC-O RTU, Thuricide® HPC, Thuricide® 48 LV Forestry, Thuricide® 76B, Thuricide® 76 LV, Bonide Bacillus Thuringiensis (BT) Moth Larvae (Caterpillar) Control, DiPel®, Security BT Dust Biological Insecticide, Fertilome Dipel Dust Biological Insecticide, Widestrike®, Plant Pesticide B.T. subsp. tenebrionis Colorado Potato Beetle Protein, SA-50 brand DiPel® dust, Ringer® Vegetable Insect Attack®, Bonide DiPel® 150 Dust For Vegetables, Green Light® DiPel® Dust, Green Light® BT Worm Killer, BT Sulfur 15-50 Dust, NEU1701I, FourStar® Briquets, FourStar® CRG, Britz Bt 25 Sulfur Dust, Thuricide® 32LV, Bonide Mosquito Beater® Water Soluble Pouches, Britz BT Dust, Summit Fallout Bti Granules, DiPel® 10G Sweet Corn Granules, DiPel® 10G Biological Insecticide Granules, DiPel® SG Plus Biological Insecticide Sand Granule, DiPel® 6L Worm Killer, VectoBac® G Biological Larvicide Granules, VectoBac® GR, Summit Mosquito Bits®, Mosquito Bits®, BMP 144 (200 G), Bti Granular Larvicide, FourStar® MBG, DiPel® 8L Worm Killer, TERROR Larvacide, VectoMax® FG Biological Larvicide Fine Granule, Chemsico Insect Granules ML, VectoBac® FG Biological Larvicide Granules, Bti Granules, RF2230 D-Granules, RF2248 U-Granules, AllPro Sustain BCG, BMP 144 (400 G), VectoPrime® FG Biological Larvicide Fine Granules, VectoBac® FG+Biological Larvicide Fine Granule, VectoBac® AS, DiPel® WP Home & Garden Insecticide, DiPel® Bio Garden Spray, WideStrike®, Meridian-02, BMP 144 (2X), grubGONE!® G, Bioprotec, Bioprotec Plus, Bioprotec HP, Bioprotec Caterpillar Insecticide Concentrate, BES0531, Novodor Biological Insecticide Flowable Concentrate, FourStar® Bti CRG, VBC-60092 (Bactimos Briquette), Summit B.t.i. BRIQUETS, Dunks, Sympatico Biological Insecticide, XenTari® AS Biological Insecticide Aqueous Suspension, B402 Biological Larvicide, VectoBac® 12 AS Biological Larvicide Aqueous Suspension, VectoBac® SC Biological Larvicide, BMP 144 (3X), CMP 123 (48 LC), Bactimos PT, Foray 48B, Foray 48BC, Foray 48F Biological Insecticide Flowable Concentrate, Foray 76B, Safer B.T. Caterpillar Killer Concentrate, Bacillus thuringiensis subsp. israelensis slurry, Bacillus thuringiensis subsp. kurstaki slurry, Trident® Biological Insecticide, VBC-60219 Biological Insecticide Slurry, Javelin, Bacillus thuringiensis subsp. aizawai slurry, FlorBac® Slurry Biological Insecticide, DiPel® ES, DiPel® ES-NT Biological Insecticide Emulsifiable Suspension, DiPel® (Worm Killer) Wettable Powder Biological Insecticide, Condor, Leap® ES Bacterial Disease Management Biological Insecticide Emulsifiable Suspension, Biobit® HPWP II Biological Insecticide, VectoBac® WDG Biological Larvicide Water Dispersible Granule, VectoBac® DT Biological Larvicide, Bactimos® WG, VectoBac® WG, BMP 123 (2X WP), Cutlass, Crymax®, Lepinox™ WDG, Crymax® WP, BMP 144 DF 3000, Condor WP, BTI WDG, Condor XL, XenTari® Biological Insecticide Water Dispersible Granule, Agree® WG, Agree® 50 WP, DiPel® DF Biological Insecticide Dry Flowable, XenTari® Biological Insecticide Dry Flowable, DiPel® DF Biological Insecticide, DiPel® 2X Biological Insecticide Wettable Powder, BioBit®® HP Biological Insecticide Wettable Powder, DiPel® WDG Biological Insecticide, VBC-60236 Biological Insecticide Dry Flowable, Foray 2WG Biological Insecticide (Water Dispersible Granules), Thuricide® HPWP, Foray WG, Thyllom beetleGONE!® Biological Insecticide, Javelin WP, ABG-6346 Biological Insecticide, ABG-6345 Technical Powder, Javelin WG, SAN 420 I WG, Javelin WG 2, BTK32, XenTari® Biological Insecticide Technical Powder, Phyllom SDS-502 MP, DiPel® Biological Insecticide Technical Powder, Novodor Technical, VBC-60225 Biological Insecticide Technical Grade Active Ingredient POW, Bonide Bacillus thuringiensis ‘O’, Chemsico HPC-O Concentrate, Thuricide® HPC-O for Home and Gardens, VectoBac® Technical Powder, VectoBac® Biological Larvicide Primary Powder, Bioprotec Technical, Summit BTI MP, BMP 144 Primary Powder, BMP 123 Primary Powder, BMP 144 Primary Powder OSF, Technical CGA-237218, Javelin Technical Concentrate, Thuricide® Technical Concentrate, SAN 420 I Technical Concentrate, CONDOR Technical Powder, Cutlass Technical Powder, Lepinox, BTT SDTC, BTT Liquid Technical Concentrate, and BTI Technical Powder BIOInsecticide.

115. The composition of any one of embodiments 101-114, wherein the plurality of minicells comprises a vector comprising a coding sequence of the exogenous protein toxin.

116. The composition of embodiment 115, wherein the vector comprises a pMB1 origin of replication.

117. The composition of embodiment 115 or embodiment 116, wherein the coding sequence of the exogenous protein toxin is operably linked to a promoter.

118. The composition of embodiment 95117 wherein the first promoter is an inducible promoter or a constitutive promoter.

119. The composition of embodiments 118, wherein the inducible promoter comprises Ptet.

120. The composition of any one of embodiments 115-119, wherein the exogenous protein toxin comprises a PirAB, wherein PirAB comprises the PirA comprising SEQ ID NO: 4 and the PirB comprising SEQ ID NO: 5, and wherein the coding sequence of the PirA comprises SEQ ID NO: 2 and the coding sequence of the PirB comprises SEQ ID NO: 3.

121. The composition of any one of embodiments 115-120, wherein expression of the exogenous protein toxin is induced with aTc.

122. The composition of any one of embodiments 103-121, wherein control comprises at least one of:
a reduction in insect pest number,
a reduction in insect pest weight,
a reduction in physical damage caused by the insect pest, and
   an increase in insect pest mortality.

123. The composition of embodiment 122, wherein the reduction in insect pest number is an at least 10% reduction, an at least 15% reduction, an at least
20% reduction, an at least 25% reduction, an at least 30% reduction, an at least 40% reduction, an at least 50% reduction, an at least 60% reduction, an at least 70% reduction, or an at least 80% reduction,
the reduction in insect pest weight is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in physical damage is an at least 10% reduction, an at least 15% reduction, at least 20% reduction, an at least 25% reduction, an at least 30% reduction, an at least 40% reduction, an at least 50% reduction, an at least 60% reduction, an at least 70% reduction, or an at least 80% reduction, and
the increase in insect pest mortality is an at least 10% increase, an at least 15% increase, an at least 20% increase, an at least 25% increase, an at least 30% increase, an at least 40% increase, an at least 50% increase, an at least 60% increase, an at least 70% increase, or an at least 80% increase.

124. The composition of any one of embodiments 103-123, wherein control comprises an observed insect pest mortality of at least about 55%, 60%, 65%, 70%, 75%, 80%, 85%, 90%, or 95%.

125. The composition of any one of embodiments 101-124, further comprising agrochemical surfactants, wherein the agrochemical surfactants improve at least one of the characteristics of sprayability, spreadability, and injectability.

125. The composition of any one of embodiments 101-125, wherein the liquid carrier phase is aqueous or oil.

126. The composition of any one of embodiments 103-125, wherein the at least one insect pest is selected from the group consisting of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., and Diptera spp.

127. A composition comprising:
a liquid carrier phase; and
a plurality of minicells dispersed in the carrier phase,
wherein the plurality of minicells comprises a minicell comprising a first effective amount of an exogenous protein toxin comprising Pir and a second effective amount of a Bt-derived AI,
wherein the first effective amount and the second effective amount are present at a ratio in the range of about 50:1-1:50.

128. The composition of embodiment 127, wherein the first effective amount and the second effective amount are present at a ratio of about 23:1, 22:1, 11:1, 6:1, 3:1, 2:1, or 1.5:1.

129. The composition of embodiment 127 or embodiment 128, wherein the first effective amount and the second effective amount combined have a synergistic effect on the control of at least one insect pest when the composition is administered to the insect pest that that exceeds an effect of the first effective amount alone and an effect of the second effective amount alone on the control of at least one insect pest when the composition is administered to the insect pest.

130. A method of controlling an insect pest, the method comprising:
administering the composition of any one of embodiments 101-129 to an insect pest.

131. The method of embodiment 130, wherein administering the composition to the insect pest comprises an administration method selected from the group consisting of delivering the composition to the insect pest for ingestion; contacting the insect pest with the composition; delivering the composition to at least one habitat where the insect pest grows, lives, reproduces, feeds, or infests; and applying the composition to a plant.

132. The method of embodiment 131, wherein the composition is applied to the plant as at least one of a foliar treatment, an injection treatment, a pre-emergence treatment, and a post-emergence treatment.

133. The method of any one of embodiments 130-132, wherein the composition is formulated as at least one of a Ready To Use (RTU) formulation, a suspension concentrate, a tank-mix, an aerosol, a seed treatment, a root dip, a soil treatment, an irrigation formulation, a sprinkler formulation, a drench treatment, a dust, an emulsifiable concentrate, a flowable concentrate, a formulation intermediate, a granular formulation, an impregnated materials formulation, a pelleted/tableted formulation, a soluble concentrate formulation, a technical chemical formulation, a water dispersable granule formulation, a water soluble packaging formulation, or a wettable powder formulation.

134. The method of any one of embodiments 130-133, wherein control comprises at least one of:
a reduction in insect pest number,
a reduction in insect pest weight,
a reduction in physical damage caused by the insect pest, and
   an increase in insect pest mortality.

135. The method of embodiment 134, wherein the reduction in insect pest number is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction, the reduction in insect pest weight is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction, the reduction in physical damage is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction, and the increase in insect pest mortality is an at least 10% increase, an at least 15% increase, an at least 20% increase, an at least 25% increase, an at least 30% increase, an at least 40% increase, an at least 50% increase, an at least 60% increase, an at least 70% increase, or an at least 80% increase.

136. The method of any one of embodiments 130-135, wherein control comprises an observed insect pest mortality on the plant of about 55%, 60%, 65%, 70%, 75%, 80%, 85%, 90%, or 95%.

137. The method of any one of embodiments 130-136, wherein the pest is selected from the group consisting of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., and Diptera spp.

138. A wettable powder comprising:
a plurality of dried minicells comprising a mixture of a first effective amount of a minicell comprising an exogenous protein toxin comprising Pir and a second effective amount of a Bt-derived AI,
wherein the first effective amount and the second effective amount are present at a ratio in the range of about 50:1-1:50, and
wherein the wettable powder is configured to be dispersed in an aqueous carrier to create a composition for controlling at least one insect pest when the composition is administered to an insect.

139. The wettable powder of embodiment 138, wherein the first effective amount and the second effective amount are present at a ratio of about 23:1, 22:1, 11:1, 6:1, 3:1, 2:1, or 1.5:1.

140. The wettable powder of embodiment 138 or embodiment 141, wherein the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest.

142. The wettable powder of any one of embodiments 138-140, wherein a particle concentration of the minicell is in the range of about 1×10² to about 8×10¹⁴.

143. The wettable powder of any one of embodiments 138-142, wherein the Bt-derived AI comprises at least one of Bacillus thuringiensis, its fermentation solids, its spores, and its insecticidal toxins.

144. The wettable powder of any one of embodiments 138-143, wherein the Bt-derived AI comprises at least two, at least three, or all of Bacillus thuringiensis, its fermentation solids, its spores, and its insecticidal toxins.

145. The wettable powder of any one of embodiment 138-144, further comprising an agrochemically acceptable solid carrier component comprising at least one of: a clay component, a kaolin component, a talc component, a chalk component, a calcite component, a quartz component, a pumice component, a diatomaceous earth component, a vermiculite component, a silicate component, a silicon dioxide component, a silica powder component, an aluminum component, an ammonium sulfate component, an ammonium phosphate component, a calcium carbonate component, an urea component, a sugar component, a starch component, a sawdust component, a ground coconut shell component, a ground corn cob component, and a ground tobacco stalk component.

146. The wettable powder of any one of embodiments 138-145, wherein the aqueous carrier comprises water.

147. The wettable powder of any one of embodiments 138-146, wherein administering the composition to the insect pest comprises an administration method selected from the group consisting of delivering the composition to the insect pest for ingestion; contacting the insect with the composition; delivering the composition to at least one habitat where the insect pest grows, lives, reproduces, feeds, or infests; and applying the composition to a plant.

148. The wettable powder of embodiment 147, wherein the composition is applied to the plant as at least one of a foliar treatment, an injection treatment, a pre-emergence treatment, and a post-emergence treatment.

149. The wettable powder of any one of embodiments 138-148, wherein the exogenous protein toxin comprises PirAB or a functional component thereof.

150. The wettable powder of embodiment 149, wherein PirAB comprises a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58, or a functional component of any thereof.

151. The wettable powder of embodiment 150, wherein PirAB comprises the PirA comprising SEQ ID NO: 4 and the PirB comprising SEQ ID NO: 5, or wherein PirAB comprises the PirA comprising SEQ ID NO: 6 and the PirB comprising SEQ ID NO: 7.

152. The wettable powder of embodiment 149, wherein PirAB comprises a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and wherein PirA is linked to a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58 by a linker sequence.

153. The wettable powder of any one of embodiments 138-152, wherein the Bt-derived AI comprises a Bt-derived biological control product selected from the group of Thuricide®, Thuricide® HPC-O RTU, Thuricide® HPC, Thuricide® 48 LV Forestry, Thuricide® 76B, Thuricide® 76 LV, Bonide Bacillus Thuringiensis (BT) Moth Larvae (Caterpillar) Control, DiPel®, Security BT Dust Biological Insecticide, Fertilome Dipel Dust Biological Insecticide, Widestrike®, Plant Pesticide B.T. subsp. tenebrionis Colorado Potato Beetle Protein, SA-50 brand DiPel® dust, Ringer® Vegetable Insect Attack®, Bonide DiPel® 150 Dust For Vegetables, Green Light® DiPel® Dust, Green Light® BT Worm Killer, BT Sulfur 15-50 Dust, NEU1701I, FourStar® Briquets, FourStar® CRG, Britz Bt 25 Sulfur Dust, Thuricide® 32LV, Bonide Mosquito Beater® Water Soluble Pouches, Britz BT Dust, Summit Fallout Bti Granules, DiPel® 10G Sweet Corn Granules, DiPel® 10G Biological Insecticide Granules, DiPel® SG Plus Biological Insecticide Sand Granule, DiPel® 6L Worm Killer, VectoBac® G Biological Larvicide Granules, VectoBac® GR, Summit Mosquito Bits®, Mosquito Bits®, BMP 144 (200 G), Bti Granular Larvicide, FourStar® MBG, DiPel® 8L Worm Killer, TERROR Larvacide, VectoMax® FG Biological Larvicide Fine Granule, Chemsico Insect Granules ML, VectoBac® FG Biological Larvicide Granules, Bti Granules, RF2230 D-Granules, RF2248 U-Granules, AllPro Sustain BCG, BMP 144 (400 G), VectoPrime® FG Biological Larvicide Fine Granules, VectoBac® FG+Biological Larvicide Fine Granule, VectoBac® AS, DiPel® WP Home & Garden Insecticide, DiPel® Bio Garden Spray, WideStrike®, Meridian-02, BMP 144 (2X), grubGONE!® G, Bioprotec, Bioprotec Plus, Bioprotec HP, Bioprotec Caterpillar Insecticide Concentrate, BES0531, Novodor Biological Insecticide Flowable Concentrate, FourStar® Bti CRG, VBC-60092 (Bactimos Briquette), Summit B.t.i. BRIQUETS, Dunks, Sympatico Biological Insecticide, XenTari® AS Biological Insecticide Aqueous Suspension, B402 Biological Larvicide, VectoBac® 12 AS Biological Larvicide Aqueous Suspension, VectoBac® SC Biological Larvicide, BMP 144 (3X), CMP 123 (48 LC), Bactimos PT, Foray 48B, Foray 48BC, Foray 48F Biological Insecticide Flowable Concentrate, Foray 76B, Safer B.T. Caterpillar Killer Concentrate, Bacillus thuringiensis subsp. israelensis slurry, Bacillus thuringiensis subsp. kurstaki slurry, Trident® Biological Insecticide, VBC-60219 Biological Insecticide Slurry, Javelin, Bacillus thuringiensis subsp. aizawai slurry, FlorBac® Slurry Biological Insecticide, DiPel® ES, DiPel® ES-NT Biological Insecticide Emulsifiable Suspension, DiPel® (Worm Killer) Wettable Powder Biological Insecticide, Condor, Leap® ES Bacterial Disease Management Biological Insecticide Emulsifiable Suspension, Biobit® HPWP II Biological Insecticide, VectoBac® WDG Biological Larvicide Water Dispersible Granule, VectoBac® DT Biological Larvicide, Bactimos® WG, VectoBac® WG, BMP 123 (2X WP), Cutlass, Crymax®, Lepinox™ WDG, Crymax® WP, BMP 144 DF 3000, Condor WP, BTI WDG, Condor XL, XenTari® Biological Insecticide Water Dispersible Granule, Agree® WG, Agree® 50 WP, DiPel® DF Biological Insecticide Dry Flowable, XenTari® Biological Insecticide Dry Flowable, DiPel® DF Biological Insecticide, DiPel® 2X Biological Insecticide Wettable Powder, BioBit®® HP Biological Insecticide Wettable Powder, DiPel® WDG Biological Insecticide, VBC-60236 Biological Insecticide Dry Flowable, Foray 2WG Biological Insecticide (Water Dispersible Granules), Thuricide® HPWP, Foray WG, Thyllom beetleGONE!® Biological Insecticide, Javelin WP, ABG-6346 Biological Insecticide, ABG-6345 Technical Powder, Javelin WG, SAN 420 I WG, Javelin WG 2, BTK32, XenTari® Biological Insecticide Technical Powder, Phyllom SDS-502 MP, DiPel® Biological Insecticide Technical Powder, Novodor Technical, VBC-60225 Biological Insecticide Technical Grade Active Ingredient POW, Bonide Bacillus thuringiensis ‘O’, Chemsico HPC-O Concentrate, Thuricide® HPC-O for Home and Gardens, VectoBac® Technical Powder, VectoBac® Biological Larvicide Primary Powder, Bioprotec Technical, Summit BTI MP, BMP 144 Primary Powder, BMP 123 Primary Powder, BMP 144 Primary Powder OSF, Technical CGA-237218, Javelin Technical Concentrate, Thuricide® Technical Concentrate, SAN 420 I Technical Concentrate, CONDOR Technical Powder, Cutlass Technical Powder, Lepinox, BTT SDTC, BTT Liquid Technical Concentrate, and BTI Technical Powder BIOInsecticide.

154. The wettable powder of any one of embodiment 138-153, wherein control comprises at least one of:
a reduction in insect pest number,
a reduction in insect pest weight,
a reduction in physical damage caused by the insect pest, and
   an increase in insect pest mortality.

155. The wettable powder of claim 154, wherein
the reduction in insect pest number is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in insect pest weight is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in physical damage is an at least 10% reduction, an at least 15% reduction, at least 20% reduction, an at least 25% reduction, an at least 30% reduction, an at least 40% reduction, an at least 50% reduction, an at least 60% reduction, an at least 70% reduction, or an at least 80% reduction, and
the increase in insect pest mortality is an at least 10% increase, an at least 15% increase, an at least 20% increase, an at least 25% increase, an at least 30% increase, an at least 40% increase, an at least 50% increase, an at least 60% increase, an at least 70% increase, or an at least 80% increase.

156. The wettable powder of any one of embodiments 138-155, wherein control comprises an observed insect pest mortality of at least about 55%, 60%, 65%, 70%, 75%, 80%, 85%, 90%, or 95%.

157. The wettable powder of any one of embodiments 138-156, wherein the at least one insect pest is selected from the group consisting of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., and Diptera spp.

158. A method of producing a wettable powder comprising:
a) providing a first effective amount of a dried minicell comprising an exogenous protein toxin comprising Pir;
b) a second effective amount of a dried Bt-derived AI; and
c) mixing the first effective amount and the second effective amount at a ratio in the range of about 50:1-1:50,
wherein the wettable powder is configured to be dispersed in an aqueous carrier to create a composition for controlling at least one insect pest when the composition is administered to an insect pest.

159. The method of embodiment 158, wherein the first effective amount and the second effective amount are mixed in a ratio of about 23:1, 22:1, 11:1, 6:1, 3:1, 2:1, or 1.5:1.

160. A plantable composition comprising:
a seed; and
a coating covering the seed, wherein the coating comprises a plurality of minicells comprising a mixture of a first effective amount of a minicell comprising an exogenous protein toxin comprising Pir and a second effective amount of a Bt-derived AI,
wherein the first effective amount and the second effective amount are present at a ratio in the range of about 50:1-1:50, and
wherein the mixture is sufficient to result in insecticidal activity on at least one insect pest feeding on the seed or a seedling emerging therefrom.

161. The plantable composition of embodiment 160, wherein the first effective amount and the second effective amount are present at a ratio of about 23:1, 22:1, 11:1, 6:1, 3:1, 2:1, or 1.5:1.

162. The plantable composition of embodiment 160 or embodiment 161, wherein the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest.

163. The plantable composition of any one of embodiments 160-162, wherein a particle concentration of the minicells is in the range of about 1×10² to about 8×10¹⁴.

164. The plantable composition of any one of embodiments 160-163, wherein the Bt-derived AI comprises at least one of Bacillus thuringiensis, its fermentation solids, its spores, and its insecticidal toxins.

165. The plantable composition of embodiment 164, wherein the Bt-derived AI comprises at least two, at least three, or all of Bacillus thuringiensis, its fermentation solids, its spores, and its insecticidal toxins.

166. The plantable composition of any one of embodiments 160-165, wherein the exogenous protein toxin comprises PirAB or a functional component thereof.

167. The plantable composition of embodiment 166, wherein PirAB comprises a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58, or a functional component of any thereof.

168. The plantable composition of embodiment 167, wherein PirAB comprises the PirA comprising SEQ ID NO: 4 and the PirB comprising SEQ ID NO: 5, or wherein PirAB comprises the PirA comprising SEQ ID NO: 6 and the PirB comprising SEQ ID NO: 7.

169. The plantable composition of embodiment 166, wherein PirAB comprises a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and wherein PirA is linked to a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58 by a linker sequence.

170. The plantable composition of any one of embodiments 160-169, wherein the Bt-derived AI comprises a Bt-derived biological control product selected from the group of Thuricide®, Thuricide® HPC-O RTU, Thuricide® HPC, Thuricide® 48 LV Forestry, Thuricide® 76B, Thuricide® 76 LV, Bonide Bacillus Thuringiensis (BT) Moth Larvae (Caterpillar) Control, DiPel®, Security BT Dust Biological Insecticide, Fertilome Dipel Dust Biological Insecticide, Widestrike®, Plant Pesticide B.T. subsp. tenebrionis Colorado Potato Beetle Protein, SA-50 brand DiPel® dust, Ringer® Vegetable Insect Attack®, Bonide DiPel® 150 Dust For Vegetables, Green Light® DiPel® Dust, Green Light® BT Worm Killer, BT Sulfur 15-50 Dust, NEU1701I, FourStar® Briquets, FourStar® CRG, Britz Bt 25 Sulfur Dust, Thuricide® 32LV, Bonide Mosquito Beater® Water Soluble Pouches, Britz BT Dust, Summit Fallout Bti Granules, DiPel® 10G Sweet Corn Granules, DiPel® 10G Biological Insecticide Granules, DiPel® SG Plus Biological Insecticide Sand Granule, DiPel® 6L Worm Killer, VectoBac® G Biological Larvicide Granules, VectoBac® GR, Summit Mosquito Bits®, Mosquito Bits®, BMP 144 (200 G), Bti Granular Larvicide, FourStar® MBG, DiPel® 8L Worm Killer, TERROR Larvacide, VectoMax® FG Biological Larvicide Fine Granule, Chemsico Insect Granules ML, VectoBac® FG Biological Larvicide Granules, Bti Granules, RF2230 D-Granules, RF2248 U-Granules, AllPro Sustain BCG, BMP 144 (400 G), VectoPrime® FG Biological Larvicide Fine Granules, VectoBac® FG+Biological Larvicide Fine Granule, VectoBac® AS, DiPel® WP Home & Garden Insecticide, DiPel® Bio Garden Spray, WideStrike®, Meridian-02, BMP 144 (2X), grubGONE!® G, Bioprotec, Bioprotec Plus, Bioprotec HP, Bioprotec Caterpillar Insecticide Concentrate, BES0531, Novodor Biological Insecticide Flowable Concentrate, FourStar® Bti CRG, VBC-60092 (Bactimos Briquette), Summit B.t.i. BRIQUETS, Dunks, Sympatico Biological Insecticide, XenTari® AS Biological Insecticide Aqueous Suspension, B402 Biological Larvicide, VectoBac® 12 AS Biological Larvicide Aqueous Suspension, VectoBac® SC Biological Larvicide, BMP 144 (3X), CMP 123 (48 LC), Bactimos PT, Foray 48B, Foray 48BC, Foray 48F Biological Insecticide Flowable Concentrate, Foray 76B, Safer B.T. Caterpillar Killer Concentrate, Bacillus thuringiensis subsp. israelensis slurry, Bacillus thuringiensis subsp. kurstaki slurry, Trident® Biological Insecticide, VBC-60219 Biological Insecticide Slurry, Javelin, Bacillus thuringiensis subsp. aizawai slurry, FlorBac® Slurry Biological Insecticide, DiPel® ES, DiPel® ES-NT Biological Insecticide Emulsifiable Suspension, DiPel® (Worm Killer) Wettable Powder Biological Insecticide, Condor, Leap® ES Bacterial Disease Management Biological Insecticide Emulsifiable Suspension, Biobit® HPWP II Biological Insecticide, VectoBac® WDG Biological Larvicide Water Dispersible Granule, VectoBac® DT Biological Larvicide, Bactimos® WG, VectoBac® WG, BMP 123 (2X WP), Cutlass, Crymax®, Lepinox™ WDG, Crymax® WP, BMP 144 DF 3000, Condor WP, BTI WDG, Condor XL, XenTari® Biological Insecticide Water Dispersible Granule, Agree® WG, Agree® 50 WP, DiPel® DF Biological Insecticide Dry Flowable, XenTari® Biological Insecticide Dry Flowable, DiPel® DF Biological Insecticide, DiPel® 2X Biological Insecticide Wettable Powder, BioBit®® HP Biological Insecticide Wettable Powder, DiPel® WDG Biological Insecticide, VBC-60236 Biological Insecticide Dry Flowable, Foray 2WG Biological Insecticide (Water Dispersible Granules), Thuricide® HPWP, Foray WG, Thyllom beetleGONE!® Biological Insecticide, Javelin WP, ABG-6346 Biological Insecticide, ABG-6345 Technical Powder, Javelin WG, SAN 420 I WG, Javelin WG 2, BTK32, XenTari® Biological Insecticide Technical Powder, Phyllom SDS-502 MP, DiPel® Biological Insecticide Technical Powder, Novodor Technical, VBC-60225 Biological Insecticide Technical Grade Active Ingredient POW, Bonide Bacillus thuringiensis ‘O’, Chemsico HPC-O Concentrate, Thuricide® HPC-O for Home and Gardens, VectoBac® Technical Powder, VectoBac® Biological Larvicide Primary Powder, Bioprotec Technical, Summit BTI MP, BMP 144 Primary Powder, BMP 123 Primary Powder, BMP 144 Primary Powder OSF, Technical CGA-237218, Javelin Technical Concentrate, Thuricide® Technical Concentrate, SAN 420 I Technical Concentrate, CONDOR Technical Powder, Cutlass Technical Powder, Lepinox, BTT SDTC, BTT Liquid Technical Concentrate, and BTI Technical Powder BIOInsecticide.

171. The plantable composition of any one of embodiments 160-170, wherein the at least one insect pest is selected from the group consisting of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., and Diptera spp.

172. The plantable composition of any one of embodiments 160-171, wherein the seed is from a plant selected from the group consisting of alfalfa, almond, apple, apricot, artichoke, asparagus, avocado, banana, barley, bean, blueberry, cranberry, Brazil nut, cacao, calamansi, canola, Polish canola, broccoli, kale, cabbage, turnip, carnation, carrot, cashew, cassava, celery, cherry, chestnut, chickpea, chicory, chili pepper, chrysanthemum, citron, coconut, coffee, cotton, cowpea, fava bean, cucumber, currant, gooseberry, date, duckweed, eggplant, elderberry, eucalyptus, flax, geranium, ginger, ginseng, grapefruit, grape, guava, hazelnut, hemp, cannabis, hops, horseradish, iris, jackfruit, kiwifruit, kumquat, lemon, lentil, lettuce, lime, lychee, macadamia, maize, mandarin, mango, mangosteen, melon, millet, oat, oil palm, okra, olive, onion, orange, papaya, parsnip, passionfruit, pecan, peach, nectarine, pear, pea, peanut, peony, persimmon, petunia, pineapple, pistachio, plantain, plum, poinsettia, pomelo, poplar, potato, pumpkin, squash, quince, raspberry, rhubarb, rice, rose, rubber, rye, safflower, satsuma, sesame seed, sorghum, sour orange, soursop, soybean, strawberry, sugar beet, sugarcane, sunflower, sweet potato, tamarind, tangerine, tea, tobacco, tomatillo, tomato, tulip, walnut, watermelon, wheat, and yam.

What is claimed is:

1. A composition comprising:
a liquid carrier phase; and
a plurality of minicells dispersed in the carrier phase,
wherein the plurality of minicells comprises a mixture of a first minicell comprising a first effective amount of a first exogenous protein toxin comprising Pir and a second minicell comprising a second effective amount of a second exogenous protein toxin comprising Cry,
wherein the first effective amount and the second effective amount are present at a ratio in the range of about 50:1-1:50.

2. The composition of claim 1, wherein the first effective amount and the second effective amount are present at a ratio of about 46:1, 23:1, 11:1, 9:1, 6:1, 5:1, 3:1, or 1:1.

3. The composition of claim 1 or claim 2, wherein the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest.

4. The composition of any one of claims 1-3, wherein a first particle concentration of the first minicell is in the range of about 1×10² to about 8×10¹⁴, and wherein a second particle concentration of the second minicell is in the range of about 1×10² to about 8×10¹⁴.

5. The composition of any one of claims 1-4, wherein administering the composition to the insect pest comprises an administration method selected from the group consisting of delivering the composition to the insect pest for ingestion; contacting the insect pest with the composition;
delivering the composition to at least one habitat where the insect pest grows, lives, reproduces, feeds, or infests; and applying the composition to a plant.

6. The composition of claim 5, wherein the composition is applied to the plant as at least one of a foliar treatment, an injection treatment, a pre-emergence treatment, and a post-emergence treatment.

7. The composition of any one of claims 1-6, wherein the composition is formulated as at least one of a Ready To Use (RTU) formulation, a suspension concentrate, a tank-mix, an aerosol, a seed treatment, a root dip, a soil treatment, an irrigation formulation, a sprinkler formulation, and a drench treatment.

8. The composition of any one of claims 1-7, wherein the first exogenous protein toxin comprises PirAB or a functional component thereof.

9. The composition of claim 8, wherein PirAB comprises a PirA selected from the group consisting of SEQ ID NO: 143, SEQ ID NO: 146, SEQ ID NO: 147, SEQ ID NO: 154, SEQ ID NO: 157, SEQ ID NO: 161, SEQ ID NO: 163, SEQ ID NO: 164, SEQ ID NO: 165, SEQ ID NO: 167, SEQ ID NO: 168, SEQ ID NO: 169, SEQ ID NO: 170, SEQ ID NO: 171, SEQ ID NO: 174, SEQ ID NO: 174, SEQ ID NO: 186, SEQ ID NO: 190, SEQ ID NO: 192, SEQ ID NO: 197, SEQ ID NO: 199, SEQ ID NO: 202, and SEQ ID NO: 203; and a PirB selected from the group consisting of SEQ ID NO: 144, SEQ ID NO: 145, SEQ ID NO: 148, SEQ ID NO: 149, SEQ ID NO: 150, SEQ ID NO: 153, SEQ ID NO: 158, SEQ ID NO: 159, SEQ ID NO: 160, SEQ ID NO: 162, SEQ ID NO: 166, SEQ ID NO: 172, SEQ ID NO: 177, SEQ ID NO: 178, SEQ ID NO: 179, SEQ ID NO: 180, SEQ ID NO: 181, SEQ ID NO: 182, SEQ ID NO: 183, SEQ ID NO: 184, SEQ ID NO: 185, SEQ ID NO: 187, SEQ ID NO: 188, SEQ ID NO: 189, SEQ ID NO: 191, SEQ ID NO: 193, SEQ ID NO: 194, SEQ ID NO: 195, SEQ ID NO: 196, SEQ ID NO: 198, SEQ ID NO: 201, and SEQ ID NO: 204, or a functional component of any thereof.

10. The composition of claim 9, wherein PirAB comprises the PirA comprising SEQ ID NO: 203 and the PirB comprising SEQ ID NO: 204, or wherein PirAB comprises the PirA comprising SEQ ID NO: 197 and the PirB comprising SEQ ID NO: 178.

11. The composition of any one of claims 1-10, wherein the second exogenous protein toxin comprises Cry1A, Cry1B, Cry1C, Cry1D, Cry1E, Cry1F, Cry1G, Cry1H, Cry1I, Cry1J, or Cry1K or a functional component thereof.

12. The composition of claim 11, wherein the Cry1A comprises a Cry1A selected from the group consisting of SEQ ID NO: 105, SEQ ID NO: 106, SEQ ID NO: 107, SEQ ID NO: 108, SEQ ID NO: 109, SEQ ID NO: 110, SEQ ID NO: 111, SEQ ID NO: 112, SEQ ID NO: 113, SEQ ID NO: 114, SEQ ID NO: 115, SEQ ID NO: 151, SEQ ID NO: 152, and SEQ ID NO: 205; the Cry1B comprises a Cry1B selected from the group consisting of SEQ ID NO: 117, SEQ ID NO: 118, SEQ ID NO: 119, SEQ ID NO: 120, SEQ ID NO: 121, SEQ ID NO: 122, and SEQ ID NO: 155; the Cry1C comprises a Cry1C selected from the group consisting of SEQ ID NO: 123, SEQ ID NO: 124, SEQ ID NO: 125, and SEQ ID NO: 156; the Cry1D comprises a Cry1D selected from the group consisting of SEQ ID NO: 126, SEQ ID NO: 127, SEQ ID NO: 175, and SEQ ID NO: 176; the Cry1E comprises a Cry1E selected from the group consisting of SEQ ID NO: 128 and SEQ ID NO: 129; the Cry1F comprises a Cry1F selected from the group consisting of SEQ ID NO: 130 and SEQ ID NO: 131; the Cry1G comprises a Cry1G selected from the group consisting of SEQ ID NO: 132 and SEQ ID NO: 133; the Cry1H comprises a Cry1H selected from the group consisting of SEQ ID NO: 134 and SEQ ID NO: 135; the Cry1I comprises a Cry1I selected from the group consisting of SEQ ID NO: 136, SEQ ID NO: 137, SEQ ID NO: 138, and SEQ ID NO: 139; the Cry1J comprises a Cry1J selected from the group consisting of SEQ ID NO: 140 and SEQ ID NO: 141; or the Cry1K comprises SEQ ID NO: 142, or a functional component of any thereof.

13. The composition of claim 11 or claim 12, wherein the second exogenous protein toxin comprises the Cry1A comprising SEQ ID NO: 205.

14. The composition of any one of claims 1-13, wherein the first minicell comprises a first vector comprising a coding sequence of the first exogenous protein toxin.

15. The composition of claim 14, wherein the first vector comprises a CloDF origin of replication or a pMB1 origin of replication.

16. The composition of claim 14 or claim 15, wherein the coding sequence of the first exogenous protein toxin is operably linked to a first promoter.

17. The composition of claim 16, wherein the first promoter is an inducible promoter or a constitutive promoter.

18. The composition of claim 17, wherein the inducible promoter comprises Ptac, Ptet, or PT7.

19. The composition of claim 17, wherein the constitutive promoter comprises J23119 (SEQ ID NO: 200).

20. The composition of any one of claims 14-19, wherein the first exogenous protein toxin comprises a PirAB, wherein PirAB comprises the PirA comprising SEQ ID NO: 203 and the PirB comprising SEQ ID NO: 204, and wherein the coding sequence of the PirA comprises SEQ ID NO: 102 and the coding sequence of the PirB comprises SEQ ID NO: 103.

21. The composition of any one of claims 14-18 and 20, wherein expression of the first exogenous protein toxin is induced with aTc or IPTG.

22. The composition of any one of claims 1-21, wherein the second minicell comprises a second vector comprising a coding sequence of the second exogenous protein toxin.

23. The composition of claim 22, wherein the second vector comprises a CloDF origin of replication or a pMB1 origin of replication.

24. The composition of claim 22 or claim 23, wherein the coding sequence of the second exogenous protein toxin is operably linked to a second promoter.

25. The composition of claim 24, wherein the second promoter is an inducible promoter or a constitutive promoter.

26. The composition of claim 25, wherein the inducible promoter comprises Ptac, Ptet, or PT7.

27. The composition of claim 25, wherein the constitutive promoter comprises J23119 (SEQ ID NO: 200).

28. The composition of any one of claims 22-27, wherein the second exogenous protein toxin comprises a Cry1A, wherein the Cry1A comprises SEQ ID NO: 205, and wherein the coding sequence of the Cry1A comprises SEQ ID NO: 104.

29. The composition of any one of claims 22-26 and 28, wherein expression of the second exogenous protein toxin is induced with aTc or IPTG.

30. The composition of any one of claims 3-29, wherein control comprises at least one of:
a reduction in insect pest number,
a reduction in insect pest weight,
a reduction in physical damage caused by the insect pest, and
an increase in insect pest mortality.

31. The composition of claim 30, wherein
the reduction in insect pest number is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in insect pest weight is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in physical damage is an at least 10% reduction, an at least 15% reduction, at least 20% reduction, an at least 25% reduction, an at least 30% reduction, an at least 40% reduction, an at least 50% reduction, an at least 60% reduction, an at least 70% reduction, or an at least 80% reduction, and
the increase in insect pest mortality is an at least 10% increase, an at least 15% increase, an at least 20% increase, an at least 25% increase, an at least 30% increase, an at least 40% increase, an at least 50% increase, an at least 60% increase, an at least 70% increase, or an at least 80% increase.

32. The composition of any one of claims 3-31, wherein control comprises an observed insect pest mortality of at least about 55%, 60%, 65%, 70%, 75%, 80%, 85%, 90%, or 95%.

33. The composition of any one of claims 1-32, further comprising agrochemical surfactants, wherein the agrochemical surfactants improve at least one of the characteristics of sprayability, spreadability, and injectability.

34. The composition of any one of claims 1-33, wherein the liquid carrier phase is aqueous or oil.

35. The composition of any one of claims 3-34, wherein the at least one insect pest is selected from the group consisting of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., and Diptera spp.

36. A composition comprising:
a liquid carrier phase; and
a plurality of minicells dispersed in the carrier phase,
wherein the plurality of minicells comprises a minicell comprising a first effective amount of a first exogenous protein toxin comprising Pir and a second effective amount of a second exogenous protein toxin comprising Cry1,
wherein the first effective amount and the second effective amount are present at a ratio in the range of about 50:1-1:50.

37. The composition of claim 36, wherein the first effective amount and the second effective amount are present at a ratio of about 46:1, 23:1, 11:1, 9:1, 6:1, 5:1, 3:1, or 1:1.

38. The composition of claim 36 or claim 37, wherein the first effective amount and the second effective amount combined have a synergistic effect on the control of at least one insect pest when the composition is administered to the insect pest that that exceeds an effect of the first effective amount alone and an effect of the second effective amount alone on the control of at least one insect pest when the composition is administered to the insect pest.

39. A method of controlling an insect pest, the method comprising:
administering the composition of any one of claims 1-38 to an insect pest.

40. The method of claim 39, wherein administering the composition to the insect pest comprises an administration method selected from the group consisting of delivering the composition to the insect pest for ingestion; contacting the insect pest with the composition; delivering the composition to at least one habitat where the insect pest grows, lives, reproduces, feeds, or infests; and applying the composition to a plant.

41. The method of claim 40, wherein the composition is applied to the plant as at least one of a foliar treatment, an injection treatment, a pre-emergence treatment, and a post-emergence treatment.

42. The method of any one of claims 39-41, wherein the composition is formulated as at least one of a Ready To Use (RTU) formulation, a suspension concentrate, a tank-mix, an aerosol, a seed treatment, a root dip, a soil treatment, an irrigation formulation, a sprinkler formulation, or a drench treatment.

43. The method of any one of claims 39-42, wherein control comprises at least one of:
a reduction in insect pest number,
a reduction in insect pest weight,
a reduction in physical damage caused by the insect pest, and
an increase in insect pest mortality.

44. The method of claim 43, wherein
the reduction in insect pest number is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in insect pest weight is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in physical damage is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction, and
the increase in insect pest mortality is an at least 10% increase, an at least 15% increase, an at least 20% increase, an at least 25% increase, an at least 30% increase, an at least 40% increase, an at least 50% increase, an at least 60% increase, an at least 70% increase, or an at least 80% increase.

45. The method of any one of claims 39-44, wherein control comprises an observed insect pest mortality on the plant of about 55%, 60%, 65%, 70%, 75%, 80%, 85%, 90%, or 95%.

46. The method of any one of claims 39-45, wherein the pest is selected from the group consisting of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., and Diptera spp.

47. A wettable powder comprising:
a plurality of dried minicells comprising a mixture of a first effective amount of a first minicell comprising a first exogenous protein toxin comprising Pir and a second effective amount of a second minicell comprising a second exogenous protein toxin comprising Cry,
wherein the first effective amount and the second effective amount are present at a ratio in the range of about 50:1-1:50, and
wherein the wettable powder is configured to be dispersed in an aqueous carrier to create a composition for controlling at least one insect pest when the composition is administered to an insect.

48. The wettable powder of claim 47, wherein the first effective amount and the second effective amount are present at a ratio of about 46:1, 23:1, 11:1, 9:1, 6:1, 5:1, 3:1, or 1:1.

49. The wettable powder of claim 47 or claim 48, wherein the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest.

50. The wettable powder of any one of claims 47-49, wherein a first particle concentration of the first minicell is in the range of about 1×10² to about 8×10¹⁴, and wherein a second particle concentration of the second minicell is in the range of about 1×10² to about 8×10¹⁴.

51. The wettable powder of any one of claims 47-50, further comprising an agrochemically acceptable solid carrier component comprising at least one of: a clay component, a kaolin component, a talc component, a chalk component, a calcite component, a quartz component, a pumice component, a diatomaceous earth component, a vermiculite component, a silicate component, a silicon dioxide component, a silica powder component, an aluminum component, an ammonium sulfate component, an ammonium phosphate component, a calcium carbonate component, an urea component, a sugar component, a starch component, a sawdust component, a ground coconut shell component, a ground corn cob component, and a ground tobacco stalk component.

52. The wettable powder of any one of claims 47-51, wherein the aqueous carrier comprises water.

53. The wettable powder of any one of claims 47-52, wherein administering the composition to the insect pest comprises an administration method selected from the group consisting of delivering the composition to the insect pest for ingestion; contacting the insect with the composition; delivering the composition to at least one habitat where the insect pest grows, lives, reproduces, feeds, or infests; and applying the composition to a plant.

54. The composition of claim 53, wherein the composition is applied to the plant as at least one of a foliar treatment, an injection treatment, a pre-emergence treatment, and a post-emergence treatment.

55. The composition of any one of claims 47-54, wherein the first exogenous protein toxin comprises PirAB or a functional component thereof.

56. The composition of claim 55, wherein PirAB comprises a PirA selected from the group consisting of SEQ ID NO: 143, SEQ ID NO: 146, SEQ ID NO: 147, SEQ ID NO: 154, SEQ ID NO: 157, SEQ ID NO: 161, SEQ ID NO: 163, SEQ ID NO: 164, SEQ ID NO: 165, SEQ ID NO: 167, SEQ ID NO: 168, SEQ ID NO: 169, SEQ ID NO: 170, SEQ ID NO: 171, SEQ ID NO: 174, SEQ ID NO: 174, SEQ ID NO: 186, SEQ ID NO: 190, SEQ ID NO: 192, SEQ ID NO: 197, SEQ ID NO: 199, SEQ ID NO: 202, and SEQ ID NO: 203; and a PirB selected from the group consisting of SEQ ID NO: 144, SEQ ID NO: 145, SEQ ID NO: 148, SEQ ID NO: 149, SEQ ID NO: 150, SEQ ID NO: 153, SEQ ID NO: 158, SEQ ID NO: 159, SEQ ID NO: 160, SEQ ID NO: 162, SEQ ID NO: 166, SEQ ID NO: 172, SEQ ID NO: 177, SEQ ID NO: 178, SEQ ID NO: 179, SEQ ID NO: 180, SEQ ID NO: 181, SEQ ID NO: 182, SEQ ID NO: 183, SEQ ID NO: 184, SEQ ID NO: 185, SEQ ID NO: 187, SEQ ID NO: 188, SEQ ID NO: 189, SEQ ID NO: 191, SEQ ID NO: 193, SEQ ID NO: 194, SEQ ID NO: 195, SEQ ID NO: 196, SEQ ID NO: 198, SEQ ID NO: 201, and SEQ ID NO: 204, or a functional component of any thereof.

57. The composition of claim 56, wherein PirAB comprises the PirA comprising SEQ ID NO: 203 and the PirB comprising SEQ ID NO: 204, or wherein PirAB comprises the PirA comprising SEQ ID NO: 197 and the PirB comprising SEQ ID NO: 178.

58. The composition of any one of claims 47-57, wherein the second exogenous protein toxin comprises Cry1A, Cry1B, Cry1C, Cry1D, Cry1E, Cry1F, Cry1G, Cry1H, Cry1I, Cry1J, or Cry1K or a functional component thereof.

59. The composition of claim 58, wherein the Cry1A comprises a Cry1A selected from the group consisting of SEQ ID NO: 105, SEQ ID NO: 106, SEQ ID NO: 107, SEQ ID NO: 108, SEQ ID NO: 109, SEQ ID NO: 110, SEQ ID NO: 111, SEQ ID NO: 112, SEQ ID NO: 113, SEQ ID NO: 14, SEQ ID NO: 115, SEQ ID NO: 151, SEQ ID NO: 152, and SEQ ID NO: 205; the Cry1B comprises a Cry1B selected from the group consisting of SEQ ID NO: 117, SEQ ID NO: 118, SEQ ID NO: 119, SEQ ID NO: 120, SEQ ID NO: 121, SEQ ID NO: 122, and SEQ ID NO: 155; the Cry1C comprises a Cry1C selected from the group consisting of SEQ ID NO: 123, SEQ ID NO: 124, SEQ ID NO: 125, and SEQ ID NO: 156; the Cry1D comprises a Cry1D selected from the group consisting of SEQ ID NO: 126, SEQ ID NO: 127, SEQ ID NO: 175, and SEQ ID NO: 176; the Cry1E comprises a Cry1E selected from the group consisting of SEQ ID NO: 128 and SEQ ID NO: 129; the Cry1F comprises a Cry1F selected from the group consisting of SEQ ID NO: 130 and SEQ ID NO: 131; the Cry1G comprises a Cry1G selected from the group consisting of SEQ ID NO: 132 and SEQ ID NO: 133; the Cry1H comprises a Cry1H selected from the group consisting of SEQ ID NO: 134 and SEQ ID NO: 135; the Cry1I comprises a Cry1I selected from the group consisting of SEQ ID NO: 136, SEQ ID NO: 137, SEQ ID NO: 138, and SEQ ID NO: 139; the Cry1J comprises a Cry1J selected from the group consisting of SEQ ID NO: 140 and SEQ ID NO: 141; or the Cry1K comprises SEQ ID NO: 142 or a functional component of any thereof.

60. The composition of claim 59, wherein the second exogenous protein toxin comprises the Cry1A comprising SEQ ID NO: 205.

61. The composition of any one of claims 47-60, wherein control comprises at least one of:
a reduction in insect pest number,
a reduction in insect pest weight,
a reduction in physical damage caused by the insect pest, and
an increase in insect pest mortality.

62. The composition of claim 61, wherein
the reduction in insect pest number is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in insect pest weight is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in physical damage is an at least 10% reduction, an at least 15% reduction, at least 20% reduction, an at least 25% reduction, an at least 30% reduction, an at least 40% reduction, an at least 50% reduction, an at least 60% reduction, an at least 70% reduction, or an at least 80% reduction, and
the increase in insect pest mortality is an at least 10% increase, an at least 15% increase, an at least 20% increase, an at least 25% increase, an at least 30% increase, an at least 40% increase, an at least 50% increase, an at least 60% increase, an at least 70% increase, or an at least 80% increase.

63. The composition of any one of claims 47-62, wherein control comprises an observed insect pest mortality of at least about 55%, 60%, 65%, 70%, 75%, 80%, 85%, 90%, or 95%.

64. The composition of any one of claims 47-63, wherein the at least one insect pest is selected from the group consisting of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., and Diptera spp.

65. A method of producing a wettable powder comprising:
a) providing a first effective amount of a first dried minicell comprising a first exogenous protein toxin comprising Pir;
b) a second effective amount of a second dried minicell comprising a second exogenous protein toxin comprising Cry; and
c) mixing the first effective amount and the second effective amount at a ratio in the range of about 50:1-1:50,
wherein the wettable powder is configured to be dispersed in an aqueous carrier to create a composition for controlling at least one insect pest when the composition is administered to an insect pest.

66. The method of claim 65, wherein the first effective amount and the second effective amount are mixed in a ratio of about 46:1, 23:1, 11:1, 9:1, 6:1, 5:1, 3:1, or 1:1.

67. A plantable composition comprising:
a seed; and
a coating covering the seed, wherein the coating comprises a plurality of minicells comprising a mixture of a first effective amount of a first minicell comprising a first exogenous protein toxin comprising Pir and a second effective amount of a second minicell comprising a second exogenous protein toxin comprising Cry,
wherein the first effective amount and the second effective amount are present at a ratio in the range of about 50:1-1:50, and
wherein the mixture is sufficient to result in insecticidal activity on at least one insect pest feeding on the seed or a seedling emerging therefrom.

68. The plantable composition of claim 67, wherein the first effective amount and the second effective amount are present at a ratio of about 46:1, 23:1, 11:1, 9:1, 6:1, 5:1, 3:1, or 1:1.

69. The plantable composition of claim 67 or claim 68, wherein the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest.

70. The plantable composition of any one of claims 67-69, wherein a first particle concentration of the first minicells is in the range of about 1×10² to about 8×10¹⁴, and wherein a second particle concentration of the second minicells is in the range of about 1×10² to about 8×10¹⁴.

71. The plantable composition of any one of claims 67-70, wherein the first exogenous protein toxin comprises PirAB or a functional component thereof.

72. The plantable composition of claim 71, wherein PirAB comprises a PirA selected from the group consisting of SEQ ID NO: 143, SEQ ID NO: 146, SEQ ID NO: 147, SEQ ID NO: 154, SEQ ID NO: 157, SEQ ID NO: 161, SEQ ID NO: 163, SEQ ID NO: 164, SEQ ID NO: 165, SEQ ID NO: 167, SEQ ID NO: 168, SEQ ID NO: 169, SEQ ID NO: 170, SEQ ID NO: 171, SEQ ID NO: 174, SEQ ID NO: 174, SEQ ID NO: 186, SEQ ID NO: 190, SEQ ID NO: 192, SEQ ID NO: 197, SEQ ID NO: 199, SEQ ID NO: 202, and SEQ ID NO: 203; and a PirB selected from the group consisting of SEQ ID NO: 144, SEQ ID NO: 145, SEQ ID NO: 148, SEQ ID NO: 149, SEQ ID NO: 150, SEQ ID NO: 153, SEQ ID NO: 158, SEQ ID NO: 159, SEQ ID NO: 160, SEQ ID NO: 162, SEQ ID NO: 166, SEQ ID NO: 172, SEQ ID NO: 177, SEQ ID NO: 178, SEQ ID NO: 179, SEQ ID NO: 180, SEQ ID NO: 181, SEQ ID NO: 182, SEQ ID NO: 183, SEQ ID NO: 184, SEQ ID NO: 185, SEQ ID NO: 187, SEQ ID NO: 188, SEQ ID NO: 189, SEQ ID NO: 191, SEQ ID NO: 193, SEQ ID NO: 194, SEQ ID NO: 195, SEQ ID NO: 196, SEQ ID NO: 198, SEQ ID NO: 201, and SEQ ID NO: 204, or a functional component of any thereof.

73. The plantable composition of claim 72, wherein PirAB comprises the PirA comprising SEQ ID NO: 203 and the PirB comprising SEQ ID NO: 204, or wherein PirAB comprises the PirA comprising SEQ ID NO: 197 and the PirB comprising SEQ ID NO: 178.

74. The plantable composition of any one of claims 67-73, wherein the second exogenous protein toxin comprises Cry1A, Cry1B, Cry1C, Cry1D, Cry1E, Cry1F, Cry1G, Cry1H, Cry1I, Cry1J, or Cry1K or a functional component thereof.

75. The plantable composition of claim 74, wherein the Cry1A comprises a Cry1A selected from the group consisting of SEQ ID NO: 105, SEQ ID NO: 106, SEQ ID NO: 107, SEQ ID NO: 108, SEQ ID NO: 109, SEQ ID NO: 110, SEQ ID NO: 111, SEQ ID NO: 112, SEQ ID NO: 113, SEQ ID NO: 114, SEQ ID NO: 115, SEQ ID NO: 151, SEQ ID NO: 152, and SEQ ID NO: 205; the Cry1B comprises a Cry1B selected from the group consisting of SEQ ID NO: 117, SEQ ID NO: 118, SEQ ID NO: 119, SEQ ID NO: 120, SEQ ID NO: 121, SEQ ID NO: 122, and SEQ ID NO: 155; the Cry1C comprises a Cry1C selected from the group consisting of SEQ ID NO: 123, SEQ ID NO: 124, SEQ ID NO: 125, and SEQ ID NO: 156; the Cry1D comprises a Cry1D selected from the group consisting of SEQ ID NO: 126, SEQ ID NO: 127, SEQ ID NO: 175, and SEQ ID NO: 176; the Cry1E comprises a Cry1E selected from the group consisting of SEQ ID NO: 128 and SEQ ID NO: 129; the Cry1F comprises a Cry1F selected from the group consisting of SEQ ID NO: 130 and SEQ ID NO: 131; the Cry1G comprises a Cry1G selected from the group consisting of SEQ ID NO: 132 and SEQ ID NO: 133; the Cry1H comprises a Cry1H selected from the group consisting of SEQ ID NO: 134 and SEQ ID NO: 135; the Cry1I comprises a Cry1I selected from the group consisting of SEQ ID NO: 136, SEQ ID NO: 137, SEQ ID NO: 138, and SEQ ID NO: 139; the Cry1J comprises a Cry1J selected from the group consisting of SEQ ID NO: 140 and SEQ ID NO: 141; or the Cry1K comprises SEQ ID NO: 142, or a functional component of any thereof.

76. The plantable composition of claim 75, wherein the second exogenous protein toxin comprises the Cry1A comprising SEQ ID NO: 205.

77. The plantable composition of any one of claims 67-76, wherein the at least one insect pest is selected from the group consisting of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., and Diptera spp.

78. The plantable composition of any one of claims 67-77, wherein the seed is from a plant selected from the group consisting of alfalfa, almond, apple, apricot, artichoke, asparagus, avocado, banana, barley, bean, blueberry, cranberry, Brazil nut, cacao, calamansi, canola, Polish canola, broccoli, kale, cabbage, turnip, carnation, carrot, cashew, cassava, celery, cherry, chestnut, chickpea, chicory, chili pepper, chrysanthemum, citron, coconut, coffee, cotton, cowpea, fava bean, cucumber, currant, gooseberry, date, duckweed, eggplant, elderberry, eucalyptus, flax, geranium, ginger, ginseng, grapefruit, grape, guava, hazelnut, hemp, cannabis, hops, horseradish, iris, jackfruit, kiwifruit, kumquat, lemon, lentil, lettuce, lime, lychee, macadamia, maize, mandarin, mango, mangosteen, melon, millet, oat, oil palm, okra, olive, onion, orange, papaya, parsnip, passionfruit, pecan, peach, nectarine, pear, pea, peanut, peony, persimmon, petunia, pineapple, pistachio, plantain, plum, poinsettia, pomelo, poplar, potato, pumpkin, squash, quince, raspberry, rhubarb, rice, rose, rubber, rye, safflower, satsuma, sesame seed, sorghum, sour orange, soursop, soybean, strawberry, sugar beet, sugarcane, sunflower, sweet potato, tamarind, tangerine, tea, tobacco, tomatillo, tomato, tulip, walnut, watermelon, wheat, and yam.

79. A composition comprising:
a liquid carrier phase;
a plurality of minicells dispersed in the carrier phase,
wherein the plurality of minicells comprises a first effective amount of an exogenous protein toxin comprising Pir; and
a second effective amount of a Bt-derived active ingredient (“AI”);
wherein the first effective amount and the second effective amount are present at a ratio in the range of about 50:1-1:50.

80. The composition of claim 79, wherein the first effective amount and the second effective amount are present at a ratio of about 23:1, 22:1, 11:1, 6:1, 3:1, 2:1, or 1.5:1.

81. The composition of claim 79 or claim 80, wherein the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest.

82. The composition of any one of claims 79-81, wherein a particle concentration of the minicell is in the range of about 1×10² to about 8×10¹⁴.

83. The composition of any one of claims 79-82, wherein the Bt-derived AI comprises at least one of Bacillus thuringiensis, its fermentation solids, its spores, and its insecticidal toxins.

84. The composition of claim 83, wherein the Bt-derived AI comprises at least two, at least three, or all of Bacillus thuringiensis, its fermentation solids, its spores, and its insecticidal toxins.

85. The composition of any one of claims 79-84, wherein administering the composition to the insect pest comprises an administration method selected from the group consisting of delivering the composition to the insect pest for ingestion; contacting the insect pest with the composition; delivering the composition to at least one habitat where the insect pest grows, lives, reproduces, feeds, or infests; and applying the composition to a plant.

86. The composition of claim 85, wherein the composition is applied to the plant as at least one of a foliar treatment, an injection treatment, a pre-emergence treatment, and a post-emergence treatment.

87. The composition of any one of claims 79-86, wherein the composition is formulated as at least one of a Ready To Use (RTU) formulation, a suspension concentrate, a tank-mix, an aerosol, a seed treatment, a root dip, a soil treatment, an irrigation formulation, a sprinkler formulation, a drench treatment, a dust, an emulsifiable concentrate, a flowable concentrate, a formulation intermediate, a granular formulation, an impregnated materials formulation, a pelleted/tableted formulation, a soluble concentrate formulation, a technical chemical formulation, a water dispersable granule formulation, a water soluble packaging formulation, or a wettable powder formulation.

88. The composition of any one of claims 79-87, wherein the exogenous protein toxin comprises PirAB or a functional component thereof.

89. The composition of claim 88, wherein PirAB comprises a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58, or a functional component of any thereof.

90. The composition of claim 89, wherein PirAB comprises the PirA comprising SEQ ID NO: 4 and the PirB comprising SEQ ID NO: 5, or wherein PirAB comprises the PirA comprising SEQ ID NO: 6 and the PirB comprising SEQ ID NO: 7.

91. The composition of claim 88, wherein PirAB comprises a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and wherein PirA is linked to a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58 by a linker sequence.

92. The composition of any one of claims 79-91, wherein the Bt-derived AI comprises a Bt-derived biological control product selected from the group of Thuricide®, Thuricide® HPC-O RTU, Thuricide® HPC, Thuricide® 48 LV Forestry, Thuricide® 76B, Thuricide® 76 LV, Bonide Bacillus Thuringiensis (BT) Moth Larvae (Caterpillar) Control, DiPel®, Security BT Dust Biological Insecticide, Fertilome Dipel Dust Biological Insecticide, Widestrike®, Plant Pesticide B.T. subsp. tenebrionis Colorado Potato Beetle Protein, SA-50 brand DiPel® dust, Ringer® Vegetable Insect Attack®, Bonide DiPel® 150 Dust For Vegetables, Green Light® DiPel® Dust, Green Light® BT Worm Killer, BT Sulfur 15-50 Dust, NEU1701I, FourStar® Briquets, FourStar® CRG, Britz Bt 25 Sulfur Dust, Thuricide® 32LV, Bonide Mosquito Beater® Water Soluble Pouches, Britz BT Dust, Summit Fallout Bti Granules, DiPel® 10G Sweet Corn Granules, DiPel® 10G Biological Insecticide Granules, DiPel® SG Plus Biological Insecticide Sand Granule, DiPel® 6L Worm Killer, VectoBac® G Biological Larvicide Granules, VectoBac® GR, Summit Mosquito Bits®, Mosquito Bits®, BMP 144 (200 G), Bti Granular Larvicide, FourStar® MBG, DiPel® 8L Worm Killer, TERROR Larvacide, VectoMax® FG Biological Larvicide Fine Granule, Chemsico Insect Granules ML, VectoBac® FG Biological Larvicide Granules, Bti Granules, RF2230 D-Granules, RF2248 U-Granules, AllPro Sustain BCG, BMP 144 (400 G), VectoPrime® FG Biological Larvicide Fine Granules, VectoBac® FG+Biological Larvicide Fine Granule, VectoBac® AS, DiPel® WP Home & Garden Insecticide, DiPel® Bio Garden Spray, WideStrike®, Meridian-02, BMP 144 (2X), grubGONE!® G, Bioprotec, Bioprotec Plus, Bioprotec HP, Bioprotec Caterpillar Insecticide Concentrate, BES0531, Novodor Biological Insecticide Flowable Concentrate, FourStar® Bti CRG, VBC-60092 (Bactimos Briquette), Summit B.t.i. BRIQUETS, Dunks, Sympatico Biological Insecticide, XenTari® AS Biological Insecticide Aqueous Suspension, B402 Biological Larvicide, VectoBac® 12 AS Biological Larvicide Aqueous Suspension, VectoBac® SC Biological Larvicide, BMP 144 (3X), CMP 123 (48 LC), Bactimos PT, Foray 48B, Foray 48BC, Foray 48F Biological Insecticide Flowable Concentrate, Foray 76B, Safer B.T. Caterpillar Killer Concentrate, Bacillus thuringiensis subsp. israelensis slurry, Bacillus thuringiensis subsp. kurstaki slurry, Trident® Biological Insecticide, VBC-60219 Biological Insecticide Slurry, Javelin, Bacillus thuringiensis subsp. aizawai slurry, FlorBac® Slurry Biological Insecticide, DiPel® ES, DiPel® ES-NT Biological Insecticide Emulsifiable Suspension, DiPel® (Worm Killer) Wettable Powder Biological Insecticide, Condor, Leap® ES Bacterial Disease Management Biological Insecticide Emulsifiable Suspension, Biobit® HPWP II Biological Insecticide, VectoBac® WDG Biological Larvicide Water Dispersible Granule, VectoBac® DT Biological Larvicide, Bactimos® WG, VectoBac® WG, BMP 123 (2X WP), Cutlass, Crymax®, Lepinox™ WDG, Crymax® WP, BMP 144 DF 3000, Condor WP, BTI WDG, Condor XL, XenTari® Biological Insecticide Water Dispersible Granule, Agree® WG, Agree® 50 WP, DiPel® DF Biological Insecticide Dry Flowable, XenTari® Biological Insecticide Dry Flowable, DiPel® DF Biological Insecticide, DiPel® 2X Biological Insecticide Wettable Powder, BioBit®® HP Biological Insecticide Wettable Powder, DiPel® WDG Biological Insecticide, VBC-60236 Biological Insecticide Dry Flowable, Foray 2WG Biological Insecticide (Water Dispersible Granules), Thuricide® HPWP, Foray WG, Thyllom beetleGONE!® Biological Insecticide, Javelin WP, ABG-6346 Biological Insecticide, ABG-6345 Technical Powder, Javelin WG, SAN 420 I WG, Javelin WG 2, BTK32, XenTari® Biological Insecticide Technical Powder, Phyllom SDS-502 MP, DiPel® Biological Insecticide Technical Powder, Novodor Technical, VBC-60225 Biological Insecticide Technical Grade Active Ingredient POW, Bonide Bacillus thuringiensis ‘O’, Chemsico HPC-O Concentrate, Thuricide® HPC-O for Home and Gardens, VectoBac® Technical Powder, VectoBac® Biological Larvicide Primary Powder, Bioprotec Technical, Summit BTI MP, BMP 144 Primary Powder, BMP 123 Primary Powder, BMP 144 Primary Powder OSF, Technical CGA-237218, Javelin Technical Concentrate, Thuricide® Technical Concentrate, SAN 420 I Technical Concentrate, CONDOR Technical Powder, Cutlass Technical Powder, Lepinox, BTT SDTC, BTT Liquid Technical Concentrate, and BTI Technical Powder BIOInsecticide.

93. The composition of any one of claims 79-92, wherein the plurality of minicells comprises a vector comprising a coding sequence of the exogenous protein toxin.

94. The composition of claim 93, wherein the vector comprises a pMB1 origin of replication.

95. The composition of claim 93 or claim 94, wherein the coding sequence of the exogenous protein toxin is operably linked to a promoter.

96. The composition of claim 95, wherein the first promoter is an inducible promoter or a constitutive promoter.

97. The composition of claim 96, wherein the inducible promoter comprises Ptet.

98. The composition of any one of claims 93-97, wherein the exogenous protein toxin comprises a PirAB, wherein PirAB comprises the PirA comprising SEQ ID NO: 4 and the PirB comprising SEQ ID NO: 5, and wherein the coding sequence of the PirA comprises SEQ ID NO: 2 and the coding sequence of the PirB comprises SEQ ID NO: 3.

99. The composition of any one of claims 93-98, wherein expression of the exogenous protein toxin is induced with aTc.

100. The composition of any one of claims 81-99, wherein control comprises at least one of:
a reduction in insect pest number,
a reduction in insect pest weight,
a reduction in physical damage caused by the insect pest, and
an increase in insect pest mortality.

101. The composition of claim 100, wherein
the reduction in insect pest number is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in insect pest weight is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in physical damage is an at least 10% reduction, an at least 15% reduction, at least 20% reduction, an at least 25% reduction, an at least 30% reduction, an at least 40% reduction, an at least 50% reduction, an at least 60% reduction, an at least 70% reduction, or an at least 80% reduction, and
the increase in insect pest mortality is an at least 10% increase, an at least 15% increase, an at least 20% increase, an at least 25% increase, an at least 30% increase, an at least 40% increase, an at least 50% increase, an at least 60% increase, an at least 70% increase, or an at least 80% increase.

102. The composition of any one of claims 81-101, wherein control comprises an observed insect pest mortality of at least about 55%, 60%, 65%, 70%, 75%, 80%, 85%, 90%, or 95%.

103. The composition of any one of claims 79-102, further comprising agrochemical surfactants, wherein the agrochemical surfactants improve at least one of the characteristics of sprayability, spreadability, and injectability.

104. The composition of any one of claims 79-103, wherein the liquid carrier phase is aqueous or oil.

105. The composition of any one of claims 81-104, wherein the at least one insect pest is selected from the group consisting of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., and Diptera spp.

106. A composition comprising:
a liquid carrier phase; and
a plurality of minicells dispersed in the carrier phase,
wherein the plurality of minicells comprises a minicell comprising a first effective amount of an exogenous protein toxin comprising Pir and a second effective amount of a Bt-derived AI,
wherein the first effective amount and the second effective amount are present at a ratio in the range of about 50:1-1:50.

107. The composition of claim 106, wherein the first effective amount and the second effective amount are present at a ratio of about 23:1, 22:1, 11:1, 6:1, 3:1, 2:1, or 1.5:1.

108. The composition of claim 106 or claim 107, wherein the first effective amount and the second effective amount combined have a synergistic effect on the control of at least one insect pest when the composition is administered to the insect pest that that exceeds an effect of the first effective amount alone and an effect of the second effective amount alone on the control of at least one insect pest when the composition is administered to the insect pest.

109. A method of controlling an insect pest, the method comprising:
administering the composition of any one of claims 79-108 to an insect pest.

110. The method of claim 109, wherein administering the composition to the insect pest comprises an administration method selected from the group consisting of delivering the composition to the insect pest for ingestion; contacting the insect pest with the composition; delivering the composition to at least one habitat where the insect pest grows, lives, reproduces, feeds, or infests; and applying the composition to a plant.

111. The method of claim 110, wherein the composition is applied to the plant as at least one of a foliar treatment, an injection treatment, a pre-emergence treatment, and a post-emergence treatment.

112. The method of any one of claims 109-111, wherein the composition is formulated as at least one of a Ready To Use (RTU) formulation, a suspension concentrate, a tank-mix, an aerosol, a seed treatment, a root dip, a soil treatment, an irrigation formulation, a sprinkler formulation, a drench treatment, a dust, an emulsifiable concentrate, a flowable concentrate, a formulation intermediate, a granular formulation, an impregnated materials formulation, a pelleted/tableted formulation, a soluble concentrate formulation, a technical chemical formulation, a water dispersable granule formulation, a water soluble packaging formulation, or a wettable powder formulation.

113. The method of any one of claims 109-112, wherein control comprises at least one of:
a reduction in insect pest number,
a reduction in insect pest weight,
a reduction in physical damage caused by the insect pest, and
an increase in insect pest mortality.

114. The method of claim 113, wherein
the reduction in insect pest number is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in insect pest weight is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in physical damage is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction, and
the increase in insect pest mortality is an at least 10% increase, an at least 15% increase, an at least 20% increase, an at least 25% increase, an at least 30% increase, an at least 40% increase, an at least 50% increase, an at least 60% increase, an at least 70% increase, or an at least 80% increase.

115. The method of any one of claims 109-114, wherein control comprises an observed insect pest mortality on the plant of about 55%, 60%, 65%, 70%, 75%, 80%, 85%, 90%, or 95%.

116. The method of any one of claims 109-115, wherein the pest is selected from the group consisting of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., and Diptera spp.

117. A wettable powder comprising:
a plurality of dried minicells comprising a mixture of a first effective amount of a minicell comprising an exogenous protein toxin comprising Pir and a second effective amount of a Bt-derived AI, wherein the first effective amount and the second effective amount are present at a ratio in the range of about 50:1-1:50, and
wherein the wettable powder is configured to be dispersed in an aqueous carrier to create a composition for controlling at least one insect pest when the composition is administered to an insect.

118. The wettable powder of claim 117, wherein the first effective amount and the second effective amount are present at a ratio of about 23:1, 22:1, 11:1, 6:1, 3:1, 2:1, or 1.5:1.

119. The wettable powder of claim 117 or claim 118, wherein the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest.

120. The wettable powder of any one of claims 117-119, wherein a particle concentration of the minicell is in the range of about 1×10² to about 8×10¹⁴.

121. The wettable powder of any one of claims 117-120, wherein the Bt-derived AI comprises at least one of Bacillus thuringiensis, its fermentation solids, its spores, and its insecticidal toxins.

122. The wettable powder of any one of claims 117-121, wherein the Bt-derived AI comprises at least two, at least three, or all of Bacillus thuringiensis, its fermentation solids, its spores, and its insecticidal toxins.

123. The wettable powder of any one of claims 117-122, further comprising an agrochemically acceptable solid carrier component comprising at least one of: a clay component, a kaolin component, a talc component, a chalk component, a calcite component, a quartz component, a pumice component, a diatomaceous earth component, a vermiculite component, a silicate component, a silicon dioxide component, a silica powder component, an aluminum component, an ammonium sulfate component, an ammonium phosphate component, a calcium carbonate component, an urea component, a sugar component, a starch component, a sawdust component, a ground coconut shell component, a ground corn cob component, and a ground tobacco stalk component.

124. The wettable powder of any one of claims 117-123, wherein the aqueous carrier comprises water.

125. The wettable powder of any one of claims 117-124, wherein administering the composition to the insect pest comprises an administration method selected from the group consisting of delivering the composition to the insect pest for ingestion; contacting the insect with the composition; delivering the composition to at least one habitat where the insect pest grows, lives, reproduces, feeds, or infests; and applying the composition to a plant.

126. The wettable powder of claim 125, wherein the composition is applied to the plant as at least one of a foliar treatment, an injection treatment, a pre-emergence treatment, and a post-emergence treatment.

127. The wettable powder of any one of claims 117-126, wherein the exogenous protein toxin comprises PirAB or a functional component thereof.

128. The wettable powder of claim 127, wherein PirAB comprises a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58, or a functional component of any thereof.

129. The wettable powder of claim 128, wherein PirAB comprises the PirA comprising SEQ ID NO: 4 and the PirB comprising SEQ ID NO: 5, or wherein PirAB comprises the PirA comprising SEQ ID NO: 6 and the PirB comprising SEQ ID NO: 7.

130. The wettable powder of claim 127, wherein PirAB comprises a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and wherein PirA is linked to a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58 by a linker sequence.

131. The wettable powder of any one of claims 117-130, wherein the Bt-derived AI comprises a Bt-derived biological control product selected from the group of Thuricide®, Thuricide® HPC-O RTU, Thuricide® HPC, Thuricide® 48 LV Forestry, Thuricide® 76B, Thuricide® 76 LV, Bonide Bacillus Thuringiensis (BT) Moth Larvae (Caterpillar) Control, DiPel®, Security BT Dust Biological Insecticide, Fertilome Dipel Dust Biological Insecticide, Widestrike®, Plant Pesticide B.T. subsp. tenebrionis Colorado Potato Beetle Protein, SA-50 brand DiPel® dust, Ringer® Vegetable Insect Attack®, Bonide DiPel® 150 Dust For Vegetables, Green Light® DiPel® Dust, Green Light® BT Worm Killer, BT Sulfur 15-50 Dust, NEU1701I, FourStar® Briquets, FourStar® CRG, Britz Bt 25 Sulfur Dust, Thuricide® 32LV, Bonide Mosquito Beater® Water Soluble Pouches, Britz BT Dust, Summit Fallout Bti Granules, DiPel® 10G Sweet Corn Granules, DiPel® 10G Biological Insecticide Granules, DiPel® SG Plus Biological Insecticide Sand Granule, DiPel® 6L Worm Killer, VectoBac® G Biological Larvicide Granules, VectoBac® GR, Summit Mosquito Bits®, Mosquito Bits®, BMP 144 (200 G), Bti Granular Larvicide, FourStar® MBG, DiPel® 8L Worm Killer, TERROR Larvacide, VectoMax® FG Biological Larvicide Fine Granule, Chemsico Insect Granules ML, VectoBac® FG Biological Larvicide Granules, Bti Granules, RF2230 D-Granules, RF2248 U-Granules, AllPro Sustain BCG, BMP 144 (400 G), VectoPrime® FG Biological Larvicide Fine Granules, VectoBac® FG+Biological Larvicide Fine Granule, VectoBac® AS, DiPel® WP Home & Garden Insecticide, DiPel® Bio Garden Spray, WideStrike®, Meridian-02, BMP 144 (2X), grubGONE!® G, Bioprotec, Bioprotec Plus, Bioprotec HP, Bioprotec Caterpillar Insecticide Concentrate, BES0531, Novodor Biological Insecticide Flowable Concentrate, FourStar® Bti CRG, VBC-60092 (Bactimos Briquette), Summit B.t.i. BRIQUETS, Dunks, Sympatico Biological Insecticide, XenTari® AS Biological Insecticide Aqueous Suspension, B402 Biological Larvicide, VectoBac® 12 AS Biological Larvicide Aqueous Suspension, VectoBac® SC Biological Larvicide, BMP 144 (3X), CMP 123 (48 LC), Bactimos PT, Foray 48B, Foray 48BC, Foray 48F Biological Insecticide Flowable Concentrate, Foray 76B, Safer B.T. Caterpillar Killer Concentrate, Bacillus thuringiensis subsp. israelensis slurry, Bacillus thuringiensis subsp. kurstaki slurry, Trident® Biological Insecticide, VBC-60219 Biological Insecticide Slurry, Javelin, Bacillus thuringiensis subsp. aizawai slurry, FlorBac® Slurry Biological Insecticide, DiPel® ES, DiPel® ES-NT Biological Insecticide Emulsifiable Suspension, DiPel® (Worm Killer) Wettable Powder Biological Insecticide, Condor, Leap® ES Bacterial Disease Management Biological Insecticide Emulsifiable Suspension, Biobit® HPWP II Biological Insecticide, VectoBac® WDG Biological Larvicide Water Dispersible Granule, VectoBac® DT Biological Larvicide, Bactimos® WG, VectoBac® WG, BMP 123 (2X WP), Cutlass, Crymax®, Lepinox™ WDG, Crymax® WP, BMP 144 DF 3000, Condor WP, BTI WDG, Condor XL, XenTari® Biological Insecticide Water Dispersible Granule, Agree® WG, Agree® 50 WP, DiPel® DF Biological Insecticide Dry Flowable, XenTari® Biological Insecticide Dry Flowable, DiPel® DF Biological Insecticide, DiPel® 2X Biological Insecticide Wettable Powder, BioBit®® HP Biological Insecticide Wettable Powder, DiPel® WDG Biological Insecticide, VBC-60236 Biological Insecticide Dry Flowable, Foray 2WG Biological Insecticide (Water Dispersible Granules), Thuricide® HPWP, Foray WG, Thyllom beetleGONE!® Biological Insecticide, Javelin WP, ABG-6346 Biological Insecticide, ABG-6345 Technical Powder, Javelin WG, SAN 420 I WG, Javelin WG 2, BTK32, XenTari® Biological Insecticide Technical Powder, Phyllom SDS-502 MP, DiPel® Biological Insecticide Technical Powder, Novodor Technical, VBC-60225 Biological Insecticide Technical Grade Active Ingredient POW, Bonide Bacillus thuringiensis ‘O’, Chemsico HPC-O Concentrate, Thuricide® HPC-O for Home and Gardens, VectoBac® Technical Powder, VectoBac® Biological Larvicide Primary Powder, Bioprotec Technical, Summit BTI MP, BMP 144 Primary Powder, BMP 123 Primary Powder, BMP 144 Primary Powder OSF, Technical CGA-237218, Javelin Technical Concentrate, Thuricide® Technical Concentrate, SAN 420 I Technical Concentrate, CONDOR Technical Powder, Cutlass Technical Powder, Lepinox, BTT SDTC, BTT Liquid Technical Concentrate, and BTI Technical Powder BIOInsecticide.

132. The wettable powder of any one of claims 117-131, wherein control comprises at least one of:
a reduction in insect pest number,
a reduction in insect pest weight,
a reduction in physical damage caused by the insect pest, and
an increase in insect pest mortality.

133. The wettable powder of claim 132, wherein
the reduction in insect pest number is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in insect pest weight is an at least 10% reduction, an at least 15% reduction, an at least 20% reduction, an at least 25% reduction, an at least 30% reduction, an at least 40% reduction, an at least 50% reduction, an at least 60% reduction, an at least 70% reduction, or an at least 80% reduction,
the reduction in physical damage is an at least 10% reduction, an at least 15% reduction, at least 20% reduction, an at least 25% reduction, an at least 30% reduction, an at least 40% reduction, an at least 50% reduction, an at least 60% reduction, an at least 70% reduction, or an at least 80% reduction, and
the increase in insect pest mortality is an at least 10% increase, an at least 15% increase, an at least 20% increase, an at least 25% increase, an at least 30% increase, an at least 40% increase, an at least 50% increase, an at least 60% increase, an at least 70% increase, or an at least 80% increase.

134. The wettable powder of any one of claims 117-133, wherein control comprises an observed insect pest mortality of at least about 55%, 60%, 65%, 70%, 75%, 80%, 85%, 90%, or 95%.

135. The wettable powder of any one of claims 117-134, wherein the at least one insect pest is selected from the group consisting of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., and Diptera spp.

136. A method of producing a wettable powder comprising:
a) providing a first effective amount of a dried minicell comprising an exogenous protein toxin comprising Pir;
b) a second effective amount of a dried Bt-derived AI; and
c) mixing the first effective amount and the second effective amount at a ratio in the range of about 50:1-1:50,
wherein the wettable powder is configured to be dispersed in an aqueous carrier to create a composition for controlling at least one insect pest when the composition is administered to an insect pest.

137. The method of claim 136, wherein the first effective amount and the second effective amount are mixed in a ratio of about 23:1, 22:1, 11:1, 6:1, 3:1, 2:1, or 1.5:1.

138. A plantable composition comprising:
a seed; and
a coating covering the seed, wherein the coating comprises a plurality of minicells comprising a mixture of a first effective amount of a minicell comprising an exogenous protein toxin comprising Pir and a second effective amount of a Bt-derived AI,
wherein the first effective amount and the second effective amount are present at a ratio in the range of about 50:1-1:50, and
wherein the mixture is sufficient to result in insecticidal activity on at least one insect pest feeding on the seed or a seedling emerging therefrom.

139. The plantable composition of claim 138, wherein the first effective amount and the second effective amount are present at a ratio of about 23:1, 22:1, 11:1, 6:1, 3:1, 2:1, or 1.5:1.

140. The plantable composition of claim 138 or claim 139, wherein the mixture of the first effective amount and the second effective amount has a synergistic effect on the control of at least one insect pest when the composition is administered to the insect pest that exceeds an effect of the first effective amount alone and an effect of the second effective amount alone on the control of at least one insect pest when the first or second effective amount is administered to the insect pest.

141. The plantable composition of any one of claims 138-140, wherein a particle concentration of the minicells is in the range of about 1×10² to about 8×10¹⁴.

142. The plantable composition of any one of claims 138-141, wherein the Bt-derived AI comprises at least one of Bacillus thuringiensis, its fermentation solids, its spores, and its insecticidal toxins.

143. The plantable composition of claim 142, wherein the Bt-derived AI comprises at least two, at least three, or all of Bacillus thuringiensis, its fermentation solids, its spores, and its insecticidal toxins.

144. The plantable composition of any one of claims 138-143, wherein the exogenous protein toxin comprises PirAB or a functional component thereof.

145. The plantable composition of claim 144, wherein PirAB comprises a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58, or a functional component of any thereof.

146. The plantable composition of claim 145, wherein PirAB comprises the PirA comprising SEQ ID NO: 4 and the PirB comprising SEQ ID NO: 5, or wherein PirAB comprises the PirA comprising SEQ ID NO: 6 and the PirB comprising SEQ ID NO: 7.

147. The plantable composition of claim 144, wherein PirAB comprises a PirA selected from the group consisting of SEQ ID NO: 4, SEQ ID NO: 6, SEQ ID NO: 8, SEQ ID NO: 10, SEQ ID NO: 12, SEQ ID NO: 14, SEQ ID NO: 16, SEQ ID NO: 17, SEQ ID NO: 18, SEQ ID NO: 19, SEQ ID NO: 20, SEQ ID NO: 21, SEQ ID NO: 22, SEQ ID NO: 23, SEQ ID NO: 24, SEQ ID NO: 25, SEQ ID NO: 26, SEQ ID NO: 27, SEQ ID NO: 28, SEQ ID NO: 29, SEQ ID NO: 30, SEQ ID NO: 31, and SEQ ID NO: 32; and wherein PirA is linked to a PirB selected from the group consisting of SEQ ID NO: 5, SEQ ID NO: 7, SEQ ID NO: 9, SEQ ID NO: 11, SEQ ID NO: 13, SEQ ID NO: 15, SEQ ID NO: 33, SEQ ID NO: 34, SEQ ID NO: 35, SEQ ID NO: 36, SEQ ID NO: 37, SEQ ID NO: 38, SEQ ID NO: 39, SEQ ID NO: 40, SEQ ID NO: 41, SEQ ID NO: 42, SEQ ID NO: 43, SEQ ID NO: 44, SEQ ID NO: 45, SEQ ID NO: 46, SEQ ID NO: 47, SEQ ID NO: 48, SEQ ID NO: 49, SEQ ID NO: 50, SEQ ID NO: 51, SEQ ID NO: 52, SEQ ID NO: 53, SEQ ID NO: 54, SEQ ID NO: 55, SEQ ID NO: 56, SEQ ID NO: 57, and SEQ ID NO: 58 by a linker sequence.

148. The plantable composition of any one of claims 138-147, wherein the Bt-derived AI comprises a Bt-derived biological control product selected from the group of Thuricide®, Thuricide® HPC-O RTU, Thuricide® HPC, Thuricide® 48 LV Forestry, Thuricide® 76B, Thuricide® 76 LV, Bonide Bacillus Thuringiensis (BT) Moth Larvae (Caterpillar) Control, DiPel®, Security BT Dust Biological Insecticide, Fertilome Dipel Dust Biological Insecticide, Widestrike®, Plant Pesticide B.T. subsp. tenebrionis Colorado Potato Beetle Protein, SA-50 brand DiPel® dust, Ringer® Vegetable Insect Attack®, Bonide DiPel® 150 Dust For Vegetables, Green Light® DiPel® Dust, Green Light® BT Worm Killer, BT Sulfur 15-50 Dust, NEU1701I, FourStar® Briquets, FourStar® CRG, Britz Bt 25 Sulfur Dust, Thuricide® 32LV, Bonide Mosquito Beater® Water Soluble Pouches, Britz BT Dust, Summit Fallout Bti Granules, DiPel® 10G Sweet Corn Granules, DiPel® 10G Biological Insecticide Granules, DiPel® SG Plus Biological Insecticide Sand Granule, DiPel® 6L Worm Killer, VectoBac® G Biological Larvicide Granules, VectoBac® GR, Summit Mosquito Bits®, Mosquito Bits®, BMP 144 (200 G), Bti Granular Larvicide, FourStar® MBG, DiPel® 8L Worm Killer, TERROR Larvacide, VectoMax® FG Biological Larvicide Fine Granule, Chemsico Insect Granules ML, VectoBac® FG Biological Larvicide Granules, Bti Granules, RF2230 D-Granules, RF2248 U-Granules, AllPro Sustain BCG, BMP 144 (400 G), VectoPrime® FG Biological Larvicide Fine Granules, VectoBac® FG+Biological Larvicide Fine Granule, VectoBac® AS, DiPel® WP Home & Garden Insecticide, DiPel® Bio Garden Spray, WideStrike®, Meridian-02, BMP 144 (2X), grubGONE!® G, Bioprotec, Bioprotec Plus, Bioprotec HP, Bioprotec Caterpillar Insecticide Concentrate, BES0531, Novodor Biological Insecticide Flowable Concentrate, FourStar® Bti CRG, VBC-60092 (Bactimos Briquette), Summit B.t.i. BRIQUETS, Dunks, Sympatico Biological Insecticide, XenTari® AS Biological Insecticide Aqueous Suspension, B402 Biological Larvicide, VectoBac® 12 AS Biological Larvicide Aqueous Suspension, VectoBac® SC Biological Larvicide, BMP 144 (3X), CMP 123 (48 LC), Bactimos PT, Foray 48B, Foray 48BC, Foray 48F Biological Insecticide Flowable Concentrate, Foray 76B, Safer B.T. Caterpillar Killer Concentrate, Bacillus thuringiensis subsp. israelensis slurry, Bacillus thuringiensis subsp. kurstaki slurry, Trident® Biological Insecticide, VBC-60219 Biological Insecticide Slurry, Javelin, Bacillus thuringiensis subsp. aizawai slurry, FlorBac® Slurry Biological Insecticide, DiPel® ES, DiPel® ES-NT Biological Insecticide Emulsifiable Suspension, DiPel® (Worm Killer) Wettable Powder Biological Insecticide, Condor, Leap® ES Bacterial Disease Management Biological Insecticide Emulsifiable Suspension, Biobit® HPWP II Biological Insecticide, VectoBac® WDG Biological Larvicide Water Dispersible Granule, VectoBac® DT Biological Larvicide, Bactimos® WG, VectoBac® WG, BMP 123 (2X WP), Cutlass, Crymax®, Lepinox™ WDG, Crymax® WP, BMP 144 DF 3000, Condor WP, BTI WDG, Condor XL, XenTari® Biological Insecticide Water Dispersible Granule, Agree® WG, Agree® 50 WP, DiPel® DF Biological Insecticide Dry Flowable, XenTari® Biological Insecticide Dry Flowable, DiPel® DF Biological Insecticide, DiPel® 2X Biological Insecticide Wettable Powder, BioBit®® HP Biological Insecticide Wettable Powder, DiPel® WDG Biological Insecticide, VBC-60236 Biological Insecticide Dry Flowable, Foray 2WG Biological Insecticide (Water Dispersible Granules), Thuricide® HPWP, Foray WG, Thyllom beetleGONE!® Biological Insecticide, Javelin WP, ABG-6346 Biological Insecticide, ABG-6345 Technical Powder, Javelin WG, SAN 420 I WG, Javelin WG 2, BTK32, XenTari® Biological Insecticide Technical Powder, Phyllom SDS-502 MP, DiPel® Biological Insecticide Technical Powder, Novodor Technical, VBC-60225 Biological Insecticide Technical Grade Active Ingredient POW, Bonide Bacillus thuringiensis ‘O’, Chemsico HPC-O Concentrate, Thuricide® HPC-O for Home and Gardens, VectoBac® Technical Powder, VectoBac® Biological Larvicide Primary Powder, Bioprotec Technical, Summit BTI MP, BMP 144 Primary Powder, BMP 123 Primary Powder, BMP 144 Primary Powder OSF, Technical CGA-237218, Javelin Technical Concentrate, Thuricide® Technical Concentrate, SAN 420 I Technical Concentrate, CONDOR Technical Powder, Cutlass Technical Powder, Lepinox, BTT SDTC, BTT Liquid Technical Concentrate, and BTI Technical Powder BIOInsecticide.

149. The plantable composition of any one of claims 138-148, wherein the at least one insect pest is selected from the group consisting of Diamondback moth (DBM), Cutworm, Fall armyworm (FAW), Red flour beetle (RFB), Colorado potato beetle (CPB), Mediterranean flour moth, Asian spotted bollworm, Lepidoptera spp., Coleoptera spp., and Diptera spp.

150. The plantable composition of any one of claims 138-149, wherein the seed is from a plant selected from the group consisting of alfalfa, almond, apple, apricot, artichoke, asparagus, avocado, banana, barley, bean, blueberry, cranberry, Brazil nut, cacao, calamansi, canola, Polish canola, broccoli, kale, cabbage, turnip, carnation, carrot, cashew, cassava, celery, cherry, chestnut, chickpea, chicory, chili pepper, chrysanthemum, citron, coconut, coffee, cotton, cowpea, fava bean, cucumber, currant, gooseberry, date, duckweed, eggplant, elderberry, eucalyptus, flax, geranium, ginger, ginseng, grapefruit, grape, guava, hazelnut, hemp, cannabis, hops, horseradish, iris, jackfruit, kiwifruit, kumquat, lemon, lentil, lettuce, lime, lychee, macadamia, maize, mandarin, mango, mangosteen, melon, millet, oat, oil palm, okra, olive, onion, orange, papaya, parsnip, passionfruit, pecan, peach, nectarine, pear, pea, peanut, peony, persimmon, petunia, pineapple, pistachio, plantain, plum, poinsettia, pomelo, poplar, potato, pumpkin, squash, quince, raspberry, rhubarb, rice, rose, rubber, rye, safflower, satsuma, sesame seed, sorghum, sour orange, soursop, soybean, strawberry, sugar beet, sugarcane, sunflower, sweet potato, tamarind, tangerine, tea, tobacco, tomatillo, tomato, tulip, walnut, watermelon, wheat, and yam.
